(19) United States
(12) Patent Application Publication
(10) Pub. No.: US 2025/0181491 A1
(43) Pub. Date: Jun. 5, 2025

(54) SYSTEM, METHOD, AND COMPUTER PROGRAM PRODUCT FOR IMPROVING MEMORY SYSTEMS

(71) Applicant: Smith Memory Technologies, LLC, Cedar Park, TX (US)

(72) Inventor: Michael S. Smith, Palo Alto, CA (US)

(21) Appl. No.: 19/035,783

(22) Filed: Jan. 23, 2025

Related U.S. Application Data
(63) Continuation-in-part of application No. 18/416,801, filed on Jan. 18, 2024.
Application No. 18/416,801 is a continuation of application No. 16/297,572, filed on Mar. 8, 2019, now abandoned.
Application No. 16/297,572 is a continuation of application No. 16/290,810, filed on Mar. 1, 2019, now abandoned.
Application No. 16/290,810 is a continuation of application No. 15/835,419, filed on Dec. 7, 2017, now abandoned.
Application No. 15/835,419 is a continuation of application No. 15/250,873, filed on Aug. 29, 2016, now abandoned.
Application No. 15/250,873 is a continuation of application No. 14/981,867, filed on Dec. 28, 2015, now abandoned.
Application No. 14/981,867 is a continuation of application No. 14/589,937, filed on Jan. 5, 2015, now Pat. No. 9,223,507.
Application No. 14/589,937 is a continuation of application No. 13/441,132, filed on Apr. 6, 2012, now Pat. No. 8,930,647.
Application No. 15/250,873 is a continuation-in-part of application No. 14/169,127, filed on Jan. 30, 2014, now abandoned.
Application No. 15/250,873 is a continuation-in-part of application No. 13/710,411, filed on Dec. 10, 2012, now Pat. No. 9,432,298.
(60) Provisional application No. 61/502,100, filed on Jun. 28, 2011.
(60) Provisional application No. 61/472,558, filed on Apr. 6, 2011.
(60) Provisional application No. 61/859,516, filed on Jul. 29, 2013.
(60) Provisional application No. 61/833,408, filed on Jun. 10, 2013.
(60) Provisional application No. 61/759,764, filed on Feb. 1, 2013.
(60) Provisional application No. 61/714,154, filed on Oct. 15, 2012.
(60) Provisional application No. 61/698,690, filed on Sep. 9, 2012.
(60) Provisional application No. 61/679,720, filed on Aug. 4, 2012.
(60) Provisional application No. 61/673,192, filed on Jul. 18, 2012.
(60) Provisional application No. 61/665,301, filed on Jun. 27, 2012.
(60) Provisional application No. 61/647,492, filed on May 15, 2012.
(60) Provisional application No. 61/635,834, filed on Apr. 19, 2012.
(60) Provisional application No. 61/608,085, filed on Mar. 7, 2012.
(60) Provisional application No. 61/602,034, filed on Feb. 22, 2012.
(60) Provisional application No. 61/585,640, filed on Jan. 11, 2012.
(60) Provisional application No. 61/580,300, filed on Dec. 26, 2011.
(60) Provisional application No. 61/569,107, filed on Dec. 9, 2011.

(51) Int. Cl. G06F 12/02; G06F 3/06; G06F 12/06; G06F 12/0866; G06F 12/12

(52) U.S. Cl. CPC G06F 12/0215; G06F 3/0613; G06F 3/065; G06F 3/0659; G06F 3/0679; G06F 12/0246; G06F 12/0638; G06F 12/0866; G06F 12/12; G06F 2212/205; G06F 2212/654; G06F 2212/7203

(57) ABSTRACT

A system, method, and computer program product are provided for cooperation memory system. The system includes a first semiconductor platform including at least one first circuit, and at least one additional semiconductor platform stacked with the first semiconductor platform and including at least one additional circuit. The system further includes an adjustment of at least one aspect of the system, for repairing one or more faulty components of the memory subsystem capable of including: a through-silicon via (TSV) between the first memory and the second memory, and a memory cell of at least one of the first memory or the second memory.

### CROSS-REFERENCE TO RELATED APPLICATIONS

The present application is a continuation-in-part of U.S. patent application Ser. No. 18/416,801, filed Jan. 18, 2024, entitled “MEMORY SYSTEM, METHOD AND COMPUTER PROGRAM PRODUCTS, which in turn is a continuation of, and claims priority to U.S. patent application Ser. No. 16/297,572, filed Mar. 8, 2016, entitled “MEMORY SYSTEM, METHOD AND COMPUTER PROGRAM PRODUCTS,” which in turn is a continuation of, and claims priority to U.S. patent application Ser. No. 16/290,810, filed Mar. 1, 2019, entitled “MEMORY SYSTEM, METHOD AND COMPUTER PROGRAM PRODUCTS,” which is a continuation of, and claims priority to U.S. patent application Ser. No. 15/835,419, filed Dec. 7, 2017, entitled “SYSTEM, METHOD AND COMPUTER PROGRAM PRODUCT FOR FETCHING DATA BETWEEN AN EXECUTION OF A PLURALITY OF THREADS,” which is a continuation-in-part of, and claims priority to U.S. patent application Ser. No. 15/250,873, filed Aug. 29, 2016, entitled “SYSTEM, METHOD AND COMPUTER PROGRAM PRODUCT FOR FETCHING DATA BETWEEN AN EXECUTION OF A PLURALITY OF THREADS,” which is a continuation-in-part of, and claims priority to U.S. patent application Ser. No. 14/981,867, filed Dec. 28, 2015, entitled “SYSTEM, METHOD AND COMPUTER PROGRAM PRODUCT FOR FETCHING DATA BETWEEN AN EXECUTION OF A PLURALITY OF THREADS,” which is a continuation of, and claims priority to U.S. patent application Ser. No. 14/589,937, filed Jan. 5, 2015, entitled “SYSTEM, METHOD AND COMPUTER PROGRAM PRODUCT FOR FETCHING DATA BETWEEN AN EXECUTION OF A PLURALITY OF THREADS,” now U.S. Pat. No. 9,223,507, which is a continuation-in-part of, and claims priority to U.S. patent application Ser. No. 13/441,132, filed Apr. 6, 2012, entitled “MULTIPLE CLASS MEMORY SYSTEMS,” now U.S. Pat. No. 8,930,647, which claims priority to U.S. Prov. App. No. 61/472,558 that was filed Apr. 6, 2011 and entitled “MULTIPLE CLASS MEMORY SYSTEM” and U.S. Prov. App. No. 61/502,100 that was filed Jun. 28, 2011 and entitled “SYSTEM, METHOD, AND COMPUTER PROGRAM PRODUCT FOR IMPROVING MEMORY SYSTEMS” which are each incorporated herein by reference in their entirety for all purposes.

U.S. patent application Ser. No. 15/250,873 is also a continuation-in-part of, and claims priority to U.S. patent application Ser. No. 13/710,411, filed Dec. 10, 2012, entitled “SYSTEM, METHOD, AND COMPUTER PROGRAM PRODUCT FOR IMPROVING MEMORY SYSTEMS”, now U.S. Pat. No. 9,432,298, which claims priority to U.S. Provisional Application No. 61/569,107 (Attorney Docket No.: SMITH090+), titled “SYSTEM, METHOD, AND COMPUTER PROGRAM PRODUCT FOR IMPROVING MEMORY SYSTEMS,” filed Dec. 9, 2011, U.S. Provisional Application No. 61/580,300 (Attorney Docket No.: SMITH100+), titled “SYSTEM, METHOD, AND COMPUTER PROGRAM PRODUCT FOR IMPROVING MEMORY SYSTEMS,” filed Dec. 26, 2011, U.S. Provisional Application No. 61/585,640 (Attorney Docket No.: SMITH110+), titled “SYSTEM, METHOD, AND COMPUTER PROGRAM PRODUCT FOR IMPROVING MEMORY SYSTEMS,” filed Jan. 11, 2012, U.S. Provisional Application No. 61/602,034 (Attorney Docket No.: SMITH120+), titled “SYSTEM, METHOD, AND COMPUTER PROGRAM PRODUCT FOR IMPROVING MEMORY SYSTEMS,” filed Feb. 22, 2012, U.S. Provisional Application No. 61/608,085 (Attorney Docket No.: SMITH130+), titled “SYSTEM, METHOD, AND COMPUTER PROGRAM PRODUCT FOR IMPROVING MEMORY SYSTEMS,” filed Mar. 7, 2012, U.S. Provisional Application No. 61/635,834 (Attorney Docket No.: SMITH140+), titled “SYSTEM, METHOD, AND COMPUTER PROGRAM PRODUCT FOR IMPROVING MEMORY SYSTEMS,” filed Apr. 19, 2012, U.S. Provisional Application No. 61/647,492 (Attorney Docket No.: SMITH150+), titled “SYSTEM, METHOD, AND COMPUTER PROGRAM PRODUCT FOR CONFIGURING A SYSTEM ASSOCIATED WITH MEMORY,” filed May 15, 2012, U.S. Provisional Application No. 61/665,301 (Attorney Docket No.: SMITH160+), titled “SYSTEM, METHOD, AND COMPUTER PROGRAM PRODUCT FOR ROUTING PACKETS OF DATA,” filed Jun. 27, 2012, U.S. Provisional Application No. 61/673,192 (Attorney Docket No.: SMITH170+), titled “SYSTEM, METHOD, AND COMPUTER PROGRAM PRODUCT FOR REDUCING A LATENCY ASSOCIATED WITH A MEMORY SYSTEM,” filed Jul. 18, 2012, U.S. Provisional Application No. 61/679,720 (Attorney Docket No.: SMITH180+), titled “SYSTEM, METHOD, AND COMPUTER PROGRAM PRODUCT FOR PROVIDING CONFIGURABLE COMMUNICATION PATHS TO MEMORY PORTIONS DURING OPERATION,” filed Aug. 4, 2012, U.S. Provisional Application No. 61/698,690 (Attorney Docket No.: SMITH190+), titled “SYSTEM, METHOD, AND COMPUTER PROGRAM PRODUCT FOR TRANSFORMING A PLURALITY OF COMMANDS OR PACKETS IN CONNECTION WITH AT LEAST ONE MEMORY,” filed Sep. 9, 2012, and U.S. Provisional Application No. 61/714,154 (Attorney Docket No.: SMITH210+), titled “SYSTEM, METHOD, AND COMPUTER PROGRAM PRODUCT FOR CONTROLLING A REFRESH ASSOCIATED WITH A MEMORY,” filed Oct. 15, 2012, all of which are incorporated herein by reference in their entirety for all purposes.

U.S. patent application Ser. No. 15/250,873 is also a continuation-in-part of, and claims priority to U.S. patent application Ser. No. 14/169,127, filed Jan. 30, 2014, entitled “SYSTEM, METHOD, AND COMPUTER PROGRAM PRODUCT FOR MODIFYING COMMANDS DIRECTED TO MEMORY”, which claims priority to U.S. Provisional Application No. 61/759,764 (Attorney Docket No.: SMITH230+), titled SYSTEM, METHOD, AND COMPUTER PROGRAM PRODUCT FOR MODIFYING COMMANDS DIRECTED TO MEMORY, filed Feb. 1, 2013, U.S. Provisional Application No. 61/833,408 (Attorney Docket No.: SMITH250+), titled SYSTEM, METHOD, AND COMPUTER PROGRAM PRODUCT FOR PATH OPTIMIZATION, filed Jun. 10, 2013, and U.S. Provisional Application No. 61/859,516 (Attorney Docket No.: SMITH270+), titled SYSTEM, METHOD, AND COMPUTER PROGRAM PRODUCT FOR IMPROVED MEMORY, filed Jul. 29, 2013, all of which is incorporated herein by reference in its entirety for all purposes.

If any definitions (e.g. figure reference signs, specialized terms, examples, data, information, etc.) from any related material (e.g. parent application, other related application, material incorporated by reference, material cited, extrinsic reference, etc.) conflict with this application (e.g. abstract, description, summary, claims, etc.) for any purpose (e.g. prosecution, claim support, claim interpretation, claim construction, etc.), then the definitions in this application shall apply.

### BACKGROUND

### Field of the Invention

Embodiments in the present disclosure generally relate to improvements in the field of memory systems.

### BRIEF SUMMARY

A system, method, and computer program product are provided for a memory system. The system includes a first semiconductor platform including at least one first circuit, and at least one additional semiconductor platform stacked with the first semiconductor platform and including at least one additional circuit. The system further includes an adjustment of at least one aspect of the system, for repairing one or more faulty components of the memory subsystem capable of including: a through-silicon via (TSV) between the first memory and the second memory, and a memory cell of at least one of the first memory or the second memory.

### BRIEF DESCRIPTION OF THE SEVERAL VIEWS OF THE DRAWINGS

So that the features of various embodiments of the present invention can be understood, a more detailed description, briefly summarized above, may be had by reference to various embodiments, some of which are illustrated in the accompanying drawings. It is to be noted, however, that the accompanying drawings illustrate only embodiments and are therefore not to be considered limiting of the scope of the invention, for the invention may admit to other effective embodiments. The following detailed description makes reference to the accompanying drawings that are now briefly described.

FIG. 1A shows an apparatus including a plurality of semiconductor platforms, in accordance with one embodiment.

FIG. 1B shows a memory system with multiple stacked memory packages, in accordance with one embodiment.

FIG. 2 shows a stacked memory package, in accordance with another embodiment.

FIG. 3 shows an apparatus using a memory system with DIMMs using stacked memory packages, in accordance with another embodiment.

FIG. 4 shows a stacked memory package, in accordance with another embodiment.

FIG. 5 shows a memory system using stacked memory packages, in accordance with another embodiment.

FIG. 6 shows a memory system using stacked memory packages, in accordance with another embodiment.

FIG. 7 shows a memory system using stacked memory packages, in accordance with another embodiment.

FIG. 8 shows a memory system using a stacked memory package, in accordance with another embodiment.

FIG. 9 shows a stacked memory package, in accordance with another embodiment.

FIG. 10 shows a stacked memory package comprising a logic chip and a plurality of stacked memory chips, in accordance with another embodiment.

FIG. 11 shows a stacked memory chip, in accordance with another embodiment.

FIG. 12 shows a logic chip connected to stacked memory chips, in accordance with another embodiment.

FIG. 13 shows a logic chip connected to stacked memory chips, in accordance with another embodiment.

FIG. 14 shows a logic chip for use with stacked memory chips in a stacked memory chip package, in accordance with another embodiment.

FIG. 15 shows the switch fabric for a logic chip for use with stacked memory chips in a stacked memory chip package, in accordance with another embodiment.

FIG. 16 shows a memory system comprising stacked memory chip packages, in accordance with another embodiment.

FIG. 17 shows a crossbar switch fabric for a logic chip for use with stacked memory chips in a stacked memory chip package, in accordance with another embodiment.

FIG. 18 shows part of a logic chip for use with stacked memory chips in a stacked memory chip package, in accordance with another embodiment.

FIG. 19-1 shows an apparatus, in accordance with one embodiment.

FIG. 19-2 shows a stacked memory package, in accordance with one embodiment.

FIG. 19-3 shows a stacked memory package architecture, in accordance with one embodiment.

FIG. 19-4 shows a stacked memory package architecture, in accordance with one embodiment.

FIG. 19-5 shows a stacked memory package architecture, in accordance with one embodiment.

FIG. 19-6 shows a portion of a stacked memory package architecture, in accordance with one embodiment.

FIG. 19-7 shows a portion of a stacked memory package architecture, in accordance with one embodiment.

FIG. 19-8 shows a stacked memory package architecture, in accordance with one embodiment.

FIG. 19-9 shows a stacked memory package architecture, in accordance with one embodiment.

FIG. 19-10A shows a stacked memory package datapath, in accordance with one embodiment.

FIG. 19-10B shows a stacked memory package architecture, in accordance with one embodiment.

FIG. 19-10C shows a stacked memory package architecture, in accordance with one embodiment.

FIG. 19-10D shows a latency chart for a stacked memory package, in accordance with one embodiment.

FIG. 19-11 shows a stacked memory package datapath, in accordance with one embodiment.

FIG. 19-12 shows a memory system using virtual channels, in accordance with one embodiment.

FIG. 19-13 shows a memory error correction scheme, in accordance with one embodiment.

FIG. 19-14 shows a stacked memory package using DBI bit for parity, in accordance with one embodiment.

FIG. 19-15 shows a method of stacked memory package manufacture, in accordance with one embodiment.

FIG. 19-16 shows a system for stacked memory chip identification, in accordance with one embodiment.

FIG. 19-17 shows a memory bus mode configuration system, in accordance with one embodiment.

FIG. 19-18 shows a memory bus merging system, in accordance with one embodiment.

While the invention is susceptible to various modifications, combinations, and alternative forms, various embodiments thereof are shown by way of example in the drawings and will herein be described in detail. It should be understood, however, that the accompanying drawings and detailed description are not intended to limit the invention to the particular form disclosed, but on the contrary, the intention is to cover all modifications, combinations, equivalents and alternatives falling within the spirit and scope of the present invention as defined by the relevant claims.

### DETAILED DESCRIPTION

### Glossary and Conventions

Terms that are special to the field of the invention or specific to this description may, in some circumstances, be defined in this description. Further, the first use of such terms (which may include the definition of that term) may be highlighted in italics just for the convenience of the reader. Similarly, some terms may be capitalized, again just for the convenience of the reader. It should be noted that such use of italics and/or capitalization, by itself, should not be construed as somehow limiting such terms: beyond any given definition, and/or to any specific embodiments disclosed herein, etc.

More information on the Glossary and Conventions may be found in U.S. Provisional Application No. 61/585,640, filed Jan. 31, 2012, titled “SYSTEM, METHOD, AND COMPUTER PROGRAM PRODUCT FOR IMPROVING MEMORY SYSTEMS,” and in U.S. Provisional Application No. 61/647,492, filed 5-15-2012, titled “SYSTEM, METHOD, AND COMPUTER PROGRAM PRODUCT FOR CONFIGURING A SYSTEM ASSOCIATED WITH MEMORY”. Each of the foregoing applications are hereby incorporated by reference in their entirety for all purposes.

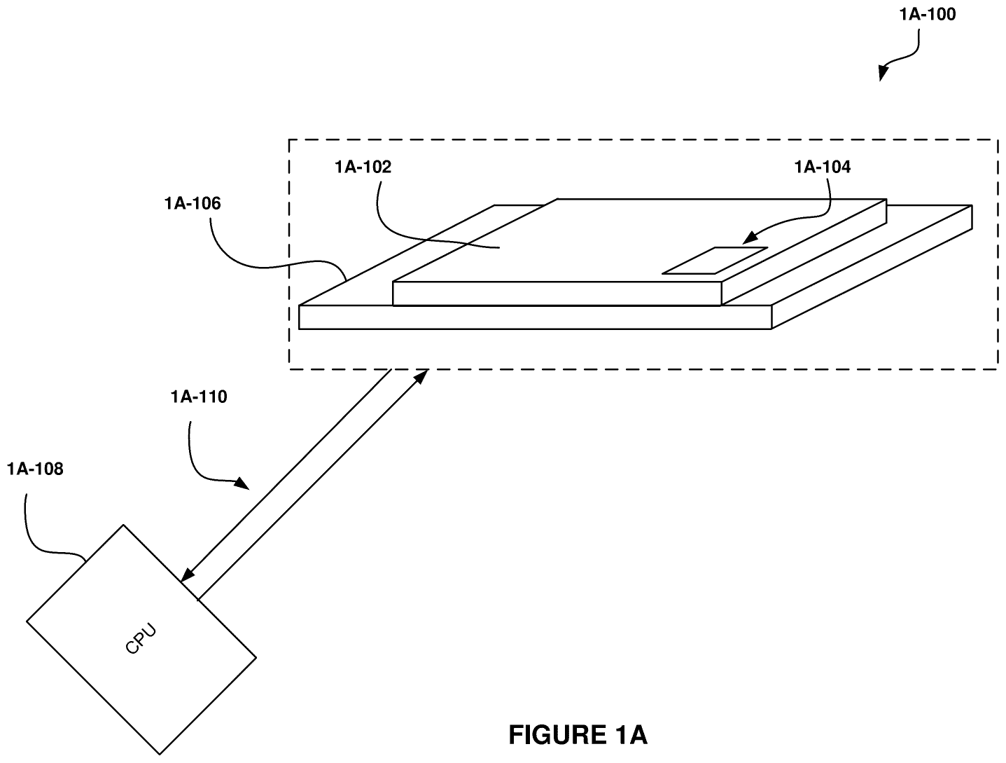

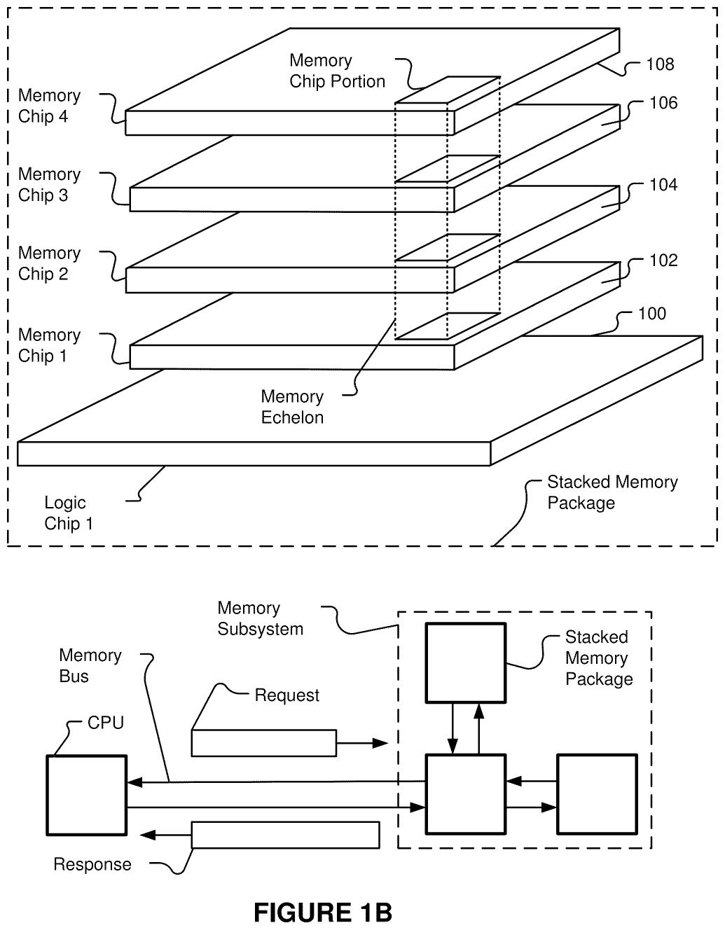

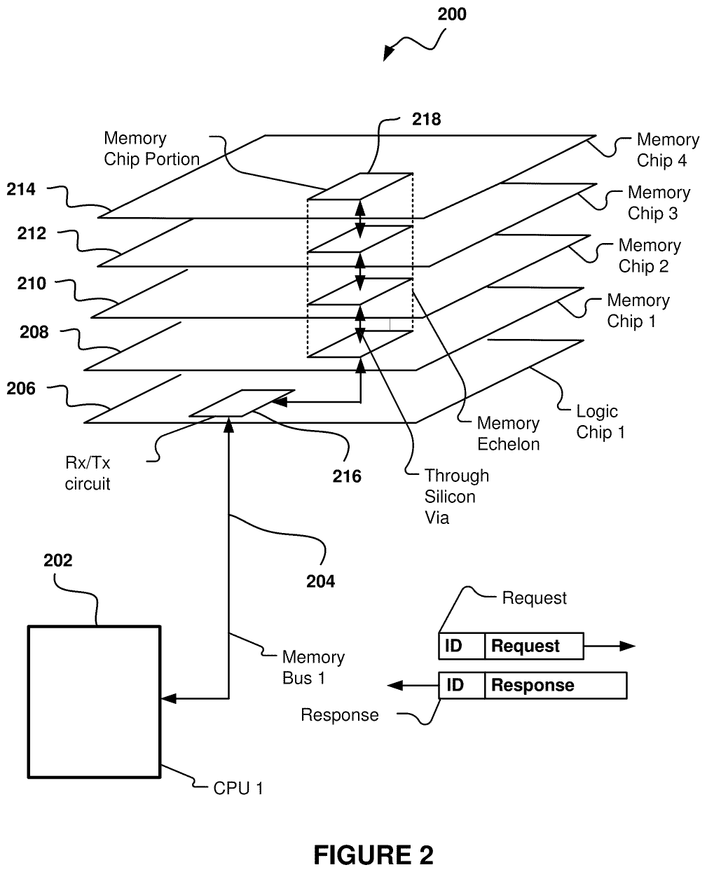

In this description there may be multiple figures that depict similar structures with similar parts or components. Thus, as an example, to avoid confusion an Object in FIG. 1 may be labeled “Object (1)” and a similar, but not identical, Object in FIG. 2 is labeled “Object (2)”, etc. Again, it should be noted that use of such convention, by itself, should not be construed as somehow limiting such terms: beyond any given definition, and/or to any specific embodiments disclosed herein, etc.

In the following detailed description and in the accompanying drawings, specific terminology and images are used in order to provide a thorough understanding. In some instances, the terminology and images may imply specific details that are not required to practice all embodiments. Similarly, the embodiments described and illustrated are representative and should not be construed as precise representations, as there are prospective variations on what is disclosed that may be obvious to someone with skill in the art. Thus this disclosure is not limited to the specific embodiments described and shown but embraces all prospective variations that fall within its scope. For brevity, not all steps may be detailed, where such details will be known to someone with skill in the art having benefit of this disclosure.

Memory devices with improved performance are required with every new product generation and every new technology node. However, the design of memory modules such as DIMMs becomes increasingly difficult with increasing clock frequency and increasing CPU bandwidth requirements yet lower power, lower voltage, and increasingly tight space constraints. The increasing gap between CPU demands and the performance that memory modules can provide is often called the “memory wall”. Hence, memory modules with improved performance are needed to overcome these limitations.

Memory devices (e.g. memory modules, memory circuits, memory integrated circuits, etc.) may be used in many applications (e.g. computer systems, calculators, cellular phones, etc.). The packaging (e.g. grouping, mounting, assembly, etc.) of memory devices may vary between these different applications. A memory module may use a common packaging method that may use a small circuit board (e.g. PCB, raw card, card, etc.) often comprised of random access memory (RAM) circuits on one or both sides of the memory module with signal and/or power pins on one or both sides of the circuit board. A dual in-line memory module (DIMM) may comprise one or more memory packages (e.g. memory circuits, etc.). DIMMs have electrical contacts (e.g. signal pins, power pins, connection pins, etc.) on each side (e.g. edge etc.) of the module. DIMMs may be mounted (e.g. coupled etc.) to a printed circuit board (PCB) (e.g. motherboard, mainboard, baseboard, chassis, planar, etc.). DIMMs may be designed for use in computer system applications (e.g. cell phones, portable devices, hand-held devices, consumer electronics, TVs, automotive electronics, embedded electronics, lap tops, personal computers, workstations, servers, storage devices, networking devices, network switches, network routers, etc.). In other embodiments different and various form factors may be used (e.g. cartridge, card, cassette, etc.).

Example embodiments described in this disclosure may include computer system(s) with one or more central processor units (CPU) and possibly one or more I/O unit(s) coupled to one or more memory systems that contain one or more memory controllers and memory devices. In example embodiments, the memory system(s) may include one or more memory controllers (e.g. portion(s) of chipset(s), portion(s) of CPU(s), etc.). In example embodiments the memory system(s) may include one or more physical memory array(s) with a plurality of memory circuits for storing information (e.g. data, instructions, state, etc.).

The plurality of memory circuits in memory system(s) may be connected directly to the memory controller(s) and/or indirectly coupled to the memory controller(s) through one or more other intermediate circuits (or intermediate devices e.g. hub devices, switches, buffer chips, buffers, register chips, registers, receivers, designated receivers, transmitters, drivers, designated drivers, re-drive circuits, circuits on other memory packages, etc.).

Intermediate circuits may be connected to the memory controller(s) through one or more bus structures (e.g. a multi-drop bus, point-to-point bus, networks, etc.) and which may further include cascade connection(s) to one or more additional intermediate circuits, memory packages, and/or bus(es). Memory access requests may be transmitted from the memory controller(s) through the bus structure(s). In response to receiving the memory access requests, the memory devices may store write data or provide read data. Read data may be transmitted through the bus structure(s) back to the memory controller(s) or to or through other components (e.g. other memory packages, etc.).

In various embodiments, the memory controller(s) may be integrated together with one or more CPU(s) (e.g. processor chips, multi-core die, CPU complex, etc.) and/or supporting logic (e.g. buffer, logic chip, etc.); packaged in a discrete chip (e.g. chipset, controller, memory controller, memory fanout device, memory switch, hub, memory matrix chip, northbridge, etc.); included in a multi-chip carrier with the one or more CPU(s) and/or supporting logic and/or memory chips; included in a stacked memory package; combinations of these; or packaged in various alternative forms that match the system, the application and/or the environment and/or other system requirements. Any of these solutions may or may not employ one or more bus structures (e.g. multidrop, multiplexed, point-to-point, serial, parallel, narrow and/or high-speed links, networks, etc.) to connect to one or more CPU(s), memory controller(s), intermediate circuits, other circuits and/or devices, memory devices, memory packages, stacked memory packages, etc.

A memory bus may be constructed using multi-drop connections and/or using point-to-point connections (e.g. to intermediate circuits, to receivers, etc.) on the memory modules. The downstream portion of the memory controller interface and/or memory bus, the downstream memory bus, may include command, address, write data, control and/or other (e.g. operational, initialization, status, error, reset, clocking, strobe, enable, termination, etc.) signals being sent to the memory modules (e.g. the intermediate circuits, memory circuits, receiver circuits, etc.). Any intermediate circuit may forward the signals to the subsequent circuit(s) or process the signals (e.g. receive, interpret, alter, modify, perform logical operations, merge signals, combine signals, transform, store, re-drive, etc.) if it is determined to target a downstream circuit; re-drive some or all of the signals without first modifying the signals to determine the intended receiver; or perform a subset or combination of these options etc.

The upstream portion of the memory bus, the upstream memory bus, returns signals from the memory modules (e.g. requested read data, error, status other operational information, etc.) and these signals may be forwarded to any subsequent intermediate circuit via bypass and/or switch circuitry or be processed (e.g. received, interpreted and re-driven if it is determined to target an upstream or downstream hub device and/or memory controller in the CPU or CPU complex; be re-driven in part or in total without first interpreting the information to determine the intended recipient; or perform a subset or combination of these options etc.).

In different memory technologies portions of the upstream and downstream bus may be separate, combined, or multiplexed; and any buses may be unidirectional (one direction only) or bidirectional (e.g. switched between upstream and downstream, use bidirectional signaling, etc.). Thus, for example, in JEDEC standard DDR (e.g. DDR, DDR2, DDR3, DDR4, etc.) SDRAM memory technologies part of the address and part of the command bus are combined (or may be considered to be combined), row address and column address may be time-multiplexed on the address bus, and read/write data may use a bidirectional bus.

In alternate embodiments, a point-to-point bus may include one or more switches or other bypass mechanism that results in the bus information being directed to one of two or more possible intermediate circuits during downstream communication (communication passing from the memory controller to a intermediate circuit on a memory module), as well as directing upstream information (communication from an intermediate circuit on a memory module to the memory controller), possibly by way of one or more upstream intermediate circuits.

In some embodiments the memory system may include one or more intermediate circuits (e.g. on one or more memory modules etc.) connected to the memory controller via a cascade interconnect memory bus, however other memory structures may be implemented (e.g. point-to-point bus, a multi-drop memory bus, shared bus, etc.). Depending on the constraints (e.g. signaling methods used, the intended operating frequencies, space, power, cost, and other constraints, etc.) various alternate bus structures may be used. A point-to-point bus may provide the optimal performance in systems requiring high-speed interconnections, due to the reduced signal degradation compared to bus structures having branched signal lines, switch devices, or stubs. However, when used in systems requiring communication with multiple devices or subsystems, a point-to-point or other similar bus may often result in significant added system cost (e.g. component cost, board area, increased system power, etc.) and may reduce the potential memory density due to the need for intermediate devices (e.g. buffers, re-drive circuits, etc.). Functions and performance similar to that of a point-to-point bus may be obtained by using switch devices. Switch devices and other similar solutions may offer advantages (e.g. increased memory packaging density, lower power, etc.) while retaining many of the characteristics of a point-to-point bus. Multi-drop bus solutions may provide an alternate solution, and though often limited to a lower operating frequency may offer a cost and/or performance advantage for many applications. Optical bus solutions may permit increased frequency and bandwidth, either in point-to-point or multi-drop applications, but may incur cost and/or space impacts.

Although not necessarily shown in all the figures, the memory modules and/or intermediate devices may also include one or more separate control (e.g. command distribution, information retrieval, data gathering, reporting mechanism, signaling mechanism, register read/write, configuration, etc.) buses (e.g. a presence detect bus, an I2C bus, an SMBus, combinations of these and other buses or signals, etc.) that may be used for one or more purposes including the determination of the device and/or memory module attributes (generally after power-up), the reporting of fault or other status information to part(s) of the system, calibration, temperature monitoring, the configuration of device(s) and/or memory subsystem(s) after power-up or during normal operation or for other purposes. Depending on the control bus characteristics, the control bus(es) might also provide a means by which the valid completion of operations could be reported by devices and/or memory module(s) to the memory controller(s), or the identification of failures occurring during the execution of the main memory controller requests, etc. The separate control buses may be physically separate or electrically and/or logically combined (e.g. by multiplexing, time multiplexing, shared signals, etc.) with other memory buses.

As used herein the term buffer (e.g. buffer device, buffer circuit, buffer chip, etc.) refers to an electronic circuit that may include temporary storage, logic etc. and may receive signals at one rate (e.g. frequency, etc.) and deliver signals at another rate. In some embodiments, a buffer is a device that may also provide compatibility between two signals (e.g., changing voltage levels or current capability, changing logic function, etc.).

As used herein, hub is a device containing multiple ports that may be capable of being connected to several other devices. The term hub is sometimes used interchangeably with the term buffer. A port is a portion of an interface that serves an I/O function (e.g., a port may be used for sending and receiving data, address, and control information over one of the point-to-point links, or buses). A hub may be a central device that connects several systems, subsystems, or networks together. A passive hub may simply forward messages, while an active hub (e.g. repeater, amplifier, etc.) may also modify the stream of data which otherwise would deteriorate over a distance. The term hub, as used herein, refers to a hub that may include logic (hardware and/or software) for performing logic functions.

As used herein, the term bus refers to one of the sets of conductors (e.g., signals, wires, traces, and printed circuit board traces or connections in an integrated circuit) connecting two or more functional units in a computer. The data bus, address bus and control signals may also be referred to together as constituting a single bus. A bus may include a plurality of signal lines (or signals), each signal line having two or more connection points that form a main transmission line that electrically connects two or more transceivers, transmitters and/or receivers. The term bus is contrasted with the term channel that may include one or more buses or sets of buses.

As used herein, the term channel (e.g. memory channel etc.) refers to an interface between a memory controller (e.g. a portion of processor, CPU, etc.) and one of one or more memory subsystem(s). A channel may thus include one or more buses (of any form in any topology) and one or more intermediate circuits.

As used herein, the term daisy chain (e.g. daisy chain bus etc.) refers to a bus wiring structure in which, for example, device (e.g. unit, structure, circuit, block, etc.) A is wired to device B, device B is wired to device C, etc. In some embodiments the last device may be wired to a resistor, terminator, or other termination circuit etc. In alternative embodiments any or all of the devices may be wired to a resistor, terminator, or other termination circuit etc. In a daisy chain bus, all devices may receive identical signals or, in contrast to a simple bus, each device may modify (e.g. change, alter, transform, etc.) one or more signals before passing them on.

A cascade (e.g. cascade interconnect, etc.) as used herein refers to a succession of devices (e.g. stages, units, or a collection of interconnected networking devices, typically hubs or intermediate circuits, etc.) in which the hubs or intermediate circuits operate as logical repeater(s), permitting for example data to be merged and/or concentrated into an existing data stream or flow on one or more buses.

As used herein, the term point-to-point bus and/or link refers to one or a plurality of signal lines that may each include one or more termination circuits. In a point-to-point bus and/or link, each signal line has two transceiver connection points, with each transceiver connection point coupled to transmitter circuits, receiver circuits or transceiver circuits.

As used herein, a signal (or line, signal line, etc.) refers to one or more electrical conductors or optical carriers, generally configured as a single carrier or as two or more carriers, in a twisted, parallel, or concentric arrangement, used to transport at least one logical signal. A logical signal may be multiplexed with one or more other logical signals generally using a single physical signal but logical signal(s) may also be multiplexed using more than one physical signal.

As used herein, memory devices are generally defined as integrated circuits that are composed primarily of memory (e.g. data storage, etc.) cells, such as DRAMs (Dynamic Random Access Memories), SRAMs (Static Random Access Memories), FeRAMs (Ferro-Electric RAMs), MRAMs (Magnetic Random Access Memories), Flash Memory and other forms of random access memory and related memories that store information in the form of electrical, optical, magnetic, chemical, biological, combinations of these or other means. Dynamic memory device types may include, but are not limited to, FPM DRAMs (Fast Page Mode Dynamic Random Access Memories), EDO (Extended Data Out) DRAMs, BEDO (Burst EDO) DRAMs, SDR (Single Data Rate) Synchronous DRAMs (SDRAMs), DDR (Double Data Rate) Synchronous DRAMs, DDR2, DDR3, DDR4, or any of the expected follow-on memory devices and related memory technologies such as Graphics RAMs (e.g. GDDR, etc.), Video RAMs, LP RAM (Low Power DRAMs) which may often be based on the fundamental functions, features and/or interfaces found on related DRAMs.

Memory devices may include chips (e.g. die, integrated circuits, etc.) and/or single or multi-chip packages (MCPs) or multi-die packages (e.g. including package-on-package (PoP), etc.) of various types, assemblies, forms, and configurations. In multi-chip packages, the memory devices may be packaged with other device types (e.g. other memory devices, logic chips, CPUs, hubs, buffers, intermediate devices, analog devices, programmable devices, etc.) and may also include passive devices (e.g. resistors, capacitors, inductors, etc.). These multi-chip packages etc. may include cooling enhancements (e.g. an integrated heat sink, heat slug, fluids, gases, micromachined structures, micropipes, capillaries, etc.) that may be further attached to the carrier and/or another nearby carrier and/or other heat removal and/or cooling system.

Although not necessarily shown in all the figures, memory module support devices (e.g. buffer(s), buffer circuit(s), buffer chip(s), register(s), intermediate circuit(s), power supply regulation, hub(s), re-driver(s), PLL(s), DLL(s), non-volatile memory, SRAM, DRAM, logic circuits, analog circuits, digital circuits, diodes, switches, LEDs, crystals, active components, passive components, combinations of these and other circuits, etc.) may be comprised of multiple separate chips (e.g. die, dice, integrated circuits, etc.) and/or components, may be combined as multiple separate chips onto one or more substrates, may be combined into a single package (e.g. using die stacking, multi-chip packaging, etc.) or even integrated onto a single device based on tradeoffs such as: technology, power, space, weight, size, cost, performance, combinations of these, etc.

One or more of the various passive devices (e.g. resistors, capacitors, inductors, etc.) may be integrated into the support chip packages, or into the substrate, board, PCB, raw card etc, based on tradeoffs such as: technology, power, space, cost, weight, etc. These packages etc. may include an integrated heat sink or other cooling enhancements (e.g. such as those described above, etc.) that may be further attached to the carrier and/or another nearby carrier and/or other heat removal and/or cooling system.

Memory devices, intermediate devices and circuits, hubs, buffers, registers, clock devices, passives and other memory support devices etc. and/or other components may be attached (e.g. coupled, connected, etc.) to the memory subsystem and/or other component(s) via various methods including multi-chip packaging (MCP), chip-scale packaging, stacked packages, interposers, redistribution layers (RDLs), solder bumps and bumped package technologies, 3D packaging, solder interconnects, conductive adhesives, socket structures, pressure contacts, electrical/mechanical/magnetic/optical coupling, wireless proximity, combinations of these, and/or other methods that enable communication between two or more devices (e.g. via electrical, optical, wireless, or alternate means, etc.).

The one or more memory modules (or memory subsystems) and/or other components/devices may be electrically/optically/wireless etc. connected to the memory system, CPU complex, computer system or other system environment via one or more methods such as multi-chip packaging, chip-scale packaging, 3D packaging, soldered interconnects, connectors, pressure contacts, conductive adhesives, optical interconnects, combinations of these, and other communication and/or power delivery methods (including but not limited to those described above).

Connector systems may include mating connectors (e.g. male/female, etc.), conductive contacts and/or pins on one carrier mating with a male or female connector, optical connections, pressure contacts (often in conjunction with a retaining and/or closure mechanism) and/or one or more of various other communication and power delivery methods. The interconnection(s) may be disposed along one or more edges (e.g. sides, faces, etc.) of the memory assembly (e.g. DIMM, die, package, card, assembly, structure, etc.) and/or placed a distance from an edge of the memory subsystem (or portion of the memory subsystem, etc.) depending on such application requirements as ease of upgrade, ease of repair, available space and/or volume, heat transfer constraints, component size and shape and other related physical, electrical, optical, visual/physical access, requirements and constraints, etc. Electrical interconnections on a memory module are often referred to as pads, contacts, pins, connection pins, tabs, etc. Electrical interconnections on a connector are often referred to as contacts, pins, etc.

As used herein, the term memory subsystem refers to, but is not limited to: one or more memory devices; one or more memory devices and associated interface and/or timing/control circuitry; and/or one or more memory devices in conjunction with memory buffer(s), register(s), hub device(s), other intermediate device(s) or circuit(s), and/or switch(es). The term memory subsystem may also refer to one or more memory devices together with any associated interface and/or timing/control circuitry and/or memory buffer(s), register(s), hub device(s) or switch(es), assembled into substrate(s), package(s), carrier(s), card(s), module(s) or related assembly, which may also include connector(s) or similar means of electrically attaching the memory subsystem with other circuitry. The memory modules described herein may also be referred to as memory subsystems because they include one or more memory device(s), register(s), hub(s) or similar devices.

The integrity, reliability, availability, serviceability, performance etc. of the communication path, the data storage contents, and all functional operations associated with each element of a memory system or memory subsystem may be improved by using one or more fault detection and/or correction methods. Any or all of the various elements of a memory system or memory subsystem may include error detection and/or correction methods such as CRC (cyclic redundancy code, or cyclic redundancy check), ECC (error-correcting code), EDC (error detecting code, or error detection and correction), LDPC (low-density parity check), parity, checksum or other encoding/decoding methods and combinations of coding methods suited for this purpose. Further reliability enhancements may include operation re-try (e.g. repeat, re-send, replay, etc.) to overcome intermittent or other faults such as those associated with the transfer of information, the use of one or more alternate, stand-by, or replacement communication paths (e.g. bus, via, path, trace, etc.) to replace failing paths and/or lines, complement and/or re-complement techniques or alternate methods used in computer, communication, and related systems.

The use of bus termination is common in order to meet performance requirements on buses that form transmission lines, such as point-to-point links, multi-drop buses, etc. Bus termination methods include the use of one or more devices (e.g. resistors, capacitors, inductors, transistors, other active devices, etc. or any combinations and connections thereof, serial and/or parallel, etc.) with these devices connected (e.g. directly coupled, capacitive coupled, AC connection, DC connection, etc.) between the signal line and one or more termination lines or points (e.g. a power supply voltage, ground, a termination voltage, another signal, combinations of these, etc.). The bus termination device(s) may be part of one or more passive or active bus termination structure(s), may be static and/or dynamic, may include forward and/or reverse termination, and bus termination may reside (e.g. placed, located, attached, etc.) in one or more positions (e.g. at either or both ends of a transmission line, at fixed locations, at junctions, distributed, etc.) electrically and/or physically along one or more of the signal lines, and/or as part of the transmitting and/or receiving device(s). More than one termination device may be used for example if the signal line comprises a number of series connected signal or transmission lines (e.g. in daisy chain and/or cascade configuration(s), etc.) with different characteristic impedances.

The bus termination(s) may be configured (e.g. selected, adjusted, altered, set, etc.) in a fixed or variable relationship to the impedance of the transmission line(s) (often but not necessarily equal to the transmission line(s) characteristic impedance), or configured via one or more alternate approach(es) to maximize performance (e.g. the useable frequency, operating margins, error rates, reliability or related attributes/metrics, combinations of these, etc.) within design constraints (e.g. cost, space, power, weight, size, performance, speed, latency, bandwidth, reliability, other constraints, combinations of these, etc.).

Additional functions that may reside local to the memory subsystem and/or hub device, buffer, etc. may include data, control, write and/or read buffers (e.g. registers, FIFOs, LIFOs, etc), data and/or control arbitration, command reordering, command retiming, one or more levels of memory cache, local pre-fetch logic, data encryption and/or decryption, data compression and/or decompression, data packing functions, protocol (e.g. command, data, format, etc.) translation, protocol checking, channel prioritization control, link-layer functions (e.g. coding, encoding, scrambling, decoding, etc.), link and/or channel characterization, command prioritization logic, voltage and/or level translation, error detection and/or correction circuitry, RAS features and functions, RAS control functions, repair circuits, data scrubbing, test circuits, self-test circuits and functions, diagnostic functions, debug functions, local power management circuitry and/or reporting, power-down functions, hot-plug functions, operational and/or status registers, initialization circuitry, reset functions, voltage control and/or monitoring, clock frequency control, link speed control, link width control, link direction control, link topology control, link error rate control, instruction format control, instruction decode, bandwidth control (e.g. virtual channel control, credit control, score boarding, etc.), performance monitoring and/or control, one or more co-processors, arithmetic functions, macro functions, software assist functions, move/copy functions, pointer arithmetic functions, counter (e.g. increment, decrement, etc.) circuits, programmable functions, data manipulation (e.g. graphics, etc.), search engine(s), virus detection, access control, security functions, memory and cache coherence functions (e.g. MESI, MOESI, MESIF, directory-assisted snooping (DAS), etc.), other functions that may have previously resided in other memory subsystems or other systems (e.g. CPU, GPU, FPGA, etc.), combinations of these, etc. By placing one or more functions local (e.g. electrically close, logically close, physically close, within, etc.) to the memory subsystem, added performance may be obtained as related to the specific function, often while making use of unused circuits or making more efficient use of circuits within the subsystem.

Memory subsystem support device(s) may be directly attached to the same assembly (e.g. substrate, interposer, redistribution layer (RDL), base, board, package, structure, etc.) onto which the memory device(s) are attached (e.g. mounted, connected, etc.) to a separate substrate (e.g. interposer, spacer, layer, etc.) also produced using one or more of various materials (e.g. plastic, silicon, ceramic, etc.) that include communication paths (e.g. electrical, optical, etc.) to functionally interconnect the support device(s) to the memory device(s) and/or to other elements of the memory or computer system.

Transfer of information (e.g. using packets, bus, signals, wires, etc.) along a bus, (e.g. channel, link, cable, etc.) may be completed using one or more of many signaling options. These signaling options may include such methods as single-ended, differential, time-multiplexed, encoded, optical, combinations of these or other approaches, etc. with electrical signaling further including such methods as voltage or current signaling using either single or multi-level approaches. Signals may also be modulated using such methods as time or frequency, multiplexing, non-return to zero (NRZ), phase shift keying (PSK), amplitude modulation, combinations of these, and others with or without coding, scrambling, etc. Voltage levels may be expected to continue to decrease, with 1.8V, 1.5V, 1.35V, 1.2V, 1V and lower power and/or signal voltages of the integrated circuits.

One or more timing (e.g. clocking, synchronization, etc.) methods may be used within the memory system, including synchronous clocking, global clocking, source-synchronous clocking, encoded clocking, or combinations of these and/or other clocking and/or synchronization methods, (e.g. self-timed, asynchronous, etc.), etc. The clock signaling or other timing scheme may be identical to that of the signal lines, or may use one of the listed or alternate techniques that are more suited to the planned clock frequency or frequencies, and the number of clocks planned within the various systems and subsystems. A single clock may be associated with all communication to and from the memory, as well as all clocked functions within the memory subsystem, or multiple clocks may be sourced using one or more methods such as those described earlier. When multiple clocks are used, the functions within the memory subsystem may be associated with a clock that is uniquely sourced to the memory subsystem, or may be based on a clock that is derived from the clock related to the signal(s) being transferred to and from the memory subsystem (e.g. such as that associated with an encoded clock, etc.). Alternately, a clock may be used for the signal(s) transferred to the memory subsystem, and a separate clock for signal(s) sourced from one (or more) of the memory subsystems. The clocks may operate at the same or frequency multiple (or sub-multiple, fraction, etc.) of the communication or functional (e.g. effective, etc.) frequency, and may be edge-aligned, center-aligned or otherwise placed and/or aligned in an alternate timing position relative to the signal(s).

Signals coupled to the memory subsystem(s) include address, command, control, and data, coding (e.g. parity, ECC, etc.), as well as other signals associated with requesting or reporting status (e.g. retry, replay, etc.) and/or error conditions (e.g. parity error, coding error, data transmission error, etc.), resetting the memory, completing memory or logic initialization and other functional, configuration or related information, etc.

Signals may be coupled using methods that may be consistent with normal memory device interface specifications (generally parallel in nature, e.g. DDR2, DDR3, etc.), or the signals may be encoded into a packet structure (generally serial in nature, e.g. FB-DIMM, etc.), for example, to increase communication bandwidth and/or enable the memory subsystem to operate independently of the memory technology by converting the signals to/from the format required by the memory device(s).

The terminology used herein is for the purpose of describing particular embodiments only and is not intended to be limiting of the invention. As used herein, the singular forms (e.g. a, an, the, etc.) are intended to include the plural forms as well, unless the context clearly indicates otherwise.

The terms comprises and/or comprising, when used in this specification, specify the presence of stated features, integers, steps, operations, elements, and/or components, but do not preclude the presence or addition of one or more other features, integers, steps, operations, elements, components, and/or groups thereof.

In the following description and claims, the terms include and comprise, along with their derivatives, may be used, and are intended to be treated as synonyms for each other.

In the following description and claims, the terms coupled and connected may be used, along with their derivatives. It should be understood that these terms are not necessarily intended as synonyms for each other. For example, connected may be used to indicate that two or more elements are in direct physical or electrical contact with each other. Further, coupled may be used to indicate that that two or more elements are in direct or indirect physical or electrical contact. For example, coupled may be used to indicate that that two or more elements are not in direct contact with each other, but the two or more elements still cooperate or interact with each other.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a circuit, component, module or system. Furthermore, aspects of the present invention may take the form of a computer program product embodied in one or more computer readable medium(s) having computer readable program code embodied thereon.

### FIG. 1A

FIG. 1A shows an apparatus 1A-100 including a plurality of semiconductor platforms, in accordance with one embodiment. As an option, the system may be implemented in the context of the architecture and environment of any subsequent Figure(s). Of course, however, the system may be implemented in any desired environment.

As shown, the apparatus 1A-100 includes a first semiconductor platform 1A-102 including at least one memory circuit 1A-104. Additionally, the apparatus 1A-100 includes a second semiconductor platform 1A-106 stacked with the first semiconductor platform 1A-102. The second semiconductor platform 1A-106 includes a logic circuit (not shown) that is in communication with the at least one memory circuit 1A-104 of the first semiconductor platform 1A-102. Furthermore, the second semiconductor platform 1A-106 is operable to cooperate with a separate central processing unit 1A-108, and may include at least one memory controller (not shown) operable to control the at least one memory circuit 1A-102.

The memory circuit 1A-104 may be in communication with the memory circuit 1A-104 of the first semiconductor platform 1A-102 in a variety of ways. For example, in one embodiment, the memory circuit 1A-104 may be communicatively coupled to the logic circuit utilizing at least one through-silicon via (TSV).

In various embodiments, the memory circuit 1A-104 may include, but is not limited to, dynamic random access memory (DRAM), synchronous DRAM (SDRAM), double data rate synchronous DRAM (DDR SDRAM, DDR2 SDRAM, DDR3 SDRAM, DDR4 SDRAM, etc.), graphics double data rate DRAM (GDDR, GDDR2, GDDR3, etc.), quad data rate DRAM (QDR DRAM), RAMBUS XDR DRAM (XDR DRAM), fast page mode DRAM (FPM DRAM), video DRAM (VDRAM), extended data out DRAM (EDO DRAM), burst EDO RAM (BEDO DRAM), multibank DRAM (MDRAM), synchronous graphics RAM (SGRAM), ZRAM (e.g. SOI RAM, Capacitor-less RAM, etc.), Phase Change RAM (PRAM or PCRAM, chalcogenide RAM, etc.), Magnetic RAM (MRAM), Field Write MRAM, Spin Torque Transfer (STT) MRAM, Memristor RAM, Racetrack memory, Millipede memory, Ferroelectric RAM (FeRAM), Resistor RAM (RRAM), Conductive-Bridging RAM (CBRAM), Silicon-Oxide-Nitride-Oxide-Silicon (SONOS) RAM, Twin-Transistor RAM (TTRAM), Thyristor-RAM (T-RAM), combinations of these and/or any other memory technology or similar data storage technology.

Further, in various embodiments, the first semiconductor platform 1A-102 may include one or more types of non-volatile memory technology (e.g. FeRAM, MRAM, PRAM, etc.) and/or one or more types of volatile memory technology (e.g. SRAM, T-RAM, Z-RAM, TTRAM, etc.). In one embodiment, the first semiconductor platform 1A-102 may include a standard (e.g. JEDEC DDR3 SDRAM, etc.) die.

In one embodiment, the first semiconductor platform 1A-102 may use a standard memory technology (e.g. JEDEC DDR3, JEDEC DDR4, etc.) but may be included on a non-standard die (e.g. the die is non-standardized, the die is not sold separately as a memory component, etc.). Additionally, in one embodiment, the first semiconductor platform 1A-102 may be a logic semiconductor platform (e.g. logic chip, buffer chip, etc.).

In various embodiments, the first semiconductor platform 1A-102 and the second semiconductor platform 1A-106 may form a system comprising at least one of a three-dimensional integrated circuit, a wafer-on-wafer device, a monolithic device, a die-on-wafer device, a die-on-die device, a three-dimensional package, or a three-dimensional package. In one embodiment, and as shown in FIG. 1A, the first semiconductor platform 1A-102 may be positioned above the second semiconductor platform 1A-106.

In another embodiment, the first semiconductor platform 1A-102 may be positioned beneath the second semiconductor platform 1A-106. Furthermore, in one embodiment, the first semiconductor platform 1A-102 may be in direct physical contact with the second semiconductor platform 1A-106.

In one embodiment, the first semiconductor platform 1A-102 may be stacked with the second semiconductor platform 1A-106 with at least one layer of material therebetween. The material may include any type of material including, but not limited to, silicon, germanium, gallium arsenide, silicon carbide, and/or any other material. In one embodiment, the first semiconductor platform 1A-102 and the second semiconductor platform 1A-106 may include separate integrated circuits.

Further, in one embodiment, the logic circuit may operable to cooperate with the separate central processing unit 1A-108 utilizing a bus 1A-110. In one embodiment, the logic circuit may operable to cooperate with the separate central processing unit 1A-108 utilizing a split transaction bus. In the context of the of the present description, a split-transaction bus refers to a bus configured such that when a CPU places a memory request on the bus, that CPU may immediately release the bus, such that other entities may use the bus while the memory request is pending. When the memory request is complete, the memory module involved may then acquire the bus, place the result on the bus (e.g. the read value in the case of a read request, an acknowledgment in the case of a write request, etc.), and possibly also place on the bus the ID number of the CPU that had made the request.

In one embodiment, the apparatus 1A-100 may include more semiconductor platforms than shown in FIG. 1A. For example, in one embodiment, the apparatus 1A-100 may include a third semiconductor platform and a fourth semiconductor platform, each stacked with the first semiconductor platform 1A-102 and each including at least one memory circuit under the control of the memory controller of the logic circuit of the second semiconductor platform 1A-106 (e.g. see FIG. 1B, etc.).

In one embodiment, the first semiconductor platform 1A-102, the third semiconductor platform, and the fourth semiconductor platform may collectively include a plurality of aligned memory echelons under the control of the memory controller of the logic circuit of the second semiconductor platform 1A-106. Further, in one embodiment, the logic circuit may be operable to cooperate with the separate central processing unit 1A-108 by receiving requests from the separate central processing unit 1A-108 (e.g. read requests, write requests, etc.) and sending responses to the separate central processing unit 1A-108 (e.g. responses to read requests, responses to write requests, etc.).

In one embodiment, the requests and/or responses may be each uniquely identified with an identifier. For example, in one embodiment, the requests and/or responses may be each uniquely identified with an identifier that is included therewith.

Furthermore, the requests may identify and/or specify various components associated with the semiconductor platforms. For example, in one embodiment, the requests may each identify at least one of the memory echelon. Additionally, in one embodiment, the requests may each identify at least one of the memory module.

In one embodiment, different semiconductor platforms may be associated with different memory types. For example, in one embodiment, the apparatus 1A-100 may include a third semiconductor platform stacked with the first semiconductor platform 1A-102 and include at least one memory circuit under the control of the at least one memory controller of the logic circuit of the second semiconductor platform 1A-106, where the first semiconductor platform 1A-102 includes, at least in part, a first memory type and the third semiconductor platform includes, at least in part, a second memory type different from the first memory type.

Further, in one embodiment, the at least one memory integrated circuit 1A-104 may be logically divided into a plurality of subbanks each including a plurality of portions of a bank. Still yet, in various embodiments, the logic circuit may include one or more of the following functional modules: bank queues, subbank queues, a redundancy or repair module, a fairness or arbitration module, an arithmetic logic unit or macro module, a virtual channel control module, a coherency or cache module, a routing or network module, reorder or replay buffers, a data protection module, an error control and reporting module, a protocol and data control module, DRAM registers and control module, and/or a DRAM controller algorithm module.

The logic circuit may be in communication with the memory circuit 1A-104 of the first semiconductor platform 1A-102 in a variety of ways. For example, in one embodiment, the logic circuit may be in communication with the memory circuit 1A-104 of the first semiconductor platform 1A-102 via at least one address bus, at least one control bus, and/or at least one data bus.

Furthermore, in one embodiment, the apparatus may include a third semiconductor platform and a fourth semiconductor platform each stacked with the first semiconductor platform 1A-102 and each may include at least one memory circuit under the control of the at least one memory controller of the logic circuit of the second semiconductor platform 1A-106. The logic circuit may be in communication with the at least one memory circuit 1A-104 of the first semiconductor platform 1A-102, the at least one memory circuit of the third semiconductor platform, and the at least one memory circuit of the fourth semiconductor platform, via at least one address bus, at least one control bus, and/or at least one data bus.

In one embodiment, at least one of the address bus, the control bus, or the data bus may be configured such that the logic circuit is operable to drive each of the at least one memory circuit 1A-104 of the first semiconductor platform 1A-102, the at least one memory circuit of the third semiconductor platform, and the at least one memory circuit of the fourth semiconductor platform, both together and independently in any combination; and the at least one memory circuit of the first semiconductor platform, the at least one memory circuit of the third semiconductor platform, and the at least one memory circuit of the fourth semiconductor platform, may be configured to be identical for facilitating a manufacturing thereof.

In one embodiment, the logic circuit of the second semiconductor platform 1A-106 may not be a central processing unit. For example, in various embodiments, the logic circuit may lack one or more components and/or functionally that is associated with or included with a central processing unit. As an example, in various embodiments, the logic circuit may not be capable of performing one or more of the basic arithmetical, logical, and input/output operations of a computer system, that a CPU would normally perform. As another example, in one embodiment, the logic circuit may lack an arithmetic logic unit (ALU), which typically performs arithmetic and logical operations for a CPU. As another example, in one embodiment, the logic circuit may lack a control unit (CU) that typically allows a CPU to extract instructions from memory, decode the instructions, and execute the instructions (e.g. calling on the ALU when necessary, etc.).

More illustrative information will now be set forth regarding various optional architectures and features with which the foregoing techniques discussed in the context of any of the present or previous figure(s) may or may not be implemented, per the desires of the user. For instance, various optional examples and/or options associated with the first semiconductor platform 1A-102, the memory circuit 1A-104, the second semiconductor platform 1A-106, and/or other optional features have been and will be set forth in the context of a variety of possible embodiments. It should be strongly noted, however, that such information is set forth for illustrative purposes and should not be construed as limiting in any manner. Any of such features may be optionally incorporated with or without the inclusion of other features described.

### FIG. 1B

FIG. 1B shows a memory system with multiple stacked memory packages, in accordance with one embodiment. As an option, the system may be implemented in the context of the architecture and environment of the previous figure or any subsequent Figure(s). Of course, however, the system may be implemented in any desired environment.

In FIG. 1B, the CPU is connected to one or more stacked memory packages using one or more memory buses.

In one embodiment, a single CPU may be connected to a single stacked memory package.

In one embodiment, one or more CPUs may be connected to one or more stacked memory packages.

In one embodiment, one or more stacked memory packages may be connected together in a memory subsystem network.

In FIG. 1B a memory read is performed by sending (e.g. transmitting from CPU to stacked memory package, etc.) a read request. The read data is returned in a read response. The read request may be forwarded (e.g. routed, buffered, etc.) between memory packages. The read response may be forwarded between memory packages.

In FIG. 1B a memory write is performed by sending (e.g. transmitting from stacked memory package, etc.) a write request. The write response (e.g. completion, notification, etc.), if any, originates from the target memory package. The write response may be forwarded between memory packages.

In contrast to current memory system a request and response may be asynchronous (e.g. split, separated, variable latency, etc.).

In FIG. 1B, the stacked memory package includes a first semiconductor platform. Additionally, the system includes at least one additional semiconductor platform stacked with the first semiconductor platform.

In the context of the present description, a semiconductor platform refers to any platform including one or more substrates of one or more semiconducting material (e.g. silicon, germanium, gallium arsenide, silicon carbide, etc.). Additionally, in various embodiments, the system may include any number of semiconductor platforms (e.g. 2, 3, 4, etc.).

In one embodiment, at least one of the first semiconductor platform or the additional semiconductor platform may include a memory semiconductor platform. The memory semiconductor platform may include any type of memory semiconductor platform (e.g. memory technology, etc.) such as random access memory (RAM) or dynamic random access memory (DRAM), etc.

In one embodiment, as shown in FIG. 1B, the first semiconductor platform may be a logic chip (Logic Chip 1, LC1). In FIG. 1B the additional semiconductor platforms are memory chips (Memory Chip 1, Memory Chip 2, Memory Chip 3, Memory Chip 4). In FIG. 1B the logic chip is used to access data stored in one or more portions on the memory chips. In FIG. 1B the portions of the memory chips are arranged (e.g. connected, coupled, etc.) so that a group of the portions may be accessed by LC1 as a memory echelon.

As used herein a memory echelon is used to represent (e.g. denote, is defined as, etc.) a grouping of memory circuits. Other terms (e.g. bank, rank, etc.) have been avoided for such a grouping because of possible confusion. A memory echelon may correspond to a bank or rank (e.g. SDRAM bank, SDRAM rank, etc.), but need not (and typically does not, and in general does not). Typically a memory echelon is composed of portions on different memory die and spans all the memory die in a stacked package, but need not. For example, in an 8-die stack, one memory echelon (ME1) may comprise portions in dies 1-4 and another memory echelon (ME2) may comprise portions in dies 5-8. Or, for example, one memory echelon (ME1) may comprise portions in dies 1,3,5,7 (e.g. die 1 is on the bottom of the stack, die 8 is the top of the stack, etc.) and another memory echelon ME2 comprise portions in dies 2,4,6,8, etc. In general there may be any number of memory echelons and any arrangement of memory echelons in a stacked die package (including fractions of an echelon, where an echelon may span more than one memory package for example).

In one embodiment, the memory technology may take any form including, but not limited to, synchronous DRAM (SDRAM), double data rate synchronous DRAM (DDR SDRAM, DDR2 SDRAM, DDR3 SDRAM, DDR4 SDRAM, etc.), graphics double data rate DRAM (GDDR, GDDR2, GDDR3, etc.), quad data rate DRAM (QDR DRAM), RAMBUS XDR DRAM (XDR DRAM), fast page mode DRAM (FPM DRAM), video DRAM (VDRAM), extended data out DRAM (EDO DRAM), burst EDO RAM (BEDO DRAM), multibank DRAM (MDRAM), synchronous graphics RAM (SGRAM), ZRAM (e.g. SOI RAM, Capacitor-less RAM, etc.), Phase Change RAM (PRAM or PCRAM, chalcogenide RAM, etc.), Magnetic RAM (MRAM), Field Write MRAM, Spin Torque Transfer (STT) MRAM, Memristor RAM, Racetrack memory, Millipede memory, Ferroelectric RAM (FeRAM), Resistor RAM (RRAM), Conductive-Bridging RAM (CBRAM), Silicon-Oxide-Nitride-Oxide-Silicon (SONOS) RAM, Twin-Transistor RAM (TTRAM), Thyristor-RAM (T-RAM), combinations of these and/or any other memory technology or similar data storage technology.

In one embodiment, the memory semiconductor platform may include one or more types of non-volatile memory technology (e.g. FeRAM, MRAM, PRAM, etc.) and/or one or more types of volatile memory technology (e.g. SRAM, T-RAM, Z-RAM, TTRAM, etc.).

In one embodiment, the memory semiconductor platform may be a standard (e.g. JEDEC DDR3 SDRAM, etc.) die.

In one embodiment, the memory semiconductor platform may use a standard memory technology (e.g. JEDEC DDR3, JEDEC DDR4, etc.) but included on a non-standard die (e.g. the die is non-standardized, the die is not sold separately as a memory component, etc.).

In one embodiment, the first semiconductor platform may be a logic semiconductor platform (e.g. logic chip, buffer chip, etc.).

In one embodiment, there may be more than one logic semiconductor platform.

In one embodiment, the first semiconductor platform may use a different process technology than the one or more additional semiconductor platforms. For example the logic semiconductor platform may use a logic technology (e.g. 45 nm, bulk CMOS, etc.) while the memory semiconductor platform(s) may use a DRAM technology (e.g. 22 nm, etc.).

In one embodiment, the memory semiconductor platform may include combinations of a first type of memory technology (e.g. non-volatile memory such as FeRAM, MRAM, and PRAM, etc.) and/or another type of memory technology (e.g. volatile memory such as SRAM, T-RAM, Z-RAM, and TTRAM, etc.).

In one embodiment, the system may include at least one of a three-dimensional integrated circuit, a wafer-on-wafer device, a monolithic device, a die-on-wafer device, a die-on-die device, a three-dimensional package, and a three-dimensional package.

In one embodiment, the additional semiconductor platform(s) may be in a variety of positions with respect to the first semiconductor platform. For example, in one embodiment, the additional semiconductor platform may be positioned above the first semiconductor platform. In another embodiment, the additional semiconductor platform may be positioned beneath the first semiconductor platform. In still another embodiment, the additional semiconductor platform may be positioned to the side of the first semiconductor platform.

Further, in one embodiment, the additional semiconductor platform may be in direct physical contact with the first semiconductor platform. In another embodiment, the additional semiconductor platform may be stacked with the first semiconductor platform with at least one layer of material therebetween. In other words, in various embodiments, the additional semiconductor platform may or may not be physically touching the first semiconductor platform.

In various embodiments, the number of semiconductor platforms utilized in the stack may depend on the height of the semiconductor platform and the application of the memory stack. For example, in one embodiment, a total height of the stack, including the memory circuits, a package substrate, and logic layer may be less than 0.5 centimeters. In another embodiment, a total height of the stack, including the memory circuits, a package substrate, and logic layer may be less than 0.4 centimeters. In another embodiment, a total height of the stack, including the memory circuits, a package substrate, and logic layer may be less than 0.3 centimeters. In another embodiment, a total height of the stack, including the memory circuits, a package substrate, and logic layer may be less than 0.2 centimeters. In another embodiment, a total height of the stack, including the memory circuits, a package substrate, and logic layer may be less than 0.1 centimeters. In another embodiment, a total height of the stack, including the memory circuits, a package substrate, and logic layer may be less than 0.4 centimeters and greater than 0.05 centimeters. In another embodiment, a total height of the stack, including the memory circuits, a package substrate, and logic layer may be less than 0.05 centimeters but greater than 0.01 centimeters. In another embodiment, a total height of the stack, including the memory circuits, a package substrate, and logic layer may be less than or equal to 1 centimeter and greater than or equal to 0.5 centimeters. In one embodiment, the stack may be sized to be utilized in a mobile phone. In another embodiment, the stack may be sized to be utilized in a tablet computer. In another embodiment, the stack may be sized to be utilized in a computer. In another embodiment, the stack may be sized to be utilized in a mobile device. In another embodiment, the stack may be sized to be utilized in a peripheral device.

More illustrative information will now be set forth regarding various optional architectures and features with which the foregoing techniques discussed in the context of any of the present or previous figure(s) may or may not be implemented, per the desires of the user. For instance, various optional examples and/or options associated with the configuration of the system, the platforms, and/or other optional features have been and will be set forth in the context of a variety of possible embodiments. It should be strongly noted, however, that such information is set forth for illustrative purposes and should not be construed as limiting in any manner. Any of such features may be optionally incorporated with or without the inclusion of other features described

### FIG. 2

### Stacked Memory Package

FIG. 2 shows a stacked memory package, in accordance with another embodiment. As an option, the system may be implemented in the context of the architecture and environment of any previous and/or subsequent Figure(s). Of course, however, the system may be implemented in any desired environment.

In FIG. 2 the CPU (CPU 1) is connected to the logic chip (Logic Chip 1, LC1) via a memory bus (Memory Bus 1, MB1). LC1 is coupled to four memory chips (Memory Chip 1 (MC1), Memory Chip 2 (MC2), Memory Chip 3 (MC3), Memory Chip 4 (MC4)).

In one embodiment the memory bus MB1 may be a high-speed serial bus.

In FIG. 2 the MB1 is shown for simplicity as bidirectional. MB1 may be a multi-lane serial link. MB1 may be comprised of two groups of unidirectional buses. For example there may be one bus (part of MB1) that transmits data from CPU 1 to LC1 that includes one or more lanes; there may be a second bus (also part of MB1) that transmits data from LC1 to CPU 1 that includes one or more lanes.

A lane is normally used to transmit a bit of information. In some buses a lane may be considered to include both transmit and receive signals (e.g. lane 0 transmit and lane 0 receive, etc.). This is the definition of lane used by the PCI-SIG for PCI Express for example and the definition that is used here. In some buses (e.g. Intel QPI, etc.) a lane may be considered as just a transmit signal or just a receive signal. In most high-speed serial links data is transmitted using differential signals. Thus a lane may be considered to consist of 2 wires (one pair, transmit or receive, as in Intel QPI) or 4 wires (2 pairs, transmit and receive, as in PCI Express). As used herein a lane consists of 4 wires (2 pairs, transmit and receive).

In FIG. 2 LC1 includes receive/transmit circuit (Rx/Tx circuit). The Rx/Tx circuit communicates (e.g. is coupled, etc.) to four portions of the memory chips called a memory echelon.

In FIG. 2 MC1, MC2 and MC3 are coupled using through-silicon vias (TSVs).

In one embodiment, the portion of a memory chip that forms part of an echelon may be a bank (e.g. DRAM bank, etc.).

In one embodiment, there may be any number of memory chip portions in a memory echelon.

In one embodiment, the portion of a memory chip that forms part of an echelon may be a subset of a bank.

In FIG. 2 the request includes an identification (ID) (e.g. serial number, sequence number, tag, etc.) that uniquely identifies each request. In FIG. 2 the response includes an ID that identifies each response. In FIG. 2 each logic chip is responsible for handling the requests and responses. The ID for each response will match the ID for each request. In this way the requestor (e.g. CPU, etc.) may match responses with requests. In this way the responses may be allowed to be out-of-order (i.e. arrive in a different order than sent, etc.).

For example the CPU may issue two read requests RQ1 and RQ2. RQ1 may be issued before RQ2 in time. RQ1 may have ID 01. RQ2 may have ID 02. The memory packages may return read data in read responses RR1 and RR2. RR1 may be the read response for RQ1. RR2 may be the read response for RQ2. RR1 may contain ID 01. RR2 may contain ID 02. The read responses may arrive at the CPU in order, that is RR1 arrives before RR2. This is always the case with conventional memory systems. However in FIG. 2, RR2 may arrive at the CPU before RR1, that is to say out-of-order. The CPU may examine the IDs in read responses, for example RR1 and RR2, in order to determine which responses belong to which requests.

As an option, the stacked memory package may be implemented in the context of the architecture and environment of the previous Figure and/or any subsequent Figure(s). Of course, however, the stacked memory package may be implemented in the context of any desired environment.

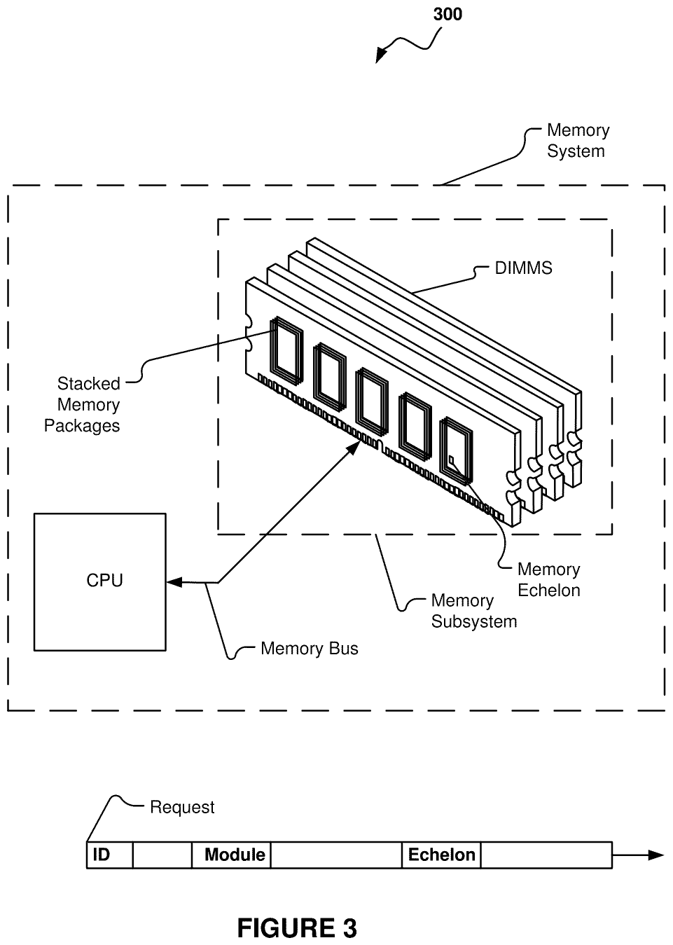

### FIG. 3

FIG. 3 shows an apparatus using a memory system with DIMMs using stacked memory packages, in accordance with another embodiment. As an option, the apparatus may be implemented in the context of the architecture and environment of the previous Figure and/or any subsequent Figure(s). Of course, however, the apparatus may be implemented in the context of any desired environment.

In FIG. 3 each stacked memory package may contain a structure such as that shown in FIG. 2.

In FIG. 3 a memory echelon is located on a single stacked memory package.

In one embodiment, the one or more memory chips in a stacked memory package may take any form and use any type of memory technology.

In one embodiment, the one or more memory chips may use the same or different memory technology or memory technologies.

In one embodiment, the one or more memory chips may use more than one memory technology on a chip.

In one embodiment, the one or more DIMMs may take any form including, but not limited to, an small-outline DIMM (SO-DIMM), unbuffered DIMM (UDIMM), registered DIMM (RDIMM), load-reduced DIMM (LR-DIMM), or any other form of mounting, packaging, assembly, etc.

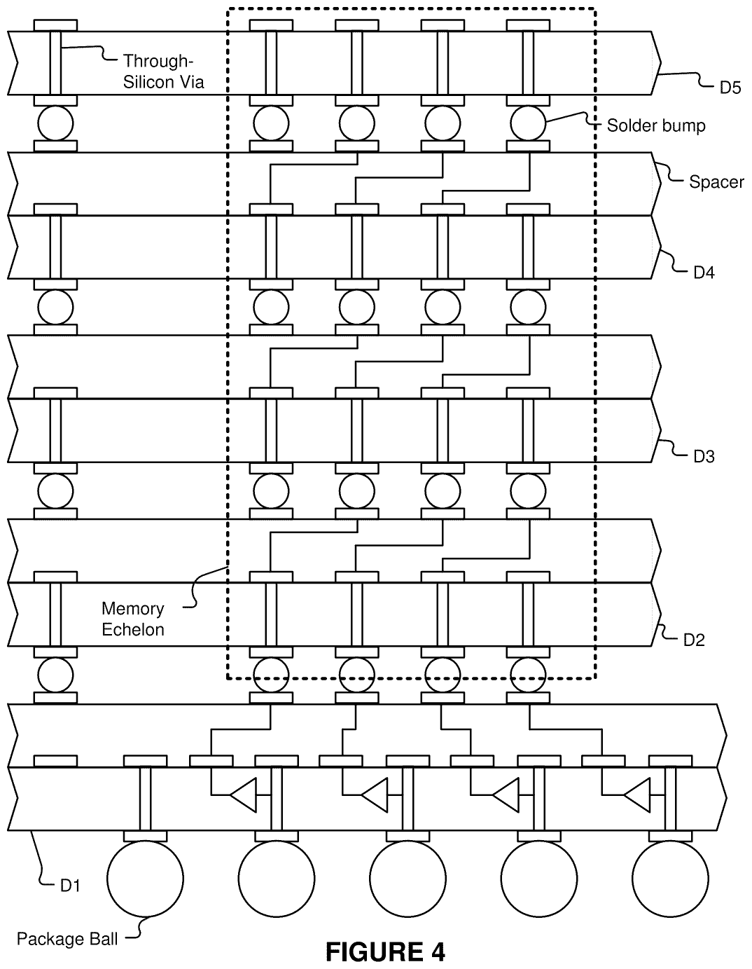

### FIG. 4

FIG. 4 shows a stacked memory package, in accordance with another embodiment. As an option, the system of FIG. 4 may be implemented in the context of the architecture and environment of the previous Figures and/or any subsequent Figure(s). Of course, however, the system of FIG. 4 may be implemented in the context of any desired environment.

FIG. 4 shows a stack of four memory chips (D2, D3, D4, D5) and a single logic chip (D1).

In FIG. 4, D1 is at the bottom of the stack and is connected to package balls.

In FIG. 4 the chips (D1, D2, D3, D4, D5) are coupled using spacers, solder bumps and through-silicon vias (TSVs).

In one embodiment the chips are coupled using spacers but may be coupled using any means (e.g. intermediate substrates, interposers, re-distribution layers (RDLs), etc.).

In one embodiment the chips are coupled using through-silicon vias (TSVs). Other through-chip (e.g. through substrate, etc.) or other chip coupling technology may be used (e.g. Vertical Circuits, conductive strips, etc.).

In one embodiment the chips are coupled using solder bumps. Other chip-to-chip stacking and/or chip connection technology may be used (e.g. C4, microconnect, pillars, micropillars, etc.)

In FIG. 4 a memory echelon comprises portions of memory circuits on D2, D3, D4, D5.

In FIG. 4 a memory echelon is connected using TSVs, solder bumps, and spacers such that a D1 package ball. is coupled to a portion of the echelon on D2. The equivalent portion of the echelon on D3 is coupled to a different D1 package ball, and so on for D4 and D5. In FIG. 4 the wiring arrangements and circuit placements on each memory chip are identical. The zig-zag (e.g. stitched, jagged, offset, diagonal, etc.) wiring of the spacers allows each memory chip to be identical.

A square TSV of width 5 micron and height 50 micron has a resistance of about 50 milliOhm. A square TSV of width 5 micron and height 50 micron has a capacitance of about 50 fF. The TSV inductance is about 0.5 pH per micron of TSV length.

The parasitic elements and properties of TSVs are such that it may be advantageous to use stacked memory packages rather than to couple memory packages using printed circuit board techniques. Using TSVs may allow many more connections between logic chip(s) and stacked memory chips than is possible using PCB technology alone. The increased number of connections allows increased (e.g. improved, higher, better, etc.) memory system and memory subsystem performance (e.g. increased bandwidth, finer granularity of access, combinations of these and other factors, etc.).

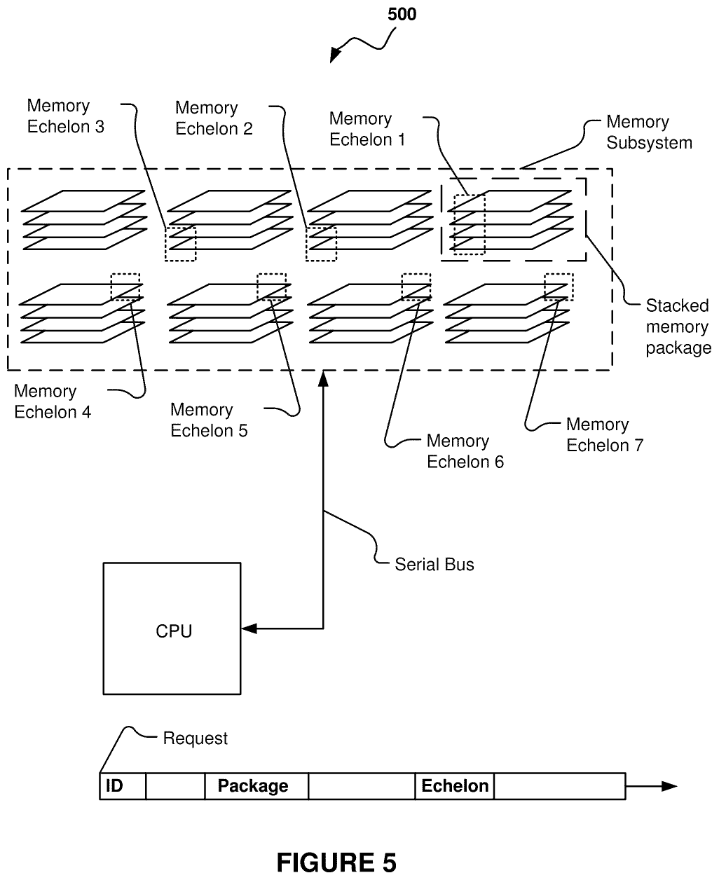

### FIG. 5

FIG. 5 shows a memory system using stacked memory packages, in accordance with another embodiment. As an option, the system of FIG. 5 may be implemented in the context of the architecture and environment of the previous Figures and/or any subsequent Figure(s). Of course, however, the system of FIG. 5 may be implemented in the context of any desired environment.

In FIG. 5 several different constructions (e.g. architectures, arrangements, topologies, structure, etc.) for an echelon are shown.

In FIG. 5 memory echelon 1 (ME1) is contained in a single stacked memory package and spans (e.g. consists of, comprises, is built from, etc.) all four memory chips in a single stacked memory package.

In FIG. 5 memory echelon 2 (ME2) is contained in a one stacked memory package and memory echelon 3 (ME3) is contained in a different stacked package. In FIG. 5 Me2 and Me3 span two memory chips. In FIG. 5 ME2 and ME3 may be combined to form a larger echelon, a super-echelon.

In FIG. 5 memory echelon 4 through memory echelon 7 (ME4, ME5, ME6, ME7) are each contained in a single stacked memory package. In FIG. 5 ME4-ME7 span a single memory chip. In FIG. 5 ME4-ME7 may be combined to form a super-echelon.

In one embodiment memory super-echelons may contain memory super-echelons (e.g. memory echelons may be nested any number of layers (e.g. tiers, levels, etc.) deep, etc.).

In FIG. 5 the connections between CPU and stacked memory packages are not shown explicitly.

In one embodiment the connections between CPU and stacked memory packages may be as shown, for example, in FIG. 1B. Each stacked memory package may have a logic chip that may connect (e.g. couple, communicate, etc.) with neighboring stacked memory package(s). One or more logic chips may connect to the CPU.

In one embodiment the connections between CPU and stacked memory packages may be through intermediate buffer chips.

In one embodiment the connections between CPU and stacked memory packages may use memory modules, as shown for example in FIG. 3.

In one embodiment the connections between CPU and stacked memory packages may use a substrate (e.g. the CPU and stacked memory packages may use the same package, etc.).

Further details of these and other embodiments, including details of connections between CPU and stacked memory packages (e.g. networks, connectivity, coupling, topology, module structures, physical arrangements, etc.) are described herein in subsequent figures and accompanying text.

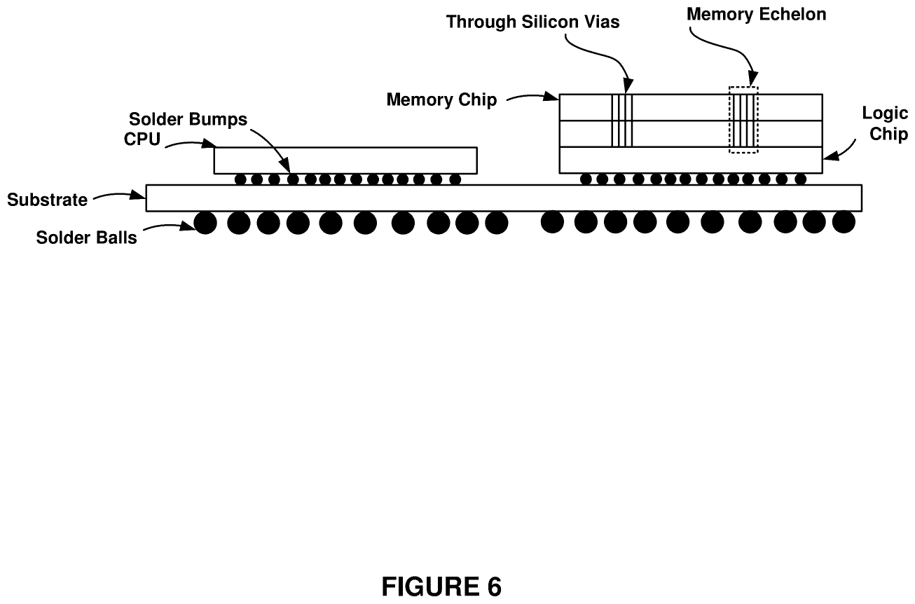

FIG. 6

FIG. 6 shows a memory system using stacked memory packages, in accordance with another embodiment. As an option, the system of FIG. 6 may be implemented in the context of the architecture and environment of the previous Figures and/or any subsequent Figure(s). Of course, however, the system of FIG. 6 may be implemented in the context of any desired environment.

In FIG. 6 the CPU and stacked memory package are assembled on a common substrate.

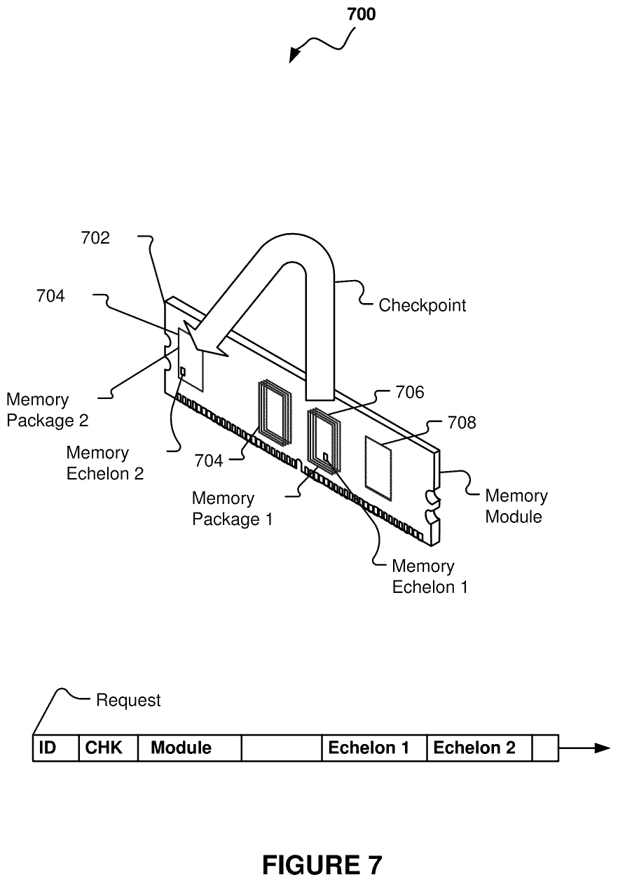

FIG. 7

FIG. 7 shows a memory system using stacked memory packages, in accordance with another embodiment. As an option, the system of FIG. 7 may be implemented in the context of the architecture and environment of the previous Figures and/or any subsequent Figure(s). Of course, however, the system of FIG. 7 may be implemented in the context of any desired environment.

In FIG. 7 the memory module (MM) may contain memory package 1 (MP1) and memory package 2 (MP2).

In FIG. 7 memory package 1 may be a stacked memory package and may contain memory echelon 1. In FIG. 7 memory package 1 may contain multiple volatile memory chips (e.g. DRAM memory chips, etc.).

In FIG. 7 memory package 2 may contain memory echelon 2. In FIG. 7 memory package 2 may be a non-volatile memory (e.g. NAND flash, etc.).

In FIG. 7 the memory module may act to checkpoint (e.g. copy, preserve, store, back-up, etc.) the contents of volatile memory in MP1 in MP2. The checkpoint may occur for only selected echelons.

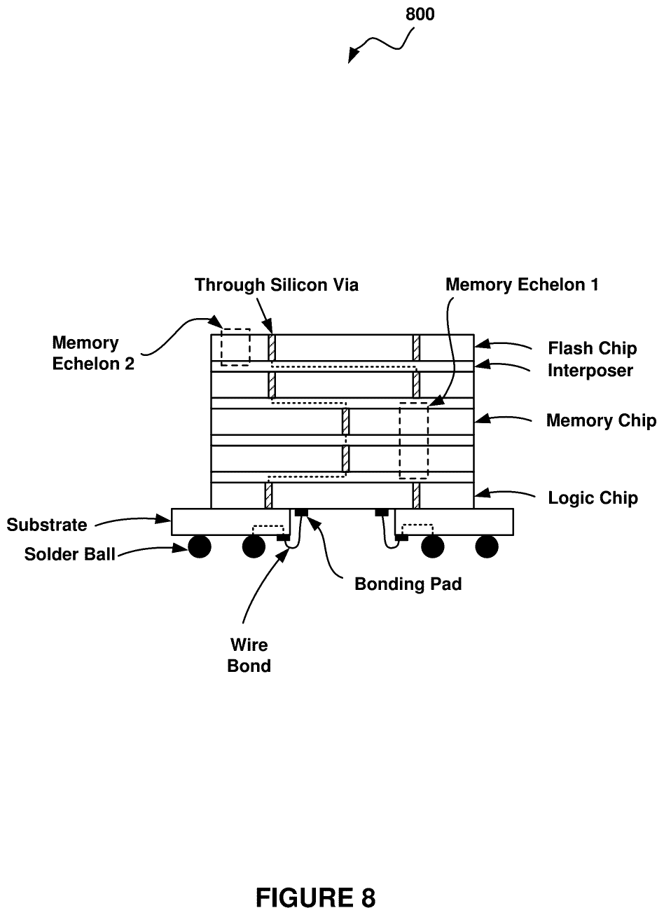

FIG. 8

FIG. 8 shows a memory system using a stacked memory package, in accordance with another embodiment. As an option, the system of FIG. 8 may be implemented in the context of the architecture and environment of the previous Figures and/or any subsequent Figure(s). Of course, however, the system of FIG. 8 may be implemented in the context of any desired environment.

In FIG. 8 the stacked memory package contains two memory chips and two flash chips. In FIG. 8 one flash memory chip is used to checkpoint one or more memory echelons in the stacked memory chips. In FIG. 8 a separate flash chip may be used together with the memory chips to form a hybrid memory system (e.g. non-homogeneous, mixed technology, etc.).

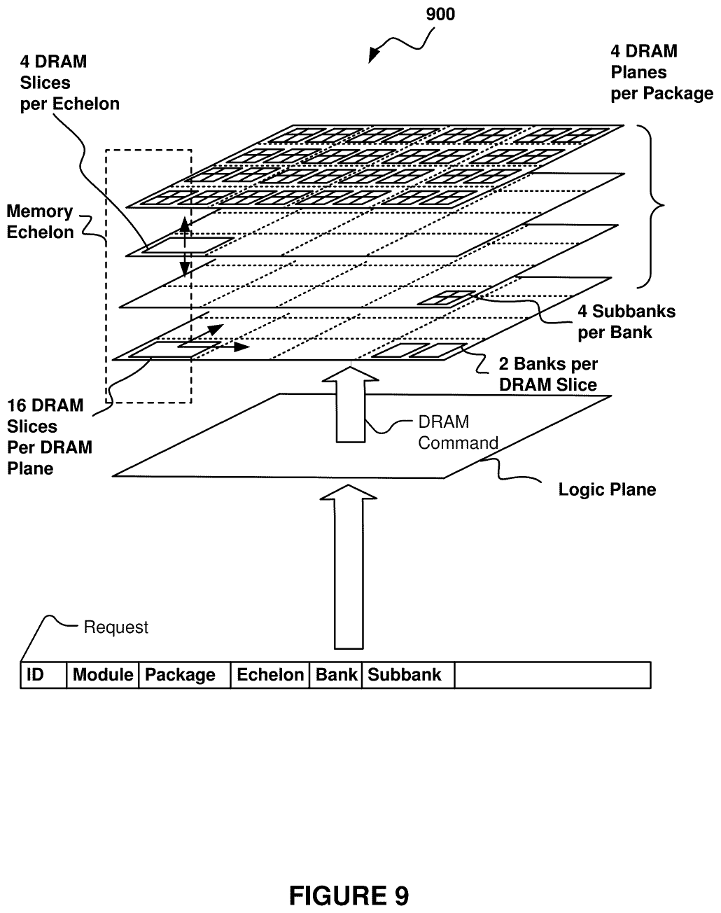

FIG. 9

FIG. 9 shows a stacked memory package, in accordance with another embodiment. As an option, the system of FIG. 9 may be implemented in the context of the architecture and environment of the previous Figures and/or any subsequent Figure(s). Of course, however, the system of FIG. 9 may be implemented in the context of any desired environment.

In FIG. 9 the stacked memory package contains four memory chips. In FIG. 9 each memory chip is a DRAM. Each DRAM is a DRAM plane.

In FIG. 9 there is a single logic chip. The logic chip forms a logic plane.

In FIG. 9 each DRAM is subdivided into portions. The portions are slices, banks, and subbanks.

A memory echelon is composed of portions, called DRAM slices. There may be one DRAM slice per echelon on each DRAM plane. The DRAM slices may be vertically aligned (using the wiring of FIG. 4 for example) but need not be aligned.

In FIG. 9 each memory echelon contains 4 DRAM slices.

In FIG. 9 each DRAM slice contains 2 banks.

In FIG. 9 each bank contains 4 subbanks.

In FIG. 9 each memory echelon contains 4 DRAM slices, 8 banks, 32 subbanks.

In FIG. 9 each DRAM plane contains 16 DRAM slices, 32 banks, 128 subbanks.

In FIG. 9 each stacked memory package contains 4 DRAM planes, 64 DRAM slices, 512 banks, 2048 subbanks.

There may be any number and arrangement of DRAM planes, banks, subbanks, slices and echelons. For example, using a stacked memory package with 8 memory chips, 8 memory planes, 32 banks per plane, and 16 subbanks per bank, a stacked memory memory package may have 8×32×16 addressable subbanks or 4096 subbanks per stacked memory package.

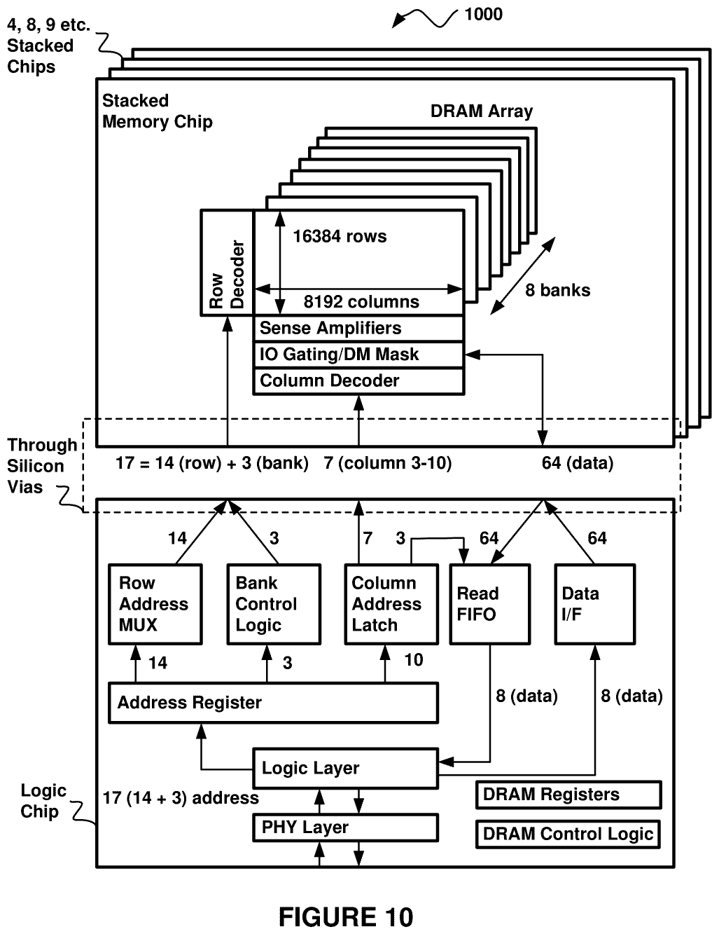

### FIG. 10

FIG. 10 shows a stacked memory package comprising a logic chip and a plurality of stacked memory chips, in accordance with another embodiment. As an option, the system of FIG. 10 may be implemented in the context of the architecture and environment of the previous Figures and/or any subsequent Figure(s). Of course, however, the system of FIG. 10 may be implemented in the context of any desired environment.

In one embodiment of stacked memory package comprising a logic chip and a plurality of stacked memory chips the stacked memory chip is constructed to be similar (e.g. compatible with, etc.) to the architecture of a standard JEDEC DDR memory chip.

A JEDEC standard DDR (e.g. DDR, DDR2, DDR3, etc.) SDRAM (e.g. JEDEC standard memory device, etc.) operates as follows. An ACT (activate) command selects a bank and row address (selected row). Data stored in memory cells in the selected row is transferred from a bank (also bank array, mat array, array, etc.) into sense amplifiers. A page is the amount of data transferred from the bank to the sense amplifiers. There are eight banks in a DDR3 DRAM. Each bank contains its own sense amplifiers and may be activated separately. The DRAM is in the active state when one or more banks has data stored in the sense amplifiers. The data remains in the sense amplifiers until a PRE (precharge) command to the bank restores the data to the cells in the bank. In the active state the DRAM can perform READs and WRITEs. A READ command column address selects a subset of data (column data) stored in the sense amplifiers. The column data is driven through I/O gating to the read latch and multiplexed to the output drivers. The process for a WRITE is similar with data moving in the opposite direction.

A 1 Gbit (128 Mb × 8) DDR3 device has the following properties:

| | |
|---|---|
| Memory bits | 1 Gbit = 16384 × 8192 × 8 = |
| | 134217728 × 8 = 1073741824 bits |
| Banks | 8 |
| Bank address | 3 bits BA0 BA1 BA2 |
| Rows per bank | 16384 |
| Columns per bank | 8192 |
| Bits per bank | 16384 × 128 × 64 = 16384 × 8192 = |
| | 134217728 |
| Address bus | 14 bits A0-A13 2\hat{ }14 = 16K = 16384 |
| Column address | 10 bits A0-A19 2\hat{ }10 = 1K = 1024 |
| Row address | 14 bits A0-A13 2\hat{ }14 = 16K = 16384 |
| Page size | 1 kB = 1024 bytes = 8 kbits = 8192 bits |

The physical layout of a bank may not correspond to the logical layout or the logical appearance of a bank. Thus, for example, a bank may comprise 9 mats (or subarrays, etc.) organized in 9 rows (M0-M8) (e.g. strips, stripes, in the x-direction, parallel to the column decoder, parallel to the local IO lines (LIOs, also datalines), local and master wordlines, etc.). There may be 8 rows of sense amps (SA0-SA8) located (e.g. running parallel to, etc.) between mats, with each sense amp row located (e.g. sandwiched, between, etc.) between two mats. Mats may be further divided into submats (also sections, etc.). For example into two (upper and lower submats), four, or eight sections, etc. Mats M0 and M8 (e.g. top and bottom, end mats, etc.) may be half the size of mats M1-M7 since they may only have sense amps on one side. The upper bits of a row address may be used to select the mat (e.g. A11-A13 for 9 mats, with two mats (e.g. M0, M8) always being selected concurrently). Other bank organizations may use 17 mats and 4 address bits, etc.

The above properties do not take into consideration any redundancy and/or repair schemes. The organization of mats and submats may be at least partially determined by the redundancy and/or repair scheme used. Redundant circuits (e.g. decoders, sense amps, etc.) and redundant memory cells may be allocated to a mat, submat, etc. or may be shared between mats, submats, etc. Thus the physical numbers of circuits, connections, memory cells, etc. may be different from the logical numbers above.

In FIG. 10 stacked memory package comprises single logic chip and four stacked memory chips. Any number of memory chips may be used depending on the limits of stacking technology, cost, size, yield, system requirement(s), manufacturability, etc.

For example, in one embodiment, 8 stacked memory chips may be used to emulate (e.g. replicate, approximate, simulate, replace, be equivalent, etc.) a standard 64-bit wide DIMM.

For example, in one embodiment, 9 stacked memory chips may be used to emulate a standard 72-bit wide ECC protected DIMM.

For example, in one embodiment, 9 stacked memory chips may be used to provide a spare stacked memory chip. The failure (e.g. due to failed memory bits, failed circuits or other components, faulty wiring and/or traces, intermittent connections, poor solder of other connections, manufacturing defect(s), marginal test results, infant mortality, excessive errors, design flaws, etc.) of a stacked memory chips may be detected (e.g. in production, at start-up, during self-test, at run time, etc.). The failed stacked memory chip may be mapped out (e.g. replaced, bypassed, eliminated, substituted, re-wired, etc.) or otherwise repaired (e.g. using spare circuits on the failed chip, using spare circuits on other stacked memory chips, etc.). The result may be a stacked memory package with a logical capacity of 8 stacked memory chips, but using more than 8 (e.g. 9, etc.) physical stacked memory chips.

In one embodiment, a stacked memory package may be designed with 9 stacked memory chips to perform the function of a high reliability memory subsystem (e.g. for use in a datacenter server etc.). Such a high reliability memory subsystem may use 8 stacked memory chips for data and 1 stacked memory chip for data protection (e.g. ECC, SECDED coding, RAID, data copy, data copies, checkpoint copy, etc.). In production those stacked memory packages with all 9 stacked memory chips determined to be working (e.g. through production test, production sort, etc.) may be sold at a premium as being protected memory subsystems (e.g. ECC protected modules, ECC protected DIMMs, etc.). Those stacked memory packages with only 8 stacked memory chips determined to be working may be configured (e.g. re-wired, etc.) to be sold as non-protected memory systems (e.g. for use in consumer goods, desktop PCs, etc.). Of course, any number of stacked memory chips may be used for data and/or data protection and/or spare(s).

In one embodiment a total of 10 stacked memory chips may be used with 8 stacked memory chips used for data, 2 stacked memory chips used for data protection and/or spare, etc.

Of course a whole stacked memory chip need not be used for a spare or data protection function.

In one embodiment a total of 9 stacked memory chips may be used, with half of one stacked memory chip set aside as a spare and half of one stacked memory chip set aside for data, spare, data protection, etc. Of course any number (including fractions etc.) of stacked memory chips in a stacked memory package may be used for data, spare, data protection etc.

Of course more than one portion (e.g. logical portion, physical portion, part, section, division, unit, subunit, array, mat, subarray, slice, etc.) of one or more stacked memory chips may also be used.

In one embodiment one or more echelons of a stacked memory package may be used for data, data protection, and/or spare.

Of course not all of a portion (e.g. less than the entire, a fraction of, a subset of, etc.) of a stacked memory chip has to be used for data, data protection, spare, etc.

In one embodiment one or more portions of a stacked memory package may be used for data, data protection and/or spare, where portion may be a part or one or more of the following: bank, a subbank, echelon, rank, other logical unit, other physical unit, combination of these, etc.

Of course not all the functions need be contained in a single stacked memory package.

In one embodiment one or more portions of a first stacked memory package may be used together with one or more portions of a second stacked memory package to perform one or more of the following functions: spare, data storage, data protection.

In FIG. 10 the stacked memory chip contains a DRAM array that is similar to the core (e.g. central portion, memory cell array portion, etc.) of a SDRAM memory device. In FIG. 10 almost all of the support circuits and control are located on the logic chip. In FIG. 10 the logic chip and stacked memory chips are connected (e.g. coupled, etc.) using through silicon vias.

The partitioning of logic between the logic chip and stacked memory chips may be made in many ways depending on silicon area, function required, number of TSVs that can be reliably manufactured, TSV size, packaging restrictions, etc. In FIG. 10 a partitioning is shown that may require about 17+7+64 or 88 signals TSVs for each memory chip. This number is an estimate only. Control signals (e.g. CS, CKE, other standard control signals, or other equivalent control signals, etc.) have not been shown or accounted for in FIG. 10 for example. In addition this number assumes all signals shown in FIG. 10 are routed to each stacked memory chip. Also power delivery through TSVs has not been included in the count. Typically it may be required to use a large number of TSVs for power delivery for example.

In one embodiment, it may be decided that not all stacked memory chips are accessed independently, in which case some, all or most of the signals may be carried on a multidrop bus between the logic chip and stacked memory chips. In this case, there may only be about 100 signal TSVs between the logic chip and the stacked memory chips.

In one embodiment, it may be decided that all stacked memory chips are to be accessed independently. In this case, with 8 stacked memory chips, there may be about 800 signal TSVs between the logic chip and the stacked memory chips.

In one embodiment, it may be decided (e.g. due to protocol constraints, system design, system requirements, space, size, power, manufacturability, yield, etc.) that some signals are routed to all stacked memory chips (e.g. together, using a multidrop bus, etc.); some signals are routed to each stacked memory chip separately (e.g. using a private bus, a parallel connection); some signals are routed to a subset (e.g. one or more, groups, pairs, other subsets, etc.) of the stacked memory chips. In this case, with 8 stacked memory chips, there may be between about 100 and about 800 signal TSVs between the logic chip and the stacked memory chips depending on the configuration of buses and wiring used.

In one embodiment a different partitioning (e.g. circuit design, architecture, system design, etc.) may be used such that, for example, the number of TSVs or other connections etc. may be reduced (e.g. connections for buses, signals, power, etc.). For example, the read FIFO and/or data interface are shown integrated with the logic chip in FIG. 10. If the read FIFO and/or data interface are moved to the stacked memory chips the data bus width between the logic chip and the stacked memory chips may be reduced, for example to 8. In this case the number of signal TSVs may be reduced to 17+10+8=35 (e.g. again considering connections to one stacked memory chip only, or that all signals are connected to all stacked memory chips on multidrop busses, etc.). Notice that in moving the read FIFO from the logic chip to the stacked memory chips we need to transmit an extra 3 bits of the column address from the logic chip to the stacked memory chips. Thus we have saved some TSVs but added others. This type of trade-off is typical in such a system design. Thus the exact numbers and types of connections may vary with system requirements (e.g. cost, time (as technology changes and improves, etc.), space, power, reliability, etc.).

In one embodiment the bus structure(s) (e.g. shared data bus, shared control bus, shared address bus, etc.) may be varied to improve features (e.g. increase the system flexibility, increase market size, improve data access rates, increase bandwidth, reduce latency, improve reliability, etc.) at the cost of increased connection complexity (e.g. increased TSV count, increased space complexity, increased chip wiring, etc.).

In one embodiment the access (e.g. data access pattern, request format, etc.) granularity (e.g. the size and number of banks, or other portions of each stacked memory chip, etc.) may be varied. For example, by using a shared data bus and shared address bus the signal TSV count may be reduced. In this manner the access granularity may be increased. For example, in FIG. 10 a memory echelon comprises one bank (from eight on each stacked memory chip) in each of the eight stacked memory chips. Thus an echelon is 8 banks (a DRAM slice is thus a bank in this case). There are thus eight memory echelons. By reducing the TSV signal count (e.g. by using shared buses, moving logic from logic chip to stacked memory chips, etc.) we can use extra TSVs to vary the access granularity. For example we can use a subbank to form the echelon, reducing the echelon size and increasing the number of echelons in the system. If there are two subbanks in a bank, we would double the number of memory echelons, etc.

Manufacturing limits (e.g. yield, practical constraints, etc.) for TSV etch and via fill determine the TSV size. A TSV requires the silicon substrate to be thinned to a thickness of 100 micron or less. With a practical TSV aspect ratio (e.g. height:width) of 10:1 or lower, the TSV size may be about 5 microns if the substrate is thinned to about 50 micron. As manufacturing improves the number of TSVs may be increased. An increased number of TSVs may allow more flexibility in the architecture of both logic chips and stacked memory chips.

Further details of these and other embodiments, including details of connections between the logic chip and stacked memory packages (e.g. bus types, bus sharing, etc.) are described herein in subsequent figures and accompanying text.

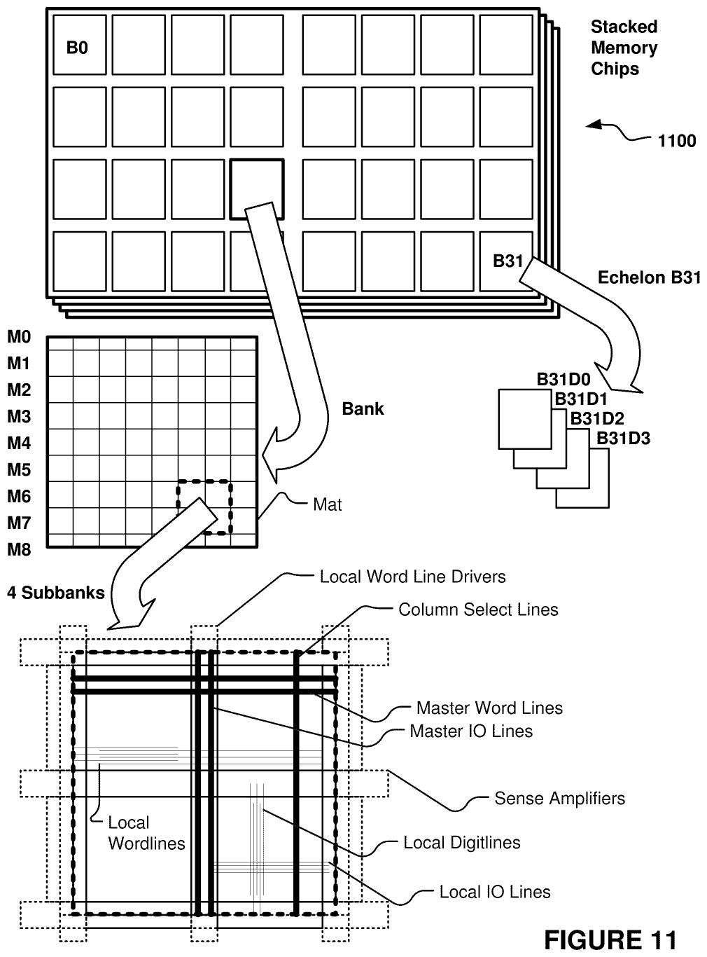

### FIG. 11

FIG. 11 shows a stacked memory chip, in accordance with another embodiment. As an option, the system of FIG. 11 may be implemented in the context of the architecture and environment of the previous Figures and/or any subsequent Figure(s). Of course, however, the system of FIG. 11 may be implemented in the context of any desired environment.

In FIG. 11 the stacked memory chip comprises 32 banks.

In FIG. 11 an exploded diagram shows a bank that comprises 9 rows (also called stripes, strips, etc.) of mats (M0-M8) (also called sections, subarrays, etc.).

In FIG. 11 the bank comprises 64 subbanks.

In FIG. 11 an echelon comprises 4 banks on 4 stacked memory chips. Thus for example echelon B31 comprises bank 31 on the top stacked memory chip (DO), B31D0 as well as B31D1, B31D2, B31D3. Note that an echelon does not have to be formed from an entire bank. Echelons may also comprise groups of subbanks.

In FIG. 11 an exploded diagram shows 4 subbanks and the arrangements of: local wordline drivers, column select lines, master word lines, master IO lines, sense amplifiers, local digitlines (also known as local bitlines, etc.), local 10 lines (also known as local datalines, etc.), local wordlines.

In one embodiment groups (e.g. 1, 4, 8, 16, 32, 64, etc.) of subbanks may be used to form part of a memory echelon. This in effect increase the number of banks. Thus, for example, a stacked memory chip with 4 banks, with each bank containing 4 subbanks that may be independently accessed, is effectively equivalent to a stacked memory chip with 16 banks, etc.

In one embodiment groups of subbanks may share resources. Normally to permit independent access to subbanks requires the addition of extra column decoders and IO circuits. For example in going from 4 subbank (or 4 bank) access to 8 subbank (or 8 bank) access, the number and area of column decoders and IO circuits double. For example a 4-bank memory chip may use 50% of the die area for memory cells and 50% overhead for sense amplifiers, row and column decoders, wiring and IO circuits. Of the 50% overhead, 10% may be for column decoders and 10 circuits. In going from 4 to 16 banks, column decoder and 10 circuit overhead may increases from 10% to 40% of the original die area. In going from 4 to 32 banks, column decoder and IO circuit overhead may increases from 10% to 80% of the original die area. This overhead may be greatly reduced by sharing resources. Since the column decoders and IO circuits are only used for part of an access they may be shared. In order to do this the control logic in the logic chip must schedule accesses so that access conflicts between shared resources are avoided.

In one embodiment, the control logic in the logic chip may track, for example, the sense amplifiers required by each access to a bank or subbank that share resources and either re-schedule, re-order, or delay accesses to avoid conflicts (e.g. contentions, etc.).

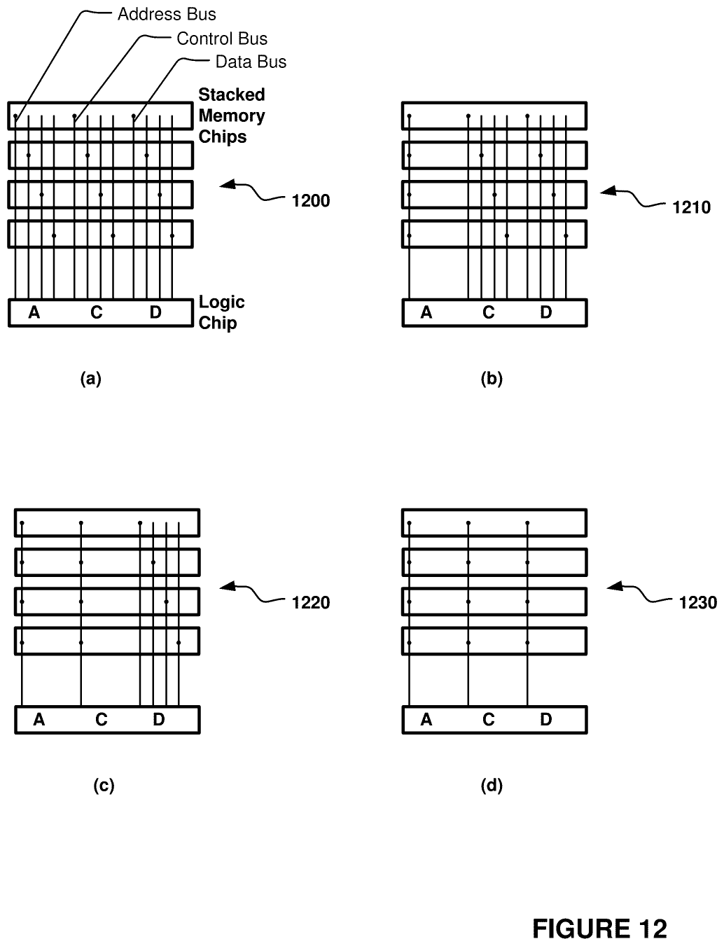

### FIG. 12

FIG. 12 shows a logic chip connected to stacked memory chips, in accordance with another embodiment. As an option, the system of FIG. 12 may be implemented in the context of the architecture and environment of the previous Figures and/or any subsequent Figure(s). Of course, however, the system of FIG. 12 may be implemented in the context of any desired environment.

FIG. 12 shows 4 stacked memory chips connected (e.g. coupled, etc.) to a single logic chip. Typically connections between stacked memory chips and one or more logic chips may be made using TSVs, spacers, and solder bumps (as shown for example in FIG. 4). Other connection and coupling methods may be used to connect (e.g. join, stack, assemble, couple, aggregate, bond, etc.) stacked memory chips and one or more logic chips.

In FIG. 12 three buses are shown: address bus (which may comprise row, column, banks addresses, etc.), control bus (which may comprise CK, CKE, other standard control signals, other non-standard control signals, combinations of these and/or other control signals, etc.), data bus (e.g. a bidirectional bus, two unidirectional buses (read and write), etc.). These may be the main (e.g. majority of signals, etc.) signal buses, though there may be other buses, signals, groups of signals, etc. The power and ground connections are not shown.

In one embodiment the power and/or ground may be shared between all chips.

In one embodiment each stacked memory chip may have separate (e.g. unique, not shared, individual, etc.) power and/or ground connections.

In one embodiment there may be multiple power connections (e.g. VDD, reference voltages, boosted voltages, back-bias voltages, quiet voltages for DLLs (e.g. VDDQ, etc.), reference currents, reference resistor connections, decoupling capacitance, other passive components, combinations of these, etc.).

In FIG. 12 (a) each stacked memory chip connects to the logic chip using a private (e.g. not shared, not multiplexed with other chips, point-to-point, etc.) bus. Note that in FIG. 12 (a) the private bus may still be a multiplexed bus (or other complex bus type using packets, shared between signals, shared between row address and column address, etc.) but in FIG. 12 (a) is not necessarily shared between stacked memory chips.

In FIG. 12 (b) the control bus and data bus of each stacked memory connects to the logic chip using a private bus. In FIG. 12 (b) the address bus of each stacked memory connects to the logic chip using a shared (e.g. multidrop, dotted, multiplexed, etc.) bus.

In FIG. 12 (c) the data bus of each stacked memory connects to the logic chip using a private bus. In FIG. 12 (b) the address bus and control bus of each stacked memory connects to the logic chip using a shared bus.

In FIG. 12 (d) the address bus (label A) and control bus (label C) and data bus (label D) of each stacked memory chip connects to the logic chip using a shared bus.

In FIG. 12 (a)-(d) note that a dot on the bus represent a connection to that stacked memory chip.

In FIG. 12 (a), (b), (c) note that it appears that each stacked memory chip has a different pattern of connections (e.g. a different dot wiring pattern, etc.). In practice it may be desirable to have every stacked memory chip be exactly the same (e.g. use the same wiring pattern, same TSV pattern, same connection scheme, same spacer, etc.). In such a case the mechanism (e.g. method, system, architecture, etc.) of FIG. 4 may be used (e.g. a stitched, zig-zag, jogged, etc. wiring pattern). The wiring of FIG. 4 and the wiring scheme shown in FIG. 12 (a), (b), (c) are logically compatible (e.g. equivalent, produce the same electrical connections, etc.).

In one embodiment the sharing of buses between multiple stacked memory chips may create potential conflicts (e.g. bus collisions, contention, resource collisions, resource starvation, protocol violations, etc.). In such cases the logic chip is able to re-schedule (re-time, re-order, etc.) access to avoid such conflicts.

In one embodiment the use of shared buses reduces the numbers of TSVs required. Reducing the number of TSVs may help improve manufacturability and may increase yield, thus reducing cost, etc.

In one embodiment, the use of private buses may increase the bandwidth of memory access, reduce the probability of conflicts, eliminate protocol violations, etc.

Of course variations of the schemes (e.g. permutations, combinations, subsets, other similar schemes, etc.) shown in FIG. 12 are possible.

For example in one embodiment using a stacked memory package with 8 chips, one set of four memory chips may used one shared control bus and a second set of four memory chips may use a second shared control bus, etc.

For example in one embodiment some control signals may be shared and some control signals may be private, etc.

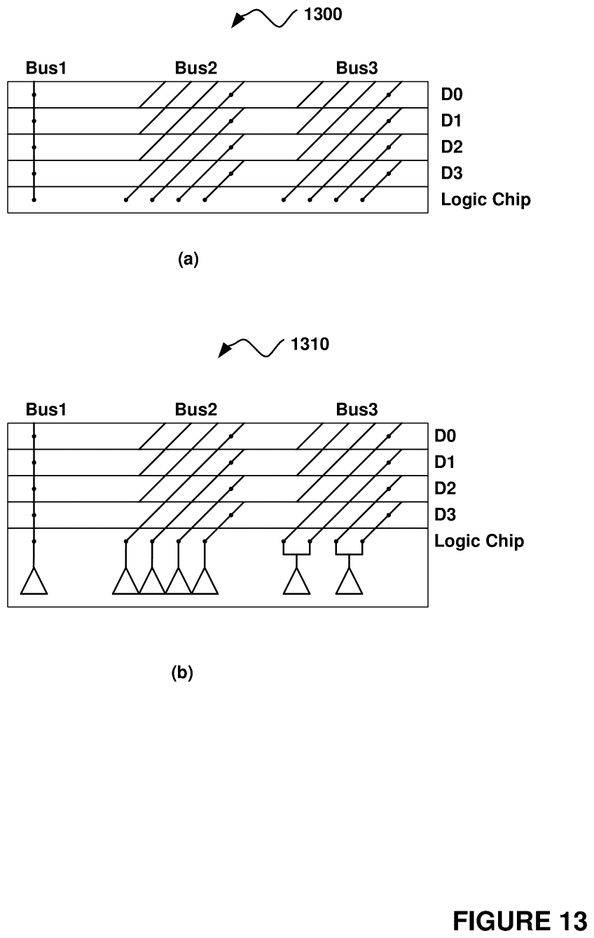

FIG. 13

FIG. 13 shows a logic chip connected to stacked memory chips, in accordance with another embodiment. As an option, the system of FIG. 13 may be implemented in the context of the architecture and environment of the previous Figures and/or any subsequent Figure(s). Of course, however, the system of FIG. 13 may be implemented in the context of any desired environment.

FIG. 13 shows 4 stacked memory chips (DO, D1, D2, D3) connected (e.g. coupled, etc.) to a single logic chip. Typically connections are made using TSVs, spacers, and solder bumps (as shown for example in FIG. 4). Other connection and coupling methods may be used.

In FIG. 13 (a) three buses are shown: Bus1, Bus2, Bus3.

Note that in FIGS. 13(a) and (b) the buses may be of any type. The wires shown may be: (1) single wires (e.g. for discrete control signals such as CK, CKE, CS, or other equivalent control signals etc.); (2) bundles of wires (e.g. a bundle of control signals each using a distinct wire (e.g. trace, path, conductors, etc.); (3) a bus (e.g. group of related signals, data bus, address bus, etc.) with each signal in the bus occupying a single wire; (3) a multiplexed bus (e.g. column address and row address multiplexed onto a single address bus, etc.); (4) a shared bus (e.g. used at time t1 for one purpose, used at time t2 for a different purpose, etc.); (5) a packet bus (e.g. data, address and/or command, request(s), response(s), encapsulated in packets, etc.); (6) any other type of communication bus or protocol; (7) changeable in form and/or topology (e.g. programmable, used as general-purpose, switched-purpose, etc.); (8) any combinations of these, etc.

In FIG. 13 (a) it should be noted that all stacked memory chips have the same physical and electrical wiring pattern. FIG. 13 (a) is logically equivalent to the connection pattern shown in FIG. 12 (b) (e.g. with Bus1 in FIG. 13 (a) equivalent to the address bus in FIG. 12(b); with Bus2 in FIG. 13 (a) equivalent to the control bus in FIG. 12(b); with Bus3 in FIG. 13 (a) equivalent to the data bus in FIG. 12(b), etc.).

In FIG. 13 (b) the wiring pattern for DO-D3 is identical to FIG. 13 (a). In FIG. 13 (b) a technique (e.g. method, architecture, etc.) is shown to connect pairs of stacked memory chips to a bus. For example, in FIG. 13 (b) Bus 3 connects two pairs: a first part of Bus3 (e.g. portion, bundle, section, etc.) connects DO and D1 while a second part of Bus 3 connects D2 and D3. In FIG. 13 (b) all 3 buses are shown as being driven by the logic chip. Of course the buses may be unidirectional from the logic chip (e.g. driven by the logic chip etc.), unidirectional to the logic chip (driven by one or more stacked memory chips, etc.), bidirectional to/from the logic chip, or use any other form of coupling between any number of the logic chip(s) and/or stacked memory chip(s), etc.

In one embodiment the schemes shown in FIG. 13 may also be employed to connect power (e.g. VDD, VDDQ, VREF, VDLL, GND, other supply and/or reference voltages, currents, etc.) to any permutation and combination of logic chip(s) and/or stacked memory chips. For example it may be required (e.g. necessary, desirable, convenient, etc.) for various design reasons (e.g. TSV resistance, power supply noise, circuit location(s), etc.) to connect a first power supply VDD1 from the logic chip to stacked memory chips D0 and D1 and a second separate power supply VDD2 from the logic chip to D2 and D3. In such a case a wiring scheme similar to that shown in FIG. 13 (b) for Bus3 may be used, etc.

In one embodiment the wiring arrangement(s) (e.g. architecture, scheme, connections, etc.) between logic chip(s) and/or stacked memory chips may be fixed.

In one embodiment the wiring arrangements may be variable (e.g. programmable, changed, altered, modified, etc.). For example, depending on the arrangement of banks, subbanks, echelons etc. it may be desirable to change wiring (e.g. chip routing, bus functions, etc.) and/or memory system or memory subsystem configurations (e.g. change the size of an echelon, change the memory chip wiring topology, time-share buses, etc.). Wiring may be changed in a programmable fashion using switches (e.g. pass transistors, logic gates, transmission gates, pass gates, etc.).

In one embodiment the switching of wiring configurations (e.g. changing connections, changing chip and/or circuit coupling(s), changing bus function(s), etc.) may be done at system initialization (e.g. once only, at start-up, at configuration time, etc.).

In one embodiment the switching of wiring configurations may be performed at run time (e.g. in response to changing workloads, to save power, to switch between performance and low-power modes, to respond to failures in chips and/or other components or circuits, on user command, on BIOS command, on program command, on CPU command, etc.).

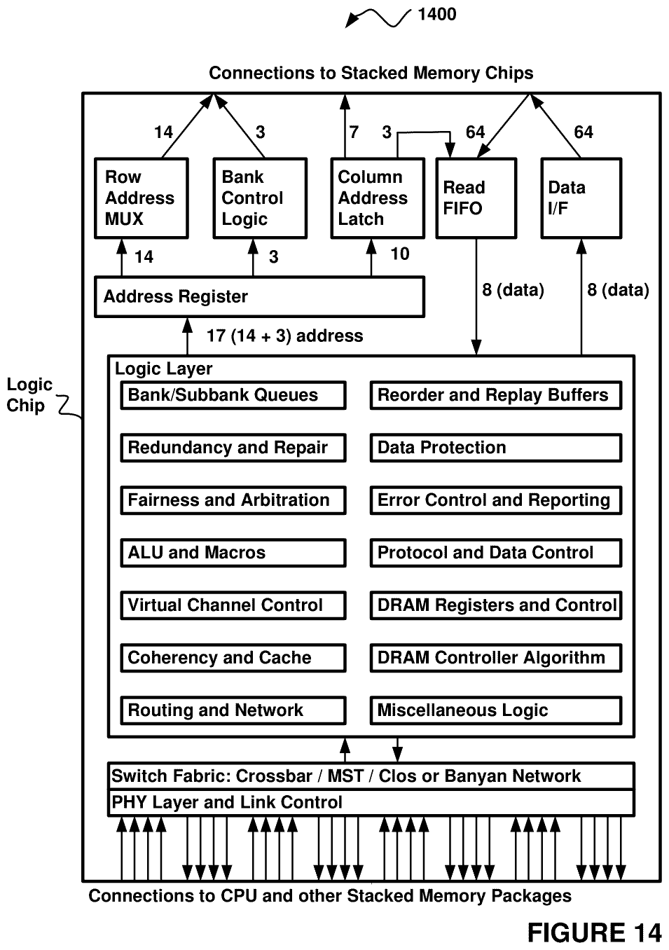

### FIG. 14

FIG. 14 shows a logic chip for use with stacked memory chips in a stacked memory chip package, in accordance with another embodiment. As an option, the system of FIG. 14 may be implemented in the context of the architecture and environment of the previous Figures and/or any subsequent Figure(s). Of course, however, the system of FIG. 14 may be implemented in the context of any desired environment.

In FIG. 14 the logic layer of the logic chip may contain the following functional blocks: (1) bank/subbank queues; (2) redundancy and repair; (3) fairness and arbitration; (4) ALU and macros; (5) virtual channel control; (6) coherency and cache; (7) routing and network; (8) reorder and replay buffers; (9) data protection; (10) error control and reporting; (11) protocol and data control; (12) DRAM registers and control; (13) DRAM controller algorithm; (14) miscellaneous logic.

In FIG. 14 the logic chip may contain a PHY layer and link layer control.

In FIG. 14 the logic chip may contain a switch fabric (e.g. one or more crossbar switches, a minimum spanning tree (MST), a Clos network, a banyan network, crossover switch, matrix switch, nonblocking network or switch, Benes network, multi-stage interconnection network, multi-path network, single path network, time division fabric, space division fabric, recirculating network, hypercube network, Strowger switch, Batcher network, Batcher-Banyon switching system, fat tree network, omega network, delta network switching system, fully interconnected fabric, hierarchical combinations of these, nested combinations of these, linear (e.g. series and/or parallel connections, etc.) combinations of these, and combinations of any of these and/or other networks, etc.).

In FIG. 14 the PHY layer is coupled to one or more CPUs and/or one or more stacked memory packages. In FIG. 14 the serial links are shown as 8 sets of 4 arrows. An arrow directed into the PHY layer represents an Rx signal (e.g. a pair of differential signals, etc.). An arrow directed out of the PHY represents Tx signal. Since a lane is defined herein to represent the wires used for both Tx and Rx FIG. 14 shows 4 sets of 4 lanes.

In one embodiment the logic chip links may be built using one or more high-speed serial links that may use dedicated unidirectional couples of serial (1-bit) point-to-point connections or lanes.

In one embodiment the logic chip links may use a bus-based system where all the devices share the same bidirectional bus (e.g. a 32-bit or 64-bit parallel bus, etc.).

In one embodiment the serial high-speed links may use one or more layered protocols. The protocols may consist of a transaction layer, a data link layer, and a physical layer. The data link layer may include a media access control (MAC) sublayer. The physical layer (also known as PHY, etc.) may include logical and electrical sublayers. The PHY logical-sublayer may contain a physical coding sublayer (PCS). The layered protocol terms may follow (e.g. may be defined by, may be described by, etc.) the IEEE 802 networking protocol model.

In one embodiment the logic chip high-speed serial links may use a standard PHY. For example, the logic chip may use the same PHY that is used by PCI Express. The PHY specification for PCI Express (and high-speed USB) is published by Intel as the PHY Interface for PCI Express (PIPE). The PIPE specification covers (e.g. specifies, defines, describes, etc.) the MAC and PCS functional partitioning and the interface between these two sublayers. The PIPE specification covers the physical media attachment (PMA) layer (e.g. including the serializer/deserializer (SerDes), other analog IO circuits, etc.).

In one embodiment the logic chip high-speed serial links may use a non-standard PHY. For example market or technical considerations may require the use of a proprietary PHY design or a PHY based on a modified standard, etc.

Other suitable PHY standards may include the Cisco/Cortina Interlaken PHY, or the MoSys CEI-11 PHY.

In one embodiment each lane of a logic chip may use a high-speed electrical digital signaling system that may run at very high speeds (e.g. over inexpensive twisted-pair copper cables, PCB, chip wiring, etc.). For example, the electrical signaling may be a standard (e.g. Low-Voltage Differential Signaling (LVDS), Current Mode Logic (CML), etc.) or non-standard (e.g. proprietary, derived or modified from a standard, standard but with lower voltage or current, etc.). For example the digital signaling system may consist of two unidirectional pairs operating at 2.525 Gbit/s. Transmit and receive may use separate differential pairs, for a total of 4 data wires per lane. A connection between any two devices is a link, and consists of 1 or more lanes. Logic chips may support single-lane link (known as a ×1 link) at minimum. Logic chips may optionally support wider links composed of 2, 4, 8, 12, 16, or 32 lanes, etc.

In one embodiment the lanes of the logic chip high-speed serial links may be grouped. For example the logic chip shown in FIG. 14 may have 4 ports (e.g. North, East, South, West, etc.). Of course the logic chip may have any number of ports.

In one embodiment the logic chip of a stacked memory package may be configured to have one or more ports, with each port having one or more high-speed serial link lanes.

In one embodiment the lanes within each port may be combined. Thus for example, the logic chip shown in FIG. 14 may have a total of 16 lanes (represented by the 32 arrows). As is shown in FIG. 14 the lanes are grouped as if the logic chip had 4 ports with 4 lanes in each port. Using logic in the PHY layer lanes may be combined, for example, such that the logic chip appears to have 1 port of 16 lanes. Alternatively the logic chip may be configured to have 2 ports of 8 lanes, etc. The ports do not have to be equal in size. Thus, for example, the logic chip may be configured to have a 1 port of 12 lanes and 2 ports of 2 lanes, etc.

In one embodiment the logic chip may use asymmetric links. For example, in the PIPE and PCI Express specifications the links are symmetrical (e.g. equal number of transmit and receive wires in a link, etc.). The restriction to symmetrical links may be removed by using switching and gating logic in the logic chip and asymmetric links may be employed. The use of asymmetric links may be advantageous in the case that there is much more read traffic than write for example. Since we have decided to use the definition of a lane from PCI Express and PCI Express uses symmetric lanes (equal numbers of Tx and Rx wires) we need to be careful in our use of the term lane in an asymmetric link. Instead we can describe the logic chip functionality in terms of Tx and Rx wires. It should be noted that the Tx and Rx wire function is as seen at the logic chip. Since every Rx wire at the logic chip corresponds to a Tx wire at the remote transmitter we must be careful not to confuse Tx and Rx wire counts at the receiver and transmitter. Of course when we consider both receiver and transmitter every Rx wire (as seen at the receiver) has a corresponding Tx wire (as seen at the transmitter).

In one embodiment the logic chip may be configured to use any combinations (e.g. numbers, permutations, combinations, etc.) of Tx and Rx wires to form one or more links where the number of Tx wires is not necessarily the same as the number of Rx wires. For example a link may use 2 Tx wires (e.g. if we use differential signaling, two wires carries one signal, etc.) and 4 Rx wires, etc. Thus for example the logic chip shown in FIG. 14 has 4 ports with 4 lanes each, 16 lanes with 4 wires per lane, or 64 wires. The logic chip shown in FIG. 14 thus has 32 Rx wires and 32 Tx wires. These wires may be allocated to links in any way desired. For example we may have the following set of links: (1) Link 1 with 16 Rx wires/12 Tx wires; (2) Link 2 with 6 Rx wires/8 Tx wires; (3) Link 3 with 6 Rx wires/8 Tx wires; (4) Link 4 with 4 Rx wires/4 Tx wires. Not all Tx and/or Rx wires need be used and even though a logic chip may be capable of supporting up to 4 ports (e.g. due to switch fabric restrictions, etc.) not all ports need be used.

Of course depending on the technology of the PHY layer it may be possible to swap the function of Tx and Rx wires. For example the logic chip of FIG. 14 has equal numbers of Rx and Tx wires. In some situations it may be desirable to change one or more Tx wires to Rx wires or vice versa. Thus for example it may be desirable to have a single stacked memory package with a very high read bandwidth. In such a situation the logic chip shown in FIG. 14 may be configured, for example, to have 56 Tx wires and 8 Rx wires.

In one embodiment the logic chip may be configured to use any combinations (e.g. numbers, permutations, combinations, etc.) of one or more PHY wires to form one or more serial links comprising a first plurality of Tx wires and a second plurality of Rx wires where the number of the first plurality of Tx wires may be different from the second plurality of Rx wires.

Of course since the memory system typically operates as a split transaction system and is capable of handling variable latency it is possible to change PHY allocation (e.g. wire allocation to Tx and Rx, lane configuration, etc.) at run time. Normally PHY configuration may be set at initialization based on BIOS etc. Depending on use (e.g. traffic pattern, system use, type of application programs, power consumption, sleep mode, changing workloads, component failures, etc.) it may be decided to reconfigure one or more links at run time. The decision may be made by CPU, by the logic chip, by the system user (e.g. programmer, operator, administrator, datacenter management software, etc.), by BIOS etc. The logic chip may present an API to the CPU specifying registers etc. that may be modified in order to change PHY configuration(s). The CPU may signal one or more stacked memory packages in the memory subsystem by using command requests. The CPU may send one or more command requests to change one or more link configurations. The memory system may briefly halt or redirect traffic while links are reconfigured. It may be required to initialize a link using training etc.

In one embodiment the logic chip PHY configuration may be changed at initialization, start-up or at run time.

The data link layer of the logic chip may use the same set of specifications as used for the PHY (if a standard PHY is used) or may use a custom design. Alternatively, since the PHY layer and higher layers are deliberately designed (e.g. layered, etc.) to be largely independent, different standards may be used for the PHY and data link layers.

Suitable standards, at least as a basis for the link layer design, may be PCI Express, MoSys GigaChip Interface (an open serial protocol), Cisco/Cortina Interlaken, etc.

In one embodiment, the data link layer of the logic chip may perform one or more of the following functions for the high-speed serial links: (1) sequence the transaction layer packets (TLPs, also requests, etc.) that are generated by the transaction layer; (2) may optionally ensure reliable delivery of TLPs between two endpoints via an acknowledgement protocol (e.g. ACK and NAK signaling, ACK and NAK messages, etc.) that may explicitly requires replay of invalid (e.g. unacknowledged, bad, corrupted, lost, etc.) TLPs; (3) may optionally initialize and manage flow control credits (e.g. to ensure fairness, for bandwidth control, etc.); (4) combinations of these, etc.

In one embodiment, for each transmitted packet (e.g. request, response, forwarded packet, etc.) the data link layer may generate a ID (e.g. sequence number, set of numbers, codes, etc.) that is a unique identifier (e.g. number (s), sequence(s), time-stamp(s), etc.), as shown for example in FIG. 2. The ID may be changed (e.g. different, incremented, decremented, unique hash, add one, count up, generated, etc.) for each outgoing TLP. The ID may serve as a unique identification field for each transmitted TLP and may be used to uniquely identify a TLP in a system (or in a set of systems, network of system, etc.). The ID may be inserted into an outgoing TLP (e.g. in the header, etc.). A check code (e.g. 32-bit cyclic redundancy check code, link CRC (LCRC), other check code, combinations of check codes, etc.) may also be inserted (e.g. appended to the end, etc.) into each outgoing TLP.

In one embodiment, every received TLP check code (e.g. LCRC, etc.) and ID (e.g. sequence number, etc.) may be validated in the receiver link layer. If either the check code validation fails (indicating a data error), or the sequence-number validation fails (e.g. out of range, non-consecutive, etc.), then the invalid TLP, as well as any TLPs received after the bad TLP, may be considered invalid and may be discarded (e.g. dropped, deleted, ignored, etc.). On receipt of an invalid TLP the receiver may send a negative acknowledgement message (NAK) with the ID of the invalid TLP. On receipt of an invalid TLP the receiver may request retransmission of all TLPs forward (e.g. including and following, etc.) of the invalid ID. If the received TLP passes the check code validation check and has a valid ID, the TLP may be considered as valid. On receipt of a valid TLP the link receiver may change the ID (which may thus be used to track the last received valid TLP) and may forward the valid TLP to the receiver transaction layer. On receipt of a valid TLP the link receiver may send an ACK message to the remote transmitter. An ACK may indicate a valid TLP was received (and thus, by extension, all TLPs with previous IDs (e.g. lower value IDs if IDs are incremented (higher if decremented, etc.), preceding TLPs, lower sequence number, earlier timestamps, etc.).

In one embodiment, if the transmitter receives a NAK message, or does not receive an acknowledgement (e.g. NAK or ACK, etc.) before a timeout period expires, the transmitter may retransmit all TLPs that lack acknowledgement (ACK). The timeout period may be programmable. The link-layer of the logic chip thus may present a reliable connection to the transaction layer, since the transmission protocol described may ensure reliable delivery of TLPs over an unreliable medium.

In one embodiment, the data-link layer may also generate and consume data link layer packets (DLLPs). The ACK and NAK messages may be communicated via DLLPs. The DLLPs may also be used to carry other information (e.g. flow control credit information, power management messages, flow control credit information, etc.) on behalf of the transaction layer.

In one embodiment, the number of in-flight, unacknowledged TLPs on a link may be limited by two factors: (1) the size of the transmit replay buffer (which may store a copy of all transmitted TLPs until they the receiver ACKs them); (2) the flow control credits that may be issued by the receiver to a transmitter. It may be required that all receivers issue a minimum number of credits to guarantee a link allows sending at least certain types of TLPs.

In one embodiment, the logic chip and high-speed serial links in the memory subsystem (as shown, for example, in FIG. 1) may typically implement split transactions (transactions with request and response separated in time). The link may also allow for variable latency (the amount of time between request and response). The link may also allow for out-of-order transactions (while ordering may be imposed as required to support coherence, data validity, atomic operations, etc.).

In one embodiment, the logic chip high-speed serial link may use credit-based flow control. A receiver (e.g. in the memory system, also known as a consumer, etc.) that contains a high-speed link (e.g. CPU or stacked memory package, etc.) may advertise an initial amount of credit for each receive buffer in the receiver transaction layer. A transmitter (also known as producer, etc.) may send TLPs to the receiver and may count the number of credits each TLP consumes. The transmitter may only transmit a TLP when doing so does not make its consumed credit count exceed a credit limit. When the receiver completes processing the TLP (e.g. from the receiver buffer, etc.), the receiver signals a return of credits to the transmitter. The transmitter may increase the credit limit by the restored amount. The credit counters may be modular counters, and the comparison of consumed credits to credit limit may requires modular arithmetic. One advantage of credit-based flow control in a memory system may be that the latency of credit return does not affect performance, provided that a credit limit is not exceeded. Typically each receiver and transmitter may be designed with adequate buffer sizes so that the credit limit may not be exceeded.

In one embodiment, the logic chip may use wait states or handshake-based transfer protocols.

In one embodiment, a logic chip and stacked memory package using a standard PIPE PHY layer may support a data rate of 250 MB/s in each direction, per lane based on the physical signaling rate (2.5 Gbaud) divided by the encoding overhead (10 bits per byte.) Thus, for example, a 16 lane link is theoretically capable of 16×250 MB/s=4 GB/s in each direction. Bandwidths may depend on usable data payload rate. The usable data payload rate may depend on the traffic profile (e.g. mix of reads and writes, etc.). The traffic profile in a typical memory system may be a function of software applications etc.

In one embodiment, in common with other high data rate serial interconnect systems, the logic chip serial links may have a protocol and processing overhead due to data protection (e.g. CRC, acknowledgement messages, etc.). Efficiencies of greater than 95% of the PIPE raw data rate may be possible for long continuous unidirectional data transfers in a memory system (such as long contiguous reads based on a low number of request, or a single request, etc.). Flexibility of the PHY layer or even the ability to change or modify the PHY layer at run time may help increase efficiency.

Next are described various features of the logic layer of the logic chip.

Bank/subbank queues.

The logic layer of a logic chip may contain queues for commands directed at each DRAM or memory system portion (e.g. a bank, subbank, rank, echelon, etc.).

Redundancy and repair;

The logic layer of a logic chip may contain logic that may be operable to provide memory (e.g. data storage, etc.) redundancy. The logic layer of a logic chip may contain logic that may be operable to perform repairs (e.g. of failed memory, failed components, etc.). Redundancy may be provided by using extra (e.g. spare, etc.) portions of memory in one or more stacked memory chips. Redundancy may be provided by using memory (e.g. eDRAM, DRAM, SRAM, other memory etc.) on one or more logic chips. For example, it may be detected (e.g. at initialization, at start-up, during self-test, at run time using error counters, etc.) that one or more components (e.g. memory cells, logic, links, connections, etc.) in the memory system, stacked memory package(s), stacked memory chip(s), logic chip(s), etc. is in one or more failure modes (e.g. has failed, is likely to fail, is prone to failure, is exposed to failure, exhibits signs or warnings of failure, produces errors, exceeds an error or other monitored threshold, is worn out, has reduced performance or exhibits other signs, fails one or more tests, etc.). In this case the logic layer of the logic chip may act to substitute (e.g. swap, insert, replace, repair, etc.) the failed or failing component(s). For example, a stacked memory chip may show repeated ECC failures on one address or group of addresses. In this case the logic layer of the logic chip may use one or more look-up tables (LUTs) to insert replacement memory. The logic layer may insert the bad address(es) in a LUT. Each time an access is made a check is made to see if the address is in a LUT. If the address is present in the LUT the logic layer may direct access to an alternate addressor spare memory. For example the data to be accessed may be stored in another part of the first LUT or in a separate second LUT. For example the first LUT may point to one or more alternate addresses in the stacked memory chips, etc. The first LUT and second LUT may use different technology. For example it may be advantageous for the first LUT to be small but provide very high-speed lookups. For example it may be advantageous for the second LUT to be larger but denser than the first LUT. For example the first LUT may be high-speed SRAM etc. and the second LUT may be embedded DRAM etc.

In one embodiment the logic layer of the logic chip may use one or more LUTs to provide memory redundancy.

In one embodiment the logic layer of the logic chip may use one or more LUTs to provide memory repair.

The repairs may be made in a static fashion. For example at the time of manufacture. Thus stacked memory chips may be assembled with spare components (e.g. parts, etc.) at various levels. For example, there may be spare memory chips in the stack (e.g. a stacked memory package may contain 9 chips with one being a spare, etc.). For example there may be spare banks in each stacked memory chip (e.g. 9 banks with one being a spare, etc.). For example there may be spare sense amplifiers, spare column decoders, spare row decoders, etc. At manufacturing time a stacked memory package may be tested and one or more components may need to be repaired (e.g. replaced, bypassed, mapped out, switched out, etc.). Typically this may be done by using fuses (e.g. antifuse, other permanent fuse technology, etc.) on a memory chip. In a stacked memory package, a logic chip may be operable to cooperate with one or more stacked memory chips to complete a repair. For example, the logic chip may be capable of self-testing the stacked memory chips. For example the logic chip may be capable of operating fuse and fuse logic (e.g. programming fuses, blowing fuses, etc.). Fuses may be located on the logic chip and/or stacked memory chips. For example, the logic chip may use non-volatile logic (e.g. flash, NVRAM, etc.) to store locations that need repair, store configuration and repair information, or act as and/or with logic switches to switch out bad or failed logic, components and/or or memory and switch in replacement logic, components, and/or spare components or memory.

The repairs may be made in a dynamic fashion (e.g. at run time, etc.). If one or more failure modes (e.g. as previously described, other modes, etc.) is detected the logic layer of the logic chip may perform one or more repair algorithms. For example, it may appear that a bank of logic is about to fail because an excessive number of ECC errors has been detected in that bank. The logic layer of the logic chip may proactively start to copy the data in the failing bank to a spare bank. When the copy is complete the logic may switch out the failing bank and replace the failing bank with a spare.

In one embodiment the logic chip may be operable to use a LUT to substitute one or more spare addresses at any time (e.g. manufacture, start-up, initialization, run time, during or after self-test, etc.). For example the logic chip LUT may contain two fields IN and OUT. The field IN may be two bits wide. The field OUT may be 3 bits wide. The stacked memory chip that exhibits signs of failure may have 4 banks. These four banks may correspond to IN[00], IN[01], IN[10], IN[11]. In normal operation a 2-bit part of the input memory address forms an input to the LUT. The output of the LUT normally asserts OUT[000] if IN[00] is asserted, OUT[011] if IN[11] is asserted, etc. The stacked memory chip may have 2 spare banks that correspond to (e.g. are connected to, are enabled by, etc.) OUT[100] and OUT[101]. Suppose the failing bank corresponds to IN[11] and OUT[011]. When the logic chip is ready to switch in the first spare bank it updates the LUT so that the LUT now asserts OUT[100]rather than OUT[011] when IN[11] is asserted etc.

The repair logic and/or other repair components (e.g. LUTs, spare memory, spare components, fuses, etc.) may be located on one or more logic chips; may be located on one or more stacked memory chips; may be located in one or more CPUs (e.g. software and/or firmware and/or hardware to control repair etc.); may be located on one or more substrates (e.g. fuses, passive components etc. may be placed on a substrate, interposer, spacer, RDL, etc.); may be located on or in a combination of these (e.g. part(s) on one chip or device, part(s) on other chip(s) or device(s), etc); or located anywhere in any components of the memory system, etc.

There may be multiple levels of repair and/or replacement etc. For example a memory bank may be replaced/repaired, a memory echelon may be replaced/repaired, or an entire memory chip may be replaced/repaired. Part(s) of the logic chip may also be redundant and replaced and/or repaired. Part(s) of the interconnects (e.g. spacer, RDL, interposer, packaging, etc.) may be redundant and used for replace or repair functions. Part(s) of the interconnects may also be replaced or repaired. Any of these operations may be performed in a static fashion (e.g. static manner; using a static algorithm; while the chip(s), package(s), and/or system is non-operational; at manufacture time; etc.) and/or dynamic fashion (e.g. live, at run time, while the system is in operation, etc.).

Repair and/or replacement may be programmable. For example, the CPU may monitor the behavior of the memory system. If a CPU detects one or more failure modes (e.g. as previously described, other modes, etc.) the CPU may instruct (e.g. via messages, etc.) one or more logic chips to perform repair operation(s) etc. The CPU may be programmed to perform such repairs when a programmed error threshold is reached. The logic chips may also monitor the behavior of the memory system (e.g. monitor their own (e.g. same package, etc.) stacked memory chips; monitor themselves; monitor other memory chips; monitor stacked memory chips in one or more stacked memory packages; monitor other logic chips; monitor interconnect, links, packages, etc.). The CPU may program the algorithm (e.g. method, logic, etc.) that each logic chip uses for repair and/or replacement. For example, the CPU may program each logic chip to replace a bank once 100 correctable ECC errors have occurred on that bank, etc.

### Fairness and Arbitration

In one embodiment the logic layer of each logic chip may have arbiters that decide which packets, commands, etc. in various queues are serviced (e.g. moved, received, operated on, examined, transferred, transmitted, manipulated, etc.) in which order. This process is arbitration. The logic layer of each logic chip may receive packets and commands (e.g. reads, writes, completions, messages, advertisements, errors, control packets, etc.) from various sources. It may be advantageous that the logic layer of each logic chip handle such requests, perform such operations etc. in a fair manner. Fair may mean for example that the CPU may issue a number of read commands to multiple addresses and each read command is treated in an equal fashion by the system so that for example one memory address range does not exhibit different performance (e.g. substantially different performance, statistically biased behavior, unfair advantage, etc.). This process is called fairness.

Note that fair and fairness may not necessarily mean equal. For example the logic layer may implement one or more priorities to different classes of packet, command, request, message etc. The logic layer may also implement one or more virtual channels. For example, a high-priority virtual channel may be assigned for use by real-time memory accesses (e.g. for video, emergency, etc.). For example certain classes of message may be less important (or more important, etc.) than certain commands, etc. In this case the memory system network may implement (e.g. impose, associate, attach, etc.) priority the use in-band signaling (e.g. priority stored in packet headers, etc.) or out of band signaling (priorities assigned to virtual channels, classes of packets, etc.) or other means. In this case fairness may correspond (e.g. equate to, result in, etc.) to each request, command etc. receiving the fair (e.g. assigned, fixed, pro rata, etc.) proportion of bandwidth, resources, etc. according to the priority scheme.

In one embodiment the logic layer of the logic chip may employ one or more arbitration schemes (e.g. methods, algorithms, etc.) to ensure fairness. For example, a crosspoint switch may use one or more (e.g. combination of, etc.): a weight-based scheme, priority based scheme, round robin scheme, timestamp based, etc. For example, the logic chip may use a crossbar for the PHY layer; may use simple (e.g. one packet, etc.) crosspoint buffers with input VQs; and may use a round-robin arbitration scheme with credit-based flow control to provide close to 100% efficiency for uniform traffic.

In one embodiment the logic layer of a logic chip may perform fairness and arbitration in the one or more memory controllers that contain one or more logic queues assigned to one or more stacked memory chips.

In one embodiment the logic chip memory controller(s) may make advantageous use of buffer content (e.g. pen pages in one or more stacked memory chips, logic chip cache, row buffers, other buffer or caches, etc.).

In one embodiment the logic chip memory controller(s) may make advantageous use of the currently active resources (e.g. open row, rank, echelon, banks, subbank, data bus direction, etc.) to improve performance.

In one embodiment the logic chip memory controller(s) may be programmed (e.g. parameters changed, logic modified, algorithms modified, etc.) by the CPU etc. Memory controller parameters etc. that may be changed include, but are not limited to the following: internal banks in each stacked memory chip; internal subbanks in each bank in each stacked memory chip; number of memory chips per stacked memory package; number of stacked memory packages per memory channel; number of ranks per channel; number of stacked memory chips in an echelon; size of an echelon, size of each stacked memory chip; size of a bank; size of a subbank; memory address pattern (e.g. which memory address bits map to which channel, which stacked memory package, which memory chip, which bank, which subbank, which rank, which echelon, etc.), number of entries in each bank queue (e.g. bank queue depth, etc.), number of entries in each subbank queue (e.g. subbank queue depth, etc.), stacked memory chip parameters (e.g. tRC, tRCD, tFAW, etc.), other timing parameters (e.g. rank-rank turnaround, refresh period, etc.).

### ALU and Macro Engines

In one embodiment the logic chip may contain one or more compute processors (e.g. ALU, macro engine, Turing machine, etc.).

For example, it may be advantageous to provide the logic chip with various compute resources. For example, the CPU may perform the following steps: fetch a counter variable stored in the memory system as data from a memory address (possibly involving a fetch of 256 bits or more depending on cache size and word lengths, possibly requiring the opening of a new page etc.); (2) increment the counter; (3) store the modified variable back in main memory (possibly to an already closed page, thus incurring extra latency etc.). One or more macro engines in the logic chip may be programmed (e.g. by packet, message, request, etc.) to increment the counter directly in memory thus reducing latency (e.g. time to complete the increment operation, etc.) and power (e.g. by saving operation of PHY and link layers, etc.). Other uses of the macro engine etc. may include, but are not limited to, one or more of the following (either directly (e.g. self-contained, in cooperation with other logic on the logic chip, etc.) or indirectly in cooperation with other system components, etc.); to perform pointer arithmetic; move or copy blocks of memory (e.g. perform CPU software bcopy( ) functions, etc.); be operable to aid in direct memory access (DMA) operations (e.g. increment address counters, etc.); compress data in memory or in requests (e.g. gzip, 7z, etc.) or expand data; scan data (e.g. for virus, programmable (e.g. by packet, message, etc.) or preprogrammed patterns, etc.); compute hash values (e.g. MD5, etc.); implement automatic packet or data counters; read/write counters; error counting; perform semaphore operations; perform atomic load and/or store operations; perform memory indirection operations; be operable to aid in providing or directly provide transactional memory; compute memory offsets; perform memory array functions; perform matrix operations; implement counters for self-test; perform or be operable to perform or aid in performing self-test operations (e.g. walking ones tests, etc.); compute latency or other parameters to be sent to the CPU or other logic chips; perform search functions; create metadata (e.g. indexes, etc.); analyze memory data; track memory use; perform prefetch or other optimizations; calculate refresh periods; perform temperature throttling calculations or other calculations related to temperature; handle cache policies (e.g. manage dirty bits, write-through cache policy, write-back cache policy, etc.); manage priority queues; perform memory RAID operations; perform error checking (e.g. CRC, ECC, SECDED, etc.); perform error encoding (e.g. ECC, Huffman, LDPC, etc.); perform error decoding; or enable; perform or be operable to perform any other system operation that requires programmed or programmable calculations; etc.

In one embodiment the one or more macro engine(s) may be programmable using high-level instruction codes (e.g. increment this address, etc.) etc. and/or low-level (e.g. microcode, machine instructions, etc.) sent in messages and/or requests.

In one embodiment the logic chip may contain stored program memory (e.g. in volatile memory (e.g. SRAM, eDRAM, etc.) or in non-volatile memory (e.g. flash, NVRAM, etc.). Stored program code may be moved between non-volatile memory and volatile memory to improve execution speed. Program code and/or data may also be cached by the logic chip using fast on-chip memory, etc. Programs and algorithms may be sent to the logic chip and stored at start-up, during initialization, at run time or at any time during the memory system operation. Operations may be performed on data contained in one or more requests, already stored in memory, data read from memory as a result of a request or command (e.g. memory read, etc.), data stored in memory (e.g. in one or more stacked memory chips (e.g. data, register data, etc.); in memory or register data etc. on a logic chip; etc.) as a result of a request or command (e.g. memory system write, configuration write, memory chip register modification, logic chip register modification, etc.), or combinations of these, etc.

### Virtual Channel Control

In one embodiment the memory system may use one or more virtual channels (VCs). Examples of protocols that use VCs include InfiniBand and PCI Express. The logic chip may support one or more VCs per lane. A VC may be (e.g. correspond to, equate to, be equivalent to, appear as, etc.) an independently controlled communication session in a single lane. Each session may have different QoS definitions (e.g. properties, parameters, settings, etc.). The QoS information may be carried by a Traffic Class (TC) field (e.g. attribute, descriptor, etc.) in a packet (e.g. in a packet header, etc.). As the packet travels though the memory system network (e.g. logic chip switch fabric, arbiter, etc.) at each switch, link endpoint, etc. the TC information may be interpreted and one or more transport policies applied. The TC field in the packet header may be comprised of one or more bits representing one or more different TCs. Each TC may be mapped to a VC and may be used to manage priority (e.g. transaction priority, packet priority, etc.) on a given link and/or path. For example the TC may remain fixed for any given transaction but the VC may be changed from link to link.

### Coherency and Cache

In one embodiment the memory system may ensure memory coherence when one or more caches are present in the memory system and may employ a cache coherence protocol (or coherent protocol).

An example of a cache coherence protocol is the Intel QuickPath Interconnect (QPI). The Intel QPI uses the well-known MESI protocol for cache coherence, but adds a new state labeled Forward (F) to allow fast transfers of shared data. Thus the Intel QPI cache coherence protocol may also be described as using a MESIF protocol.

In one embodiment, the memory system may contain one or more CPUs coupled to the system interconnect through a high performance cache. The CPU may thus appear to the memory system as a caching agent. A memory system may have one or more caching agents.

In one embodiment, one or more memory controllers may provide access to the memory in the memory system. The memory system may be used to store information (e.g. programs, data, etc.). A memory system may have one or more memory controllers (e.g. in each logic chip in each stacked memory package, etc.). Each memory controller may cover (e.g. handle, control, be responsible for, etc.) a unique portion (e.g. part of address range, etc.) of the total system memory address range. For example, if there are two memory controllers in the system, then each memory controller may control one half of the entire addressable system memory, etc. The addresses controlled by each controller may be unique and not overlap with another controller. A portion of the memory controller may form a home agent function for a range of memory addresses. A system may have at least one home agent per memory controller. Some system components in the memory system may be responsible for (e.g. capable of, etc.) connecting to one or more input/output subsystems (e.g. storage, networking, etc.). These system components are referred to as I/O agents. One or more components in the memory system may be responsible for providing access to the code (e.g. BIOS, etc.) required for booting up (e.g. initializing, etc.) the system. These components are called firmware agents (e.g. EFI, etc.).

Depending upon the function that a given component is intended to perform, the component may contain one or more caching agents, home agents, and/or I/O agents. A CPU may contain at least one home agent and at least one caching agent (as well as the processor cores and cache structures, etc.)

In one embodiment messages may be added to the data link layer to support a cache coherence protocol. For example the logic chip may use one or more, but not limited to, the following message classes at the link layer: Home (HOM), Data Response (DRS), Non-Data Response (NDR), Snoop (SNP), Non-Coherent Standard (NCS), and Non-Coherent Bypass (NCB). A group of cache coherence message classes may be used together as a collection separately from other messages and message classes in the memory system network. The collection of cache coherence message classes may be assigned to one or more Virtual Networks (VNs).

Cache coherence management may be distributed to all the home agents and cache agents within the system. Cache coherence snooping may be initiated by the caching agents that request data, and this mechanism is called source snooping. This method may be best suited to small memory systems that may require the lowest latency to access the data in system memory. Larger systems may be designed to use home agents to issue snoops. This method is called the home snooped coherence mechanism. The home snooped coherence mechanism may be further enhanced by adding a filter or directory in the home agent (e.g. directory-assisted snooping (DAS), etc.). A filter or directory may that help reduce the cache coherence traffic across the links.

In one embodiment the logic chip may contain a filter and/or directory operable to participate in a cache coherent protocol. In one embodiment the cache coherent protocol may be one of: MESI, MESIF, MOESI. In one embodiment the cache coherent protocol may include directory-assisted snooping.

### Routing and Network

In one embodiment the logic chip may contain logic that operates at the physical layer, the data link layer (or link layer), the network layer, and/or other layers (e.g. in the OSI model, etc.). For example, the logic chip may perform one or more of the following functions (but not limited to the following functions): performing physical layer functions (e.g. transmit, receive, encapsulation, decapsulation, modulation, demodulation, line coding, line decoding, bit synchronization, flow control, equalization, training, pulse shaping, signal processing, forward error correction (FEC), bit interleaving, error checking, retry, etc.); performing data link layer functions (e.g. inspecting incoming packets; extracting those packets (commands, requests, etc.) that are intended for the stacked memory chips and/or the logic chip; routing and/or forwarding those packets destined for other nodes using RIB and/or FIB; etc.); performing network functions (e.g. QoS, routing, re-assembly, error reporting, network discovery, etc.).

### Reorder and Replay Buffers

In one embodiment the logic chip may contain logic and/or storage (e.g. memory, registers, etc.) to perform reordering of packets, commands, requests etc. For example the logic chip may receive read request with ID 1 for memory address 0x010 followed later in time by read request with ID 2 for memory address 0x020. The memory controller may know that address 0x020 is busy or that it may otherwise be faster to reorder the request and perform transaction ID 2 before transaction ID 1 (e.g. out of order, etc.). The memory controller may then form a completion with the requested data from 0x020 and ID 2 before it forms a completion with data from 0x010 and ID 1. The requestor may receive the completions out of order, that is the requestor may receive completion with ID2 before it receives the completion with ID 1. The requestor may associate requests with completions using the ID.

In one embodiment the logic chip may contain logic and/or storage (e.g. memory, registers, etc.) that are operable to act as one or more replay buffers to perform replay of packets, commands, requests etc. For example, if an error occurs (e.g. is detected, is created, etc.) in the logic chip the logic chip may request the command, packet, request etc. to be retransmitted. Similarly the CPU, another logic chip, other system component, etc. as a receiver may detect one or more errors in a transmission (e.g. packet, command, request, completion, message, advertisement, etc.) originating at (e.g. from, etc.) the logic chip. If the receiver detects an error, the receiver may request the logic chip (e.g. the transmitter, etc.) to replay the transmission. The logic chip may therefore store all transmissions in one or more replay buffers that may be used to replay transmissions.

### Data Protection

In one embodiment the logic chip may provide continuous data protection on all data and control paths. For example in memory system it may be important that when errors occur they are detected. It may not always be possible to recover from all errors but it is often worse for an error to occur and go undetected, a silent error. Thus it may be advantageous for the logic chip to provide protection (e.g. CRC, ECC, parity, etc.) on all data and control paths.

### Error Control and Reporting

In one embodiment the logic chip may provide means to monitor errors and report errors.

In one embodiment the logic chip may perform error checking in a programmable manner.

For example, it may be advantageous to change (e.g. modify, alter, etc.) the error coding used in various stages (e.g. paths, logic blocks, memory on the logic chip, other data storage (registers, eDRAM, etc.), stacked memory chips, etc.). For example, error coding used in the stacked memory chips may be changed from simple parity (e.g. XOR, etc.) to ECC (e.g. SECDED, etc.). Data protection may not be (and typically is not) limited to the stacked memory chips. For example a first data error protection and detection scheme used on memory (e.g. eDRAM, SRAM, etc.) on the logic chip may offer lower latency (e.g. be easier and faster to detect, compute, etc.) but decreased protection (e.g. may only cover 1 bit error etc.); a second data error protection and detection scheme may offer greater protection (e.g. be able to correct multiple bit errors, etc.) but require longer than the first scheme to compute. It may be advantageous for the logic chip to switch (e.g. autonomously as a result of error rate, by CPU command, etc.) between a first and second data protection scheme.

### Protocol and Data Control

In one embodiment the logic chip may provide network and protocol functions (e.g. network discovery, network initialization, network and link maintenance and control, link changes, etc.).

In one embodiment the logic chip may provide data control functions and associated control functions (e.g. resource allocation and arbitration, fairness control, data MUXing and DEMUXing, handling of ID and other packet header fields, control plane functions, etc.)

### DRAM Registers and Control

In one embodiment the logic chip may provide access to (e.g. read, etc.) and control of (e.g. write, etc.) all registers (e.g. mode registers, etc.) in the stacked memory chips.

In one embodiment the logic chip may provide access to (e.g. read, etc.) and control of (e.g. write, etc.) all registers that may control functions in the logic chip.

### (13) DRAM Controller Algorithm

In one embodiment the logic chip may provide one or more memory controllers that control one or more stacked memory chips. The memory controller parameters (e.g. timing parameters, etc.) as well as the algorithms, methods, tuning controls, hints, metrics, etc. may be programmable and may be changed (e.g. modified, altered, tuned, etc.). The changes may be made by the logic chip, by one or more CPUs, by other logic chips in the memory system, remotely (e.g. via network, etc.), or by combinations of these. The changes may be made using messages, requests, commands, packets etc.

### Miscellaneous Logic

In one embodiment the logic chip may provide miscellaneous logic to perform one or more of the following functions (but not limited to the following functions): interface and link characterization (e.g. using PRBS, etc.); providing mixed-technology (e.g. hybrid, etc.) memory (e.g. using DRAM and NAND in stacked memory chips, etc.); providing parallel access to one or more memory areas as ping-pong buffers (e.g. keeping track of the latest write, etc.); adjusting the PHY layer organization (e.g. using pools of CMOS devices to be allocated among link transceivers when changing link configurations, etc.); changing data link layer formats (e.g. formats and fields of packet, transaction, command, request, completion, etc.

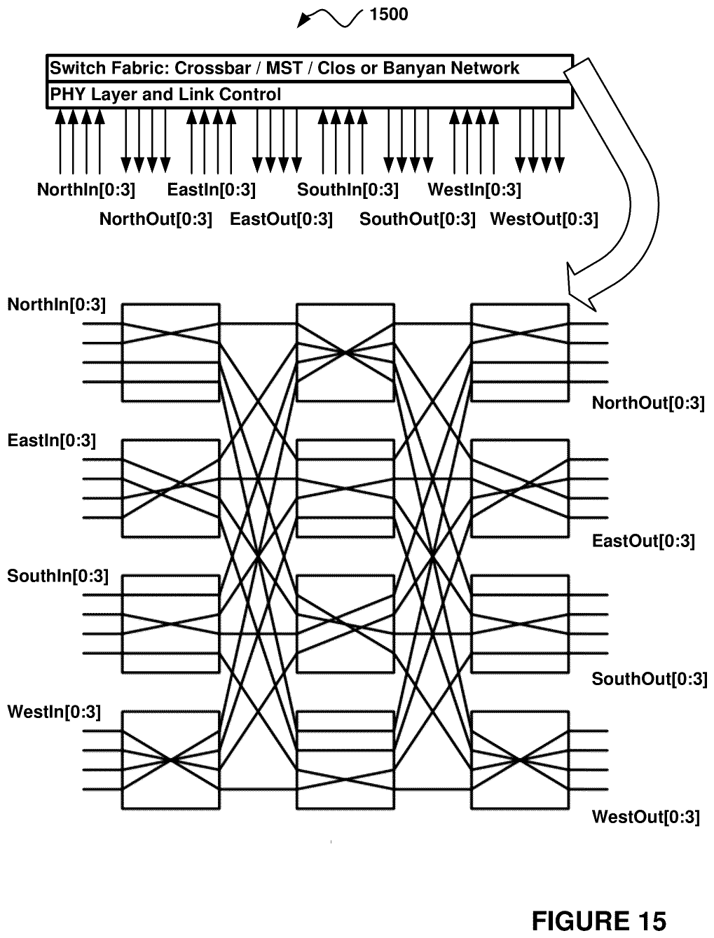

### FIG. 15

FIG. 15 shows the switch fabric for a logic chip for use with stacked memory chips in a stacked memory chip package, in accordance with another embodiment. As an option, the system of FIG. 15 may be implemented in the context of the architecture and environment of the previous Figures and/or any subsequent Figure(s). Of course, however, the system of FIG. 15 may be implemented in the context of any desired environment.

In FIG. 15 the portion of a logic chip that supports flexible configuration of the PHY layer is shown. In this figure only the interconnection of the PHY ports are shown.

In FIG. 15 the logic chip initially has 4 ports: North, East, South, West. Each port initially has input wires (e.g. NorthIn, etc.) and output wires (e.g. NorthOut, etc.). In FIG. 15 each arrow represent two wires that for example may carry a single differential high-speed serial signal. In FIG. 15 each port initially has 16 wires: 8 input wires and 8 output wires.

Although, as described in some embodiments the wires may be flexibly allocated between lanes, links and ports it may be helpful to think of the wires as belong to distinct ports though they need not do so.

In FIG. 15 the PHY ports are joined using a nonblocking minimum spanning tree (MST). This type of switch architecture may be best suited to a logic chip that always has the same number of input and outputs for example.

In one embodiment the logic chip may use any form of switch or connection fabric to route input PHY ports and output PHY ports.

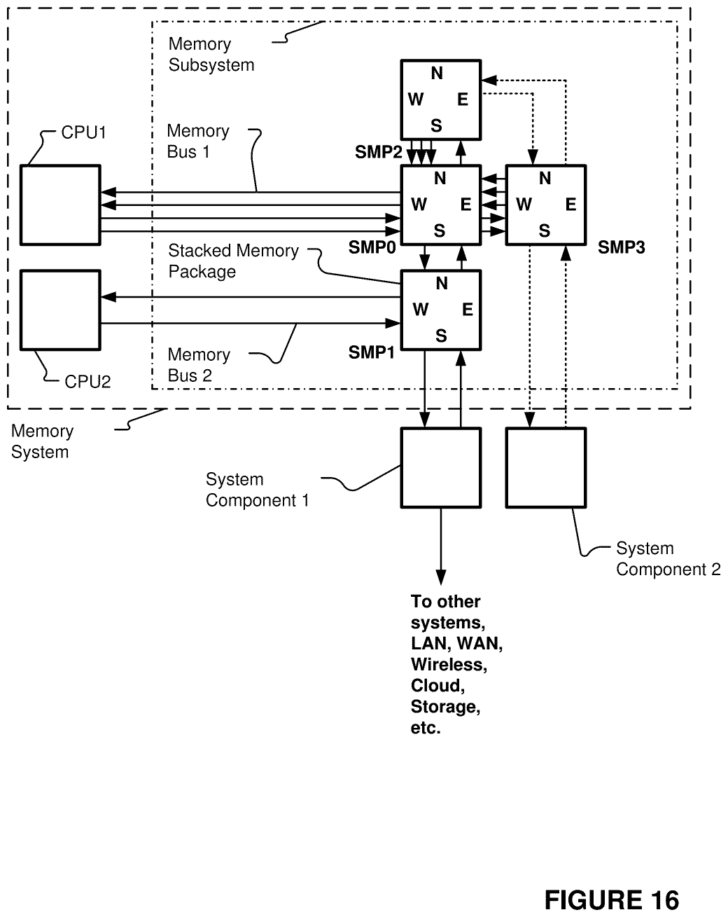

FIG. 16 shows a memory system comprising stacked memory chip packages, in accordance with another embodiment. As an option, the system of FIG. 16 may be implemented in the context of the architecture and environment of the previous Figures and/or any subsequent Figure(s). Of course, however, the system of FIG. 16 may be implemented in the context of any desired environment.

In FIG. 16 there are 3 CPUs: CPU1 and CPU2.

In FIG. 16 there are 4 stacked memory packages: SMP0, SMP1, SMP2, SMP3.

In FIG. 16 there are 2 system components: System Component 1 (SC1), System Component 2 (SC2).

In FIG. 16 CPU1 is connected to SMP0 via Memory Bus 1 (MB1).

In FIG. 16 CPU2 is connected to SMP1 via Memory Bus 2(MB2).

In FIG. 16 the memory subsystem comprises SMP0, SMP1, SMP2, SMP3.

In FIG. 16 the stacked memory packages may each have 4 ports (as shown for example in FIG. 14). FIG. 16 illustrates the various ways in which stacked memory packages may be coupled in order to communicate with each other and the rest of the system.

In FIG. 16 SMP0 is configured as follows: the North port is configured to use 6 Rx wires/2 Tx wires; the East port is configured to use 6 Rx wires/4 Tx wires; the South port is configured to use 2 Rx wires/2 Tx wires; the West port is configured to use 4 Rx wires/4 Tx wires. In FIG. 16 SMP0 thus uses 6+6+2+4=18 Tx wires and 2+4+2+4=12 Rx wires, or 30 wires in total. SMP0 may thus be either: (1) a chip with 36 or more wires configured with a switch that uses equal numbers of Rx and Tx wires (and thus some Rx wires would be unused); (2) a chip with 30 or more wires that has complete flexibility in Rx and Tx wire configuration; (3) a chip such as that shown in FIG. 14 with enough capacity on each port that may use a fixed lane configuration for example (and thus some lanes remain unused). FIG. 16 is not necessarily meant to represent a typical memory system configuration but rather illustrate the flexibility and nature of a memory systems that may be constructed using stacked memory chips as described herein.

In FIG. 16 the link (e.g. high-speed serial connections, etc.) between SMP2 and SMP3 is shown as dotted. This indicates that: (1) the connections are present (e.g. traces connect the two stacked memory packages, etc.) but due to configuration (e.g. resources used elsewhere due to a configuration change, etc.) the link is not currently active. For example deactivation of links on the West port of SMP3 may allow reactivation of the link on the North port. Such a link configuration change may be made at run time for example, as previously described.

In one embodiment links between stacked memory packages and/or CPU and/or other system components may be activated and deactivated at run time.

In FIG. 16 the two CPUs may maintain memory coherence in the memory system and/or the entire system. As shown in FIG. 14 the logic chips in each stacked memory package may be capable of maintaining coherence using a cache coherency protocol (e.g. using MESI protocol, MOESI protocol, directory-assisted snooping (DAS), etc.).

In one embodiment the logic chip of a stacked memory package maintains cache coherency in a memory system.

In FIG. 16 there are two system components, SC1 and SC2, connected to the memory subsystem. SC1 may be a network interface for example (e.g. Ethernet card, wireless interface, switch, etc.). SC2 may be a storage device, another type of memory, another system, multiple devices or systems, etc. Such system components may be permanently attached or pluggable (e.g. before start-up, hot pluggable, etc.).

In one embodiment one or more system components may be operable to be coupled to one or more stacked memory packages.

In FIG. 16 routing of transactions (e.g. requests, responses, messages, etc.) between network nodes (e.g. CPUs, stacked memory packages, system components, etc.) may be performed using one or more routing protocols.

A routing protocol may be used to exchange routing information within a network. In a small network such as that typically found in a memory system, the simplest and most efficient routing protocol may be an interior gateway protocol (IGP). IGPs may be divided into two general categories: (1) distance-vector (DV) routing protocols; (2) link-state routing protocols.

Examples of DV routing protocols used in the Internet are: Routing Information Protocol (RIP), Interior Gateway Routing Protocol (IGRP), Enhanced Interior Gateway Routing Protocol (EIGRP). A DV routing protocol may use the Bellman-Ford algorithm. In a distance-vector routing protocol, each node (e.g. router, switch, etc.) may possess information about the full network topology. A node advertises (e.g. using advertisements, messages, etc.) a distance value (DV) from itself to other nodes. A node may receive similar advertisements from other nodes. Using the routing advertisements each node may construct (e.g. populate, create, build, etc.) one or more routing tables and associated data structures, etc. One or more routing tables may be stored in each logic chip (e.g. in embedded DRAM, SRAM, flip-flops, registers, attached stacked memory chips, etc.). In the next advertisement cycle, a node may advertise updated information from its routing table(s). The process may continue until the routing tables of each node converge to stable values.

Examples of link-state routing protocols used in the Internet are: Open Shortest Path First (OSPF), Intermediate System to Intermediate System (IS-IS). In a link-state routing protocol each node may possess information about the complete network topology. Each node may then independently calculate the best next hop from itself to every possible destination in the network using local information of the topology. The collection of the best next hops may be used to form a routing table. In a link-state protocol, the only information passed between the nodes may be information used to construct the connectivity maps.

A hybrid routing protocols may have both the features of DV routing protocols and link-state routing protocols. An example of a hybrid routing protocol is Enhanced Interior Gateway Routing Protocol (EIGRP).

In one embodiment the logic chip may use a routing protocol to construct one or more routing tables stored in the logic chip. The routing protocol may be a distance-vector routing protocol, a link-state routing protocol, a hybrid routing protocol, or another type of routing protocol.

The choice of routing protocol may be influenced by the design of the memory system with respect to network failures (e.g. logic chip failures, repair and replacement algorithms used, etc.).

In one embodiment it may be advantageous to designate (e.g. assign, elect, etc.) one or more master nodes that keep one or more copies of one or more routing tables and structures that hold all the required routing information for each node to make routing decisions. The master routing information may be propagated (e.g. using messages, etc.) to all nodes in the network. For example, in the memory system network of FIG. 16 CPU 1 may be the master node. At start-up CPU 1 may create the routing information. For example CPU 1 may use a network discovery protocol and broadcast discovery messages to establish the number, type, and connection of nodes.

One example of a network discovery protocol used in the Internet is the Neighbor Discovery Protocol (NDP). NDP operates at the link layer and may perform address auto configuration of nodes, discovery of nodes, determining the link layer addresses of nodes, duplicate address detection, address prefix discovery, and may maintain reachability information about the paths to other active neighbor nodes. NDP includes Neighbor Unreachability Detection (NUD) that may improve robustness of delivery in the presence of failing nodes and/or links, or nodes that may move (e.g. removed, hot-plugged etc.). NDP defines and uses five different ICMP packet types to perform functions. The NDP protocol and/or NDP packet types may be used as defined or modified to be used specifically in a memory system network. The network discovery packet types used in a memory system network may include one or more of the following: Solicitation, Advertisement, Neighbor Solicitation, Neighbor Advertisement, Redirect.

When the master node has established the number, type, and connection of nodes.etc. the master node may create network information including network topology, routing information, routing tables, forwarding tables, etc. The organization of master nodes may include primary master nodes, secondary master nodes, etc. For example in FIG. 16 CPU 1 may be designated as the primary master node and CPU 2 may be designated as the secondary master node. In the event of a failure (e.g. permanent, temporary, etc.) in or around CPU 1, the primary maser node may no longer be able to perform the functions required to maintain routing tables, etc. In this case the secondary master node CPU 2 may assume the role of master node. CPU1 and CPU2 may monitor each other by exchange of messages etc.

In one embodiment the memory system network may use one or more master nodes to create routing information.

In one embodiment there may be a plurality of master nodes in the memory system network that monitor each other. The plurality of master nodes may be ranked as primary, secondary, tertiary, etc. The primary master node may perform master node functions unless there is a failure in which case the secondary master node takes over as primary master node. If the secondary master node fails, the tertiary master node may take over, etc.

A routing table (also known as Routing Information Base (RIB), etc.) may be one or more data tables or data structures, etc. stored in a node (e.g. CPU, logic chip, system component, etc.) of the memory system network that may list the routes to particular network destinations, and in some cases, metrics (e.g. distances, cost, etc.) associated with the routes. A routing table in a node may contain information about the topology of the network immediately around that node. The construction of routing tables may be performed by one or more routing protocols.

In one embodiment the logic chip in a stacked memory package may contain routing information stored in one or more data structures (e.g. routing table, forwarding table, etc.). The data structures may be stored in on-chip memory (e.g. embedded DRAM (eDRAM), SRAM, CAM, etc.) and/or off-chip memory (e.g. in stacked memory chips, etc.).

The memory system network may use packet (e.g. message, transaction, etc.) forwarding to transmit (e.g. relay, transfer, etc.) packets etc. between nodes. In hop-by-hop routing, each routing table lists, for all reachable destinations, the address of the next node along the path to the destination: The next node along the path is the next hop. The algorithm to relay packets to their destination is thus to deliver the packet to the next hop. The algorithm may assume that the routing tables are consistent at each node,

The routing table may include, but is not limited to, one or more of the following information fields: the Destination Network ID (DNID) (e.g. if there is more than one network, etc.); Route Cost (RC) (e.g. the cost or metric of the path on which the packet is to be sent, etc.); Next Hop (NH) (e.g. the address of the next node to which the packet is to be sent on the way to its final destination, etc.); Quality of Service (QOS) associated with the route (e.g. virtual channel to be used, priority, etc.); Filter Information (FI) (e.g. filtering criteria, access lists, etc. that may be associated with the route, etc.); Interface (IF) (e.g. such as link0 for the first lane or link or wire pair, etc, link1 for the second, etc.).

In one embodiment the memory system network may use hop-by-hop routing.

In one embodiment it may be advantageous for the memory system network to use static routing, where routes through the memory system network are described by fixed paths (e.g. static, etc.). For example, a static routing protocol may be simple and thus easier and most inexpensive to implement.

In one embodiment it may be advantageous for the memory system network to use adaptive routing. Examples of adaptive routing protocols used in the Internet include: RIP, OSPF, IS-IS, IGRP, EIGRP. Such protocols may be adopted as is or modified for use in a memory system network. Adaptive routing may enable the memory system network to alter a path that a route takes through the memory system network. Paths in the memory system network may be changed in response to (e.g. as a result of, etc.) a change in the memory system network (e.g. node failures, link failure, link activation, link deactivation, link change, etc.). Adaptive routing may allow for the memory system network to route around node failures (e.g. loss of a node, loss of one or more connections between nodes, etc.) as long as other paths are available.

In one embodiment it may be advantageous to use a combination of static routing (e.g. for next hop information, etc.) and adaptive routing (e.g. for link structures, etc.).

In FIG. 16 SMP0, SMP2 and SMP3 may form a physical ring (e.g. a circular connection, etc.) if SMP3 is connected to SMP2 (e.g. using the link connection shown as dotted, etc.). The memory system network may use rings, trees, meshes, star, double rings, or any network topology. If the network topology is allowed to contain physical rings then the routing protocol may be chosen to allow one or more logical loops in the network.

A logical loop (switching loop, or bridge loop) occurs in a network when there is more than one path (at Layer 2, the data link layer, in the OSI model) between two endpoints. For example a logical loop occurs if there are multiple connections between two network nodes or two ports on the same node connected to each other, etc. If the data link layer header does not support a time to live (TTL) field, a packet (e.g. frame, etc.) that is sent into a looped network topology may endlessly loop.

A physical network topology that contains physical rings and logical loops (e.g. switching loops, bridge loops, etc.) may be necessary for reliability. A logical loop-free logical topology may be created by choice of protocol (e.g. spanning tree protocol (STP), etc.). For example, STP may allow the memory system network to include spare (e.g. redundant, etc.) links to provide increased reliability (e.g. automatic backup paths if an active link fails, etc.) without introducing logical loops, or the need for manual enabling/disabling of the spare links.

In one embodiment the memory system network may use rings, trees, meshes, star, double rings, or any network topology.

In one embodiment the memory network may use a protocol that avoids logical loops in a network that may contain physical rings.

In one embodiment it may be advantageous to minimize the latency (e.g. delay, forwarding delay, etc.) to forward packets from one node to the next. For example the logic chip, CPU or other system components etc. may use optimizations to reduce the latency. For example, the routing tables may not be used directly for packet forwarding. The routing tables may be used to generate the information for a smaller forwarding table. A forwarding table may contain only the routes that are chosen by the routing algorithm as preferred (e.g. optimized, lowest latency, fastest, most reliable, currently available, currently activated, lowest cost by a metric, etc.) routes for packet forwarding. The forwarding table may be stored in an format (e.g. compressed format, pre-compiled format, etc.) that is optimized for hardware storage and/or speed of lookup.

The use of a separate routing table and forwarding table may be used to separate a Control Plane (CP) function of the routing table from the Forwarding Plane (FP) function of the forwarding table. The separation of control and forwarding (e.g. separation of FP and CP, etc.) may provide increased performance (e.g. lower forwarding latency, etc.).

One or more forwarding tables (or forwarding information base (FIB), etc.) may be used in each logic chip etc. to quickly find the proper exit interface to which the input interface should send a packet to be transmitted by the node. FIBs may be optimized for fast lookup of destination addresses. FIBs may be maintained (e.g. kept, etc.) in one-to-one correspondence with the RIBs. RIBs may then be separately optimized for efficient updating by the memory system network routing protocols and other control plane methods. The RIBs and FIBs may contain the full set of routes learned by the node.

FIBs in each logic chip may be implemented using fast hardware lookup mechanisms (e.g. ternary content addressable memory (TCAM), CAM, DRAM, eDRAM, SRAM, etc.).

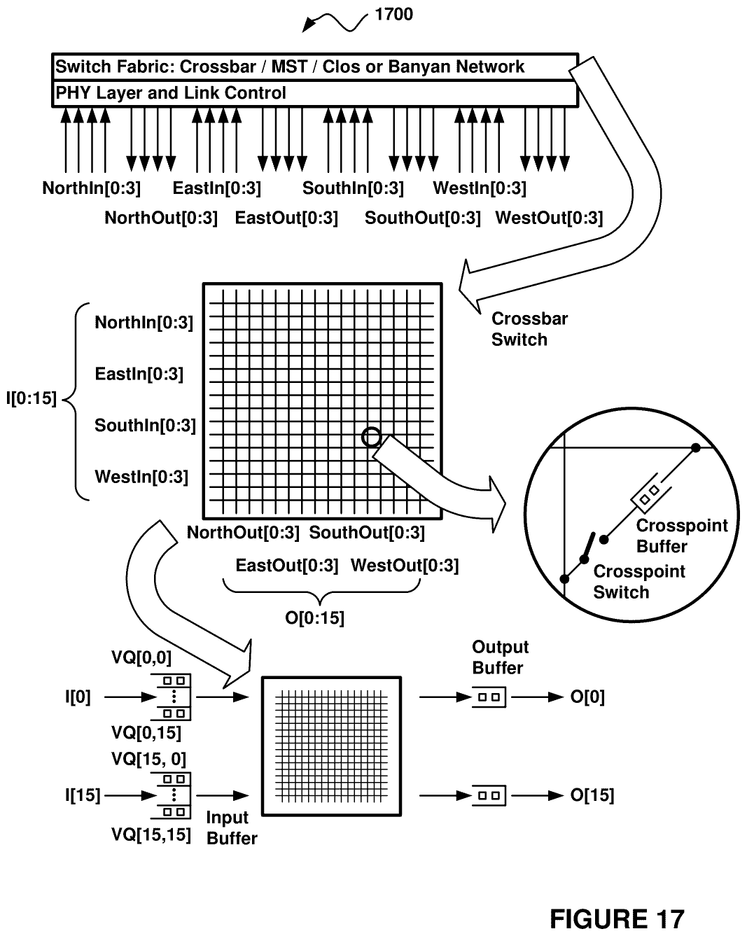

### FIG. 17

FIG. 17 shows a crossbar switch fabric for a logic chip for use with stacked memory chips in a stacked memory chip package, in accordance with another embodiment. As an option, the system of FIG. 17 may be implemented in the context of the architecture and environment of the previous Figures and/or any subsequent Figure(s). Of course, however, the system of FIG. 17 may be implemented in the context of any desired environment.

In FIG. 17 the portion of a logic chip that supports flexible configuration of the PHY layer is shown. In this figure only the interconnection of the PHY ports are shown.

In one embodiment the inputs and outputs of a logic chip may be connected to a crossbar switch.

In FIG. 17 the inputs are connected to a fully connected crossbar switch. The switch matrix may consist of switches and optionally crosspoint buffers connected to each switch.

In FIG. 17 the inputs are connected to input buffers that comprise one or more virtual queues. For example input NorthIn[0] or I[0] may be connected to virtual queues VQ[0, 0] through VQ[0, 15]. Virtual queue VQf, k] may hold packets arriving at input j that are destined (e.g. intended, etc.) for output k, etc.

In FIG. 17 assume that the packets arrive at the inputs at the beginning of time slots. In FIG. 17 the switching of inputs to outputs may occur using one or more scheduling cycles. In the first part of scheduling cycle a matching algorithm may selects a matching between inputs j and outputs k. In the second part of a scheduling cycle packets are transferred (e.g. moved, etc.) from inputs j to outputs k. The speedup factor s is the number of scheduling cycles per time slot. If s is greater than 1 then the outputs may also be buffered, as shown in FIG. 17.

In an N×N crossbar switch such as that shown in FIG. 17 a crossbar with input buffers only may be an input queued (IQ) switch; a crossbar with output buffers only may be an output-queued (OQ) switch; a crossbar with input buffer and output buffers may be a combined input queued and output-queued (CIOQ) switch. An IQ switch may use buffers with bandwidth at up to twice the line rate. An IQ switch may operate at about 60% efficiency (e.g. due to head of line (HOL) blocking, etc.) with random packet traffic and packet destinations, etc. An OQ switch may use buffers with bandwidth of greater than N+1 line rate, which may require very high operating speeds for high-speed links. A CIOQ switch using virtual queues may be more efficient than an IQ or an OQ switch and may, for example, eliminate HOL blocking.

In one embodiment the logic chip may use a crossbar switch that is an IQ switch, and OQ switch, or a CIOQ switch.

In normal operation the switch shown in FIG. 17 may connect one input to one output (e.g. unicast, packet unicast, etc.). In order to perform certain tasks (e.g. network discovery, network maintenance, link changes, message broadcast, etc.) it may be required to connect an input to more than one output (e.g. multicast, packet multicast, etc.).

A switch that may support unicast and multicast may maintain two types of queues: (1) unicast packets are stored in VQs; (2) and multicast packets are stored in one or more separate multicast queues. By closing (e.g. connecting, shorting, etc.) multiple crosspoint switches on one input line simultaneously (e.g. together, at the same time or nearly the same time, etc.) the crossbar switch may perform packet replication and multicast within the switch fabric. At the beginning of each time slot, the scheduling algorithm may decide the crosspoint switches to close.

Similar mechanisms to provide for both unicast and multicast support may be used with other switch and routing architectures such as that shown in FIG. 15 for example.

In one embodiment the logic chip may use a switch (e.g. crossbar, switch matrix, routing structure (tree, network, etc.), or other routing mechanism, etc.) that supports unicast and/or multicast.

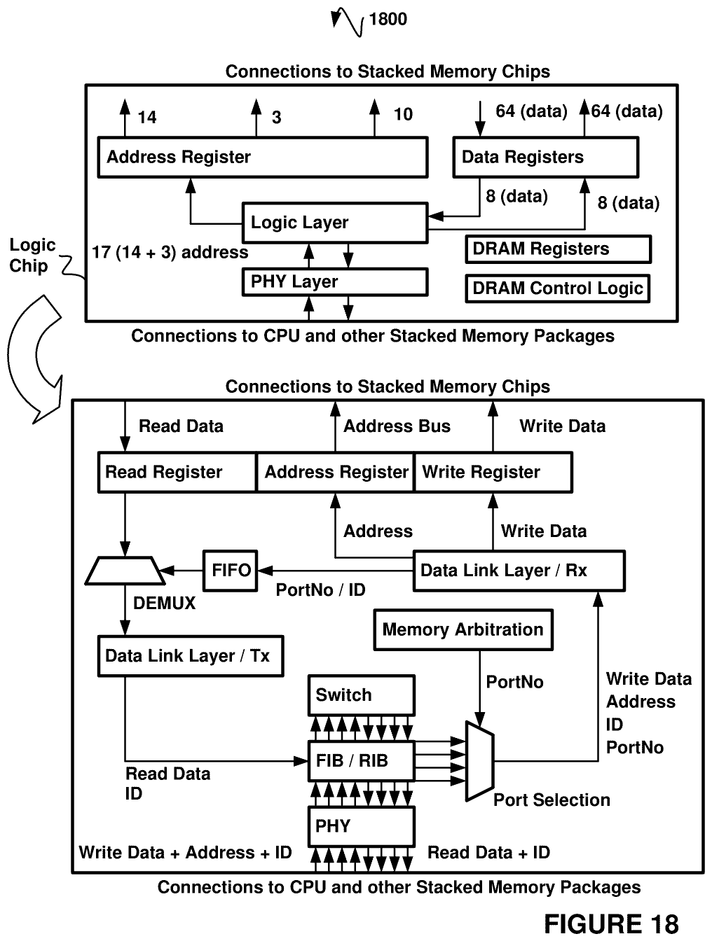

### FIG. 18

FIG. 18 shows part of a logic chip for use with stacked memory chips in a stacked memory chip package, in accordance with another embodiment. As an option, the system of FIG. 18 may be implemented in the context of the architecture and environment of the previous Figures and/or any subsequent Figure(s). Of course, however, the system of FIG. 18 may be implemented in the context of any desired environment.

In FIG. 18 the logic chip contains (but is not limited to) the following functional blocks: read register, address register, write register, DEMUX, FIFO, data link layer/Rx, data link layer/Tx, memory arbitration, switch, FIB/RIB, port selection, PHY.

In FIG. 18 the PHY block may be responsible for transmitting and receiving packets on the high-speed serial interconnect links to one or more CPUs and one or more stacked memory packages.

In FIG. 18 the PHY block has four input ports and four output ports. In FIG. 18 the PHY block is connected to a block that maintains FIB and RIB information. The FIB/RIB block extracts incoming packets from the PHY block that are destined for the logic chip and passes the packets to the port selection block. The FIB/RIB block injects read data and transaction ID from the data link layer/Tx block into the PHY block.

The FIB/RIB block passes incoming packets that require forwarding to the switch block where they are routed to the correct outgoing link via the FIB/RIB block (e.g. using information from the FIB/RIB tables etc.) to the PHY block.

The memory arbitration block picks (e.g. assigns, chooses, etc.) a port number, PortNo (e.g. one of the four PHY ports in the chip shown in FIG. 18, but in general the port may be a link or wire pair etc.). The port selection block receives the PortNo and selects (e.g. DEMUXes, etc.) the write data, address data, transaction ID along with any other packet information from the corresponding port (e.g. port corresponding to PortNo, etc.). The write data, address data, transaction ID and other packet information is passed with PortNo to the data link layer/Rx.

The data link layer/Rx block processes the packet information at the OSI data link layer (e.g. error checking, etc.). The data link layer/Rx block passes write data and address data to the write register and address register respectively. The PortNo and ID fields are passed to the FIFO block.

The FIFO block holds the ID information from successive read requests that is used to match the read data returned from the stacked memory devices to the incoming read requests. The FIFO block controls the DEMUX block.

The DEMUX block passes the correct read data with associated ID to the FIB/RIB block.

The read register block, address register block, write register block are shown in more detail with their associated logic and data widths in FIG. 14.

Of course other architectures, algorithms, circuits, logic structures, data structures etc. may be used to perform the same, similar, or equivalent functions shown in FIG. 18.

The capabilities of the present invention may be implemented in software, firmware, hardware or some combination thereof.

As one example, one or more aspects of the present invention may be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

In various optional embodiments, the features, capabilities, techniques, and/or technology, etc. of the memory and/or storage devices, networks, mobile devices, peripherals, hardware, and/or software, etc. disclosed in the following applications may or may not be incorporated into any of the embodiments disclosed herein: U.S. Provisional Application No. 61/472,558, filed Apr. 6, 2011, titled “Multiple class memory systems”; U.S. Provisional Application No. 61/502,100, filed Jun. 28, 2011, titled “SYSTEM, METHOD, AND COMPUTER PROGRAM PRODUCT FOR IMPROVING MEMORY SYSTEMS”; U.S. Provisional Application No. 61/515,835, filed Aug. 5, 2011, titled “STORAGE SYSTEMS”; U.S. Provisional Application No. 61/566,577, filed Dec. 2, 2011, titled “IMPROVED MOBILE DEVICES”; U.S. Provisional Application No. 61/470,336, filed Mar. 31, 2011, titled “SYSTEM, METHOD, AND COMPUTER PROGRAM PRODUCT FOR UTILIZING IMAGE RECOGNITION TO PERFORM AN ACTION”; and U.S. Provisional Application No. 61/470,391, filed Mar. 31, 2011, titled “SYSTEM, METHOD, AND COMPUTER PROGRAM PRODUCT FOR ENABLING A PERIPHERAL DEVICE TO UTILIZE FUNCTIONALITY ASSOCIATED WITH A MOBILE DEVICE.” Each of the foregoing applications are hereby incorporated by reference in their entirety for all purposes.

Example embodiments described herein may include computer system(s) with one or more central processor units (CPU) and possibly one or more I/O unit(s) coupled to one or more memory systems that may contain one or more memory controllers and memory devices. As used herein, the term memory subsystem refers to, but is not limited to: one or more memory devices; one or more memory devices and associated interface and/or timing/control circuitry; and/or one or more memory devices in conjunction with memory buffer(s), register(s), hub device(s), other intermediate device(s) or circuit(s), and/or switch(es). The term memory subsystem may also refer to one or more memory devices, in addition to any associated interface and/or timing/control circuitry and/or memory buffer(s), register(s), hub device(s) or switch(es), assembled into substrate(s), package(s), carrier(s), card(s), module(s) or related assembly, which may also include connector(s) or similar means of electrically attaching the memory subsystem with other circuitry.

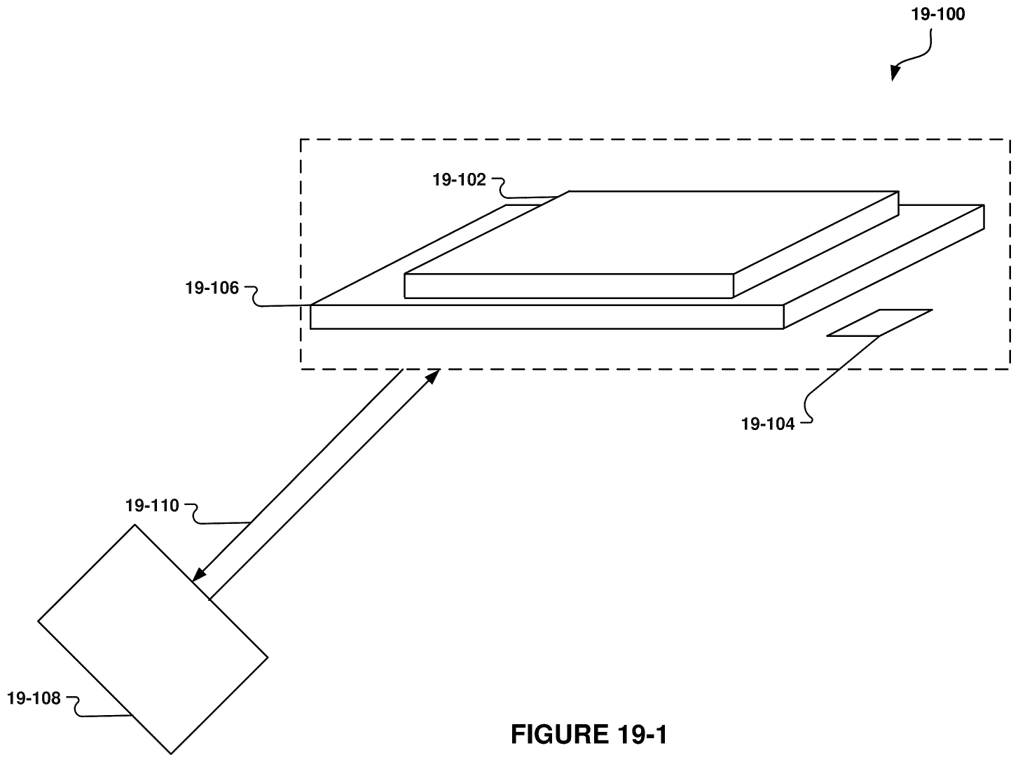

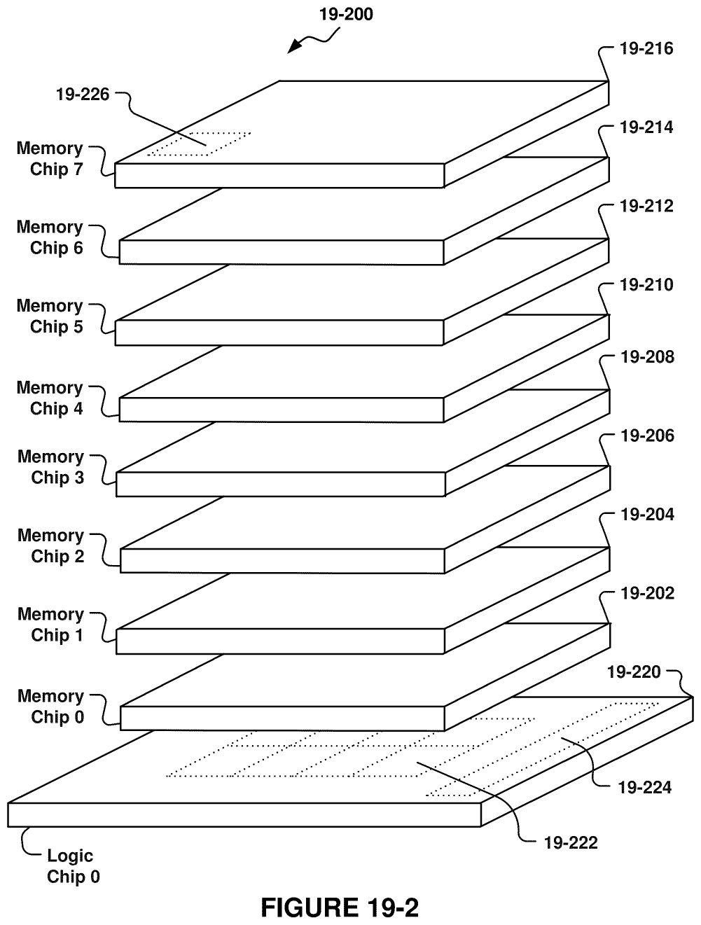

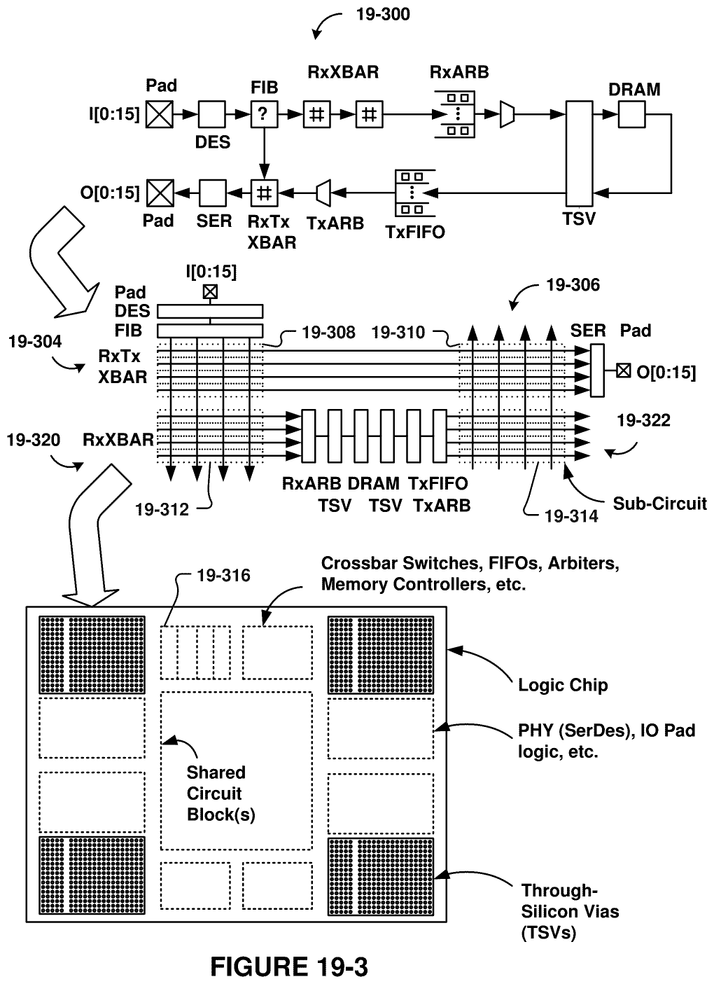

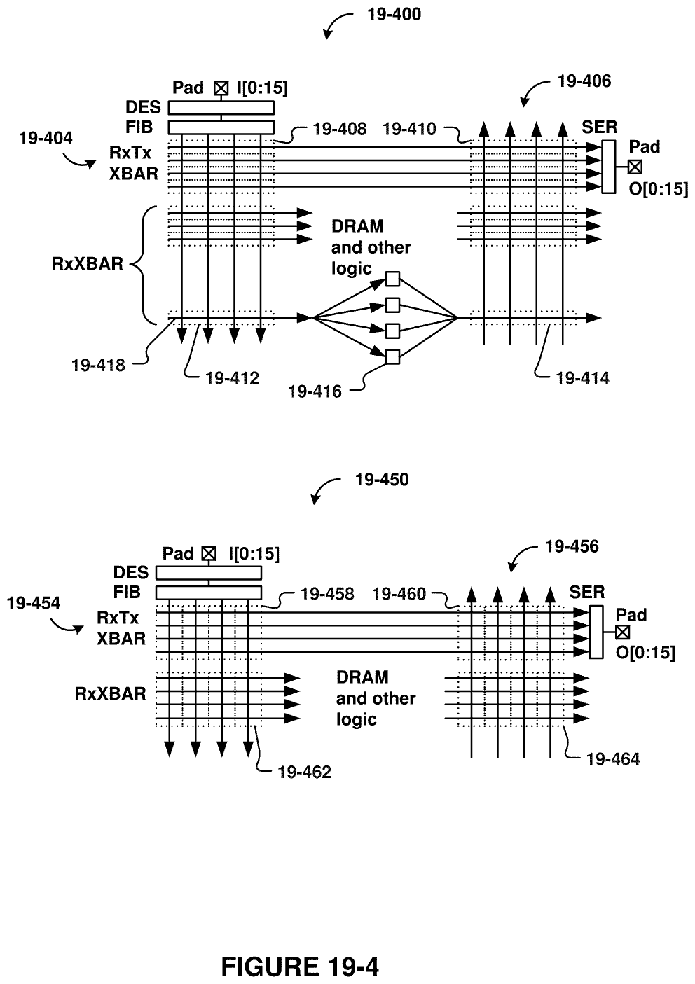

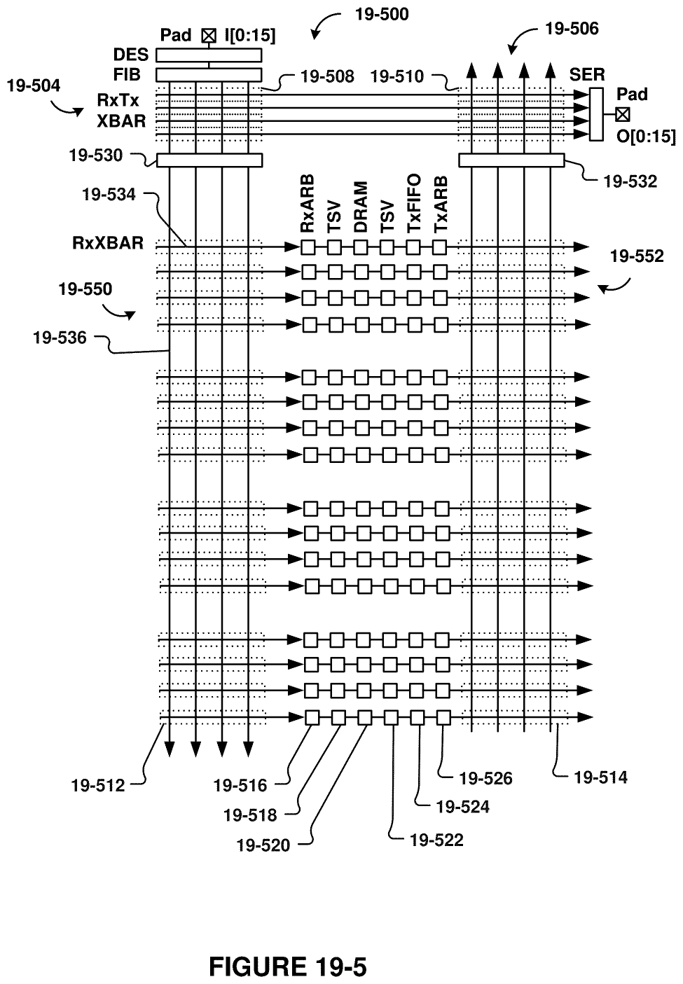

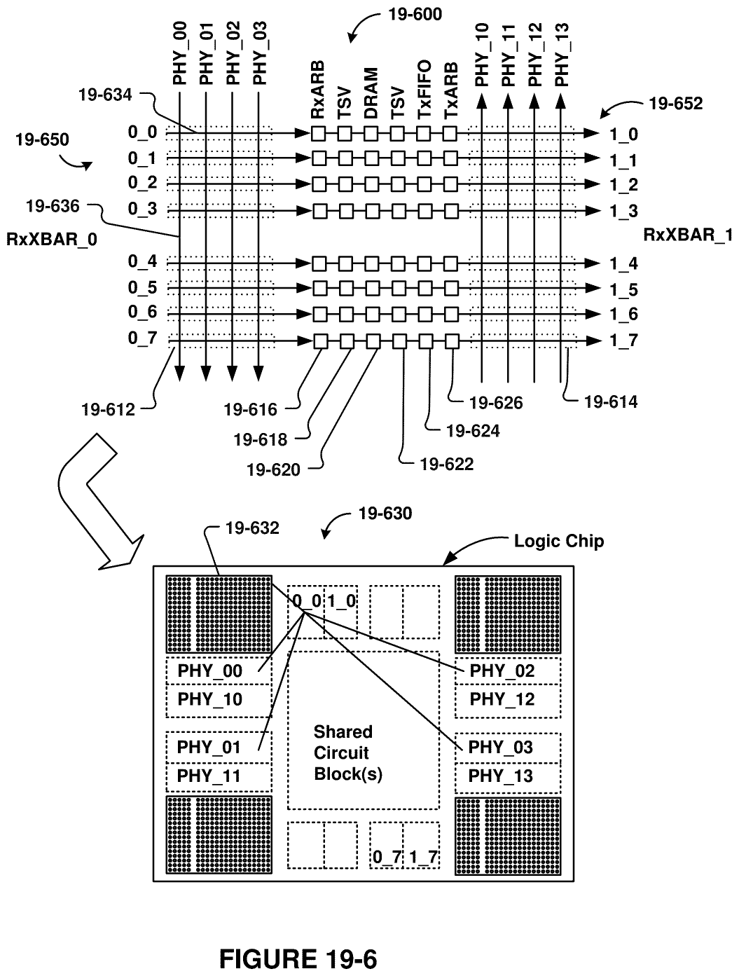

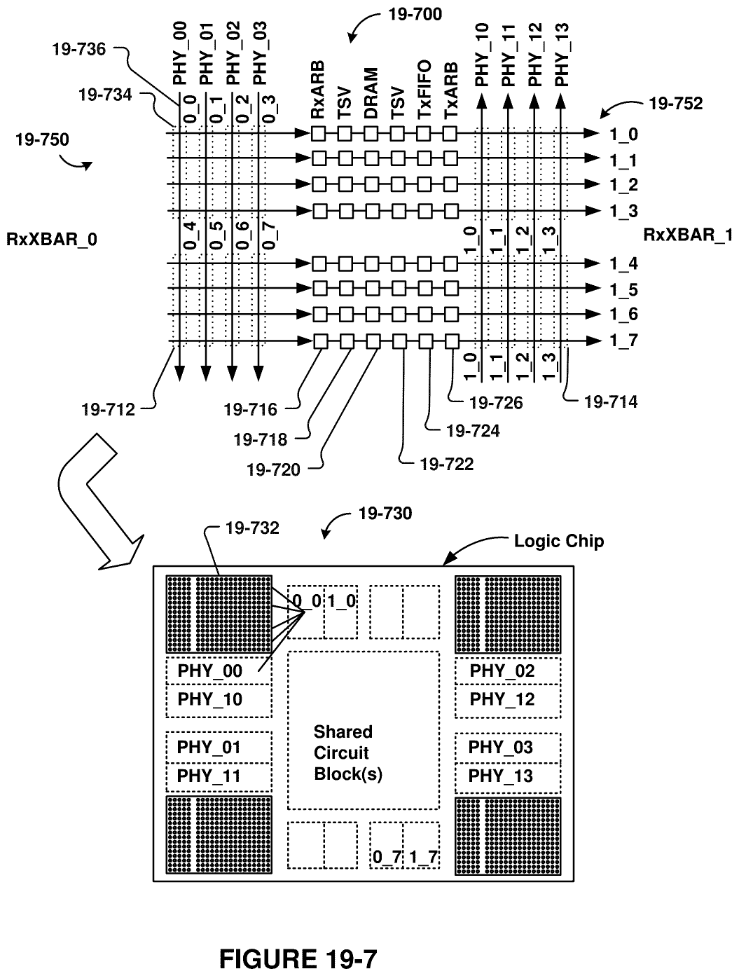

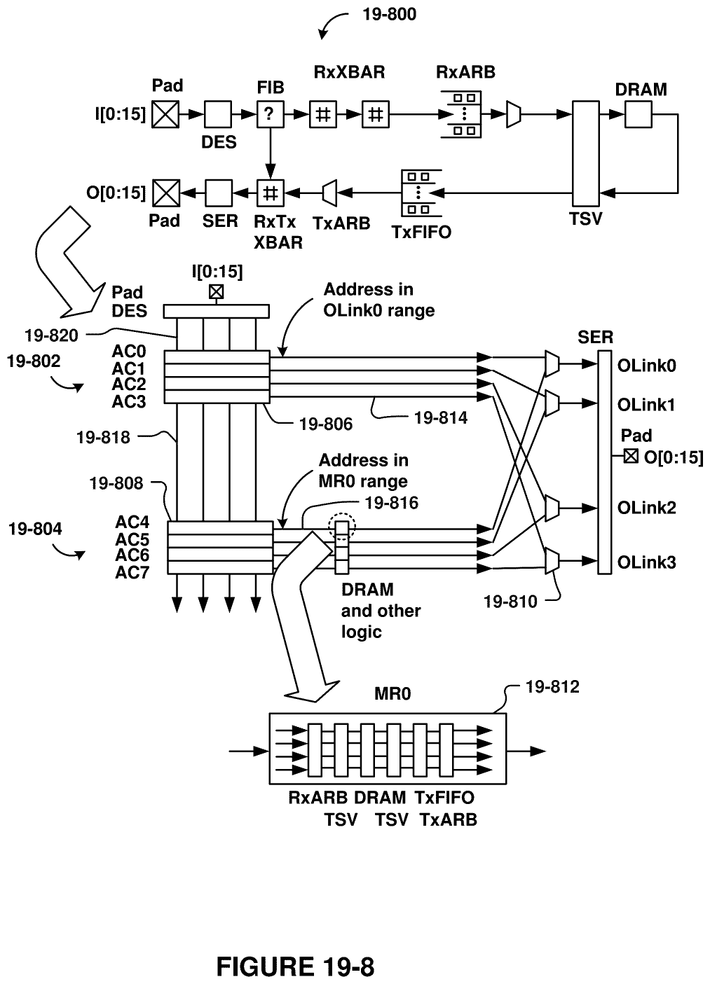

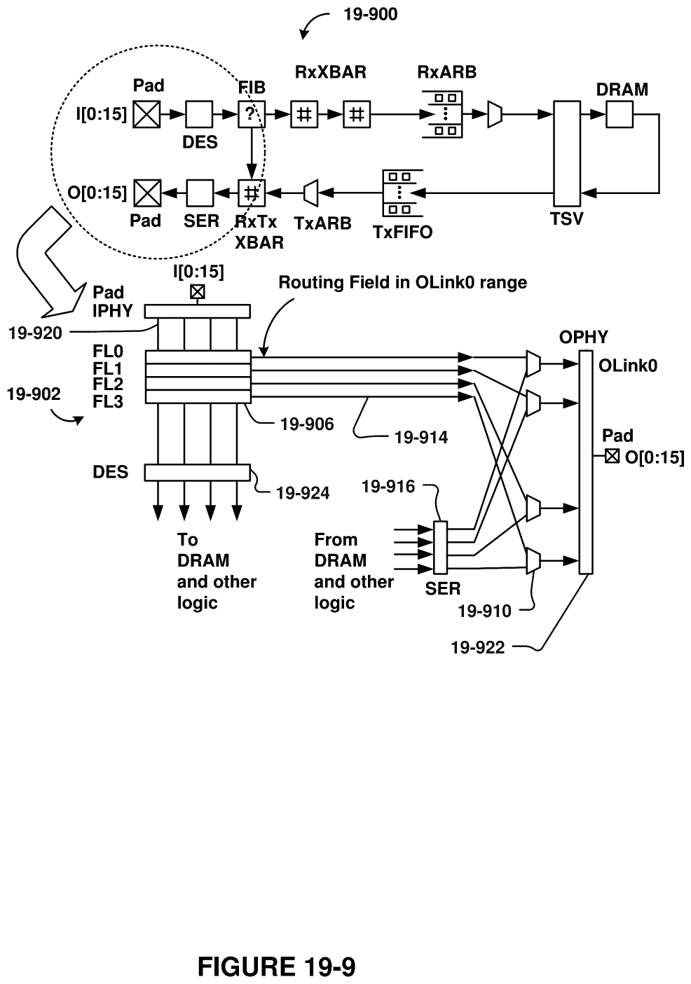

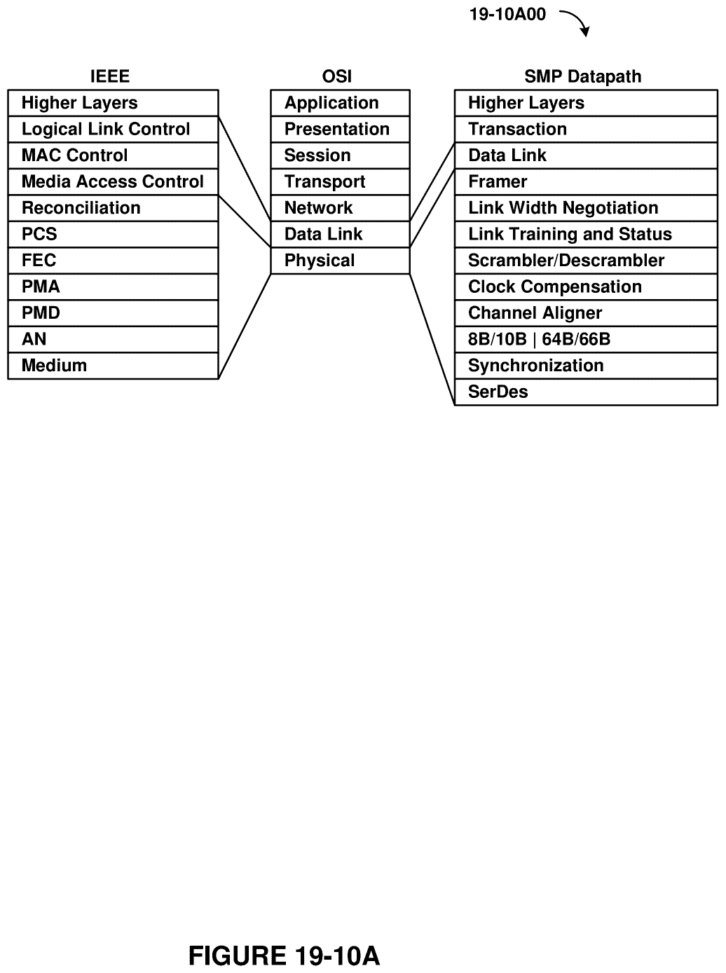

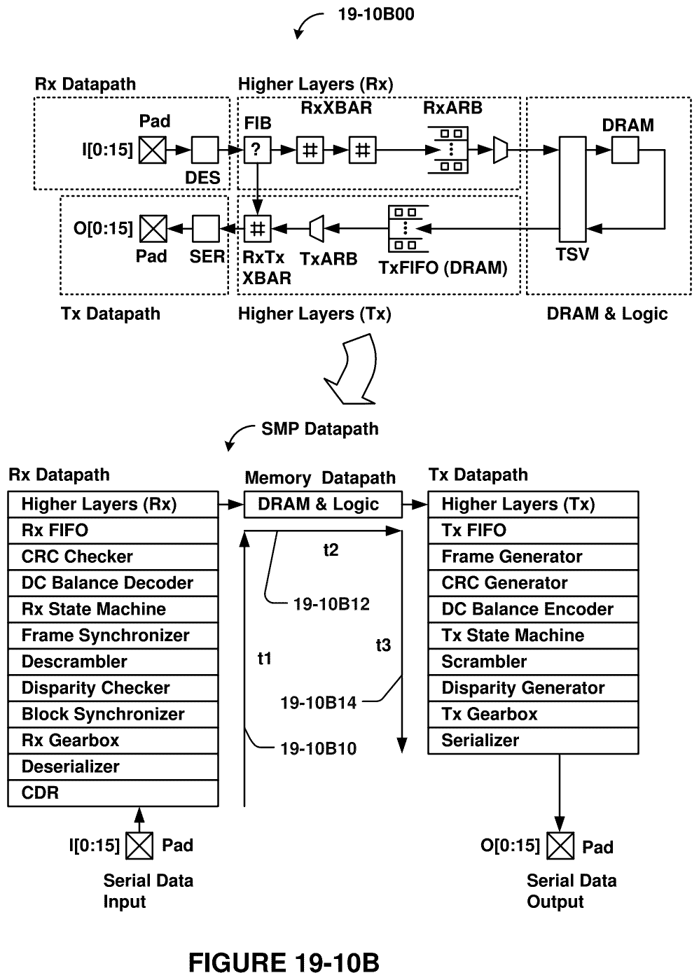

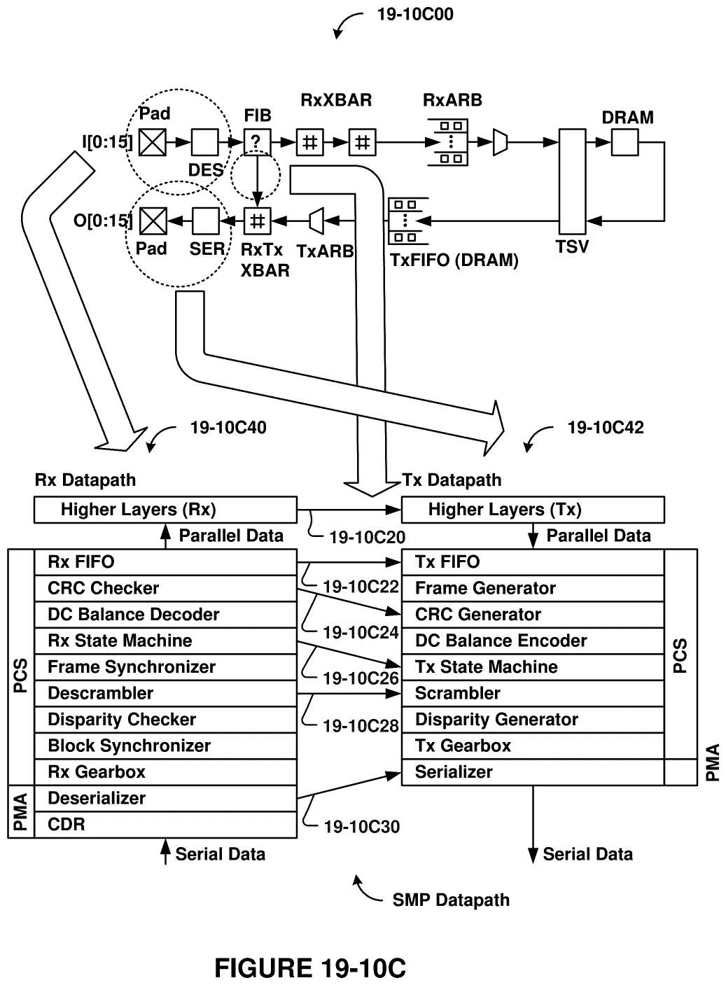

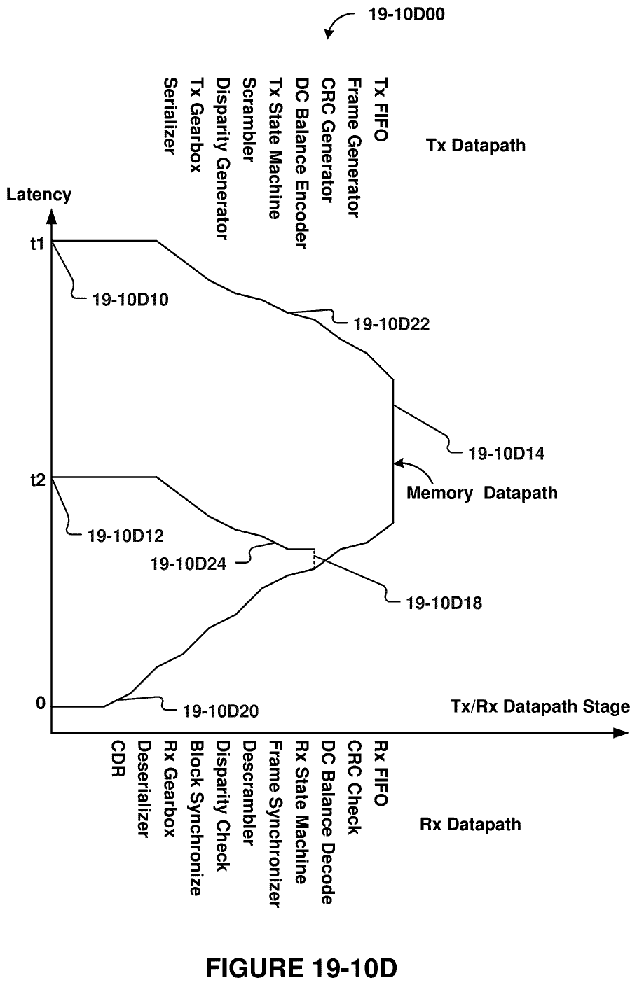

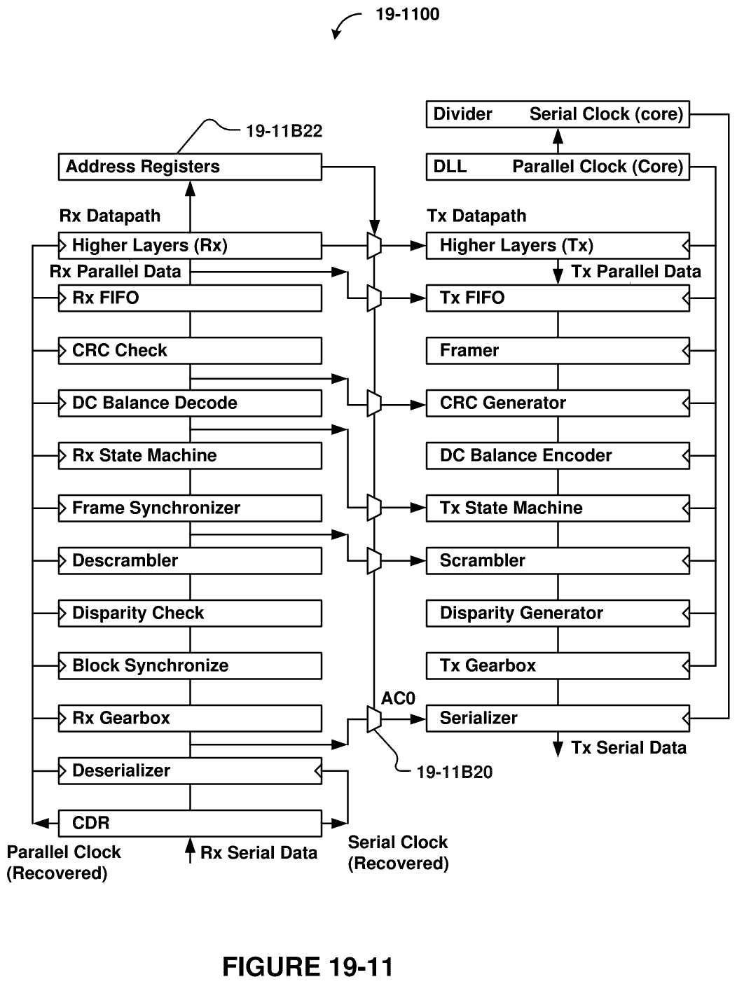

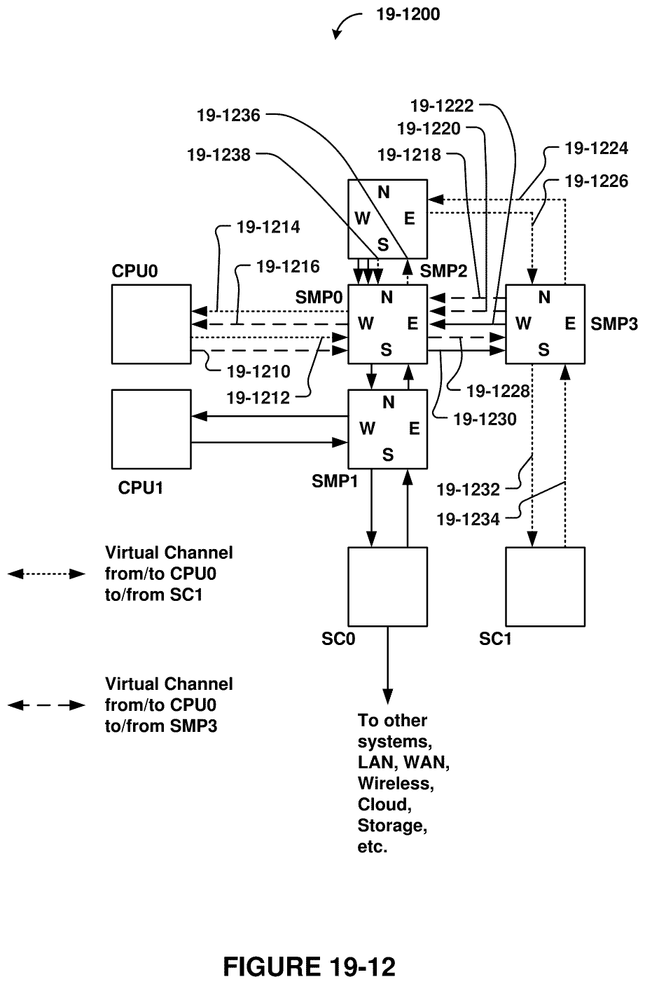

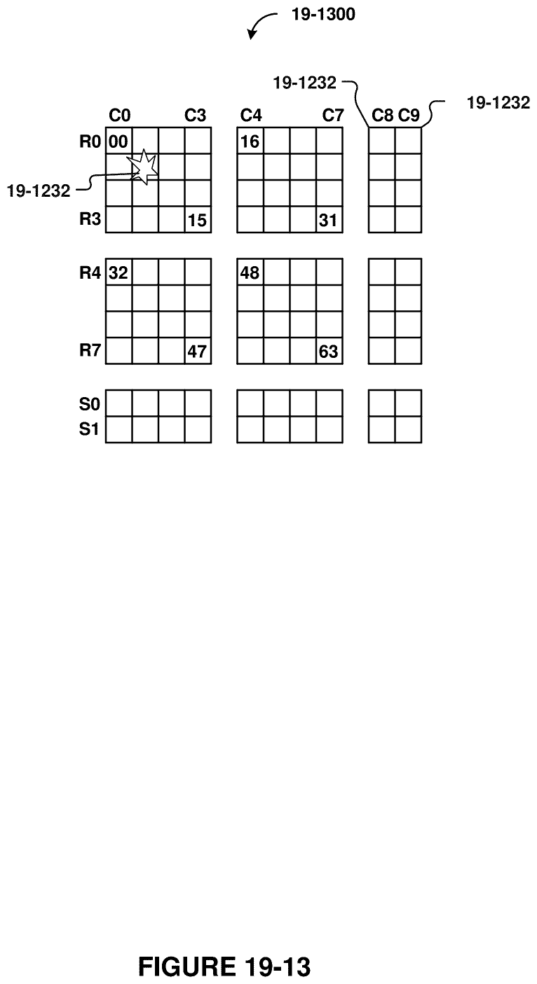

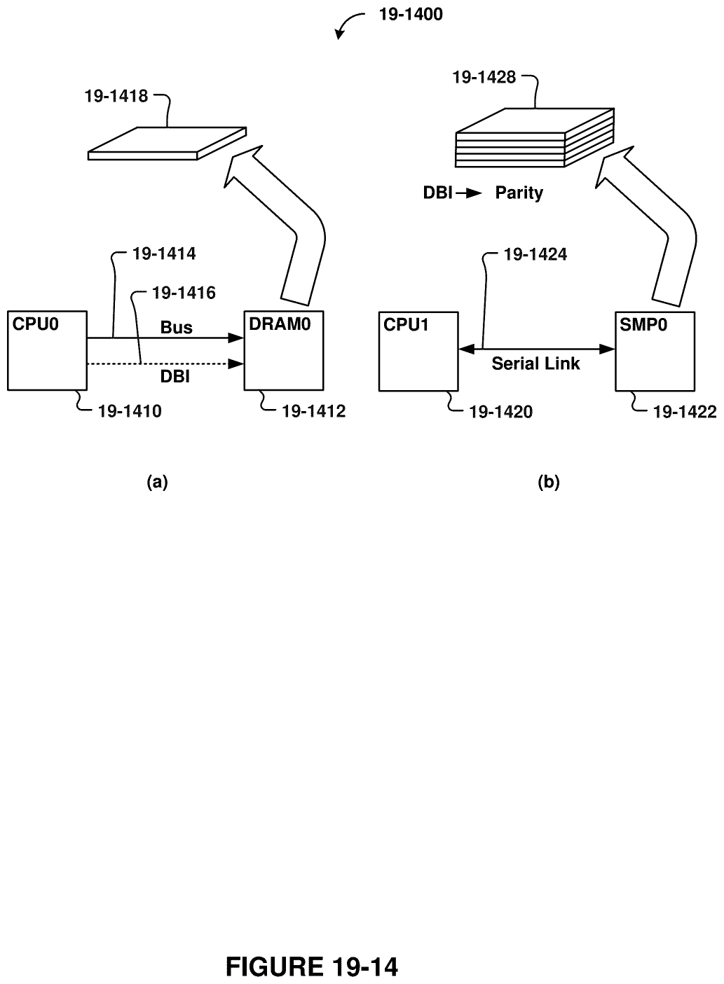

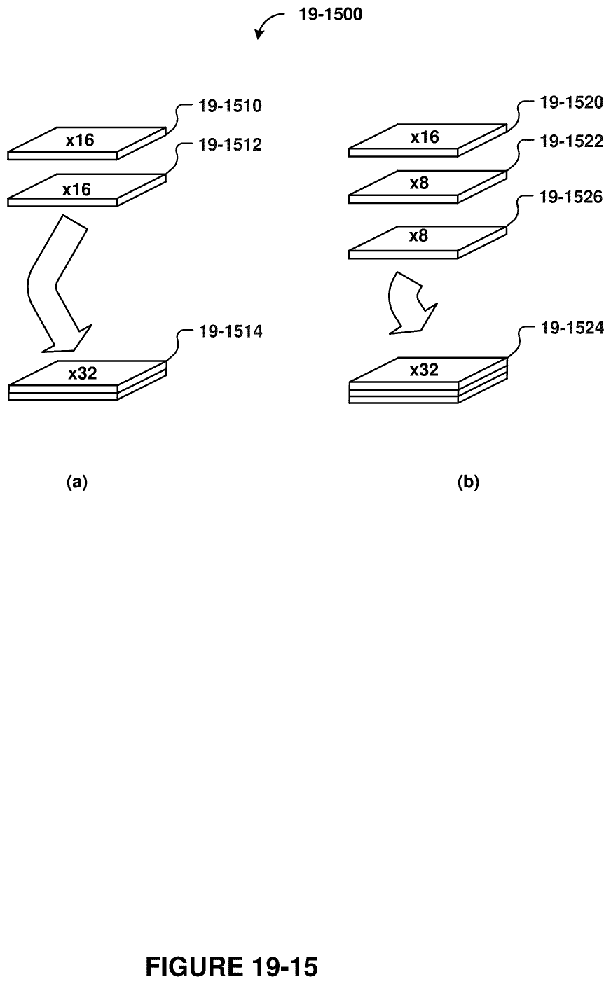

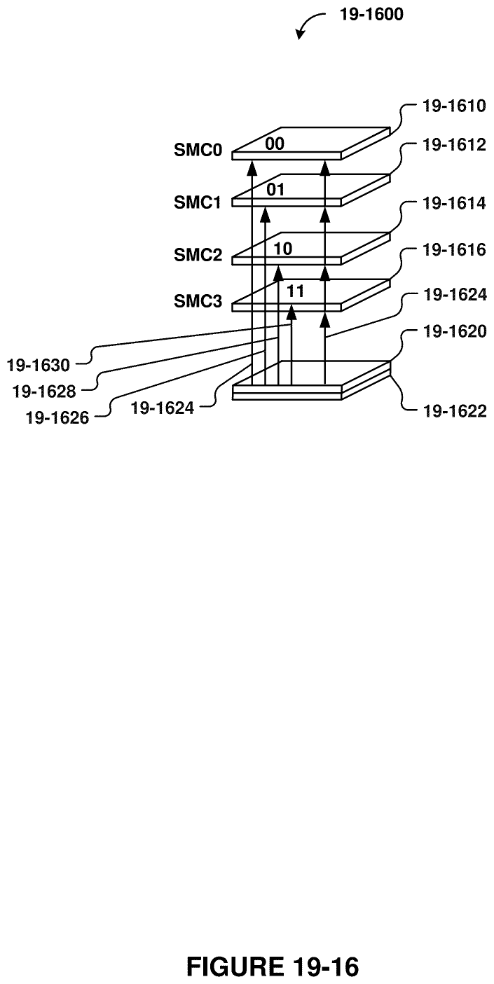

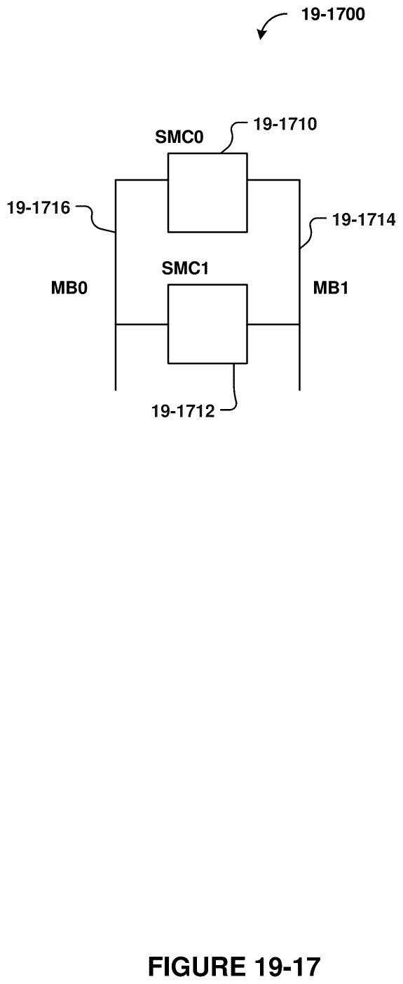

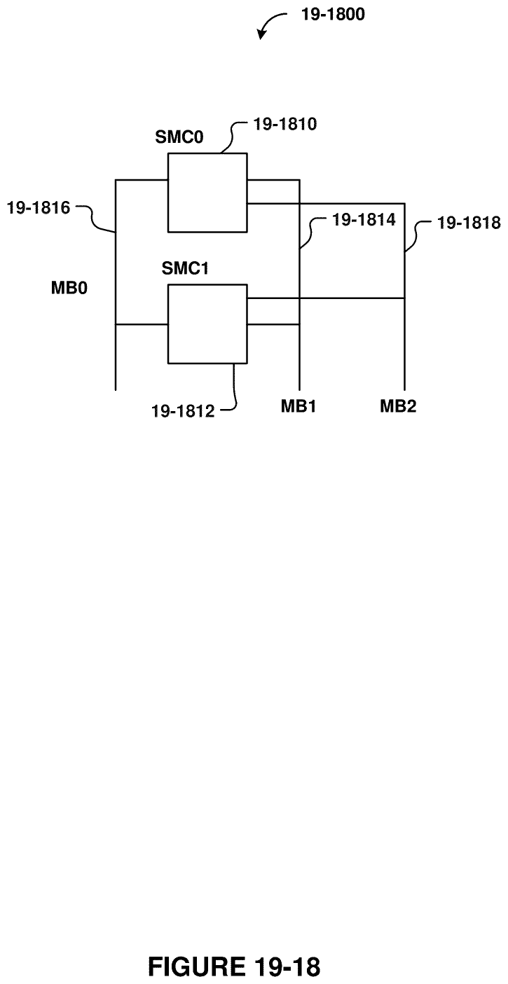

### FIG. 19-1

FIG. 19-1 shows an apparatus 19-100, in accordance with one embodiment. As an option, the apparatus 19-100 may be implemented in the context of any subsequent Figure(s). Of course, however, the apparatus 19-100 may be implemented in the context of any desired environment.

It should be noted that a variety of optional architectures, capabilities, and/or features will now be set forth in the context of a variety of embodiments in connection with a description of FIG. 19-1. Any one or more of such optional architectures, capabilities, and/or features may or may not be used in combination with any other one or more of such described optional architectures, capabilities, and/or features. Of course, embodiments are contemplated where any one or more of such optional architectures, capabilities, and/or features may be used alone without any of the other optional architectures, capabilities, and/or features.

As shown, in one embodiment, the apparatus 19-100 includes a first semiconductor platform 19-102, which may include a first memory. Additionally, the apparatus 19-100 includes a second semiconductor platform 19-106 stacked with the first semiconductor platform 19-102. In one embodiment, the second semiconductor platform 19-106 may include a second memory. As an option, the first memory may be of a first memory class. Additionally, the second memory may be of a second memory class.

In another embodiment, a plurality of stacks may be provided, at least one of which includes the first semiconductor platform 19-102 including a first memory of a first memory class, and at least another one which includes the second semiconductor platform 19-106 including a second memory of a second memory class. Just by way of example, memories of different classes may be stacked with other components in separate stacks, in accordance with one embodiment. To this end, any of the components described above (and hereinafter) may be arranged in any desired stacked relationship (in any combination) in one or more stacks, in various possible embodiments.

In another embodiment, the apparatus 19-100 may include a physical memory sub-system. In the context of the present description, physical memory refers to any memory including physical objects or memory components. For example, in one embodiment, the physical memory may include semiconductor memory cells. Furthermore, in various embodiments, the physical memory may include, but is not limited to, flash memory (e.g., NOR flash, NAND flash, etc.), random access memory (e.g., RAM, SRAM, DRAM, SDRAM, eDRAM, embedded DRAM, MRAM, PRAM, etc.), memristor, phase-change memory, FeRAM, PRAM, MRAM, resistive RAM, RRAM, a solid-state disk (SSD) or other disk, magnetic media, and/or any other physical memory and/or memory technology etc. (volatile memory, nonvolatile memory, etc.) that meets the above definition.

Additionally, in various embodiments, the physical memory sub-system may include a monolithic memory circuit, a semiconductor die, a chip, a packaged memory circuit, or any other type of tangible memory circuit, or any intangible grouping of tangible memory circuits, combinations of these, etc. In one embodiment, the apparatus 19-100 or associated physical memory sub-system may take the form of a dynamic random access memory (DRAM) circuit. Such DRAM may take any form including, but not limited to, synchronous DRAM (SDRAM), double data rate synchronous DRAM (DDR SDRAM, DDR2 SDRAM, DDR3 SDRAM, etc.), graphics double data rate DRAM (GDDR, GDDR2, GDDR3, etc.), quad data rate DRAM (QDR DRAM), RAMBUS XDR DRAM (XDR DRAM), fast page mode DRAM (FPM DRAM), video DRAM (VDRAM), extended data out DRAM (EDO DRAM), burst EDO RAM (BEDO DRAM), multibank DRAM (MDRAM), synchronous graphics RAM (SGRAM), and/or any other DRAM or similar memory technology.

In the context of the present description, a memory class may refer to any memory classification of a memory technology. For example, in various embodiments, the memory class may include, but is not limited to, a flash memory class, a RAM memory class, an SSD memory class, a magnetic media class, and/or any other class of memory in which a type of memory may be classified. Still yet, it should be noted that the memory classification of memory technology may further include a usage classification of memory, where such usage may include, but is not limited power usage, bandwidth usage, speed usage, etc. In embodiments where the memory class includes a usage classification, physical aspects of memories may or may not be identical.

In the one embodiment, the first memory class may include non-volatile memory (e.g., FeRAM, MRAM, and PRAM, etc.), and the second memory class may include volatile memory (e.g., SRAM, DRAM, T-RAM, Z-RAM, and TTRAM, etc.). In another embodiment, one of the first memory or the second memory may include RAM (e.g., DRAM, SRAM, etc.) and the other one of the first memory or the second memory may include NAND flash. In another embodiment, one of the first memory or the second memory may include RAM (e.g., DRAM, SRAM, etc.) and the other one of the first memory or the second memory may include NOR flash. Of course, in various embodiments, any number (e.g., 2, 3, 4, 5, 6, 7, 8, 9, or more, etc.) of combinations of memory classes may be utilized.

In one embodiment, there may be connections (not shown) that are in communication with the first memory and pass through the second semiconductor platform 19-106. Such connections that are in communication with the first memory and pass through the second semiconductor platform 19-106 may be formed utilizing through-silicon via (TSV) technology. Additionally, in one embodiment, the connections may be communicatively coupled to the second memory.

For example, in one embodiment, the second memory may be communicatively coupled to the first memory. In the context of the present description, being communicatively coupled refers to being coupled in any way that functions to allow any type of signal (e.g., a data signal, an electric signal, etc.) to be communicated between the communicatively coupled items. In one embodiment, the second memory may be communicatively coupled to the first memory via direct contact (e.g., a direct connection, etc.) between the two memories. Of course, being communicatively coupled may also refer to indirect connections, connections with intermediate connections therebetween, etc. In another embodiment, the second memory may be communicatively coupled to the first memory via a bus. In one embodiment, the second memory may be communicatively coupled to the first memory utilizing one or more TSVs.

As another option, the communicative coupling may include a connection via a buffer device. In one embodiment, the buffer device may be part of the apparatus 19-100. In another embodiment, the buffer device may be separate from the apparatus 19-100.

Further, in one embodiment, at least one additional semiconductor platform (not shown) may be stacked with the first semiconductor platform 19-102 and the second semiconductor platform 19-106. In this case, in one embodiment, the additional semiconductor may include a third memory of at least one of the first memory class or the second memory class, and/or any other additional circuitry. In another embodiment, the at least one additional semiconductor may include a third memory of a third memory class.

In one embodiment, the additional semiconductor platform may be positioned between the first semiconductor platform 19-102 and the second semiconductor platform 19-106. In another embodiment, the at least one additional semiconductor platform may be positioned above the first semiconductor platform 19-102 and the second semiconductor platform 19-106. Further, in one embodiment, the additional semiconductor platform may be in communication with at least one of the first semiconductor platform 19-102 and/or the second semiconductor platform 19-102 utilizing wire bond technology.

Additionally, in one embodiment, the additional semiconductor platform may include additional circuitry in the form of a logic circuit. In this case, in one embodiment, the logic circuit may be in communication with at least one of the first memory or the second memory. In one embodiment, at least one of the first memory or the second memory may include a plurality of sub-arrays in communication via shared data bus.

Furthermore, in one embodiment, the logic circuit may be in communication with at least one of the first memory or the second memory utilizing TSV technology. In one embodiment, the logic circuit and the first memory of the first semiconductor platform 19-102 may be in communication via a buffer. In this case, in one embodiment, the buffer may include a row buffer.

Further, in one embodiment, the apparatus 19-100 may be configured such that the first memory and the second memory are capable of receiving instructions via a single memory bus 19-110. The memory bus 19-110 may include any type of memory bus. Additionally, the memory bus may be associated with a variety of protocols (e.g., memory protocols such as JEDEC DDR2, JEDEC DDR3, JEDEC DDR4, SLDRAM, RDRAM, LPDRAM, LPDDR, etc; I/O protocols such as PCI, PCI-E, HyperTransport, InfiniBand, QPI, etc; networking protocols such as Ethernet, TCP/IP, iSCSI, etc; storage protocols such as NFS, SAMBA, SAS, SATA, FC, etc; and other protocols (e.g., wireless, optical, etc.); etc.). Of course, other embodiments are contemplated with multiple memory buses.

In one embodiment, the apparatus 19-100 may include a three-dimensional integrated circuit. In one embodiment, the first semiconductor platform 19-102 and the second semiconductor platform 19-106 together may include a three-dimensional integrated circuit. In the context of the present description, a three-dimensional integrated circuit refers to any integrated circuit comprised of stacked wafers and/or dies (e.g., silicon wafers and/or dies, etc.), which are interconnected vertically and are capable of behaving as a single device.

For example, in one embodiment, the apparatus 19-100 may include a three-dimensional integrated circuit that is a wafer-on-wafer device. In this case, a first wafer of the wafer-on-wafer device may include the first memory of the first memory class, and a second wafer of the wafer-on-wafer device may include the second memory of the second memory class.

In the context of the present description, a wafer-on-wafer device refers to any device including two or more semiconductor wafers that are communicatively coupled in a wafer-on-wafer configuration. In one embodiment, the wafer-on-wafer device may include a device that is constructed utilizing two or more semiconductor wafers, which are aligned, bonded, and possibly cut in to at least one three-dimensional integrated circuit. In this case, vertical connections (e.g., TSVs, etc.) may be built into the wafers before bonding or created in the stack after bonding. In one embodiment, the first semiconductor platform 19-102 and the second semiconductor platform 19-106 together may include a three-dimensional integrated circuit that is a wafer-on-wafer device.

In another embodiment, the apparatus 19-100 may include a three-dimensional integrated circuit that is a monolithic device. In the context of the present description, a monolithic device refers to any device that includes at least one layer built on a single semiconductor wafer, communicatively coupled, and in the form of a three-dimensional integrated circuit. In one embodiment, the first semiconductor platform 19-102 and the second semiconductor platform 19-106 together may include a three-dimensional integrated circuit that is a monolithic device.

In another embodiment, the apparatus 19-100 may include a three-dimensional integrated circuit that is a die-on-wafer device. In the context of the present description, a die-on-wafer device refers to any device including one or more dies positioned on a wafer. In one embodiment, the die-on-wafer deice may be formed by dicing a first wafer into singular dies, then aligning and bonding the dies onto die sites of a second wafer. In one embodiment, the first semiconductor platform 19-102 and the second semiconductor platform 19-106 together may include a three-dimensional integrated circuit that is a die-on-wafer device.

In yet another embodiment, the apparatus 19-100 may include a three-dimensional integrated circuit that is a die-on-die device. In the context of the present description, a die-on-die device refers to a device including two or more aligned dies in a die-on-die configuration. In one embodiment, the first semiconductor platform 19-102 and the second semiconductor platform 19-106 together may include a three-dimensional integrated circuit that is a die-on-die device.

Additionally, in one embodiment, the apparatus 19-100 may include a three-dimensional package. For example, the three-dimensional package may include a system in package (SiP) or chip stack MCM. In one embodiment, the first semiconductor platform and the second semiconductor platform are housed in a three-dimensional package.

In one embodiment, the apparatus 19-100 may be configured such that the first memory and the second memory are capable of receiving instructions from a device 19-108 via the single memory bus 19-110. In one embodiment, the device 19-108 may include one or more components from the following list (but not limited to the following list): a central processing unit (CPU); a memory controller, a chipset, a memory management unit (MMU); a virtual memory manager (VMM); a page table, a table lookaside buffer (TLB); one or more levels of cache (e.g., L1, L2, L3, etc.); a core unit; an uncore unit; etc.

In the context of the following description, optional additional circuitry 19-104 (which may include one or more circuitries each adapted to carry out one or more of the features, capabilities, etc. described herein) may or may not be included to cause, implement, etc. any of the optional architectures, features, capabilities, etc. disclosed herein. While such additional circuitry 19-104 is shown generically in connection with the apparatus 19-100, it should be strongly noted that any such additional circuitry 19-104 may be positioned in any components (e.g., the first semiconductor platform 19-102, the second semiconductor platform 19-106, the device 19-108, an unillustrated logic unit or any other unit described herein, a separate unillustrated component that may or may not be stacked with any of the other components illustrated, a combination thereof, etc.).

In another embodiment, the additional circuitry 19-104 may or may not be capable of receiving (and/or sending) a data operation request and an associated a field value. In the context of the present description, the data operation request may include a data write request, a data read request, a data processing request and/or any other request that involves data. Still yet the field value may include any value (e.g., one or more bits, protocol signal, any indicator, etc.) capable of being recognized in association with a field that is affiliated with memory class selection. In various embodiments, the field value may or may not be included with the data operation request and/or data associated with the data operation request. In response to the data operation request, at least one of a plurality of memory classes may be selected, based on the field value. In the context of the present description, such selection may include any operation or act that results in use of at least one particular memory class based on (e.g., dictated by, resulting from, etc.) the field value. In another embodiment, a data structure embodied on a non-transitory readable medium may be provided with a data operation request command structure including a field value that is operable to prompt selection of at least one of a plurality of memory classes, based on the field value. As an option, the foregoing data structure may or may not be employed in connection with the aforementioned additional circuitry 19-104 capable of receiving (and/or sending) the data operation request.

In yet another embodiment, memory regions and/or memory sub-regions of any of the memory described herein may be arranged to optimize one or more parallel operations in association with the memory.

Further, in one embodiment, the apparatus 19-100 may include at least one circuit for receiving a plurality of packets and routing at least one of the packets in a manner that avoids processing in connection with at least one of a plurality of processing layers. In one embodiment, the at least one circuit may include a logic circuit. Additionally, in one embodiment, the at least one circuit may be part of at least one of the first semiconductor platform 19-102 or the second semiconductor platform 19-106.

In another embodiment, the at least one circuit may be separate from the first semiconductor platform 19-102 and the second semiconductor platform 19-106. In one embodiment, the at least one circuit may be part of a third semiconductor platform stacked with the first semiconductor platform 19-102 and the second semiconductor platform 19-106.

Still yet, in other embodiments, the at least one circuit may include or be part of any of the components shown in FIG. 19-1. Of course, it further contemplated that, in still other unillustrated embodiments, the at least one circuit may include or be part of any other component (not shown).

Additionally, in one embodiment, the first semiconductor platform 19-102 and the second semiconductor platform 19-106 may each be uniquely identified. In another embodiment, the first semiconductor platform 19-102 and the second semiconductor platform 19-106 may be coupled utilizing a plurality of buses each capable of operating in a plurality of different modes. Further, in one embodiment, the first semiconductor platform and the second semiconductor platform may be coupled utilizing a plurality of buses that are capable of being merged.

In one embodiment, the apparatus 19-100 may be operable such that the at least one packet is routed to at least one of the first semiconductor platform 19-102 or the second semiconductor platform 19-106. In another embodiment, the apparatus 19-100 may be operable such that the at least one packet is routed to both the first semiconductor platform 19-102 and the second semiconductor platform 19-106. In one embodiment, the processing layers may include network processing layers.

Furthermore, in one embodiment, the first semiconductor platform 19-102 and the second semiconductor platform 19-106 may be situated in a single package. In this case, in one embodiment, the apparatus 19-100 may be operable such that the at least one packet is routed to at least one other memory in at least one other package.

Additionally, in one embodiment, the apparatus 19-100 may be operable for identifying information such that the at least one packet is routed based on the information. For example, in one embodiment, the apparatus 19-100 may be operable such that the information is extracted from a header of the at least one packet. In another embodiment, the apparatus 19-100 may be operable such that the information is extracted from a payload of the at least one packet.

Further, in one embodiment, the apparatus 19-100 may be operable such that the information is identified based on one or more characteristics of the at least one packet. For example, in various embodiments, the one or more characteristics may include at least one of a length, a destination, and/or statistics.

In one embodiment, the apparatus 19-100 may be operable such that the processing is avoided by replacing a first process with a second process to thereby avoid the first process. In one embodiment, the apparatus 19-100 may be operable such that the processing is avoided, bypassing processing in connection with at least one of a plurality of processing layers.

Additionally, in one embodiment, the apparatus 19-100 may be operable for utilizing a plurality of virtual channels in connection with the packets. Still yet, in one embodiment, the apparatus 19-100 may be operable for performing an error correction scheme in connection with the packets. In one embodiment, the apparatus 19-100 may be operable for utilizing at least one dynamic bus inversion (DBI) bit for parity purposes. Additionally, in one embodiment, the first memory and the second memory may be each capable of handling a X-bit width and the apparatus 19-100 may be operable for handling a Y-bit width, where X is different than Y.

As set forth earlier, any one or more of the foregoing optional architectures, capabilities, and/or features may or may not be used in combination with any other one or more of such optional architectures, capabilities, and/or features. Still yet, any one or more of the foregoing optional architectures, capabilities, and/or features may be implemented utilizing any desired apparatus, method, and program product (e.g., computer program product, etc.) embodied on a non-transitory readable medium (e.g., computer readable medium, etc.). Such program product may include software instructions, hardware instructions, embedded instructions, and/or any other instructions, and may be used in the context of any of the components (e.g., platforms, processing unit, MMU, VMM, TLB, etc.) disclosed herein, as well as semiconductor manufacturing/design equipment, as applicable.

Even still, while embodiments are described where any one or more of the foregoing optional architectures, capabilities, and/or features may or may not be incorporated into a memory system, additional embodiments are contemplated where a processing unit (e.g., CPU, GPU, etc.) is provided in combination with or in isolation of the memory system, where such processing unit is operable to cooperate with such memory system to accommodate, cause, prompt and/or otherwise cooperate with the memory system to allow for any of the foregoing optional architectures, capabilities, and/or features. For that matter, further embodiments are contemplated where a single semiconductor platform (e.g., 19-102, 19-106, etc.) is provided in combination with or in isolation of any of the other components disclosed herein, where such single semiconductor platform is operable to cooperate with such other components disclosed herein at some point in a manufacturing, assembly, OEM, distribution process, etc., to accommodate, cause, prompt and/or otherwise cooperate with one or more of the other components to allow for any of the foregoing optional architectures, capabilities, and/or features. To this end, any description herein of receiving, processing, operating on, reacting to, etc. signals, data, etc. may easily be replaced and/or supplemented with descriptions of sending, prompting/causing, etc. signals, data, etc. to address any desired cause and/or effect relationship among the various components disclosed herein.

It should be noted that while the embodiments described in this specification and in specifications incorporated by reference may show examples of stacked memory system and improvements to stacked memory systems, the examples described and the improvements described may be generally applicable to a wide range of electrical and/or electronic systems. For example, improvements to signaling, yield, bus structures, test, repair etc. may be applied to the field of memory systems in general as well as systems other than memory systems, etc.

More illustrative information will now be set forth regarding various optional architectures, capabilities, and/or features with which the foregoing techniques discussed in the context of any of the Figure(s) may or may not be implemented, per the desires of the user. For instance, various optional examples and/or options associated with the configuration/operation of the apparatus 19-100, the configuration/operation of the first and/or second semiconductor platforms, and/or other optional features have been and will be set forth in the context of a variety of possible embodiments. It should be strongly noted that such information is set forth for illustrative purposes and should not be construed as limiting in any manner. Any of such features may be optionally incorporated with or without the inclusion of other features described.

It should be noted that any embodiment disclosed herein may or may not incorporate, at least in part, various standard features of conventional architectures, as desired. Thus, any discussion of such conventional architectures and/or standard features herein should not be interpreted as an intention to exclude such architectures and/or features from various embodiments disclosed herein, but rather as a disclosure thereof as exemplary optional embodiments with features, operations, functionality, parts, etc. which may or may not be incorporated in the various embodiments disclosed herein.

### FIG. 19-2

FIG. 19-2 shows a stacked memory package 19-200, in accordance with one embodiment. As an option, the stacked memory package may be implemented in the context of FIG. 19-1 and/or any other Figure(s). Of course, however, the stacked memory package may be implemented in the context of any desired environment.

In FIG. 19-2, the stacked memory package 19-200 may comprise a logic chip 19-220 and a plurality of stacked memory chips (19-202, 19-204, 19-206, 19-208, 19-210,19-212, 19-214, 19-216, etc.), in accordance with another embodiment. In FIG. 19-2 one logic chip is shown, but any number may be used. In FIG. 19-2, eight stacked memory chips are shown, but any number may be used. If more than one logic chip is used then they may be the same or different (for example, one chip may perform logic functions, while one chip may perform high-speed optical IO functions for example). In FIG. 19-2, each of the plurality of stacked memory chips may comprise a memory array (e.g., DRAM array, etc.). Of course, any type of memory may equally be used (e.g., SDRAM, NAND flash, PCRAM, combinations of these, etc.) in one or more memory arrays on each stacked memory chip. Each stacked memory chip may be the same or different (e.g., one stacked memory chip may be DRAM, another stacked memory chip may be NAND flash, etc.). One or more of the logic chip(s) may also include one or more memory arrays (e.g., embedded DRAM, NAND flash, other non-volatile memory, NVRAM, register files, SRAM, combinations of these, etc).

In FIG. 19-2, the logic chip(s) may be divided (e.g., partitioned, sectioned, etc.) into one or more first type of circuit blocks 19-222 (e.g., regions, functional areas, circuits, portions of the logic chip(s), etc.). In FIG. 19-2, the first type of circuit blocks may correspond to (e.g., be coupled to, be associated with, be responsible for driving and/or controlling, etc.) one or more memory regions (e.g., parts, portions, etc.) of one or more of the stacked memory chips. The first type of circuit block may be a dedicated circuit block in the sense that the circuit block may be dedicated to one or more memory regions of the stacked memory chip(s). In FIG. 19-2, eight dedicated circuit blocks are shown, but any number of dedicated circuit blocks may be used. Dedicated circuit blocks may, for example, perform such functions as (but not limited to): 10 functions, link layer functions, datapath functions, memory controller functions, etc.

In FIG. 19-2, the logic chip(s) may be divided (e.g., partitioned, sectioned, etc.) into one or more second type of circuit blocks 19-224 (e.g., regions, functional areas, circuits, etc.). In FIG. 19-2, the second type of circuit blocks may be shared between groups of one or more memory regions (e.g., parts, portions, etc.) of one or more of the stacked memory chips or other circuits and/or perform shared functions (e.g., functions of the stacked memory package as a whole, functions common to and/or shared with more than one other circuit or block, etc.). The second type of circuit block may be a shared circuit block in the sense that the circuit block is shared between one or more memory regions of the stacked memory chip(s) and/or other components, parts etc. of the stacked memory package or memory system, etc. In FIG. 19-2, one shared circuit block is shown, but any number of shared circuit blocks may be used. Shared circuit blocks may, for example, perform such functions as (but not limited to): test and/or repair functions, nonvolatile memory, configuration functions, register read/write functions and operations, power supply and power regulation functions, initialization and control circuits, calibration circuits, characterization circuits, error detection circuits, error coding circuits, error control and error recovery circuits, status and information control and signaling, clocking and/or clock functions, other memory system functions, etc.

In FIG. 19-2, the stacked memory chip(s) may be divided (e.g., partitioned, sectioned, etc.) into one or more memory regions 19-226. In FIG. 19-2, the memory regions may be banks, subbanks, arrays, subarrays, echelons, pages, sectors, other portion(s) of a memory array, groupings of portion(s) of a memory array (e.g., groups of banks, etc.), combinations of these, etc. Any number, type, combination(s), and arrangement of memory regions from different memory chips and/or types of memory chips (e.g., DRAM, NAND flash, etc.), etc. may be used.

In one embodiment, one or more portions of memory (e.g., embedded DRAM, NVRAM, NAND flash, etc.) that may be present on the one or more logic chip(s) may be grouped with (e.g., associated with, virtually linked to, combined with, coupled to, etc.) one or more memory regions in one or more stacked memory chips. For example, memory on a logic chip may be used to repair faulty memory regions and/or used to perform test functions, characterization functions, repair functions, etc. For example, memory on a logic chip may be used to index, locate, relocate, link, virtually link, etc. memory regions or portion(s) of memory regions. For example, memory on a logic chip may be used to store the address(es) and/or pointer(s), etc. to portion(s) of faulty memory region(s) and/or store information to portion(s) of replacement memory region(s), etc. For example, memory on a logic chip may be used to store test results, characterization results, usage information, error statistics, etc.

In FIG. 19-2, the memory regions may be grouped. Thus there may be groups of groups of memory regions. Thus, for example, if a memory region is a group of banks, there may be one or more groups of groups of banks, etc. For example, if a memory region is a bank, a group of memory regions may be formed from one bank on each stacked memory chip. In one embodiment the dedicated circuits may be dedicated to a group of memory regions. For example, a dedicated circuit block may be dedicated to a group of eight banks, one bank on each of eight stacked memory chips. Any number, type and arrangement of dedicated circuits and memory regions may be used.

In order to illustrate the different possible connections (e.g., modes, couplings, connections, etc.) between block(s) on the logic chip(s) and the stacked memory chip(s), the definition of a notation and the definition of terms associated with the notation is described next. The notation is described in detail in U.S. Provisional Application No. 61/647,492, filed May 15, 2012, titled “SYSTEM, METHOD, AND COMPUTER PROGRAM PRODUCT FOR CONFIGURING A SYSTEM ASSOCIATED WITH MEMORY,” which is hereby incorporated by reference in its entirety for all purposes. The notation may use a numbering of the smallest elements of interest (e.g., components, macros, circuits, blocks, groups of circuits, etc.) at the lowest level of the hierarchy (e.g., at the bottom of the hierarchy, at the leaf nodes of the hierarchy, etc.). For example, the smallest element of interest in a stacked memory package may be a bank of an SDRAM stacked memory chip. The bank may be 32 Mb, 64 Mb, 128 Mb, 2565 Mb in size, etc. The banks may be numbered 0, 1, 2, 3, . . . , k where k may be the total number of banks in the stacked memory package (or memory system, etc.). A group (e.g., pool, matrix, collection, assembly, set, range, etc.), and/or groups as well as groupings of the smallest element may then be defined using the numbering scheme. In a first design for a stacked memory package, for example, there may be 32 banks on each stacked memory chip; these banks may be numbered 0-31 on the first stacked memory chip, for example. In this first design, four banks may make up a bank group, these banks may be numbered 0, 1, 2, 3 for example. In this first design, there may be four stacked memory chips in a stacked memory package. In this first design, for example, an echelon may be defined as a group of banks comprising banks 0, 1, 32, 33, 64, 65, 96, 97.

It should be noted that a bank has been used as the smallest element of interest only as an example here in this first design, banks need not be present in all designs, embodiments, configurations, etc. It should be noted that a bank has been used as the smallest element of interest only as an example, any element may be used (e.g., array, subarray, bank, subbank, group of banks, group of subbanks, echelons, groups of echelons, group of arrays, group of subarrays, other portions(s), group(s) of portion(s), combinations of these, etc.).

Thus, in this first design for example, it may be seen that the term echelon may be precisely defined using the numbering scheme and, in this example, may comprise eight banks, with two on each of the four stacked memory chips. Further the physical (e.g., spatial, locations, etc.) of the elements (e.g., banks, etc.) may be defined using the numbering scheme (e.g., element 0 next to element 1 on a first stacked memory chip, element 32 on a second stacked memory chip above element 0 on a first stacked memory chip, etc.). Further the electrical, logical and other properties, relationships, etc. of elements may be similarly may be defined using the notation and numbering scheme.

There may be several terms that are currently used or in current use, etc. to describe parts of a 3D memory system that may not necessarily be used consistently and/or have a consistent meaning and/or precise definition. For example, the term tile may sometimes be used to mean a portion of a SDRAM or portion of an SDRAM bank. This specification may avoid the use of the term tile (or tiled, tiling, etc.) in this sense because there is no consensus on the definition of the term tile, and/or there is no consistent use of the term tile, and/or there is conflicting use of the term tile in current use.

The term bank may be usually used (e.g., frequently used, normally used, often used, etc.) to describe a portion of a SDRAM that may operate semi-autonomously (e.g., permits concurrent operation, pipelined operation, parallel operation, etc.). This specification may use the term bank in a manner that is consistent with this usual (e.g., generally accepted, widely used, etc.) definition. This specification and specifications incorporated by reference may, in addition to the term bank, also use the term array to include configurations, designs, embodiments, etc. that may use a bank as the smallest element of interest, but that may also use other elements (e.g., structures, components, blocks, circuits, etc.) as the smallest element of interest. Thus, the term array, in this specification and specifications incorporated by reference, may be used in a more general sense than the term bank in order to include the possibility that an array may be one or more banks (e.g., array may include, but is not limited to banks, etc.). For example, in a second design, a stacked memory chip may use NAND flash technology and an array may be a group of NAND flash memory cells, etc. For example, in a third design, a stacked memory chip may use NAND flash technology and SDRAM technology and an array may be a group of NAND flash memory cells grouped with a bank of an SDRAM, etc. For example, a fourth design may be described using banks (e.g., in order to simplify explanation, etc.), but other designs based on the fourth design may use elements than banks for example,

This specification and specifications incorporated by reference may use the term subarray to describe any element that is below (e.g., a part of, a sub-element, etc.) an array in the hierarchy. Thus, for example, in a fifth design, an array (e.g., an array of subarrays, etc.) may be a group of banks (e.g., a bank group, some other collection of banks, etc.) and in this case a subarray may be a bank, etc. It should be noted that both an array and a subarray may have nested hierarchy (e.g., to any depth of hierarchy, any level of hierarchy, etc.). Thus, for example, an array may contain other array(s). Thus, for example, a subarray may contain other subarray(s), etc.

The term partition has recently come to be used to describe a group of banks typically on one stacked memory chip. This specification may avoid the use of the term partition in this sense because there is no consensus on the definition of the term partition, and/or there is no consistent use of the term partition, and/or there is conflicting use of the term partition in current use. For example, there is no definition of how the banks in a partition may be related for example.

The term slice and/or the term vertical slice has recently come to be used to describe a group of banks (e.g., a group of partitions for example, with the term partition used as described above). Some of the specifications incorporated by reference may use the term slice in a similar, but not necessarily identical, manner. Thus, to avoid any confusion over the use of the term slice, this specification may use the term section to describe a group of portions (e.g., arrays, subarrays, banks, other portions(s), etc.) that may be grouped together logically (possibly also electrically and/or physically), possibly on the same stacked memory chip, and that may form part of a larger group across multiple stacked memory chips for example. Thus, the term section may include a slice (e.g., a section may be a slice, etc.) as the term slice may be previously used in specifications incorporated by reference. The term slice previously used in specifications incorporated by reference may be equivalent to the term partition in current use (and used as described above, but recognizing that the term partition may not be consistently defined, etc.). For example, in a fifth design, a stacked memory package may contain four stacked memory chips, each stacked memory chip may contain 16 arrays, each array may contain 2 subarrays. The subarrrays may be numbered from 0-63. In this fifth design, each array may be a section. For example, a section may comprise subarrays 0, 1. In this fifth design a subarray may be a bank, but need not be a bank. In this fifth design the two subarrays in each array need not necessarily be on the same stacked memory chip, but may be.

As an example of why more precise, but still flexible, definitions may be needed, the following example may be considered. For instance, in this fifth deign, consider a first array comprising a first subarray on a first stacked memory chip that may be coupled to a faulty second subarray on the first stacked memory chip. Thus, for example, a spare third subarray from a second stacked memory chip may be switched into place to replace the second subarray that is faulty. In this case the arrays in a stacked memory package may comprise subarrays on the same stacked memory chip, but may also comprise subarrays from more than one stacked memory chip. It could be considered that in this case the two subarrays (e.g., the first subarray and the third subarray) may be logically coupled as if on the same stacked memory chip, but may be physically on different stacked memory chips, etc.

The term vault has recently come to be used to describe a group of partitions, but is also sometimes used to describe the combination of partitions with some of a logic chip (or base logic, etc.). This specification may avoid the use of the term vault in this sense because there is no consensus on the definition of the term vault, and/or there is no consistent use of the term vault, and/or there is conflicting use of the term vault in current use.

This specification and specifications incorporated by reference may use the term echelon to describe a group of sections (e.g., groups of arrays, groups of banks, other portions(s), etc.) that may be grouped together logically (possibly also grouped together electrically and/or grouped together physically, etc.) possibly on multiple stacked memory chips, for example. The logical access to an echelon may be achieved by the coupling of one or more sections to one or more logic chips, for example. To the system, an echelon may appear (e.g., may be accessed, may be addressed, is organized to appear, etc.) as separate (e.g., virtual, abstracted, intangible, etc.) portion(s) of the memory system (e.g., portion(s) of one or more stacked memory packages, etc.), for example. The term echelon, as used in this specification and in specifications incorporated by reference, may be equivalent to the term vault in current use (but the term vault may not be consistently defined, etc.). For example, in a sixth design, a stacked memory package may contain four stacked memory chips, each stacked memory chip may contain 16 arrays, each array may contain 2 subarrays. In this sixth design, a group of four arrays, one array on each stacked memory chip, may be an echelon. In this sixth design, the arrays (rather than subarrays, etc.) may the smallest element of interest and the arrays numbered from 0-63. In this sixth design, an echelon may comprise arrays 0, 1, 16, 17, 32, 33, 48, 49. In this sixth design, array 0 may be next to array 1, and array 16 above array 0, etc. In this sixth design an array may be a section. In this sixth design a subarray may be a bank, but need not be a bank. For example, the term echelon may be illustrated by FIGS. 2, 5, 9, and 11 of U.S. Provisional Application No. 61/569,107, filed 12-09-2011, titled “SYSTEM, METHOD, AND COMPUTER PROGRAM PRODUCT FOR IMPROVING MEMORY SYSTEMS,” which is incorporated herein by reference in its entirety.

The term configuration may be used in this specification and specifications incorporated by reference to describe a variant (e.g., modification, change, alteration, etc.) of an embodiment (e.g., an example, a design, an architecture, etc.). For example, a first embodiment may be described in this specification with four stacked memory chips in a stacked memory package. A first configuration of the first embodiment may thus, have four stacked memory chips. A second configuration of the first embodiment may have eight stacked memory chips, for example. In this case, the first configuration and the second configuration may differ in a physical aspect (e.g., attribute, property, parameter, feature, etc.). Configurations may differ in any physical aspect, electrical aspect, logical aspect, and/or other aspect, and/or combinations of these. Configurations may thus, differ in one or more aspects. Configurations may be changed, altered, programmed, reprogrammed, updated, reconfigured, modified, specified, etc. at design time, during manufacture, during assembly, at test, at start-up, during operation, and/or at any time, and/or at combinations of these times, etc. Configuration changes, etc. may be permanent (e.g., fixed, programmed, etc.) and/or non-permanent (e.g., programmable, configurable, transient, temporary, etc.). For example, even physical aspects may be changed. For example, a stacked memory package may be manufactured with five stacked memory chips with one stacked memory chip as a spare, so that a final product with five memory chips may only use any of the four stacked memory chips (and thus, have multiple programmable configurations, etc.). For example, a stacked memory package with eight stacked memory chips may be sold in two configurations: a first configuration with all eight stacked memory chips enabled and working and a second configuration that has been tested and found to have 1-4 faulty stacked memory chips and thus, sold in a configuration with four stacked memory chips enabled, etc. For example, configurations may correspond to modes of operation. Thus, for example, a first mode of operation may correspond to satisfying 32-byte cache line requests in a 32-bit system with aggregated 32-bit responses from one or more portions of a stacked memory package and a second mode of operation may correspond to satisfying 64-byte cache line requests in a 64-bit system with aggregated 64-bit responses from one or more portions of a stacked memory package. Modes of operation may be configured, reconfigured, programmed, altered, changed, modified, etc. by system command, autonomously by the memory system, semi-autonomously by the memory system, combinations of these and/or other methods, etc. Configuration state, settings, parameters, values, timings, etc. may be stored by fuse, anti-fuse, register settings, design database, solid-state storage (volatile and/or non-volatile), and/or any other permanent or non-permanent storage, and/or any other programming or program means, and/or combinations of these and/or other means, etc.

Having defined a notation and terms associated with this notation the different possible connections (e.g., modes, couplings, connections, etc.) between block(s) on the logic chip(s) and the stacked memory chip(s) may now be described in more detail. The notation will use the memory region 19-226 of the stacked memory chip(s) as the smallest elements of interest. In order to illustrate the different possible connections a specific example stacked memory package may be used. In this specific example the stacked memory package may contain eight stacked memory chips (e.g., numbered zero through seven, etc.). Each stacked memory chip may contain eight memory regions (e.g., numbered zero through seven, etc.). Thus the notation may be used to describe the 64 memory regions in the stacked memory package as 0-63, with memory regions 0-7 on stacked memory chip 0, memory regions 8-15 stacked memory chip 1, etc. The stacked memory package may contain a single logic chip. The dedicated circuit blocks on the logic chip may be connected in various ways. For example, the logic chip may contain eight dedicated circuit blocks (e.g., numbered zero through seven, etc.). For example, dedicated circuit block 0 may be dedicated to memory regions 0, 8, 16, 24, 32, 40, 48, 56 (e.g., a single memory region on each of eight stacked memory chips). In this example, memory regions 0, 8, 16, 24, 32, 40, 48, 56 may form an echelon or other grouping of memory regions. In another example configuration of the same stacked memory package, the logic chip may contain four dedicated circuit blocks (e.g., numbered zero through three, etc.). For example, dedicated circuit block 0 may be dedicated to memory regions 0, 1, 8, 9, 16, 17, 24, 25, 32, 33, 40, 41, 48, 49, 56, 57 (e.g., two memory regions on each of eight stacked memory chips). For example, memory regions 0 and 1 on memory chip 0 may be a pair of banks, a group of banks, etc. In this example, memory regions 0, 1, 8, 9, 16, 17, 24, 25, 32, 33, 40, 41, 48, 49, 56, 57 may form an echelon or other grouping of memory regions. In another example configuration of the same stacked memory package, the logic chip may contain four dedicated circuit blocks (e.g., numbered zero through three, etc.). For example, dedicated circuit block 0 may be dedicated to memory regions 0, 1, 2, 3, 8, 9, 10, 11, 16, 17, 18, 19, 24, 25, 26, 27 (e.g., four memory regions on each of a subset of four stacked memory chips out of eight total stacked memory chips). In this example, memory regions 0, 1, 2, 3, 8, 9, 10, 11, 16, 17, 18, 19, 24, 25, 26, 27 may form an echelon or other grouping of memory regions. It may now be seen that other arrangements, combinations, organizations, configurations, etc. of memory regions with different connectivity, coupling, etc. to one or more circuit blocks on one or more logic chips may be possible.

In some configurations of stacked memory package there may be more than one type of dedicated circuit block with, for example, different connectivity to (e.g., association with, functionality with, etc.) the memory region(s). Thus, for example, a stacked memory package may contain eight stacked memory chips. Each stacked memory chip may contain 16 memory regions (e.g., banks, pairs of banks, bank groups, etc.). A group of eight memory regions comprising one memory region on each stacked memory chip may form an echelon. The stacked memory package may thus contain 16 echelons, for example.

Each echelon may have a dedicated memory controller and thus there may be 16 dedicated memory controllers. Each memory controller may thus be a dedicated circuit block of a first type and each memory controller may be considered to be dedicated to eight memory regions. The stacked memory package may contain four links (e.g., four buses, high-speed serial connections, etc. to the memory system, etc.). The logic chip may contain one or more serializer/deserializer (SERDES, SerDes, etc.) circuit blocks for each high-speed link. These SerDes circuit blocks may be considered to be dedicated circuit blocks or shared circuit blocks. For example, one or more links and the associated SerDes circuit blocks may be dedicated (e.g., associated with, coupled to, etc.) one or more echelons. In this case, for example, the SerDes circuit blocks may be considered to be dedicated circuit blocks. In this case, for example, the SerDes circuit blocks may not be dedicated to the same number, type, or arrangement of memory regions as other dedicated circuit blocks. Thus in this case, for example, the SerDes circuit blocks may be considered to be a second type of dedicated circuit block. In a different example, configuration or design the links and the associated SerDes circuit blocks may be shared (e.g., associated with, coupled to, etc.) all echelons and/or all memory regions. In this case, for example, the SerDes circuit blocks may be considered to be shared circuit blocks. The stacked memory package may contain one or more switches (e.g., crossbar switches, switching networks, etc.). For example, a first crossbar switch may be used to connect any of four input links to any of four output links. For example, a second crossbar switch may be used to connect any of four input links to any of 16 memory controllers. Each crossbar switch taken as a single circuit block may be considered a shared circuit block. The crossbar switches may be organized hierarchically or otherwise divided (e.g., into one or more sub-circuit blocks, etc.). In this case the divided portion(s) of a shared circuit block may be considered to be dedicated sub-circuit blocks. For example, the first crossbar switch, a shared circuit block, may couple any one of four input links to any one of four output links. The first crossbar switch may thus be considered to comprise a first crossbar matrix of 16 switching circuits. This first crossbar matrix of 16 switching circuits may be divided, for example, into four sub-circuit blocks each sub-circuit block comprising four switching circuits. These first crossbar sub-circuit blocks may be considered dedicated sub-circuit blocks. For example, depending on the division of the first crossbar switch, the first crossbar sub-circuit blocks may be considered as dedicated to a particular input link, or a particular output link. For example, depending on how the links may be dedicated, the first crossbar sub-circuit blocks may or may not be dedicated to memory regions. For example, the second crossbar switch, a shared circuit block, may couple any one of four input links to any one of 16 memory controllers, with each memory controller coupled to an echelon of memory regions. The second crossbar switch may thus be considered to comprise a second crossbar matrix of switching circuits. This second crossbar matrix of switching circuits may be divided, for example, into four sub-circuit blocks. These four second crossbar sub-circuit blocks may be considered dedicated sub-circuit blocks. For example, the second crossbar sub-circuit blocks may be considered as dedicated to a set (e.g., group, collection, etc.) of four memory controllers and thus to a set (e.g., group, collection, etc.) of echelons of memory regions. Thus, in this example, the second crossbar sub-circuit blocks may be considered a dedicated circuit block of a second type since the number of memory regions associated with a dedicated circuit block of a first type and the number of memory regions associated with a dedicated circuit block of a second type may be different. Thus it may be seen that that different types, arrangements, combinations, organizations, configurations, connections, etc. of dedicated circuit blocks and/or shared circuit blocks on one or more logic chips with different connectivity, coupling, etc. to memory regions of one or more stacked memory chips and/or logic chips may be possible. Of course any number and/or type and/or arrangements and/or connections of stacked memory chips, logic chips, memory regions, memory controllers, links, switches, SERDES, etc. may be used.

In FIG. 19-2 each of the memory arrays may comprise one or more banks (or other portion(s) of the memory array(s), etc.). For example, the stacked memory chips in FIG. 19-2 may comprise BB banks. For example, BB may be 2, 4, 8, 16, 32, etc. In one embodiment, the BB banks may be subdivided (e.g., partitioned, divided, grouped, arranged, logically arranged, physically arranged, etc.) into a plurality of bank groups (e.g., 32 banks may be divided into 16 groups of 2 banks, 8 banks may be divided into 2 groups of 4 banks, etc.). The banks may be further subdivided or may not be further subdivided into subbanks and so on (e.g., subbanks may optionally be further divided, etc.). The groups of banks and/or banks within groups may be able to operate in parallel (e.g., one or more operations such as read and/or write may be performed simultaneously, or nearly simultaneously and/or partially overlapped in time, etc.) and/or in a pipelined (e.g., overlapping in time, etc.) fashion, etc. The groups of subbanks and/or subbanks within groups may also be able to operate in parallel and/or pipelined fashion, etc.

In FIG. 19-2 each of the plurality of stacked memory chips may comprise a DRAM array with banks, but if a different memory technology (or multiple memory technologies, etc.) is used, then one or more memory array(s) may be subdivided in any fashion [e.g., pages, sectors, rows, columns, volumes, ranks, echelons (as defined herein), sections (as defined herein), NAND flash planes, DRAM planes (as defined herein), other portion(s), other collections(s), other groupings(s), combinations of these, etc.].

As an option, the stacked memory package of FIG. 19-2 may be implemented in the context of the architecture and environment of the previous Figures and/or any subsequent Figure(s). Of course, however, the stacked memory package of FIG. 19-2 may be implemented in the context of any desired environment.

### FIG. 19-3

FIG. 19-3 shows a stacked memory package architecture 19-300, in accordance with one embodiment. As an option, the stacked memory package architecture may be implemented in the context of the previous Figures and/or any other Figure(s). As an option, for example, the stacked memory package architecture of FIG. 19-3 may be implemented in the context of the stacked memory package of FIG. 19-2. In FIG. 19-3, the architecture may be implemented, for example, in the context of FIG. 15 of U.S. Provisional Application No. 61/580,300, filed Dec. 26, 2011, titled “SYSTEM, METHOD, AND COMPUTER PROGRAM PRODUCT FOR IMPROVING MEMORY SYSTEMS.” Of course, however, the stacked memory package architecture of FIG. 19-3 may be implemented in the context of any desired environment.

In FIG. 19-3, the die layout (e.g., floorplan, circuit block arrangements, architecture, etc.) of the logic chip may be designed to match (e.g., align, couple, connect, assemble, etc.) with the die layout of the stacked memory chip(s) and/or other logic chip(s). For example, the die layout of the logic chip in FIG. 19-3 may, for example, match the die layout of the stacked memory chip shown in FIG. 15-5 of U.S. Provisional Application No. 61/647,492, filed May 15, 2012, titled “SYSTEM, METHOD, AND COMPUTER PROGRAM PRODUCT FOR CONFIGURING A SYSTEM ASSOCIATED WITH MEMORY.”

In FIG. 19-3, the logic chip may comprise a number of dedicated circuit blocks and a number of shared circuit blocks. For example, the logic chip may include (but not limited to) one or more of the following circuit blocks: IO pad logic (labeled as Pad in FIG. 19-3); deserializer (labeled as DES in FIG. 19-3), which may be part of the physical (PHY) layer; forwarding information base or routing table etc. (labeled as FIB in FIG. 19-3); receiver crossbar (labeled as RxXBAR in FIG. 19-3), which may be connected to the memory regions via one or more memory controllers, receiver arbitration logic (labeled as RxARB in FIG. 19-3), which may also include logic (e.g., memory control logic and other logic, etc.) associated with the memory regions of the stacked memory chips, the through-silicon via connections (labeled as TSV in FIG. 19-3), which may also include repaired or reconfigured TSV arrays for example, stacked memory chips (labeled as DRAM in FIG. 19-3) and associated memory regions (e.g., banks, echelons, sections, etc.), transmit FIFO (labeled as TxFIFO in FIG. 19-3), which may include other logic (e.g., protocol logic, etc.) to associate memory responses with requests, etc, transmit arbiter (labeled as TxARB in FIG. 19-3), receive/transmit crossbar (labeled as RxTxXBAR in FIG. 19-3), which may be coupled to the high-speed serial links that may connect the stacked memory package to the memory system, for example, serializer (labeled as SER in FIG. 19-3), which may be part of the physical (PHY) layer.

It should be noted that not all circuit elements, circuit components, circuit blocks, logical functions, buses, etc. may be shown explicitly in FIG. 19-3. For example, connections to the DRAM may (and typically will) comprise separate buses for command and data. For example, one or more memory controllers may be considered part of either/both of the circuit blocks labeled RxXBAR and RxARB in FIG. 19-3. Of course many combinations of circuits, buses, etc. may be used to perform the functions logically diagrammed in the DRAM datapath and other parts (e.g., logical functions, circuit blocks, etc.) of FIG. 19-3. For example, the architecture of the DRAM datapaths and DRAM control paths and their functions etc. may be implemented, for example, in the context shown in FIG. 13 and/or FIG. 15, together with the accompanying text, of U.S. Provisional Application No. 61/580,300, filed Dec. 26, 2011, titled “SYSTEM, METHOD, AND COMPUTER PROGRAM PRODUCT FOR IMPROVING MEMORY SYSTEMS.”

In one embodiment the functions of the RxXBAR and RxTxXBAR may be merged, overlapped, shared, and/or otherwise combined, etc. For example, FIG. 19-3 shows one possible architecture for the RxTxXBAR and RxXBAR in which RxTxXBAR may comprise portions (e.g., circuits, partitions, blocks, etc.) 19-304 and 19-306; and RxXBAR may comprise portions 19-320 and 19-322. For example, portion 19-304 (or one or more parts thereof) of RxTxXBAR may be merged with (e.g., constructed in one block with, use common circuits with, etc.) portion 19-320 (or one or more parts thereof) of RxXBAR. For example, portion 19-306 (or one or more parts thereof) of RxTxXBAR may be merged with (e.g., constructed in one block with, use common circuits with, etc.) portion 19-322 (or one or more parts thereof) of RxXBAR. For example, one or more sub-circuit blocks 19-308 in RxTxXBAR may be merged with one or more sub-circuit blocks 19-312 in RxXBAR. In such merged and/or combined and/or otherwise transformed circuits the connectivity of the RxXBAR and/or RxTxXBAR may not be exactly as shown in the block diagram of FIG. 19-3, but the functionality (e.g., logical behavior, logical function(s), etc.) may be the same or essentially the same as shown in the block diagram of FIG. 19-3.

Note that, in FIG. 19-3, RxXBAR portion 19-320 and RxXBAR portion 19-322 may be crossbar switches, crossbar circuits, crossbars, etc. with one type of input and one type of output. For example, the inputs to RxXBAR portion 19-320 may be coupled to one or more input pads, I[0:15]. For example, the outputs from RxXBAR portion 19-320 may be coupled to memory regions (via, for example, RxARB and TSV blocks, etc.). In FIG. 19-3, RxTxXBAR portion 19-304 is a crossbar switch that may be regarded as having one type of input and two types of output. In FIG. 19-3, RxTxXBAR portion 19-306 is a crossbar switch that may be regarded as having two types of input and one type of output. These logical drawings (e.g., topologies, circuit representations, etc.) may represent a more complex type of crossbar circuit structure. For example, in FIG. 19-3, the RxTxXBAR portion 19-304 may have a first type of output (e.g., lines, buses, connections, wires, signals, etc.) to RxXBAR portion 19-320 and a second type of output to RxTxXBAR portion 19-306. Thus, as drawn in FIG. 19-3 for example, the RxTxXBAR portion 19-304 may have four input lines and eight output lines. The switching behavior (e.g., logical behavior, logical function(s), etc.) of RxTxXBAR portion 19-304 may be simpler (e.g., different functionality, etc.) than a 4×8 crossbar, however. For example, the destination of inputs (packets, commands, etc.) to RxTxXBAR portion 19-304 may be known ahead of their connection (e.g., ahead of time, etc.) to the RxTxXBAR crossbar. For example, commands and/or data may be either destined (e.g., targeted, addressed, etc.) to a memory region on the stacked memory package or may be destined to be routed directly to the output link(s) for another part of the memory system. Thus, for example, a pre-stage (e.g., circuit block, logic function, etc.) may route an input immediately to one of the two sets of four output lines. Thus, for example, the RxTxXBAR portion 19-304 may be logically implemented as two 4×4 crossbars driven by such a pre-stage. Similarly in FIG. 19-3, the RxTxXBAR portion 19-306 may have a first type of input from RxTxXBAR portion 19-304 and may have a second type of input from RxXBAR portion 19-320. Thus, as drawn in FIG. 19-3 for example, the RxTxXBAR portion 19-306 may have four output lines and eight input lines. The switching behavior (e.g., logical behavior, logical function(s), etc.) of RxTxXBAR portion 19-306 may be simpler than an 8×4 crossbar, however. For example, commands from the RxTxXBAR may be essentially merged (e.g., combined, aggregated, etc.) with data and other responses etc. from the RxXBAR and routed to the output link(s). Thus, for example, a pre-stage (e.g., circuit block, logic function, etc.) may arbitrate between two sets of four input lines. Thus, for example, the RxTxXBAR portion 19-304 may be logically implemented as a 4×4 crossbar driven by such a pre-stage.

Of course, many combinations of crossbars, crossbar circuits, switching networks, switch fabrics, programmable connections, etc. in combination with, in conjunction with, comprising, etc. arbiters, selectors, MUXes, other logic and/or logic stages, etc. may be used to perform the logical functions and/or other functions that may include crossbar circuits and/or equivalent functions etc. as diagrammed in FIG. 19-3, for example. For example, one or more of the crossbar switches or portions of crossbar circuits (e.g., components, blocks, functions, etc.) illustrated in FIG. 19-3 may be implemented in the context shown in FIG. 6 of U.S. Provisional Application No. 61/580,300, filed Dec. 26, 2011, titled “SYSTEM, METHOD, AND COMPUTER PROGRAM PRODUCT FOR IMPROVING MEMORY SYSTEMS.” For example, the connections and/or coupling and/or logical functions of one or more crossbar circuits used to connect to the stacked memory chips (e.g., DRAM), memory controllers, FIFOs, arbiters, and/or other associated logic may be implemented, for example, in the context shown in FIG. 7 of U.S. Provisional Application No. 61/580,300, filed Dec. 26, 2011, titled “SYSTEM, METHOD, AND COMPUTER PROGRAM PRODUCT FOR IMPROVING MEMORY SYSTEMS.” Thus, for example, crossbars, crossbar circuits, switches, etc. may be constructed from cascaded (e.g., series connected, parallel connected, series-parallel connected, combinations of these, etc.) switching networks. Thus, for example, crossbar circuits may be blocking, non-blocking, etc. Thus, for example, crossbar circuits may be hierarchical, nested, recursive, etc. Thus, for example, crossbar circuits may contain queues, arbiters, MUXes, FIFOs, virtual queues, virtual channels, priority control, etc. For example, crossbar circuits may be operable to be modified, programmable, reprogrammable, configurable, etc. Thus, for example, crossbar circuits or other programmable connections may be altered at design time, during manufacturing and/or assembly, during or after testing, at system start-up, during or after characterization operations and/or functions, during system operation (e.g., periodically, continuously, etc.), combinations of these times (e.g., at multiple times, etc.), etc. For example, crossbar circuits may be constructed from any switching means including (but not limited to) one or more of the following: CMOS switches, MOS switches, transistor switches, pass gates, MUXes, optical switches, mechanical (e.g., micromechanical, MEMS, etc.) switches, other electrical and/or logical switching means, other circuits/macros/cells, combinations of these and/or other switching means, etc

In FIG. 19-3 the crossbar switches and/or crossbar circuits may contain one or more sub-circuits. Thus, for example, the RxTxXBAR may be a shared circuit block with several sub-circuit blocks that may be dedicated circuit blocks. For example, as shown in FIG. 19-3, the RxTxXBAR may be divided into two portions: the first portion 19-304 may switch the input links and the second portion 19-306 may switch the DRAM outputs. For example, as shown in FIG. 19-3, each portion of the RxTxXBAR may be divided into four sub-circuits. Each sub-circuit may be located (e.g., layout placed, floorplanned, etc.) on the logic chip die separately (e.g., distinct from other similar copies of the sub-circuit, etc.). For example, in FIG. 19-3, a first sub-circuit 19-308 may be part of a first portion of the RxTxXBAR. For example, in FIG. 19-3, a second sub-circuit 19-310 may be part of a second portion of the RxTxXBAR. For example, in FIG. 19-3, a third sub-circuit 19-312 may be part of a first portion of the RxXBAR. For example, in FIG. 19-3, a fourth sub-circuit 19-314 may be part of a second portion of the RxXBAR. For example, in FIG. 19-3, the first sub-circuit 19-308, the second sub-circuit 19-310, the third sub-circuit 19-312, and the fourth sub-circuit 19-314 may be located (layout placed, floorplanned, etc.) in a dedicated circuit block 19-316. Of course circuit block 19-316 may contain other logic in addition to the crossbar sub-circuits, etc. In this example, then, the RxXBAR and the RxTxXBAR circuit blocks may be regarded as shared circuit blocks but the RxXBAR sub-circuit blocks and RxTxXBAR sub-circuit blocks (such as the layout 19-316) may be regarded as dedicated (or assigned, allocated, associated with, etc.) a set (e.g., group, collection, etc.) of memory support circuits (e.g., memory controllers, FIFOs, arbiters, datapaths, buses, etc.) as well as a set (e.g., group, echelon, section, etc.) of memory regions on one or more of the stacked memory chips.

In one embodiment the architecture (e.g., circuit design, layout, etc.) of the crossbar switch circuit blocks may be such that the sub-circuits may be simplified and/or optimized (e.g., minimized in area, maximized in speed, minimized in parasitic effects, etc.). For example, in FIG. 19-3 the sub-circuit 19-308, sub-circuit 19-310, sub-circuit 19-312, and sub-circuit 19-314 may all be optimized and similar (e.g., the same, copies, nearly the same, based on the same macro element(s), etc.).

As an option, the stacked memory package architecture of FIG. 19-3 may be implemented in the context of the architecture and environment of the previous Figures and/or any subsequent Figure(s). Of course, however, the stacked memory package architecture of FIG. 19-3 may be implemented in the context of any desired environment.

FIG. 19-4

FIG. 19-4 shows a stacked memory package architecture 19-400, in accordance with one embodiment. As an option, the stacked memory package architecture may be implemented in the context of FIG. 19-4 and/or any other Figure(s). Of course, however, the stacked memory package architecture may be implemented in the context of any desired environment.

In FIG. 19-4 the circuits, components, etc. may function in a manner similar to that described in the context of similar circuits and components in FIG. 19-3. In the architecture 19-400 the RxXBAR may connect (e.g., couple, etc.) to DRAM and other logic 19-416, as shown in FIG. 19-4. The DRAM and other logic shown in FIG. 19-4 may include (but is not limited to) one or more of the following components: RxARB, DRAM, TSV (for example used both to connect the command and write data to the DRAM and to connect the read data from the DRAM as well as other miscellaneous control and other DRAM signals, etc.), TxFIFO, TxARB. Thus, for example, the DRAM and other logic may be as shown in more detail in FIG. 19-3. In FIG. 19-4 the RxXBAR may include one or more horizontal lines 19-418 (e.g., wire, bus, multiplexed bus, switched bus, connection, etc.). Of course the orientation (e.g., horizontal, vertical, etc.) of the horizontal line(s) shown in the logical drawing of FIG. 19-4 may have no logical significance. The lines, buses, connections or other coupling means of any of the crossbar(s) (or any other circuit components, etc.) may be of any spatial orientation, nature, etc. In FIG. 19-4 there may be four copies of the DRAM and other logic coupled to each horizontal line of the RxXBAR. In FIG. 19-4, the DRAM and other logic may represent a group (e.g., set, collection, etc.) of memory regions and the associated logic. For example, the associated logic may include FIFOs, arbiters, memory controllers, etc. For example, a stacked memory package using the architecture of FIG. 19-4 may contain eight stacked memory chips. Each stacked memory chip may contain 16 memory regions. Thus, for example, the stacked memory package may contain a total of 8×16=128 memory regions. The stacked memory package may comprise four links to the external memory system using 16 input pads, I[0:15]. Each link may be coupled to the RxTxXBAR and RxXBAR through the DES and FIB circuit blocks, for example. Each of the four horizontal lines of the RxXBAR may be coupled to four groups of memory regions and associated logic. Thus, for example, there may be 16 groups of memory regions and associated logic. Thus, for example, each of the 16 groups of memory regions and associated logic may include 128/16=8 memory regions. Thus, each memory controller, for example, may control a group containing eight memory regions. The eight memory regions in each group may, for example, form an echelon. Thus in FIG. 19-4 the architecture 19-400 for the RxXBAR may have a horizontal line dedicated to four memory controllers and 32 memory regions. Of course, other arrangements of crossbar circuits, crossbar lines, memory regions, and associated logic may be used.

For example, architecture 19-450 in FIG. 19-4 shows another construction for the crossbar circuits. In the architecture 19-450 of FIG. 19-4 the sub-circuits may be constructed (e.g., formed, wired, architected, connected, coupled, floorplanned, etc.) in a different manner than that shown in FIG. 19-3 and/or in the architecture 19-400 of FIG. 19-4, for example. For example, in the architecture 19-450, the sub-circuit 19-458 of the RxTxBAR may be constructed so that the width direction of the sub-circuit is across multiple memory regions or (in an alternative, equivalent view) the sub-circuit generates one output (e.g., the sub-circuit 19-458 may be a vertical slice of the crossbar in architecture 19-450 and the sub-circuit 19-408 may be a horizontal slice of the crossbar circuit in architecture 19-400). Of course either a horizontal slice sub-circuit construction (e.g., architecture, design, layout, etc.) or a vertical slice sub-circuit construction (e.g., the width or height direction of the sub-circuit, the signals arrayed across the longest part of the sub-circuit, width of the sub-circuit along the input direction or output direction, etc.) may be used for any of the crossbar circuits or portion(s) of the crossbar circuits. For example, the RxTxXBAR may use a horizontal slice sub-circuit construction (as shown for example in architecture 19-400) while the RxXBAR may use a vertical slice sub-circuit construction (as shown for example in architecture 19-450).

The number, size, type, construction, and other features of the sub-circuits of the crossbar circuits (or any other circuit blocks, etc.) may be designed, for example, so that any sub-circuits may be distributed (e.g., sub-circuits placed separately, sub-circuits connected separately, sub-circuits placed locally to associated functions, etc.) on the logic chip(s). The distribution of the sub-circuits may be such as to minimize parasitic delays due to wiring; to allow direct, short, or otherwise optimize connections and/or coupling between logic chip(s) and/or stacked memory chip(s); to minimize die area (e.g., silicon area, circuit area, etc.); to minimize power dissipation; to minimize the difficulty of performing circuit layout (e.g., meet timing constraints, minimize crosstalk and/or other deleterious signal effects, etc.); combinations of these and/or other factors, etc.

As an option, the stacked memory package architecture of FIG. 19-4 may be implemented in the context of the architecture and environment of the previous Figures and/or any subsequent Figure(s). Of course, however, the stacked memory package architecture of FIG. 19-4 may be implemented in the context of any desired environment.

### FIG. 19-5

FIG. 19-5 shows a stacked memory package architecture 19-500, in accordance with one embodiment. As an option, the stacked memory package architecture may be implemented in the context of the previous Figures and/or any other Figure(s). Of course, however, the stacked memory package architecture may be implemented in the context of any desired environment.

In FIG. 19-5 the circuits, components, etc. may function in a manner similar to that described in connection with similar circuits and components in FIG. 19-3 and FIG. 19-4. In the architecture 19-500 the RxXBAR may connect to DRAM and other logic, as shown, for example, in FIG. 19-4. The DRAM and other logic shown in FIG. 19-5 may include (but is not limited to) one or more of the following components: RxARB 19-516, DRAM 19-520 (which may be divided into one or more memory regions, etc.), TSV 19-518 (to connect the command and write data to the DRAM), TSV 19-522 (to connect the read data from the DRAM as well as other miscellaneous control and other DRAM signals, etc.), TxFIFO 19-524, TxARB 19-526. The description and functions of the various blocks, including blocks such as memory controllers etc. that may not be shown explicitly in FIG. 19-5, may be similar to that described in the context of FIG. 19-3 and the accompanying text and references.

In FIG. 19-5 the RxXBAR may include one or more horizontal lines 19-534 (e.g., wire, bus, multiplexed bus, switched bus, connection, etc.). Of course the orientation of the horizontal line shown in the logical drawing of FIG. 19-5 may have no logical significance. The lines, buses, connections or other coupling means of any of the crossbar(s) (or any other circuit components, etc.) may be of any spatial orientation, nature, etc. In FIG. 19-5 there may be one copy of the DRAM and other logic coupled to each horizontal line of the RxXBAR. In FIG. 19-5, the DRAM and other logic may represent a group (e.g., set, collection, etc.) of memory regions and the associated logic. For example, a stacked memory package using the architecture of FIG. 19-5 may contain eight stacked memory chips. Each stacked memory chip may contain 16 memory regions. Thus, for example, the stacked memory package may contain a total of 8×16=128 memory regions. The stacked memory package may comprise four links to the external memory system using 16 input pads, I[0:15]. Each link may be coupled to the RxTxXBAR and RxXBAR through the DES and FIB circuit blocks, for example. Each of the 16 horizontal lines of the RxXBAR may be coupled to one group of memory regions and associated logic. Thus, for example, there may be 16 groups of memory regions and associated logic. Thus, for example, each of the 16 groups of memory regions and associated logic may include 128/16=8 memory regions. Thus each memory controller, for example, may control a group containing eight memory regions. The eight memory regions in each group may, for example, form an echelon (as defined herein, etc.). Thus, in FIG. 19-4, the architecture 19-500 for the RxXBAR may have a horizontal line dedicated to one memory controller and 8 memory regions.

The architecture 19-400 for the RxXBAR of FIG. 19-4 may have a horizontal line dedicated to four memory controllers and 32 memory regions and the architecture 19-500 for the RxXBAR of FIG. 19-5 may have a horizontal line dedicated to one memory controller and 8 memory regions. A stacked memory package may contain MR memory regions, and a logic chip may contain MC memory controllers. Thus in different configurations, the RxXBAR, for example, may have HL_RxXBAR horizontal lines and thus may have a horizontal line dedicated to MC/HL_RxXBAR memory controllers and MR/HL_RxXBAR memory regions, where HL_RxXBAR may be any number. Note that, in the architecture shown in FIG. 19-5, HL_RxXBAR is also equal to the number of RxXBAR outputs (given the orientation of the crossbar shown in FIG. 19-5, with horizontal lines corresponding to outputs).

In FIG. 19-5, the RxXBAR may include one or more vertical lines 19-536 (e.g., wire, bus, multiplexed bus, switched bus, connection, etc.). Of course the orientation of the vertical line shown in the logical drawing of FIG. 19-5 may have no logical significance. The lines, buses, connections or other coupling means of any of the crossbar(s) (or any other circuit components, etc.) may be of any spatial orientation, direction, nature, etc.

In FIG. 19-5, the RxXBAR may have four vertical lines (e.g., corresponding to four inputs to the crossbar, etc.) that may correspond to (e.g., coupled to, connected to, etc.) four links (coupled to 16 input pads, I[0:15], for example). In different configurations of the RxXBAR there may be any number of vertical lines and thus any number of crossbar inputs, including a single input. For example, in one embodiment the input requests and/or input commands (read requests, write requests, etc.) may be transmitted in such a fashion that a single request or single command is completely contained on one link of one or more links (e.g., requests may not spread or be distributed over more than one link, etc.). Thus, for example, a stacked memory package with four links may have four request streams (e.g., sets, collections, simultaneous signals, etc.). These four request streams may be combined (e.g., merged, coalesced, aggregated, etc.) into a single stream. The single stream may then be used as a single input to the RxXBAR. Of course any number of links DLNK may be merged (or expanded) to any number of request streams REQSTR. Thus, in an analogous fashion to the horizontal lines of RxXBAR, in different configurations, the RxXBAR, for example, may have VL_RxXBAR vertical lines (which may be equal to REQSTR) and thus may have a vertical line dedicated to MC/VL_RxXBAR memory controllers and MR/VL_RxXBAR memory regions, where VL_RxXBAR may be any number. In one embodiment requests may be spread over more than one link, however the request stream(s) may still be merged or expanded to any number of streams as inputs to the RxXBAR for example.

The above examples illustrated how the number of inputs and number of outputs of the crossbar circuits (or other switching functions, etc.) may be architected so that the number of inputs and/or outputs dedicated to circuit resources such as memory controller and memory regions may be varied. For example, the architecture 19-400 of FIG. 19-4 may be used to achieve a ratio of 1:4 between RxXBAR outputs and memory controllers. For example, the architecture 19-500 of FIG. 19-5 may be used to achieve a ratio of 1:1 between RxXBAR outputs and memory controllers. The memory region notation may be used to illustrate the differences between these two architectures. For example, a stacked memory package may contain 128 (e.g., numbered 0-127) memory regions on eight (e.g., numbered 0-7) stacked memory chips (e.g., 16 memory regions per stacked memory chip). For example, the architecture 19-400 of FIG. 19-4 may have four RxXBAR outputs with each RxXBAR output dedicated to four groups (e.g., numbered 0-3) of eight memory regions (e.g., 32 memory regions), e.g., group 0 may contain memory regions 0, 8, 16, 24, 32, 40, 48, 56 (which may form an echelon, etc.). For example, the architecture 19-500 of FIG. 19-5 may have 16 RxXBAR outputs with each RxXBAR output dedicated to eight memory regions, e.g., memory regions 0, 8, 16, 24, 32, 40, 48, 56 (which may form an echelon, etc.).

The above examples have focused on the RxXBAR function, as shown in FIG. 19-5 for example. Similar alternative designs may be applied to the other crossbar circuits and/or portions of crossbar circuits and/or MUXes and/or switches and/or switching functions on the logic chip(s) in FIG. 19-5 and in other Figures in this specification and specifications incorporated herein by reference. In FIG. 19-5, for example, the number of inputs to RxTxXBAR portion 19-504 may be varied as VL_RxTxXBAR_1; the number of outputs of a first type (with output type and input type used as described in the text accompanying FIG. 19-3 for example) from RxTxXBAR portion 19-504 may be varied as VL_RxTxXBAR_1_1; the number of outputs of a second type from RxTxXBAR portion 19-504 may be varied as HL_RxTxXBAR_1_2; the number of outputs from RxTxXBAR portion 19-506 may be varied as HL_RxTxXBAR_2; the number of inputs of a first type to RxTxXBAR portion 19-506 may be varied as VL_RxTxXBAR_2_1; the number of inputs of a second type to RxTxXBAR portion 19-506 may be varied as HL_RxTxXBAR_2_2; the number of inputs to RxXBAR portion 19-534 may be varied as VL_RxXBAR_1; the number of outputs from RxXBAR portion 19-534 may be varied as HL_RxXBAR_1; the number of inputs to RxXBAR portion 19-552 may be varied as VL_RxXBAR_2; the number of outputs from RxXBAR portion 19-552 may be varied as HL_RxXBAR_2; etc.

For example, in FIG. 19-5, VL_RxTxXBAR_1=4; VL_RxTxXBAR_1_1=4; HL_RxTxXBAR_1_2=4; HL_RxTxXBAR_2=4; VL_RxTxXBAR_2_1=4; HL_RxTxXBAR_2_2=4; VL_RxXBAR_1=4; HL_RxXBAR_1=16; VL_RxXBAR_2=4; and HL_RxXBAR_2=16. Of course, other arrangements of crossbar lines, memory regions, and associated logic may be used.

Note that in FIG. 19-5, for example, VL_RxTxXBAR_1_1 (first type outputs)=VL_RxXBAR_1 (inputs)=4, but that need not be the case. Also, in FIG. 19-5, HL_RxTxXBAR_1_2 (second type outputs)=HL_RxTxXBAR_2_2 (second type inputs); HL_RxXBAR_1 (outputs)=HL_RxXBAR_2 (inputs); VL_RxXBAR_2 (outputs)=VL_RxTxXBAR_2_1 (first type inputs), but that need not be the case. For example, in FIG. 19-5 there may be circuit blocks 19-530 and 19-532 that may merge/expand the command and/or request and/or data streams. Thus, for example, circuit block 19-530 may change VL_RxXBAR_1 to be different from VL_RxTxXBAR_1_1, etc. Thus, for example, circuit block 19-532 may change VL_RxXBAR_2 to be different from VL_RxTxXBAR_2_1, etc. Other circuit blocks (not shown on FIG. 19-5) may change HL_RxTxXBAR_2_2 from HL_RxTxXBAR_1_2 (e.g., number of output links may be different from number of input links, for example).

In one embodiment, circuit blocks may change the format of signals that may be switched (e.g., connected, manipulated, transformed, etc.) in one or more crossbar circuits. For example, in FIG. 19-5, RXTxXBAR portion 19-504 may switch packets (e.g., signals at the PHY layer, for example). Circuit block 19-530 may change the format of RxTXXBAR outputs (e.g., change one or more types of output signal, etc.) from serialized packets to a parallel bus, for example. Thus, for example, in FIG. 19-5, RxXBAR portion 19-550 may switch signals on a parallel bus (e.g., signals above the PHY layer, for example).

In FIG. 19-5 (as well as, for example FIG. 19-3 and FIG. 19-4) the crossbar switches and crossbar circuits may be shown as balanced. The term balanced is used to indicate that the resources (circuits, connections, etc.) may be designed in a symmetric, fair, equal etc. fashion. Thus each link for example is or may be logically similar to other links; each crossbar line is or may be logically similar to other lines of the same type; each DRAM circuit is or may be logically similar to other DRAM circuits of the same type; each memory controller, FIFO, arbiter, etc. is or may be logically similar to circuits of the same type, and so on. This need not be the case. As an example, status requests and associated status responses may correspond to a very small amount of memory system traffic. In some cases, for example, status traffic may generate a burst of traffic at system start-up (e.g., boot time, etc.) but very little traffic at other times. Thus, in one embodiment, status requests and/or status responses may be assigned to a single link. In such an embodiment, configuration, design etc. the need for arbiters, queues, other circuits etc. may be reduced (e.g., eliminated, obviated, decreased, etc.). Such an embodiment may employ an unbalanced architecture, that is an architecture where not all circuit elements, sub-circuits, etc. that perform a similar function may be identical (e.g., are logically identical, are logically similar, are copies, are different instances of the same macro, etc.). An unbalanced architecture may thus include (but is not limited to) an architecture where in a number of circuits that may be otherwise similar or identical, one or more circuits, groups of circuits, circuits acting in combination, programming of circuits, aspects of circuits, etc. may be special (e.g., distinct, different, differing in one or more aspects, having different parameters and/or characteristics, having different logical behavior, performs a different logical function, etc.).

Unbalanced architectures may be used for a number of different reasons. For example, certain output links may be dedicated to certain memory regions (possibly under programmable control, etc.). For example, certain request may have higher priority than others and may be assigned to certain input links and/or logic chip datapath resources and/or certain output links (possibly under programmable control, etc.) and/or other system (e.g., stacked memory package, memory system, etc.) resources. Unbalanced architectures may also be used to handle differences in observed or predicated traffic. For example, more links (input links or output links) and/or circuit resources (logic chip and/or stacked memory chip resources, etc.) may be provided to read traffic than write traffic (or vice versa). For example, one or more paths in one or more of the crossbar switches and associated logic may contain logic for handling virtual traffic. Such an architecture may be constructed, for example, in the context of FIG. 13 of U.S. Provisional Application No. 61/580,300, filed Dec. 26, 2011, titled “SYSTEM, METHOD, AND COMPUTER PROGRAM PRODUCT FOR IMPROVING MEMORY SYSTEMS.”

For example, in one embodiment one of the vertical paths in the RxTxXBAR in FIG. 19-5 may be designed to handle virtual traffic (e.g., using one or more virtual channels, specifying one or more virtual channels, using priority fields and/or traffic classes, using virtual links, virtual path(s), etc.). In this embodiment, the input commands and/or input requests that use a virtual channel etc. may be steered to (e.g., associated with, directed to, coupled to, connected to, routed to, etc.) a particular path (e.g., links, channels, buses, circuits, function blocks, switches, virtual path(s), combinations of these, etc.).

Of course any number, type, format or structure (e.g., packet, bus, etc.), bus width, encoding, class (e.g., traffic class, virtual channel, virtual path(s), etc.), priorities, etc. of signals may be switched at any point in the architecture using schemes such as those described and illustrated above with respect to the architecture shown in FIG. 19-5 and/or with respect to any of the other architectures shown in other Figures in this application and/or in Figures in other applications incorporated herein by reference along with the accompanying text.

### FIG. 19-6

FIG. 19-6 shows a portion of a stacked memory package architecture 19-600, in accordance with one embodiment. As an option, the stacked memory package architecture may be implemented in the context of the previous Figures and/or any other Figure(s). Of course, however, the stacked memory package architecture may be implemented in the context of any desired environment.

In FIG. 19-6, the RxXBAR may be implemented in the context of FIG. 19-5, for example. In FIG. 19-6, the RxXBAR may comprise two portions RxXBAR_0 19-650 and RxXBAR_1 19-652. The portions RxXBAR_0 and RxXBAR_1 may be coupled to DRAM and associated logic, as shown and similar to the corresponding components described for example in FIG. 19-5 and the accompanying text. The DRAM and other logic shown in FIG. 19-6 may include (but is not limited to) one or more of the following components: RxARB 19-616, DRAM 19-620 (which may be divided into one or more memory regions, etc.), TSV 19-618 (to connect the command and write data to the DRAM), TSV 19-622 (to connect the read data from the DRAM as well as other miscellaneous control and other DRAM signals, etc.), TxFIFO 19-624, TxARB 19-626. The description and functions of the various blocks, including blocks such as memory controllers etc. that may not be shown explicitly in FIG. 19-6, may be similar to that described in the context of FIG. 19-3 and the accompanying text and references. Note that in FIG. 19-6 the RxXBAR may be a different size from that shown in FIG. 19-4 for example. Of course the RxXBAR may be of any size and coupled to any number of stacked memory chips, memory regions, memory controllers, other associated logic, etc.

In FIG. 19-6, the RxXBAR_0 may be divided into a number of sub-circuits 19-612. In FIG. 19-6, the RxXBAR_0 sub-circuits may be numbered 0_0, 01, 0_2, 03, 04, 0_5, 06, 0_7. In FIG. 19-6, the RxXBAR_1 may be divided into a number of sub-circuits 19-614. In FIG. 19-6, the RxXBAR_1 sub-circuits may be numbered 10, 11, 12, 13, 14, 15, 16, 1_7. In FIG. 19-6, there may be four input links connected (directly or indirectly, via logic, etc.) to the inputs of the RxXBAR. In FIG. 19-6, the RxXBAR may have four inputs that may be numbered PHY_00, PHY_01, PHY_02, PHY_03. In FIG. 19-6, there may be four output links connected (directly or indirectly, via logic, etc.) to the outputs of the RxXBAR. In FIG. 19-6, the RxXBAR may have four outputs that may be numbered PHY_10, PHY_11, PHY_12, PHY_13. Of course any number of RxXBAR inputs and outputs may be used.

In FIG. 19-6, the architecture includes an example die layout 19-630 (e.g., floorplan, etc.) for a logic chip containing the RxXBAR and other logic. The die layout of the logic chip in FIG. 19-6 may be implemented in the context of FIG. 19-3 for example. The die layout of the logic chip in FIG. 19-6 may, for example, match the die layout of the stacked memory chip shown in FIG. 15-5 of U.S. Provisional Application No. 61/647,492, filed May 15, 2012, titled “SYSTEM, METHOD, AND COMPUTER PROGRAM PRODUCT FOR CONFIGURING A SYSTEM ASSOCIATED WITH MEMORY.”

Layout considerations such as power/ground supplies and power distribution noise etc. may restrict and/or otherwise constrain etc. the placement of the IO pads for the high-speed serial links. Thus, for example, in FIG. 19-6 the position of the circuits PHY_00, PHY_01, PHY_02, PHY_03 and PHY_10, PHY_11, PHY_12, PHY_13 may be constrained to the perimeter of the logic chip in the locations shown. Layout considerations for each stacked memory chip and restrictions on the placement and number etc. of TSVs may constrain the placement of sub-circuits 0_0, 01, 0_2, 03, 04, 05, 06, 0_7 and sub-circuits 1_0, 1_1, 1_2, 1_3, 1_4, 1_5, 1_6, 1_7. In addition since the memory regions may be distributed across each stacked memory chip, in one embodiment it may be preferable (e.g., for performance, etc.) to separate the RxXBAR sub-circuits as shown in the logic chip die layout of FIG. 19-6.

In FIG. 19-6, the connections (e.g., logical connections, wires, buses, groups of signals, etc.) may be as shown (e.g., by lines on the drawing) between sub-circuit 0_0 and TSV array 19-632 (which may provide coupling to the memory regions on one or more stacked memory chips and may correspond, for example, to circuit block 19-620) and between sub-circuit 0_0 and PHY_00, PHY_01, PHY_02, PHY_03. Similar connections may be present (but may not be shown in FIG. 19-6) for all the other sub-circuits (e.g., 0_1 through 07 and 1_0 through 1_7).

In FIG. 19-6, the sub-circuits 0_0, 0_1, 02, 03, 04, 05, 06, 0_7 and sub-circuits 1_0, 1_1, 1_2, 1_3, 1_4, 1_5, 16, 1_7 may form horizontal slices of the RxXBAR. Of course, the orientation of the sub-circuits in the logical drawing of FIG. 19-5 may have no logical significance. The choice of sub-circuit shape(s) and/or orientation(s) (e.g., horizontal slice, vertical slice, combination of horizontal slice and vertical slice, mix of horizontal slice and vertical slice, other shapes and/or portion(s), combinations of these, etc.) may optimize the performance of the circuits (e.g., reduce layout parasitic, reduce wiring length, improve maximum operating frequency, reduce coupling parasitic, reduce crosstalk, increase routability, etc.).

### FIG. 19-7

FIG. 19-7 shows a portion of a stacked memory package architecture 19-700, in accordance with one embodiment. As an option, the stacked memory package architecture may be implemented in the context of the previous Figures and/or any other Figure(s). Of course, however, the stacked memory package architecture may be implemented in the context of any desired environment.

In FIG. 19-7, the RxXBAR may be implemented in the context of FIG. 19-5, for example. In FIG. 19-7, the RxXBAR may comprise two portions RxXBAR_0 19-750 and RxXBAR_1 19-752. The portions RxXBAR_0 and RxXBAR_1 may be coupled to DRAM and associated logic, as shown and similar to the corresponding components described for example in FIG. 19-5 and the accompanying text. The DRAM and other logic shown in FIG. 19-7 may include (but is not limited to) one or more of the following components: RxARB 19-716, DRAM 19-720 (which may be divided into one or more memory regions, etc.), TSV 19-718 (to connect the command and write data to the DRAM), TSV 19-722 (to connect the read data from the DRAM as well as other miscellaneous control and other DRAM signals, etc.), TxFIFO 19-724, TxARB 19-726. The description and functions of the various blocks, including blocks such as memory controllers etc. that may not be shown explicitly in FIG. 19-7, may be similar to that described in the context of FIG. 19-3 and the accompanying text and references. Note that in FIG. 19-7 the RxXBAR may be a different size from that shown in FIG. 19-4, for example. Of course, the RxXBAR may be of any size and coupled to any number of stacked memory chips, memory regions, memory controllers, other associated logic, etc.

In FIG. 19-7, the RxXBAR_0 may be divided into a number of sub-circuits 19-712. In FIG. 19-7, the RxXBAR_0 sub-circuits may be numbered 0_0, 01, 0_2, 03, 04, 0_5, 06, 0_7. In FIG. 19-7, the RxXBAR_1 may be divided into a number of sub-circuits 19-714. In FIG. 19-7, the RxXBAR_1 sub-circuits may be numbered 10, 11, 12, 13, 14, 15, 16, 1_7. In FIG. 19-7, there may be four input links connected (directly or indirectly, via logic, etc.) to the inputs of the RxXBAR. In FIG. 19-7, the RxXBAR has four inputs that may be numbered PHY_00, PHY_01, PHY_02, PHY_03. In FIG. 19-7, there may be four output links connected (directly or indirectly, via logic, etc.) to the outputs of the RxXBAR. In FIG. 19-7, the RxXBAR has four outputs that may be numbered PHY_10, PHY_11, PHY_12, PHY_13. Of course, any number of RxXBAR inputs and outputs may be used.

In FIG. 19-7, the architecture includes an example die layout 19-730 (e.g., floorplan, etc.) for a logic chip containing the RxXBAR and other logic. The die layout of the logic chip in FIG. 19-7 may be implemented in the context of FIG. 19-3 for example. The die layout of the logic chip in FIG. 19-7 may, for example, match the die layout of the stacked memory chip shown in FIG. 15-5 of U.S. Provisional Application No. 61/647,492, filed May 15, 2012, titled “SYSTEM, METHOD, AND COMPUTER PROGRAM PRODUCT FOR CONFIGURING A SYSTEM ASSOCIATED WITH MEMORY.”

Layout considerations such as power/ground supplies and power distribution noise etc. may restrict and/or otherwise constrain etc. the placement of the IO pads for the high-speed serial links. Thus, for example, in FIG. 19-7 the position of the circuits PHY_00, PHY_01, PHY_02, PHY_03 and PHY_10, PHY_11, PHY_12, PHY_13 may be constrained to the perimeter of the logic chip in the locations shown. Layout considerations for each stacked memory chip and restrictions on the placement and number etc. of TSVs may constrain the placement of sub-circuits 0_0, 01, 0_2, 03, 04, 05, 06, 0_7 and sub-circuits 1_0, 1_1, 1_2, 1_3, 1_4, 1_5, 1_6, 1_7. In addition, since the memory regions may be distributed across each stacked memory chip, in one embodiment it may be preferable (e.g., for performance, etc.) to separate the RxXBAR sub-circuits as shown in the logic chip die layout of FIG. 19-7.

In FIG. 19-7, the connections (e.g., logical connections, wires, buses, groups of signals, etc.) may be as shown (e.g., by lines on the drawing) between sub-circuit 0_0 and TSV array 19-732 (which may provide coupling to the memory regions on one or more stacked memory chips and may correspond, for example, to circuit block 19-720) and between sub-circuit 0_0 and PHY_00, PHY_01, PHY_02, PHY_03. Similar connections may be present (but may not be not shown in FIG. 19-7) for all the other sub-circuits (e.g., 0_1 through 07 and 1_0 through 1_7).

In FIG. 19-7, the sub-circuits 0_0, 0_1, 02, 03, 04, 05, 06, 0_7 and sub-circuits 1_0, 1_1, 1_2, 1_3, 1_4, 1_5, 16, 1_7 may form vertical slices of the RxXBAR. Of course, the orientation of the sub-circuits in the logical drawing of FIG. 19-5 may have no logical significance. The choice of sub-circuit shape(s) and/or orientation(s) (e.g., horizontal slice, vertical slice, combination of horizontal slice and vertical slice, mix of horizontal slice and vertical slice, other shapes and/or portion(s), combinations of these, etc.) may optimize the performance of the circuits (e.g., reduce layout parasitic, reduce wiring length, improve maximum operating frequency, reduce coupling parasitic, reduce crosstalk, increase routability, etc.).

In FIG. 19-7, the connections (e.g., wiring, buses, etc.) between sub-circuit 0_0 and TSV array 19-732 may be more optimal in some design metrics (e.g., total net length reduced, etc.) than in FIG. 19-6. In other logic chip die layouts (possibly driven by other stacked memory chip die layouts, etc.) the architecture shown in FIG. 19-6 may provide a more optimal layout for some design metrics. The choice of sub-circuit may then depend on one or more of the following factors (but not limited to the following factors): total wire or bus length, routing complexity, stacked memory chip die layout(s), logic chip die layout(s), timing (e.g., maximum operating frequency, etc.), power, signal integrity (e.g., noise, crosstalk, etc.), combinations of these factors, etc.

### FIG. 19-8

FIG. 19-8 shows a stacked memory package architecture 19-800, in accordance with one embodiment. As an option, the stacked memory package architecture may be implemented in the context of the previous Figures and/or any other Figure(s). As an option, the stacked memory package architecture of FIG. 19-8 may be implemented in the context of FIG. 19-3 and/or any other Figure(s). As an option, for example, one or more portions (e.g., circuit blocks, datapath elements, components, logical functions, etc.) of the stacked memory package architecture of FIG. 19-8 may be implemented in the context of FIG. 15 of U.S. Provisional Application No. 61/580,300, filed Dec. 26, 2011, titled “SYSTEM, METHOD, AND COMPUTER PROGRAM PRODUCT FOR IMPROVING MEMORY SYSTEMS.” Of course, however, the stacked memory package architecture of FIG. 19-8 may be implemented in the context of any desired environment.

In FIG. 19-8, the logic chip may comprise a number of dedicated circuit blocks and a number of shared circuit blocks. For example, the logic chip may include (but not limited to) one or more of the following circuit blocks: IO pad logic (labeled as Pad in FIG. 19-8); deserializer (labeled as DES in FIG. 19-8), which may be part of the physical (PHY) layer; forwarding information base or routing table etc. (labeled as FIB in FIG. 19-8); receiver crossbar (labeled as RxXBAR in FIG. 19-8), which may be connected to the memory regions via one or more memory controllers, receiver arbitration logic (labeled as RxARB in FIG. 19-8), which may also include memory control logic and other logic associated with the memory regions of the stacked memory chips, the through-silicon via connections (labeled as TSV in FIG. 19-8), which may also include repaired or reconfigured TSV arrays for example, stacked memory chips (labeled as DRAM in FIG. 19-8) and associated memory regions (e.g., banks, echelons, sections, etc.), transmit FIFO (labeled as TxFIFO in FIG. 19-8), which may include other protocol logic to associate memory responses with requests, etc, transmit arbiter (labeled as TxARB in FIG. 19-8), receive/transmit crossbar (labeled as RxTxXBAR in FIG. 19-8), which may be coupled to the high-speed serial links that may connect the stacked memory package to the memory system, for example, serializer (labeled as SER in FIG. 19-8), which may be part of the physical (PHY) layer.

It should be noted that not all circuit elements, circuit components, circuit blocks, logical functions, circuit functions, clocking, buses, etc. may be shown explicitly in FIG. 19-8. For example, connections to the DRAM may (and typically will) comprise separate buses for command and data. For example, one or more memory controllers may be considered part of either/both of the circuit blocks labeled RxXBAR and RxARB in FIG. 19-8. Of course many combinations of circuits, buses, datapath elements, logical blocks, etc. may be used to perform the functions logically diagrammed in the DRAM datapath and other parts (e.g., logical functions, circuit blocks, etc.) of FIG. 19-8. For example, the architecture of the DRAM datapaths and DRAM control paths and their functions etc. may be implemented, for example, in the context shown in FIG. 13 and/or FIG. 15, together with the accompanying text, of U.S. Provisional Application No. 61/580,300, filed Dec. 26, 2011, titled “SYSTEM, METHOD, AND COMPUTER PROGRAM PRODUCT FOR IMPROVING MEMORY SYSTEMS.”

In one embodiment, the functions of the FIB and/or RxXBAR and/or RxTxXBAR may be merged, overlapped, shared, or otherwise combined. For example, FIG. 19-8 shows one embodiment in which the FIB function(s), or portion(s) of the FIB function(s), may be performed by address comparison. In FIG. 19-8, the packet routing functions performed by the FIB (e.g., routing table, routing function, etc.) may be performed, for example, by address comparators 19-802 and 19-804.

For example, in FIG. 19-8, address comparator AC3 may receive (e.g., as an input, etc.) a first address or address field (e.g., from an internal logic chip signal, as an address received by the logic chip in a command and stored on the logic chip, programmed in the logic chip, etc.) and compare the first address field with a second address or address field in a received packet (e.g., read request, write request, other requests and/or responses and/or commands, etc). For example, in FIG. 19-8, address comparator AC3 may receive a request packet containing an address field on (e.g., via, etc.) the link, bus, or other connection means 19-820. If the first address field matches (e.g., truthfully compares to, successfully compares to, meets a defined criteria of comparison, etc.) the second address field, then address comparator AC3 may forward the received packet (e.g., AC3 may forward the received packet signal(s), etc.) to MUX 19-810. In FIG. 19-8, for example, the MUX 19-810 may forward (e.g., drive the signals, pass the signals, etc.) the received packet to the outputs. For example, in FIG. 19-8, the received packet gated by AC3 may be driven to the OLink3 output(s), as shown, on (e.g., via, etc.) the link, bus, or other connection means 19-814. For example, in FIG. 19-8, the OLink3 output(s) may be one of the output links that may connect the stacked memory package to other parts (e.g., one or more CPUs, other stacked memory packages, etc.) of the system and other parts of the memory system. For example, the received packet may be a request from a/the CPU in the system and destined for another stacked memory package. For example, the received packet may be a response from another stacked memory packed destined for a/the CPU in the system, etc. The address matching may be performed by various methods, possibly under programmable control. For example, corresponding to (e.g., working with, appropriate for, etc.) the architecture in FIG. 19-8, received packets may contain a two-bit link address field with possible contents: 00, 01, 10, 11. In FIG. 19-8, for example, the address comparator AC0 may be programmed (e.g., receive as input, be connected to a register or other storage means with fixed or programmable contents, etc.) with link address 00. Similarly, address comparator AC1 may be programmed with link address 01, address comparator AC2 may be programmed with link address 10, address comparator AC3 may be programmed with link address 11. Using the above example, address comparator AC3 may compare the first address (e.g., the programmed link address value of 11, etc.) with the second address, e.g., the link address field in the received packet. If the link address field in the received packet is 11, then the received packet may be driven via MUX to the outputs.

In FIG. 19-8, for example, there may be four link address comparators AC0, AC1, AC2, AC3 that may gate (e.g., select signals, determine the value of driven signals, etc.) signals 19-814 to the outputs. Any number of link address comparators may be used to gate signals to the outputs, depending, for example, on factors such as the number of input links and/or output links.

Of course any length (e.g., number of bits, etc.) of link address field may be used, and the length may depend for example on the number of input links and/or output links. Of course any comparison means or comparison functions may be used. For example, comparison(s) may be made to a range of addresses or ranges of addresses.

In FIG. 19-8, received packets (e.g., requests, commands, etc.) may also be routed to the DRAM (or other memory, etc.) or other destination(s) (e.g., logic chip circuits, logic chip memory, logic chip registers, DRAM registers, other control or storage registers, etc.) in a similar or identical fashion to that described above for packets that may be destined for the stacked memory package outputs. In FIG. 19-8, for example, there may be four memory address comparators AC4, AC5, AC6, AC7 that gate signals 19-816 to the DRAM and other logic. In FIG. 19-8, for example, there may be four address comparators AC4, AC5, AC6, AC7 that gate signals 19-816. Any number of memory address comparators may be used, depending, for example, on factors such as the number memory regions, organization of DRAM and/or memory regions (e.g., number of echelons, etc.).

Of course, any length (e.g., number of bits, etc.) of memory address field may be used, and the length may depend for example on the number, size, type, etc. of stacked memory chips, memory regions, etc.

Of course any comparison means or comparison functions may be used. For example, comparison(s) may be made to a range of addresses or ranges of addresses. For example comparison may be made to high order (e.g., most-significant bits, etc.) of the memory address in a request (e.g., read request, write request, etc.). For example, comparison may be made to a range of memory addresses. For example, comparison may be made to one or more sets of ranges of addresses, etc. For example, special (e.g., pre-programmed, programmable at run-time, fixed by design/protocol/standard, etc.) addresses and/or address field(s) may be used for certain functions (e.g., test commands, register and/or mode programming, status requests, error control, etc.).

In FIG. 19-8, for example, memory address comparator AC4 19-808 may gate requests to addresses in memory region MRO. As shown in FIG. 19-8 for example, memory region MRO may comprise DRAM and other logic that may consist of four memory controllers and other logic (e.g., RxARB, TxFIFO, TxARB, etc.). Thus, for example, MRO may itself comprise of multiple memory regions with addresses and/or address ranges that may or may not be contiguous (e.g., continuous address range, address range without breaks or gaps, etc.).

In one embodiment, the addresses and/or address ranges used for comparison may be virtual. For example, one or more DRAM (e.g., DRAM, DRAM portions, memory chips, memory chip portions, stacked memory chips, stacked memory chip portions, DRAM logic or other memory associated logic, TSV or other connections/buses, etc.) may fail or may be faulty. Thus, possibly as a result, one or more of the memory regions in the stacked memory package may fail and/or may be faulty and/or appear to be faulty, etc. (such failures may occur at any time, e.g., at manufacture, at test, at assembly, at run-time, etc.). In case of such faults or failures and/or apparent faults/failures, etc, the logic chip may act (e.g., autonomously, under system direction, under program control, using microcode, a combination of these, etc.) to repair and/or replace the faulty memory regions. In one embodiment, the logic chip may store (e.g., in NVRAM, in flash memory, in portions of one or more stacked memory chips, combinations of these, etc.) the addresses (or other equivalent database information, links, indexes, pointers, start address and lengths, etc.) of the faulty memory regions. The logic chip may then replace (e.g., assign, re-assign, virtualize, etc.) faulty memory regions with spare memory region(s) and/or other resource(s) (e.g., circuits, connections, buses, TSVs, DRAM, etc.). In this case, the system may be unaware that the address supplied, for example, in a received packet, or the address supplied to perform a comparison etc. is a virtual address. The logic chip may then effectively convert the supplied virtual addresses to the actual addresses of one or more memory regions that may include replaced or repaired etc. memory region(s).

Other operations, functions, algorithms, methods, etc. may be used instead of or in addition to comparison. For example, in one embodiment, a single bit in a received packet may be used (e.g., set, etc.) to indicate whether a received packet is destined for the stacked memory package. For example, a command code, header field, packet format, packet length, etc. in/of a received packet may be used to indicate whether a packet must be forwarded or has reached the intended destination. Of course, any length field or number of fields, etc. may be used.

In one embodiment, such indicators and/or indications may be set by a/the CPU in the system or by the responder (or other originator in the system, etc.). Such indicators and/or indications may be transmitted (e.g., hop-by-hop, forwarded, etc.) through the memory system (e.g., through the network, etc.). For example, the system may (e.g., at start-up, etc.) enumerate (e.g., probe, etc.) the memory system (e.g., stacked memory packages, portions of stacked memory packages, other system components, etc.). Each memory system component (e.g., stacked memory package, portion(s) of stacked memory package(s), CPUs, other components, etc.) may then be assigned a unique identification code (e.g., field, group of bits, binary number, label, marker, tag, etc.). The unique identification or other marker etc. may be sent with a packet. A logic chip in a stacked memory package may thus, for example, make a simple comparison with the identification field assigned to itself, etc.

### FIG. 19-9

FIG. 19-9 shows a stacked memory package architecture 19-900, in accordance with one embodiment. As an option, the stacked memory package architecture may be implemented in the context of the previous Figures and/or any other Figure(s). Of course, however, the stacked memory package architecture may be implemented in the context of any desired environment.

In FIG. 19-9, the logic chip may comprise a number of dedicated circuit blocks and a number of shared circuit blocks. For example, the logic chip may include (but not limited to) one or more of the following circuit blocks: IO pad logic (labeled as Pad in FIG. 19-9); deserializer (labeled as DES in FIG. 19-9), which may be part of the physical (PHY) layer; forwarding information base or routing table etc. (labeled as FIB in FIG. 19-9); receiver crossbar (labeled as RxXBAR in FIG. 19-9), which may be connected to the memory regions via one or more memory controllers, receiver arbitration logic (labeled as RxARB in FIG. 19-9), which may also include memory control logic and other logic associated with the memory regions of the stacked memory chips, the through-silicon via connections (labeled as TSV in FIG. 19-9), which may also include repaired or reconfigured TSV arrays for example, stacked memory chips (labeled as DRAM in FIG. 19-9) and associated memory regions (e.g., banks, echelons, sections, etc.), transmit FIFO (labeled as TxFIFO in FIG. 19-9), which may include other protocol logic to associate memory responses with requests, etc, transmit arbiter (labeled as TxARB in FIG. 19-9), receive/transmit crossbar (labeled as RxTxXBAR in FIG. 19-9), which may be coupled to the high-speed serial links that may connect the stacked memory package to the memory system, for example, serializer (labeled as SER in FIG. 19-9), which may be part of the physical (PHY) layer.

It should be noted that not all circuit elements, circuit components, circuit blocks, logical functions, circuit functions, clocking, buses, etc. may be shown explicitly in FIG. 19-9. For example, connections to the DRAM may (and typically will) comprise separate buses for command and data. For example, one or more memory controllers may be considered part of either/both of the circuit blocks labeled RxXBAR and RxARB in FIG. 19-9. Of course many combinations of circuits, buses, datapath elements, logical blocks, etc. may be used to perform the functions logically diagrammed in the DRAM datapath and other parts (e.g., logical functions, circuit blocks, etc.) of FIG. 19-9. For example, the architecture of the DRAM datapaths and DRAM control paths and their functions etc. may be implemented, for example, in the context shown in FIG. 13 and/or FIG. 15, together with the accompanying text, of U.S. Provisional Application No. 61/580,300, filed Dec. 26, 2011, titled “SYSTEM, METHOD, AND COMPUTER PROGRAM PRODUCT FOR IMPROVING MEMORY SYSTEMS.”

In one embodiment, the functions of the FIB and/or DES and/or RxXBAR and/or RxTxXBAR may be merged, overlapped, shared, or otherwise combined. In one embodiment, it may be required to minimize the latency (e.g., delay, routing delay, forwarding delay, etc.) of packets as they may be forwarded through the memory system network that may comprise several stacked memory packages coupled by high-speed serial links, for example. For example, it may be required or desired to minimize the delay between the time a packet that is required (e.g., destined, desired, etc.) to be forwarded (e.g., relayed, etc.) enters (e.g., arrives at the inputs, is received, is input to, etc.) a stacked memory package and the time that the packet exits (e.g., leaves the outputs, is transmitted, is output from, etc.) the stacked memory package. FIG. 19-9 shows one embodiment in which the FIB function(s), or portion(s) of the FIB function(s), for example, may be performed by a field comparison ahead of (e.g., before, preceding, etc.) the deserializer or ahead of a portion of the deserializer. Thus, for example, the latency (e.g., for forwarding packets, etc.) may be reduced. Thus, for example, the power consumption of the stacked memory package and memory system may be reduced (e.g., by eliminating one or more deserialization step(s) and subsequent one or more serialization step(s) of forwarded packets, etc.), etc. In FIG. 19-9, the packet routing functions performed by the FIB (e.g., routing table, routing function, etc.) may be performed, for example, by comparators 19-902.

For example, in FIG. 19-9, comparator FL3 may receive (e.g., as an input, etc.) a first routing field (e.g., from an internal logic chip signal, as a field received by the logic chip in a command and stored on the logic chip, programmed in the logic chip, etc.) and compare the first routing field with a second routing field in a received packet (e.g., read request, write request, other requests and/or responses and/or commands, etc). For example, in FIG. 19-9, comparator FL3 may receive a request packet containing a routing field on (e.g., via, etc.) the link, bus, or other connection means 19-920. If the first routing field matches (e.g., truthfully compares to, successfully compares to, meets a defined criteria of comparison, etc.) the second routing field, then comparator FL3 may forward the received packet (e.g., FL3 may forward the received packet signal(s), etc.) to MUX 19-910. In FIG. 19-9, for example, the MUX 19-910 may forward (e.g., drive the signals, pass the signals, etc.) the received packet to the outputs. For example, in FIG. 19-9, the received packet gated by FL3 may be driven to the OLink3 output(s), as shown, on (e.g., via, etc.) the link, bus, or other connection means 19-914. For example, in FIG. 19-9, the OLink3 output(s) may be one of the output links that may connect the stacked memory package to other parts (e.g., one or more CPUs, other stacked memory packages, etc.) of the system and other parts of the memory system. For example, the received packet may be a request from a/the CPU in the system and destined for another stacked memory package. For example, the received packet may be a response from another stacked memory packed destined for a/the CPU in the system, etc. The routing field matching may be performed by various methods, possibly under programmable control. For example, corresponding to (e.g., working with, appropriate for, etc.) the architecture in FIG. 19-9, received packets may contain a routing field with possible contents: 00, 01, 10, 11. In FIG. 19-9, for example, the comparator FL0 may be programmed (e.g., receive as input, be connected to a register or other storage means with fixed or programmable contents, etc.) with link address 00. Similarly, comparator FL1 may be programmed with 01, comparator FL2 may be programmed with 10, comparator FL3 may be programmed with 11. Using the above example, comparator FL3 may compare the first routing field (e.g., the programmed value of 11, etc.) with the second routing field, e.g., the routing field in the received packet. If the routing field in the received packet is 11, then the received packet may be driven via MUX to the outputs.

In FIG. 19-9, for example, there may be four comparators FL0, FL1, FL2, FL3 that may gate (e.g., select signals, determine the value of driven signals, etc.) signals 19-914 to the outputs. Any number of comparators may be used to gate signals to the outputs, depending, for example, on factors such as the number of input links and/or output links.

Of course, any length (e.g., number of bits, etc.) of routing field may be used, and the length may depend for example on the number of input links and/or output links. Of course any comparison means or comparison functions may be used. For example, comparison(s) may be made to a range (e.g., 1-3, etc.) or to multiple ranges (e.g., 1-3 and 5-7, etc.). Other operations, functions, logical functions, algorithms, methods, etc. may be used instead of or in addition to comparison.

In FIG. 19-9, note that comparators 19-902 may be coupled between (e.g., may be connected between, may be logically located between, etc.) the input PHY (labeled IPHY in FIG. 19-9) and the deserializer 19-924 (labeled DES in FIG. 19-9). In FIG. 19-9, note that comparators 19-902 may drive the output PHY 19-922 (labeled OPHY in FIG. 19-9) directly (e.g., without serialization, etc.). In FIG. 19-9, note that the DRAM and other logic may drive the serializer 19-916 (labeled SER in FIG. 19-9). Other architectures based on FIG. 19-9 may be possible. For example, comparators 19-902 (or other equivalent logic functions or similar logic functions, etc.) may be coupled between portions of the desrializer e.g., some of the deserializer functions or portions of the deserializer and/or associated logical functions and/or operations etc. may be ahead of the comparison or equivalent functions.

As an option, the stacked memory package architecture of FIG. 19-9 may be implemented in the context of the architecture and environment of the previous Figures and/or any subsequent Figure(s). Of course, however, the stacked memory package architecture of FIG. 19-9 may be implemented in the context of any desired environment.

FIG. 19-10A

FIG. 19-10A shows a stacked memory package datapath 19-10A00, in accordance with one embodiment. As an option, the stacked memory package datapath may be implemented in the context of the previous Figures and/or any other Figure(s). Of course, however, the stacked memory package datapath may be implemented in the context of any desired environment.

In FIG. 19-10A, the stacked memory package (SMP) datapath may include (but is not limited to) one or more of the following functions, circuit blocks, logical steps, etc: SerDes (serializer/deserializer), synchronization, encoding/decoding (e.g., 8B/10B, 64B/66B, 64B/67B, other DC balance encoding and decoding schemes, etc.), channel aligner, clock compensation, scrambler/descrambler (e.g., scrambler for Tx, descrambler for Rx, etc), link training and status, link width negotiation (and/or lane width, speed, etc. negotiation, etc.), framer, data link (layer(s), e.g., may be multiple blocks, etc.), transaction (layer(s), e.g., may be multiple blocks, etc.), higher layers (e.g., DRAM and other logic, DRAM datapaths, control paths, other logic, etc.). In one embodiment, most or all of the SMP datapath may be contained in one or more logic chips in the stacked memory package.

For example, in FIG. 19-10A, the architecture of the SMP datapath, and/or Rx datapath, and/or Tx datapath, and/or DRAM datapaths, and/or DRAM control paths, and/or the functions contained in the datapaths and/or control paths and/or other logic, etc. may be implemented, for example, in the context shown in FIG. 19-3 of this application and/or FIG. 13 and/or FIG. 15, together with the accompanying text, of U.S. Provisional Application No. 61/580,300, filed Dec. 26, 2011, titled “SYSTEM, METHOD, AND COMPUTER PROGRAM PRODUCT FOR IMPROVING MEMORY SYSTEMS.”

In FIG. 19-10A, the SMP datapath is compared with (e.g., matched to, aligned with, etc.) the International Organization for Standardization (ISO) Open Systems Interconnection (OSI) model and the Institute of Electrical and Electronics Engineers (IEEE) model (e.g., IEEE 802.3 model, etc.). The SMP datapath may include (but is not limited to) one or more of the following OSI functions, layers, or sublayers, etc: application, presentation, session, transport, network, data link, physical. In one embodiment, the logic chip may contain logic in the network, data link, physical OSI layers, for example. The logic chip(s) in a stacked memory package, and thus the SMP datapath, may include (but is not limited to) one or more of the following IEEE functions, layers, or sublayers, etc: logical link control (LLC), MAC control, media access control (MAC), reconciliation, physical coding sublayer (PCS), forward error correction (FEC), physical medium attachment (PMA), physical medium dependent (PMD), auto-negotiation (AN), medium (e.g., cable, copper, optical, twisted-pair, CAT-5, other, etc.). Not all of the IEEE model elements may be relevant to (e.g., present in, used by, correspond to, etc.) the SMP datapath. For example, auto-negotiation (AN) may not be present in all implementations of the SMP datapath. For example, the IEEE model elements present in the SMP datapath may depend on the type of input(s) and/or output(s) that the SMP may use (e.g., optical, 10Gbit Ethernet, SPI, PCIe, etc.). In one embodiment, the logic chip(s) in a stacked memory package, and thus the SMP datapath, may contain logic in all of the IEEE layers shown in FIG. 19-10A, for example. In one embodiment, a first type of logic chip (e.g., CMOS logic chip, etc.) may perform functions from the LLC to PMA layers and a second type of logic chip (e.g., mixed-signal chip, etc.) may perform the PMD layer (e.g., short-haul optical interconnect, multi-mode fiber PHY, etc.).

### FIG. 19-10B

FIG. 19-10B shows a stacked memory package architecture 19-10B00, in accordance with one embodiment. As an option, the stacked memory package architecture may be implemented in the context of the previous Figures and/or any other Figure(s). Of course, however, the stacked memory package architecture may be implemented in the context of any desired environment.

The circuits, components, functions, etc. shown in FIG. 19-10B may function in a manner similar to that described in the context of similar circuits and components in FIG. 19-3, for example.

For example, in FIG. 19-10B, the architecture of the SMP datapath, and/or Rx datapath, and/or Tx datapath, and/or memory datapath, and/or higher layers(Rx), and/or higher layers(Tx), and/or DRAM datapaths, and/or DRAM control paths, and/or the functions contained in the datapaths and/or control paths and/or other logic, etc. may be implemented, for example, in the context shown in FIG. 19-3 of this application and/or FIG. 13 and/or FIG. 15, together with the accompanying text, of U.S. Provisional Application No. 61/580,300, filed Dec. 26, 2011, titled “SYSTEM, METHOD, AND COMPUTER PROGRAM PRODUCT FOR IMPROVING MEMORY SYSTEMS.”

In FIG. 19-10B, the stacked memory package (SMP) Rx datapath may include (but is not limited to) one or more of the following functions, circuit blocks, logical steps, etc: Rx FIFO, CRC checker, DC balance decoder, Rx state machine, frame synchronizer, descrambler, disparity checker, block synchronizer, Rx gearbox, deserializer (e.g., DES, SerDes, etc.), clock and data recovery (CDR), etc.

In FIG. 19-10B, the stacked memory package (SMP) Tx datapath may include (but is not limited to) one or more of the following functions, circuit blocks, logical steps, etc: Tx FIFO (which may be distinct, separate, etc. from the TxFIFO(DRAM) that may be present in the higher layers, as shown in FIG. 19-10B, for example), frame generator, CRC generator, DC balance encoder, Tx state machine, scrambler, disparity generator, Tx gearbox, serializer (e.g., SER, SerDes, etc.), etc.

In FIG. 19-10B, not all the elements (e.g., components, circuits, blocks, etc) in the Rx datapath and/or Tx datapath may be shown explicitly. For example, certain embodiments of stacked memory package may use physical medium or physical media (e.g., optical, copper, wireless, and/or combinations of these and other coupling means, etc.) that may require additional elements, functions, etc. Thus, for example, there may be additional circuits, circuit blocks, functions, operations, etc. for certain embodiments (e.g., protocol functions; wireless functions; optical functions; protocol conversion or other protocol manipulation functions; additional physical layer and/or data links layer functions; additional LLC, MAC, PCS, FEC, PMA, PMD functions; combinations of these; etc).

In FIG. 19-10B, not all the elements (e.g., components, circuits, blocks, etc) in the Rx datapath and/or Tx datapath may be used in all embodiments. For example, not all embodiments may use a disparity function, etc.

In FIG. 19-10B, not all the elements (e.g., components, circuits, blocks, etc) in the Rx datapath and/or Tx datapath may be exactly as shown. As one example, the position (e.g., logical connection, coupling to other blocks, etc.) of the Tx state machine and/or Rx state machine may not be exactly as shown in FIG. 19-10B in all embodiments. For example, the Tx state machine and/or Rx state machine may receive inputs to more than one block and provide outputs to more than one block, etc.

In FIG. 19-10B, not all the elements (e.g., components, circuits, blocks, etc) in the Rx datapath and/or Tx datapath may be connected exactly as shown in all embodiments. For example, one or more of the logical functions, etc. shown in the Rx datapath and/or Tx datapath in FIG. 19-10B may be performed in a parallel (or nearly parallel, etc.) fashion or manner.

In FIG. 19-10B, the elements (e.g., components, circuits, blocks, etc) used in the Rx datapath and/or Tx datapath and/or their functions etc. may depend on the protocol and/or standard (if any) used for the high-speed serial links or other IO coupling means used by the stacked memory package (e.g., SPI, Ethernet, RapidIO, HyperTransport, PICe, Interlaken, etc.).

In FIG. 19-10B, some of the elements (e.g., components, circuits, blocks, etc) in the Rx datapath and/or Tx datapath may be implemented (e.g., used, instantiated, function, etc.) on a per lane basis and some elements may be common to all lanes. For example, the Rx state machine is a common block, etc. For example, one or more of the following may be used on a per lane basis: Rx gearbox, Tx gearbox, CRC checker, CRC generator, scrambler, descrambler, etc.

In FIG. 19-10B, the Rx FIFO in the Rx datapath may perform clock compensation (e.g., in 10GBASE deleting idles or ordered sets and inserting idles, in PCIe compensating for differences between the upstream transmitter and local receiver, or other compensation in other protocols, etc.). In FIG. 19-10B, the Rx FIFO may provide FIFO empty and FIFO full signals to the higher layers (Rx). In some embodiments, the Rx FIFO may use separate FIFO read and FIFO write clocks, and the Rx FIFO may compensate for differences in these clocks. In some embodiments, the Rx FIFO input bus width may be different from the output bus width (e.g., input bus width may be 32 bits, output bus width may be 64 bits, etc.).

In FIG. 19-10B, the CRC checker may calculate a cyclic redundancy check (CRC) using the received data and compares the result to the CRC value (e.g., in the received packet, in a diagnostic word, etc). In some embodiments, the CRC checker may perform additional functions. For example, in Interlaken-based protocols, the CRC-32 checker may also output the lane status message (at bit 33) and link status message (at bit 32) of the diagnostic word. The CRC checker may output a CRC error signal that may be sent to the higher layers (Rx). The CRC checker may use a standard polynomial (e.g., CRC-32, etc.) or non-standard polynomial. The CRC checker may use a fixed or programmable polynomial. Of course, any error protection, error correction, error detection, etc. scheme or schemes (e.g., CRC, other error checking code, hash, etc.) may be used. Such schemes may be fixed, programmable, configurable, etc.

In FIG. 19-10B, the DC balance decoder may implement (e.g., perform, calculate, etc.) 64B/66B decoding, for example (e.g., as specified in Clause 49 of the IEEE802.3-2008 specification, etc.). Of course any standard decoding scheme (e.g., 8B/10B, 64B/67B, etc.) or non-standard decoding scheme, etc. may be used. Such decoding schemes may be fixed, programmable, configurable, etc.

In FIG. 19-10B, the Rx state machine may perform control functions in the Rx logic (e.g., PCS layer, PCS blocks, etc.) to implement link synchronization (e.g., PCIe, etc.) and/or control functions for the Rx datapath logic in general (e.g., monitoring bit-error rate (BER), handling of error conditions, etc.). Error conditions that may be handled by the Rx state machine may include (but are not limited to) one or more of the following: loss of word boundary synchronization, invalid scrambler state, lane alignment failure, CRC error, flow control error, unknown control word, illegal codeword, etc. The Rx state machine may be programmable (e.g., using microcode, etc.).

In FIG. 19-10B, the frame synchronizer may perform frame lock functions (e.g., in Interlaken-based protocols, etc.). For example, the frame synchronizer may implement (e.g., perform, etc.) frame lock by searching for four synchronization control words in four consecutive Interlaken metaframes. After frame synchronization is achieved, the frame synchronizer may monitor the scrambler word in the received metaframes and may signal frame lock loss after three consecutive mismatches or four invalid synchronization words. After frame lock loss, the synchronization algorithm and process may be re-started. The frame synchronizer may signal frame lock status to the higher layers (Rx).

In FIG. 19-10B, the descrambler may operate in one or more modes (e.g., frame synchronous mode for Interlaken-based protocols, self-synchronous mode for IEEE 802.3 protocols, etc.). For example, in frame synchronous mode, the descrambler may uses the scrambler seed from the received scrambler state word once block synchronization is achieved. The descrambler may forward the current descrambler state to the frame synchronizer. For example, in self-synchronous mode the scrambler state may be a function of the received data stream and the scrambler state may be recovered after the number of bits equal to the length of the scrambler (e.g., 58 bits, etc.) are received.

In FIG. 19-10B, the disparity checker may be implemented for some protocols (e.g., Interlaken-based protocols, etc.). For example, in Interlaken-based protocols, the disparity checker may check the framing bit in bit position 66 of the word that may enable the disparity checker to identify whether bits for that word are inverted. Other similar algorithms and/or checked schemes may be used. Such algorithms may be fixed, programmable, configurable, etc.

In FIG. 19-10B, the block synchronizer may initiate and maintain a word boundary lock. The block synchronizer may implement, for example, the flow diagram shown in FIG. 13 of Interlaken Protocol Definition v1.2. For example, using an Interlaken-based protocol, the block synchronizer may search for valid synchronization header bits within the serial data stream. A word boundary lock may be achieved after 64 consecutive legal synchronization patterns are found. After a word boundary lock is achieved, the block synchronizer may monitor and flag invalid synchronization header bits. If 16 or more invalid synchronization header bits are found within 64 consecutive word boundaries, the block synchronizer may signal loss of lock. After word boundary lock loss, the synchronization algorithm and process may be re-started. The block synchronizer may signal word boundary lock status to the higher layers (Rx). The synchronizer and/or synchronization algorithms, schemes, etc. may be programmable, configurable, etc.

In FIG. 19-10B, the Rx gearbox may interface the PMA and PMD/PCS blocks.

In FIG. 19-10B, the deserializer (e.g., DES, SerDes, etc.) may receive serial input data from a buffer in the CDR block using the recovered serial clock (e.g., high-speed clock, etc.) and convert, for example, 8 bits at a time (e.g., using the parallel recovered clock, low-speed clock, etc.) to a parallel bus forwarded to the PCS blocks (e.g., Rx gearbox and above, etc.). The deserializer may deserialize a fixed number, a programmable number, or variable number of bits (e.g., 8, 10, 16, 20, 32, 40, 128, etc.). The deserializer and deserializer functions may be fixed, programmable, configurable, etc.

In FIG. 19-10B, the clock and data recovery (CDR) may recover the clock from the input (e.g., received, etc.) serial data. The CDR outputs may include the serial recovered clock (e.g., high-speed, etc.) and the parallel recovered clock (e.g., low-speed, etc.) that may be used to clock (e.g., as clock inputs for, etc.) one or more receiver blocks (e.g., PMA and PCS blocks, etc.). The CDR or equivalent function(s) may be fixed, programmable, configurable, etc.

In FIG. 19-10B, the Tx FIFO in the Tx datapath may implement an interface between the higher layers (Tx) and the transmitter datapath blocks (e.g., PCS layer blocks, etc.). In some embodiments, the Tx FIFO may use separate FIFO read and FIFO write clocks, and the Tx FIFO may compensate for differences in these clocks. In some embodiments, the Tx FIFO input bus width may be different from the output bus width (e.g., input bus width may be 64 bits, output bus width may be 32 bits, etc.). The Tx FIFO or equivalent function(s) may be fixed, programmable, configurable, etc.

In FIG. 19-10B, the frame generator (e.g., framer, etc.) may perform one or more functions to map the transmit data stream to one or more frames. For example, in Interlaken-based protocols, the frame generator may map the transmit data stream to metaframes. The metaframe length may be programmable from 5 to a maximum value of 8191, 8-byte (64-bit) words. The frame generator may generate the required skip words with every metaframe following the scrambler state word in order to perform clock rate compensation. The frame generator may generate additional skip words based on the Tx FIFO state (e.g., capacity, etc.). The frame synchronizer may forward the skip words it receives in order other blocks may maintain multi-lane deskew alignment. The frame generator, framer, etc. and/or frame generation algorithms, schemes, etc. may be programmable, configurable, etc.

In FIG. 19-10B, the CRC generator may calculate (e.g., generate, output, etc.) a cyclic redundancy check (CRC) using the transmit data. The data fields, range of data, data words, block size, etc. of the transmit data used to calculate the CRC may be fixed or programmable. The polynomial used to calculate the CRC may be fixed or programmable. The polynomial used to calculate the CRC may be standard (e.g., CRC-32, etc.) or non-standard. For example, the CRC-32 generator may calculate the CRC for a metaframe. In some cases the CRC may be inserted in a special word. For example, the CRC may be added to the diagnostic word of a metaframe in an Interlaken-based protocol. The CRC generator, other error code generators, etc. and/or error code generation algorithms, schemes, etc. may be programmable, configurable, etc.

In FIG. 19-10B, the DC balance encoder may be, for example, a standard (e.g., IEEE standard, ISO standard, etc.) 64B/66B encoder that may receive a 64-bit data input stream from the Tx FIFO and may output a 66-bit encoded data output stream. The 66-bit encoded data output stream may contain two overhead synchronization header bits (e.g., preambles, etc.) that the receiver PCS blocks may use (e.g., for block synchronization, bit-error rate (BER) monitoring, etc.). The 64B/66B encoding may also perform one or more other functions (e.g., create sufficient edge transitions in the serial data stream for the Rx clock data recovery (CDR) circuit block to maintain lock (e.g., achieve clock recovery, maintain phase lock, etc.) on the input serial data, reduce noise (e.g., EMI, etc.), delineate (e.g., mark, etc.) word boundaries, etc.). Other encoding schemes (standard, non-standard, etc.) may also be used by the DC balance encoder. Such encoding schemes may be programmable and/or configurable.

In FIG. 19-10B, the Tx state machine may perform control functions in the Tx logic (e.g., PCS layer, PCS blocks, etc.) and/or control functions for the Tx datapath logic in general (e.g., handling of error conditions, etc.). The Tx state machine may be programmable (e.g., using microcode, etc.).

In FIG. 19-10B, the scrambler may function to reduce noise (e.g., EMI, etc.) by reducing (e.g., eliminating, shortening, etc.) long sequences of zeros or ones and other of data pattern repetition in the data stream. The scrambler may operate in one or more modes (e.g., frame synchronous mode for Interlaken-based protocols, self-synchronous mode for IEEE 802.3 protocols, etc.). The scrambler may use a fixed or programmable polynomial (e.g., x\hat{ }58+x\hat{ }39+1 for Interlaken-based protocols, etc.). The scrambler, and/or other equivalent function(s), etc. and/or scrambling algorithms, schemes, etc. may be programmable, configurable, etc.

In FIG. 19-10B, the disparity generator may be implemented for some protocols (e.g., Interlaken-based protocols, etc.). For example, in Interlaken-based protocols, the disparity generator may invert the sense of bits in each transmitted word to maintain a running disparity within a fixed bound (e.g., ±96 bit for Interlaken-based protocols, etc.). The disparity generator outputs a framing bit in bit position 66 of the word that may enable the disparity checker to identify whether bits for that word are inverted. The disparity generator, and/or other equivalent function(s), etc. and/or disparity algorithms, schemes, etc. may be programmable, configurable, etc.

In FIG. 19-10B, the Tx gearbox may interface the PMA and PMD/PCS blocks.

In FIG. 19-10B, the serializer may convert the input low-speed parallel transmit data stream from the Tx dapath logic (e.g., PCS layer, etc.) to high-speed serial data output. The serializer may send the high-speed serial data output to the IO transmitter buffer (not shown in FIG. 19-10B). The serializer may support a fixed, a programmable number, or a variable serialization factor (e.g., 8, 10, 16, 20, 32, 40, 128, etc.). In some embodiments, the serializer may be programmed to send LSB first or MSB first. In some embodiments, the serializer may be programmed to perform polarity inversion (e.g., allowing differential signals on a link to be swapped, etc.). In some embodiments, the serializer may be programmed to perform bit reversal (e.g., MSB to LSB, 8-bit swizzle, etc.). The serializer and serializer functions may be fixed, programmable, configurable, etc. and may be linked (e.g., matched with, complement, invert, etc.) the deserializer and deserializer functions.

In FIG. 19-10B, the Rx datapath latency 19-10B10 (e.g., time delay, packet delay, etc.) may be t1 (e.g., delay of all blocks in the signal path from the input pads to the Rx FIFO output). In FIG. 19-10B, the DRAM and other logic latency 19-10B12 may be t2 (e.g., delay of all blocks in the signal path from the Rx FIFO output to the Tx FIFO input). In FIG. 19-10B, the Tx datapath latency 19-10B14 may be t3 (e.g., delay of all blocks in the signal path from the Tx FIFO input to the output pads).

In FIG. 19-10B, the architecture of the Rx datapath and/or Tx datapath may conform to (e.g., adhere to, follow, obey, etc.) standard high-speed models (e.g., OSI model, IEEE model, etc.). For example, the architecture of the Rx datapath and Tx datapath may follow the models shown in the context of FIG. 19-10A for example. Thus, embodiments that may be based on the architecture of FIG. 19-10B, for example, may be implemented (e.g., utilize, employ, etc.) standard solutions (e.g., off-the-shelf libraries, standard IP blocks, third-party IP, standard macros, library functions, circuit block generators, etc.) for implementations (e.g., ASIC, FPGA, custom IC, other integrated circuit(s), combinations of these, etc.) of one or more logic chips in the stacked memory package, etc.

### FIG. 19-10C

FIG. 19-10C shows a stacked memory package architecture 19-10C00, in accordance with one embodiment. As an option, the stacked memory package architecture may be implemented in the context of the previous Figures and/or any other Figure(s). Of course, however, the stacked memory package architecture may be implemented in the context of any desired environment.

The circuits, components, functions, etc. shown in FIG. 19-10C may function in a manner similar to that described in the context of similar circuits and components in FIG. 19-3 and/or FIG. 19-10B, for example.

For example, in FIG. 19-10C, the architecture of the SMP datapath 19-10C00, and/or Rx datapath 19-10C40, and/or Tx datapath 19-10C42, and/or higher layers(Rx), and/or higher layers(Tx), and/or DRAM datapaths, and/or DRAM control paths, and/or the functions contained in the datapaths and/or control paths and/or other logic, etc. may be implemented, for example, in the context shown in FIG. 19-3 of this application and/or FIG. 13 and/or FIG. 15, together with the accompanying text, of U.S. Provisional Application No. 61/580,300, filed Dec. 26, 2011, titled “SYSTEM, METHOD, AND COMPUTER PROGRAM PRODUCT FOR IMPROVING MEMORY SYSTEMS.”

In FIG. 19-10C, the function of the FIB block may be to route (e.g., forward, etc.) packets (e.g., requests, responses, etc.) that are not destined for the stacked memory package to the output circuits. In a memory system it may be critical to reduce the latency of the memory system response. Thus, it may be desired, for example, to reduce the latency required for a stacked memory package to forward a packet not destined for itself. Thus, it may be desired, for example, to minimize the latency (e.g., signal delay, timing delay, etc.) of the logical path in FIG. 19-10C from the input pads (labeled I[0:15] in FIG. 19-10C), through the deserializer (labeled DES in FIG. 19-10C), through the forwarding information base or routing table (labeled FIB in FIG. 19-10C), through the RxTx crossbar (labeled RxTxXBAR in FIG. 19-10C), through the serializer (labeled SER in FIG. 19-10C), to the output pads (labeled O[0:15] in FIG. 19-10C).

In FIG. 19-10C, the packet forwarding latency may typically comprise the following components: (1) the Rx datapath latency (measured from input pad to Rx FIFO output); (2) the latency (e.g., delay) of the logic path or portion of the logic path 19-10C20 that may implement the FIB and RxTxXBAR function(s) (e.g., possibly as part of the higher layers (Rx) and/or higher layers (Tx) blocks shown in FIG. 19-10C; (3) the Tx datapath latency (measured from the input of the TX FIFO to the output pads).

In one embodiment, the packet forwarding latency may be reduced by introducing one or more paths between the Rx datapath and Tx datapath. These paths may be fast paths, short circuits, short cuts, bypasses, cut throughs, etc.

For example, in one embodiment a fast path 19-10C22 may be implemented between the Rx FIFO and Tx FIFO. The fast path logic may detect a packet that is destined to be forwarded (as described in the context of FIG. 8 and/or FIG. 9, for example) and inject the packet data into the Tx datapath. The fast path logic may also match clock domains between the Rx datapath and Tx datapath.

For example, in one embodiment a fast path 19-10C24 may be implemented between the CRC checker and the CRC generator. The fast path logic may also match clock domains between the Rx datapath and Tx datapath.

In one embodiment a fast path 19-10C26 may be implemented between the Rx state machine and Tx state machine. The fast path logic may also match clock domains between the Rx datapath and Tx datapath.

In one embodiment a fast path 19-10C24 may be implemented between the descrambler and scrambler. The fast path logic may also match clock domains between the Rx datapath and Tx datapath.

In one embodiment a fast path 19-10C24 may be implemented between the deserializer and serializer. The fast path logic may also match clock domains between the Rx datapath and Tx datapath.

The implementation of a fast path may depend on the latency required. For example, the latencies of the various circuit blocks, functions, etc. in the Rx datapath and Tx datapath may be measured (e.g., at design time, etc.) and the optimum location of one or more fast paths may be decided based on trade-offs such as (but not limited to): die area, power, complexity, testing, yield, cost, etc.

The implementation of a fast path may depend on the protocol used. For example, the use of a standard protocol (e.g., SPI, HyperTransport, PCIe, QPI, Interlaken, etc.) or a non-standard protocol based on a standard protocol, etc. may impose limitations (e.g., restrictions, boundary conditions, requirements, etc.) on the location of the fast path and/or logic required to implement the fast path. For example, some of the fast paths may bypass the CRC checker and CRC generator. Both CRC checker and CRC generator may be bypassed if the CRC is calculated over the packet to be forwarded. For example, packets may be fixed in length and a multiple of the CRC payload. For example, packets may be padded to a multiple of the CRC payload, etc. For example, if the CRC generator function in the Tx datapath cannot be bypassed, the CRC generator in the Tx datapath may still be bypassed, for example, by implementing a separate (e.g., second, possibly faster) CRC generator circuit block dedicated to the fast path and to forwarded packets.

Of course, other fast paths may be implemented in a similar fashion.

Of course, more than one fast path may be implemented. In one embodiment, for example, one or more fast paths may be enabled (e.g., selected, etc.) under programmable control.

### FIG. 19-10D

FIG. 19-10D shows a latency chart for a stacked memory package 19-10D00, in accordance with one embodiment. As an option, the latency chart for a stacked memory package may be implemented in the context of the previous Figures and/or any other Figure(s). Of course, however, the latency chart for a stacked memory package may be implemented in the context of any desired environment.

The chart of FIG. 19-10D may apply, for example, in the context of the stacked memory package architecture of FIG. 19-10C. The chart or graph shows the cumulative latency (e.g., timing delay, etc.) of packets, packet signals, etc. as a function of the circuit block position. For example the total latency of a stacked memory package from input pad to output pad may be t1, as shown in FIG. 19-10D by label 19-10D10. The latency t1 may be the sum of three parts: (1) the latency of the Rx datapath (as shown by curve portion or path 19-10D20); (2) the latency of the memory datapath (as shown by straight line 19-10D14); (3) the latency of the Tx datapath (as shown by curve portion or path 19-10D22). The latency properties of a fast path may be easily discerned from such a chart. For example, the latency of fast path 19-10C26 in FIG. 19-10C may be t2, as shown in FIG. 19-10D by label 19-10D12. The latency t2 may be the sum of the following parts: (1) the latency of a portion of the Rx datapath from input pad (e.g., including CDR) up to and including the Rx state machine (as shown by a part of curve portion or path 19-10D20); (2) the latency of any fast path logic e.g., timing adjustment between clock domains, etc. as shown by the dashed line 19-10D18); (3) the latency of a portion of the Tx datapath from the input of the Tx state machine to output pad (e.g., including serializer) and as shown by curve portion or path 19-10D24.

Use of charts such as that shown in FIG. 19-10D00 may allow the design of the SMP datapath and fast paths. In particular the use of such charts may allow the design of fast paths that may eliminate circuit blocks that have large latency (e.g., the Rx FIFO in the Rx datapath and/or Tx FIFO in the Tx datapath). The use of such charts may allow the design of fast paths that may eliminate circuit blocks that have large variations in latency (e.g., the Rx FIFO in the Rx datapath and/or Tx FIFO in the Tx datapath).

As an option, the latency chart for a stacked memory package of FIG. 19-10D may be implemented in the context of the architecture and environment of the previous Figures and/or any subsequent Figure(s). Of course, however, the latency chart for a stacked memory package of FIG. 19-10D may be implemented in the context of any desired environment.

### FIG. 19-11

FIG. 19-11 shows a stacked memory package datapath 19-1100, in accordance with one embodiment. As an option, the stacked memory package datapath may be implemented in the context of the previous Figures and/or any other Figure(s). Of course, however, the stacked memory package datapath may be implemented in the context of any desired environment.

For example, in FIG. 19-10A, the architecture of the SMP datapath, and/or Rx datapath, and/or Tx datapath, and/or DRAM datapaths, and/or DRAM control paths, and/or the functions contained in the datapaths and/or control paths and/or other logic, etc. may be implemented, for example, in the context shown in FIG. 19-3 and/or FIG. 19-10C of this application and/or FIG. 13 and/or FIG. 15, together with the accompanying text, of U.S. Provisional Application No. 61/580,300, filed Dec. 26, 2011, titled “SYSTEM, METHOD, AND COMPUTER PROGRAM PRODUCT FOR IMPROVING MEMORY SYSTEMS.”

FIG. 19-11 shows the architecture for a stacked memory package datapath including fast paths. In FIG. 19-11 circuit blocks 19-11B20 may gate the fast paths. For example, circuit block AC0 may function as an address comparator, as described in the context of FIG. 19-8, for example. Address registers 19-11B22 may provide an address to be matched (e.g., compared, etc.). The address registers may be loaded via the Rx datapath, for example, under program control. In one embodiment, the address comparator may also adjust (e.g., re-time, compensate for, etc.) timing between clock domains. For example, in FIG. 19-11, the Rx datapath may be driven by the low-speed (e.g., parallel, etc.) recovered clock and the high-speed recovered serial clock; the Tx datapath may be driven by the core parallel clock and core serial clock.

### FIG. 19-12

FIG. 19-12 shows a memory system using virtual channels 19-1200, in accordance with one embodiment. As an option, the memory system may be implemented in the context of the previous Figures and/or any other Figure(s). Of course, however, the memory system may be implemented in the context of any desired environment.

For example, in FIG. 19-12, the memory system etc. may be implemented, for example, in the context shown in FIG. 16, together with the accompanying text, of U.S. Provisional Application No. 61/569,107, filed Dec. 9, 2011, titled “SYSTEM, METHOD, AND COMPUTER PROGRAM PRODUCT FOR IMPROVING MEMORY SYSTEMS”.

In FIG. 19-12, the stacked memory packages and other memory system components etc. may be connected (e.g., linked, coupled, etc.) using one or more virtual channels. A virtual channel, for example, may allows more than one channel to be transmitted (e.g., connected, coupled, etc.) on a link. For example, in FIG. 19-21 two example virtual channels are shown. In FIG. 19-12 a first virtual channel may connect CPU0 with system component SC1. The first virtual channel may comprise the following segments (e.g., lanes, links, connections, buses, combinations of these and/or other connection means, etc.): (1) link 19-1212, (2) link 19-1236, (3) link 19-1226, (4) link 19-1232 (e.g., all outbound to the memory system), (5) link 19-1234, (6) link 19-1224, (7) link 19-1238, (8) link 19-1214 (e.g., all inbound from the memory system). Each link may comprise multiple lanes. Each link may have different numbers of lanes. The second virtual channel may comprise the following segments (e.g., lanes, links, connections, buses, combinations of these and/or other connection means, etc.): (1) link 19-1210, (2) link 19-1228 (e.g., all outbound to the memory system), (3) links 19-1218 and 19-1220, (4) link 19-1216 (e.g., all inbound from the memory system). Note that the second virtual channel may have one segment with two links.

Note that, although not shown in FIG. 19-12 for clarity, any link or set (e.g., group, etc.) of links may contain (e.g., carry, hold, etc.) more than one virtual channel. Each virtual channel may connect (e.g., couple, etc.) different endpoints, etc. Of course any number, type, arrangement of channels, virtual channels, virtual path(s), virtual links, virtual lanes, virtual circuit(s), etc. may be used.

In one embodiment, the number of links and/or the number of lanes in a link and/or the number of virtual channels used to connect system components may be fixed or varied (e.g., programmable at any time, etc.). For example, traffic in the memory system may be asymmetric with more read traffic than write traffic. Thus, for example, the connection between SMP3 and SMP0 (e.g., carrying read traffic, etc.) in the second virtual channel may be programmed to comprise two links, etc.

In one embodiment, the protocol used for one or more high-speed serial links may support virtual channels. For example, the number of the virtual channel may be contained in a field as part of a packet header, part of a control word, etc. In one embodiment the virtual channel may be used to create one or more fast paths, as described, for example, in the context of FIG. 19-10C and/or FIG. 19-11. The virtual channel number, for example, may be used as an address field and compared with a programmed address field, as described in the context of FIG. 19-8 and/or FIG. 19-11, for example.

As an option, the memory system of FIG. 19-12 may be implemented in the context of the architecture and environment of the previous Figures and/or any subsequent Figure(s). Of course, however, the memory system of FIG. 19-12 may be implemented in the context of any desired environment.

### FIG. 19-13

FIG. 19-13 shows a memory error correction scheme 19-1300, in accordance with one embodiment. As an option, the memory error correction scheme may be implemented in the context of FIG. 19-13 and/or any other Figure(s). Of course, however, the memory error correction scheme may be implemented in the context of any desired environment including any type (e.g., technology, etc.) of memory.

For example, in FIG. 19-13, the memory error correction scheme may be implemented, for example, in the context shown in FIG. 4, together with the accompanying text, of U.S. Provisional Application No. 61/580,300, filed Dec. 26, 2011, titled “SYSTEM, METHOD, AND COMPUTER PROGRAM PRODUCT FOR IMPROVING MEMORY SYSTEMS.”

In FIG. 19-13, a first memory region may comprise cells 0-63 organized in columns C0-C7 and rows R0-R7, as shown. The first memory region may have one or more associated spare (e.g., redundant, etc.) second memory regions. In FIG. 13, for example, the one or more spare second memory regions may be organized, for example, as columns C8, C9 and rows SO, Sl. Any number, organization, size of spare second memory regions may be used. In one embodiment, the spare second memory regions may be part of the same bank as the first memory regions and may share the same support logic (e.g., sense amplifiers, row decoders, column decoders, etc.) as the first memory regions. In one embodiment, the spare second memory regions may be part of the same bank as the first memory regions and may have some or all of the support logic (e.g., sense amplifiers, row decoders, column decoders, etc.) may be dedicated and separate from (e.g., distinct from, capable of operating separately from, capable of operating in parallel with, etc.) the first memory regions.

In one embodiment, for example, the spare regions may be used for flexible and/or programmable error protection. In one embodiment, one or more of the spare second memory regions may be used to store one or more error correction codes. For example, column C8 may be used for parity (e.g., over data stored in a row, columns C0-C3, etc.). Parity may be odd or even, etc. For example, column C9 may be used for parity (e.g., over C4-C7, etc.). Other schemes may be used. For example, C8 may be used for parity for odd columns and C9 for even columns, etc. For example columns C8, C9 may be used to store an ECC code (e.g., SECDED, etc.) for columns C0-C7, etc. Any codes and/or coding schemes may be used (e.g., parity, CRC, ECC, SECDED, LDPC, Hamming, Reed-Solomon, hash functions, combinations of these and other schemes, etc.) depending on the size and organization of the memory region(s) to be protected, the error protection required (e.g., strength of protection, correction capabilities, detection capabilities, complexity, etc.) and spare memory region(s) available (e.g., number of regions, size of regions, organization of regions, etc.).

For example, when R1 is read with data in columns C0-C7 and error code(s) in C8-C9 an error may occur in cell 05, as shown in FIG. 19-13. This error may be detected by the error code information in columns C8 and/or C9.

More than one error correction scheme may be used to increase error protection. For example, in one embodiment, the spare second memory regions may be organized into more than one error correction regions. For example, in FIG. 19-13, spare rows S0, S1 may be used to store parity information over columns C0-C9. For example, the cell in the first column of row S0 may store parity information for column C0, rows R0-R3. For example, the cell in the first column of row S1 may store parity information for column C0, rows R4-R7. The error code information in rows S0-S1 may be updated each time a row R0-R7 is accessed. The error code information update may occur using a simple XOR if the error codes are based on parity, etc. The updates may occur at the same time (or at nearly the same time, pipelined, etc.) as the accesses to rows R0-R7 depending on the nature and amount of support logic (e.g., sense amplifiers, row decoders, column decoders, etc.) used by rows R0-R7 and rows S0-S1, etc. For example, when more than one error occurs in a row, the error code information in C8, C9 may fail (e.g., be unable to detect and/or correct the errors, etc.). In this case, error codes in rows S0-S1 may be read and errors corrected with the additional error coding information from row S0 and/or S1. Of course, any error coding scheme (e.g., codes, error detection scheme, error correction scheme, etc.) may be used with any number, size, organization of the more than one error correction regions.

In one embodiment, the error protection scheme may be dynamic. For example, in FIG. 19-13, at an initial first time (e.g., at start-up, etc.) the error protection scheme may be as described above with columns C8, C9 providing parity coverage for rows R0-R7 and rows S0, S1 providing parity coverage for columns C0-C9. At a later second time, for example, a portion of a memory region may fail. For example, row R1 may fail (or reach a programmed error threshold, etc.) and may need to be replaced with a spare row. For example, spare row S0 may be used to replace faulty row R1, etc. At a later third time, the error scheme may now be changed. For example, spare row Si may now be used as parity for rows R0, R2-R7, SO (e.g., SO has replaced faulty row RI). In one embodiment, a similar or identical scheme to that just described may be used to alter error protection schemes as a result of faulty memory regions or portion(s) of faulty memory regions detected and/or replaced at manufacture time, assembly time, during or after test, etc. In one embodiment, periodic characterization and/or testing and/or scrubbing, etc. during run time may result in a dynamic change in error protection schemes, etc.

In one embodiment, spare memory regions may be temporarily used to increase the error coverage of a memory region in which one or more memory errors have occurred, or a (possibly programmable) threshold, etc. of memory errors have occurred, etc. For example, error coding may be increased from a first level of parity coverage of a memory region to include a second level of coverage e.g., ECC coverage or other more effective (e.g., more effective than parity, etc.) coverage of the memory region (e.g., with coding by row, by column, by combinations of both, by other region shapes, etc.). The logic chip, for example, may scan (e.g., either autonomously or under system and/or program control, etc.) the affected memory region (e.g., the memory region where the error(s) have occurred, etc.) and create the error codes for the higher (e.g., second, third, etc.) level of error coverage. After scanning is complete a repair and/or replacement step etc. may be scheduled to cause the affected memory to be copied to a spare or redundant area, for example (with operations performed either autonomously by the logic chip, for example, or under system and/or program control, etc.). In any scheme, the locations of the affected memory regions and replacement memory regions may, for example, be stored by the logic chip (e.g., using indexes, tables, indexed tables, linked lists, etc. stored in non-volatile memory, etc.).

The use of redundant or spare memory regions may be extended to provide error coverage of columns in addition to rows. The use of redundant or spare memory regions may be further extended to cover groups of columns in addition to groups of rows. In this way the occurrence of errors may be quickly determined, since this check is performed for every read. However errors occur relatively infrequently in normal operation. Thus, there it may be possible to take a much longer time to determine the exact location (number of errors, cells in error, etc.) and nature of the error(s) using combinations (e.g., nested, etc.) of error coding and error codes stored in one or more redundant memory regions. For example, if the memory uses a split request and response protocol then the responses for accesses with errors that take longer to correct may simply be delayed with respect to accesses with no errors and/or accesses with errors that may be corrected quickly (e.g., on the fly, etc.).

In one embodiment, the types of codes, arrangement of spare memory regions, locations of codes, length of codes, etc. may be fixed or programmable (e.g., at design time, at manufacture, at test, at start-up, during operation, etc.).

### FIG. 19-14

FIG. 19-14 shows a stacked memory package using DBI bit for parity 19-1400, in accordance with one embodiment. As an option, the stacked memory package using DBI bit for parity may be implemented in the context of the previous Figures and/or any other Figure(s). Of course, however, the stacked memory package using DBI bit for parity may be implemented in the context of any desired environment.

In FIG. 19-14a, a DRAM chip (e.g., die, etc.) 19-1412 may be connected to CPU 19-1410 using a bus 19-1414 with a dynamic bus inversion (DBI) capability with DBI information carried on a signal line 19-1416. The DBI bit may protect one or more data buses or portions of one or more buses (e.g., reduce noise, etc.).

In FIG. 19-14b, a stacked memory package 19-1422 may use one or more DRAM die based on (e.g., designed from the same database, derived from, etc.) the DRAM die design shown in FIG. 19-14a. The stacked memory package SMP0 may be connected to CPU 19-1420 using one or more serial links 19-1424. The serial links may not require a separate DBI signal line. The DRAM die used in the stacked memory package may use the resources (e.g., extra signal line, wiring, circuit space, etc.) for parity or other error protection information etc. that may be more suited to the stacked memory package environment, etc.

FIG. 19-15

FIG. 19-5 shows a method of stacked memory package manufacture 19-1500, in accordance with one embodiment. As an option, the method of stacked memory package manufacture may be implemented in the context of the previous Figures and/or any other Figure(s). Of course, however, the method of stacked memory package manufacture may be implemented in the context of any desired environment.

In FIG. 19-15a, the stacked memory package 19-1514 may be capable of providing 32 bits in some manner of access (e.g., an echelon may be 32 bits in width etc.). In FIG. 19-15a, the stacked memory package may be manufactured from two stacked memory chips each of which may be capable of providing 16 bits, etc. In FIG. 19-16a, a logic chip in the stacked memory package (not shown explicitly in FIG. 19-16a) may, for example, perform some or all of the functions necessary to aggregate (or otherwise combine, etc.) outputs from stacked memory chip 19-510 and stacked memory chip 19-512 so that stacked memory package 19-1514 may be capable of providing 32 bits in some manner of access.

In FIG. 19-15b, the stacked memory package 19-1524 may be capable of providing 32 bits in some manner of access (e.g., an echelon may be 32 bits in width etc.). In FIG. 19-15b, the stacked memory package may be manufactured from three stacked memory chips as shown. A first type of stacked memory chip may be capable of providing 16 bits, etc. A second type of stacked memory chip may be capable of providing 8 bits, etc. In FIG. 19-15b, the stacked memory package may be manufactured from one stacked memory chip of the first type and two stacked memory chips of the second type, as shown. In FIG. 19-16b, a logic chip in the stacked memory package (not shown explicitly in FIG. 19-16b) may, for example, perform some or all of the functions necessary to aggregate (or otherwise combine, etc.) outputs from stacked memory chip 19-520, stacked memory chip 19-522, and stacked memory chip 19-526 so that stacked memory package 19-1514 may be capable of providing 32 bits in some manner of access.

For example, the yield (e.g., during manufacture, test, etc.) of the stacked memory chips of the first type may be such that some chips may be faulty or appear to be faulty (e.g., due to faulty connections, etc.). Some of these faulty chips may be converted (e.g., by programming, etc.) so that they may appear as stacked memory chips of the second type. Thus, for example, there may be cost savings in assembling such converted chips for use in a stacked memory package.

Thus, in one embodiment, of a first type of stacked memory chip, the stacked memory chip may be operable to be converted to a second type of stacked memory chip.

In one embodiment, the conversion operation may be as shown in FIG. 19-15b in order to convert a chip with an access of one number of bits to an access with a different number of bits.

In one embodiment, a conversion operation may convert any aspect or aspects of stacked memory chip appearance, operation, function, behavior, parameter, etc. For example, one or more resource that allow operation of circuits in parallel (and thus faster e.g., pipelined etc.) may be faulty (e.g., after test, etc.). In this case, the conversion operation may switch out the faulty circuit(s) and the conversion may result in a slightly slower, but still functional part, etc.

Thus, for example, in one embodiment of a stacked memory package, one or more of the stacked memory chips may be converted stacked memory chips.

The conversion of one or more aspects (e.g., chip appearance, operation, function, behavior, parameter, etc.) may involve aspects that may be tangible (e.g., concrete, etc.) and/or aspects that may be intangible (e.g., abstract, virtual, etc.). For example, a conversion may allow two portions (e.g., first portion and second portion) of a memory chip to function (e.g., appear, etc.) as a single portion (e.g., third portion) of a memory chip. For example, the first portion and the second portion may appear as tangible aspects while the third portion may appear as an intangible (e.g., virtual, abstract, etc.) aspect.

Such conversion may also operate at the chip level. For example, a stacked memory chip may have thee memory regions that may be designed to operate in the manner of a first memory function, e.g., to provide 16 bits. Thus, for example, the three memory regions may provide 16 bits from each of three memory regions. During manufacture, etc. a first memory region may be tested and found faulty. During manufacture, etc. the second and third memory regions may be tested and found to be working correctly. For example, the first memory region may be found capable of providing only 8 bits. In one embodiment, one or more memory regions may be converted so as to provide a working, but possibly potentially less capable, finished part. For example, the first memory region (e.g., the faulty memory region) may be converted to operate in the manner of a second memory function, e.g., to provide 8 bits. For example, the second memory region (e.g., working) may be converted to operate in the manner of a second memory function, e.g., to provide 8 bits. The converted part, for example, may now provide (or appear to provide, etc.) 16 bits from two memory regions e.g., 16 bits from the (working) third memory region and 8 bits from the (converted, originally faulty) first memory region aggregated with 8 bits from the (converted, originally working) second memory region. The aggregation may be performed, for example, on the memory chip and/or on a logic chip in a stacked memory package, etc. Of course any such conversion scheme may be used to convert any aspect of the memory chip behavior (e.g., circuit block connections, timing parameters, functional behavior, error coding schemes, test and/or characterization modes, monitoring systems, power states and/or power-saving behavior/modes, memory configurations, memory organizations, mode and/or register settings, clock settings, spare memory regions and/or other spare or redundant structures, bus structures, IO circuit functions, register settings, etc.) so that one or more aspects of a memory chip behavior may be converted from the behavior of a first type of memory chip to the behavior of a second type of memory chip.

In one embodiment of a stacked memory package, the behavior of the stacked memory package may be converted. For example, the behavior of the stacked memory package may be converted by converting one or more stacked memory chips. For example, the behavior of the stacked memory package may be converted by converting one or more logic chips in the stacked memory package. Any aspect of the logic chip behavior may be converted (e.g., circuit block connections, circuit operation and/or modes of operation, timing parameters, functional behavior, error coding schemes, test and/or characterization modes, monitoring systems, power states and/or power-saving behavior/modes, memory configurations, memory organizations, content of on-chip memory (e.g., embedded DRAM, SRAM, NVRAM, etc.), internal program code, firmware, bus structures, bus functions, bus priorities, IO circuit functions, IO termination schemes, IO characterization patterns, serial link and lane structures and/or configurations, clocking, error handling, error masking, error reporting, error signaling, mode registers, register settings, etc.). For example, the behavior of the stacked memory package may be converted by converting one or more logic chips in the stacked memory package and one or more stacked memory chips in the stacked memory package. Any aspect of the combination of logic chip(s) with one or more stacked memory chips may be converted (e.g. TSV connections, other chip to chip coupling means, circuit block connections, timing parameters, functional behavior, error coding schemes, test and/or characterization modes, monitoring systems, power states and/or power-saving behavior/modes, power-supply voltage modes, memory configurations, memory organizations, bus structures, IO circuit functions, register settings, etc.).

In one embodiment, the conversion of a part (e.g., stacked memory package, stacked memory chip, logic chip, combinations of these, etc.) may happen at manufacture or test time. Such conversion may effectively increase the yield of parts and/or reduce manufacturing costs, for example. In one embodiment, the conversion may be permanent (e.g., by blowing fuses, etc.). In one embodiment, the conversion may require information on the conversion to be stored and applied to the part(s), combinations of parts, etc. at a later time. The storage of conversion information may be in software supplied with the part, for example, and loaded at run time (e.g., system boot, etc.).

In one embodiment, the conversion(s) of part(s) may occur at run time. For example, one or more portions of one or more parts may fail at run time. The failure(s) may be detected (e.g., by the CPU, by a logic chip in a stacked memory package, by an error signal or other error indication originating from one or more memory chips, from an error signal from the stacked memory package, from combinations of these and/or other indications, etc.). As a result of the failure detection one or more conversions of one or more parts may be initiated, scheduled (e.g., for future events such as system re-start, etc.), recommended (e.g., to the CPU and/or user, system supervisor, etc.), or other restorative, corrective, preventative, precautionary, etc. actions performed, etc. For example, as a result of failure(s) or indications of impending failure(s) the conversion of one or more parts in the memory system may put the memory system in an altered but still operative mode (e.g., limp home mode, degraded mode, basic mode, subset mode, emergency mode, shut down mode, etc.). Such a mode may allow the system to fail gracefully, or provide time for the system to be shut down gracefully and repaired, etc.

As one example, one or more links of a stacked memory package may fail in operation during run-time. The failures may be detected (as described above, for example) and a conversion scheduled. For example, the scheduled conversion may replace one or more links. For example, the scheduled conversion may reconfigure the memory system network or trigger (e.g., initiate, program, recommend, etc.) a reconfiguration of the memory system network. The memory system network may comprise multiple nodes (e.g., CPUs, stacked memory packages, other system components, etc.). The memory system reconfiguration may remove nodes (e.g., disable one or more functions in a logic chip in a stacked memory package, etc.), alter nodes (e.g., initiate and/or command a conversion or other operation to be performed on one or more stacked memory packages, etc.), change routing (e.g., modify the FIB behavior, otherwise modify the routing behavior, etc), or make other memory system network topology and/or function changes, etc. For example, the scheduled conversion may reconfigure the connection containing the failed links to use fewer links.

As another example, one or more memory cells in a stacked memory package may fail in operation during run time. The failures may cause a flood of error messages that may threaten to overwhelm the system. The logic chip in the stacked memory package may decide (e.g., under internal program control triggered by monitoring the error messages, under system and/or CPU command, etc.) to effect a conversion and suspend or otherwise change error message behavior. For example, the logic chip may suspend error messages (e.g., temporarily, periodically, permanently, etc.). The temporary, periodic, and/or permanent cessation of error messages may allow, for example, a CPU to recover and possibly make a decision (possibly in cooperation with the logic chip, etc.) on the next course of action. The logic chip may perform a series of operations in addition to the conversion operation(s). In the above example, the logic chip may also schedule a repair and/or replacement operation (which may or may not be treated as a conversion operation, etc.) for the faulty memory region(s), etc. In the above example, the logic chip may also schedule a second conversion (e.g., more than one conversion may be performed, conversions may be related, etc.). For example, the logic chip may schedule a second conversion in order to change the error protection scheme for the faulty memory region(s), etc.

In one embodiment, the decision(s) to schedule conversion(s), the scheduling of conversion(s), the decision(s) on the nature, number, type, etc. of conversion(s) may be performed, for example, by one or more logic chips in one or more stacked memory packages and/or by one or more CPUs connected (e.g., coupled directly or indirectly, local or remote, etc.) to the memory system, or by combinations of these, etc. For example, the stacked memory package may contain a logic chip with an embedded CPU (or equivalent state machine, etc.) and program code and/or microcode and/or firmware, etc. (e.g., stored in SRAM, embedded DRAM, NVRAM, stacked memory chips, combinations of these, etc.). The logic chip may thus be capable of performing conversion operations autonomously (e.g., under its own control, etc.) or semi-autonomously. For example, the logic chip in a stacked memory package may operate to perform conversions in cooperation with other system components, e.g., one or more CPUs, other logic chips, combinations of these, with inputs (e.g., commands, signals, data, etc.) from these components, etc.

### FIG. 19-16

FIG. 19-16 shows a system for stacked memory chip identification 19-1600, in accordance with one embodiment. As an option, the system for stacked memory chip identification may be implemented in the context of the previous Figures and/or any other Figure(s). Of course, however, the system for stacked memory chip identification may be implemented in the context of any desired environment.

For example, in FIG. 19-16, the system for stacked memory chip identification may be implemented, for example, in the context shown in FIG. 12 and/or FIG. 13, together with the accompanying text, of U.S. Provisional Application No. 61/569,107, filed Dec. 9, 2011, titled “SYSTEM, METHOD, AND COMPUTER PROGRAM PRODUCT FOR IMPROVING MEMORY SYSTEMS”.

In a stacked memory package, it may be required for all stacked memory chips to be identical (e.g., use the same manufacturing masks, etc.). In that case it may be difficult for an attached logic chip to address each, apparently identical, stacked memory chip independently (e.g., uniquely, etc.). The challenge amounts to finding a way to uniquely identify (e.g., label, mark, etc.) each identical stacked memory chip. In FIG. 19-16, there may be four stacked memory chips, SMC0 19-1610, SMC1 19-1612, SMC2 19-1614, SMC3 19-1616. Of course, any number of stacked memory chips may be used. In FIG. 19-16, there may be two logic chips, 19-1620, 19-1622. Of course, any number of logic chips may be used. In one embodiment, one or more of the logic chips in a stacked memory package may be operable to imprint a unique label on one or more of the stacked memory chips in the stacked memory package. In FIG. 19-16, the logic chips may be connected (e.g., coupled, etc.) to the stacked memory chips using four separate buses: 19-1624, 19-19-26, 19-1628, 19-1630 e.g., one separate bus for each stacked memory chip. The four separate buses may be constructed (e.g., designed, etc.) using, for example, TSV connections in the context, for example, of Bus 2 in FIG. 13 of U.S. Provisional Application No. 61/569,107, filed Dec. 9, 2011, titled “SYSTEM, METHOD, AND COMPUTER PROGRAM PRODUCT FOR IMPROVING MEMORY SYSTEMS.” In FIG. 19-16, the logic chips may be connected to the stacked memory chips using one common (e.g., shared, etc.) bus 19-1624.

In one embodiment, a logic chip may, at a first time, forward a unique code (e.g., label, binary number, tag, etc.) to one or more (e.g., including all) stacked memory chips. The stacked memory chip may store the unique label in a register, etc. At a later, second time, a logic chip may send a command to one or more (e.g., including all) of the stacked memory chips on the shared bus. The command may for example, contain the label 01 in a label field in the command. A stacked memory chip may compare the label field in the command with its own unique label. In one embodiment, only the stacked memory chip whose label matches the label in the command may respond to the command. For example, in FIG. 19-16 only stacked memory chip SMC1 with a unique label of 01 may respond to a command with label 01.

Of course, there may be (and typically will be) many buses equivalent to the shared bus (e.g., many copies of the shared bus). Each stacked memory chip may use its unique label to identify commands on each shared bus. Although separate buses may be used for each command, it may be require less area and fewer TSV connections to use a shared bus. Thus the use of a system for stacked memory chip identification may save TSV connections, save die area and thus increase yield, reduce costs, etc.

In one embodiment, the system for stacked memory chip identification just described may be used for a portion or for portions of one or more stacked memory chips. For example, each portion (e.g., an echelon, part of an echelon, etc.) or a group of portions (e.g., on one or more stacked memory chips, etc.) may have a unique identification.

In one embodiment, the system for stacked memory chip identification just described may be used with one or more buses that may be contained (e.g., designed, used, etc.) on a stacked memory chip and/or logic chip(s). For example, one or more buses may couple (e.g., connect, communicate with, etc.) one or more portions (e.g., an echelon, part of an echelon, parts of an echelon, other parts or portions or groups of portions of one or more stacked memory chips, combinations of these, etc.) of one or more stacked memory chips and/or parts or portions or groups of portions of one or more logic chips, etc. The buses may be used, for example, to form a network or networks on one or more logic chip(s) and/or stacked memory chip(s). The identification system may be used to provide unique labels for one or more of these portions of one or more stacked memory chips, and/or one or more logic chips, etc.

In one embodiment, the system for stacked memory chip identification just described may be extended to encompass more complex bus operations. For example, in one embodiment, chips may be imprinted with more than one label. For example: SMC0 may have a label of a first type of 00, a label of a second type 0; SMC1 may have a label of a first type of 01, a label of a second type 0; SMC2 may have a label of a first type of 10, a label of a second type 1; SMC3 may have a label of a first type of 11, a label of a second type 1. A logic chip may send a command on a first shared bus with a label of the first type and, for example, only one stacked memory chip may respond to the command. A logic chip may send a command on a second shared bus with a label of the second type and, for example, two stacked memory chips may respond to the command. Other similar schemes may be used. For example, a logic chip may send a command on a first shared bus with a label of the first type and flag(s) in the command set that may direct the stacked memory chips to treat one or more of the label fields as don't care bit(s). Thus, for example, only one stacked memory chip may respond to the command (no don't care bits), two stacked memory chip may respond to the command (one don't care bit), four stacked memory chip may respond to the command (two don't care bits).

In one embodiment, buses in a stacked memory package may be switched from separate to multi-way shared by using labels. Thus for example, a bus connecting a logic chip to four stacked memory chips may operate in one of several bus modes: (1) as a shared bus connecting a logic chip to all four stacked memory chips, (2) as a two shared buses connecting any two sets of two stacked memory chips (e.g., 4×3/2=6 sets), (3) as three buses with two separate buses connecting the logic chip to one stacked memory chip and one shared bus connecting the logic chip to two stacked memory chips, (4) combinations of these and/or other modes, configurations, etc.

These bus modes (e.g., configurations, functions, etc.) may be used, for example, to configure (e.g., modes, width, speed, priority, other functions and/or logical behavior, etc.) address buses, command buses, data buses, other buses or bus types on the logic chip(s) and/or stacked memory chip(s), and/or buses between logic chip(s) and stacked memory chip(s). Bus modes may be configured at start-up (e.g., boot time) or configured at run time (e.g., during operation, etc.). For example, an address bus, and/or command bus, and/or data bus may be switched from separate to shared during operation, etc.

Thus, for example, such bus modes, bus mode configuration methods, and systems for stacked memory chip identification as described above may be used to switch between configurations shown in the context of FIG. 13 of U.S. Provisional Application No. 61/569,107, filed Dec. 9, 2011, titled “SYSTEM, METHOD, AND COMPUTER PROGRAM PRODUCT FOR IMPROVING MEMORY SYSTEMS.”

FIG. 19-17

FIG. 19-17 shows a memory bus mode configuration system 19-1700, in accordance with one embodiment. As an option, the memory bus mode configuration system may be implemented in the context of the previous Figures and/or any other Figure(s). Of course, however, the memory bus mode configuration system may be implemented in the context of any desired environment.

For example, in FIG. 19-17, the memory bus mode configuration system may be implemented in the context shown in FIG. 19-16 of this application and/or FIG. 12 and/or FIG. 13, together with the accompanying text, of U.S. Provisional Application No. 61/569,107, filed Dec. 9, 2011, titled “SYSTEM, METHOD, AND COMPUTER PROGRAM PRODUCT FOR IMPROVING MEMORY SYSTEMS”.

In FIG. 19-17, memory chip SMC0 19-1710 and memory chip SMC1 19-1712 may be stacked memory chips, parts or portions of stacked memory chips, groups of portions of stacked memory chips (e.g., echelons, etc.), combinations of these and/or other parts or portions of one or more stacked memory chips, or other memory chips, etc. In FIG. 19-17, memory chip SMC0 19-1710 and memory chip SMC1 19-1712 may be parts or portions of a single stacked memory chip (e.g., SMC0 and SMC1 may be on the same stacked memory chip, etc.) or other memory chip, etc. For example, SMC0 and SMC1 may be banks, parts of a bank, subarrays, parts of an echelon, combinations of these and/or other parts or portions of a stacked memory chip, other memory chip, etc.

In FIG. 19-17, memory chip SMC0 19-1710 and memory chip SMC1 19-1712 may be coupled by two buses: memory bus MB0 19-1716 and memory bus MB1 19-1714. For example MB0 may be a data bus. For example, MB1 may be a command and address bus (e.g., command and address multiplexed onto one bus, etc.). In one embodiment, it may be desired to switch one or more memory buses between shared and separate modes of operation. In FIG. 19-17, there are two memory chips, but any number of memory chips may be used. In FIG. 19-17, there are two buses, but any number of buses may be used.

For example, in a first configuration, it may be required to operate MB0 as a shared data bus (e.g., as if both SMC0 and SMC1 shared one data bus, etc.). In this first configuration it may be required that MB1 operate as a shared command/address bus (e.g., as if both SMC0 and SMC1 shared one command/address bus, etc.).

For example, in a second configuration, it may be required to operate MB0 as a shared data bus (e.g., as if both SMC0 and SMC1 shared one data bus, etc.). In this second configuration it may be required that MB1 operate as a separate command/address bus (e.g., as if both SMC0 and SMC1 have a dedicated separate command/address bus, etc.).

For example, in a third configuration, it may be required to operate MB0 as a separate data bus (e.g., as if both SMC0 and SMC1 have a dedicated separate data bus, etc.). In this third configuration it may be required that MB1 operate as a shared command/address bus (e.g., as if both SMC0 and SMC1 shared one command/address bus, etc.).

For example, in a fourth configuration, it may be required to operate MB0 as a separate data bus (e.g., as if both SMC0 and SMC1 have a dedicated separate data bus, etc.). In this fourth configuration it may be required that MB1 operate as a separate command/address bus (e.g., as if both SMC0 and SMC1 have a dedicated separate command/address bus, etc.).

Of course, such configurations as just described may be used together, configurations may be switched (e.g., programmable, etc.), more than one configuration may be used on one or more buses at the same time, etc. Configurations may be applied to multiple buses. For example, SMC0 and SMC1 may have one, two, three, or any number of buses which may be configured (e.g., switched, programmed etc.) in any number of configurations or combination(s) of configurations, etc. Of course, any number of memory chips may be coupled by any number of programmable buses.

Using the bus modes, bus mode configuration methods, and systems for stacked memory chip identification as described above in the context of FIG. 19-16, the buses may be configured (possibly dynamically, e.g., at run-time, etc.) to be any of the four configurations described. Of course, in general, one or more buses may be programmed (e.g., configured, etc.) to any number of possible configuration modes, etc.

Of course, any number of buses and/or any number of memory chips may be used. Of course, separated command buses and address buses (e.g., distinct, demultiplexed command bus and address bus(es), etc.) may be used (e.g., including possibly separate buses for row address, column address, bank address, other address, etc.).

### FIG. 19-18

FIG. 19-18 shows a memory bus merging system 19-1800, in accordance with one embodiment. As an option, the memory bus merging system may be implemented in the context of the previous Figures and/or any other Figure(s). Of course, however, the memory bus merging system may be implemented in the context of any desired environment.

For example, in FIG. 19-18, the memory bus merging system may be implemented in the context shown in FIG. 13 of U.S. Provisional Application No. 61/569,107, filed Dec. 9, 2011, titled “SYSTEM, METHOD, AND COMPUTER PROGRAM PRODUCT FOR IMPROVING MEMORY SYSTEMS” and/or FIG. 14 of U.S. Provisional Application No. 61/602,034, filed Feb. 22, 2012, titled “SYSTEM, METHOD, AND COMPUTER PROGRAM PRODUCT FOR IMPROVING MEMORY SYSTEMS.”

In FIG. 19-17, memory chip SMC0 19-1810 and memory chip SMC1 19-1812 may be stacked memory chips, parts or portions of stacked memory chips, groups of portions of stacked memory chips (e.g., echelons, etc.), combinations of these and/or other parts or portions of one or more stacked memory chips, or other memory chips, etc. In FIG. 19-17, memory chip SMC0 19-1810 and memory chip SMC1 19-1812 may be parts or portions of a single stacked memory chip (e.g., SMC0 and SMC1 may be on the same stacked memory chip, etc.) or other memory chip, etc. For example, SMC0 and SMC1 may be banks, parts of a bank, subarrays, parts of an echelon, combinations of these and/or other parts or portions of a stacked memory chip, or other memory chip, etc.

In FIG. 19-18, memory chip SMC0 19-1810 and memory chip SMC1 19-1812 may be coupled by three buses: memory bus MB0 19-1816, memory bus MB1 19-1814, memory bus MB2 19-1818. For example, MB0 may be a command/address bus. For example MB1 and MB2 may be data buses. In one embodiment, it may be desired to switch one or more data buses between shared and separate modes of operation. For example, it may be required to merge two or more buses to a single bus. For example, it may be required to split one bus to one or more separate buses. Thus, for example, in FIG. 19-18, in a first configuration it may be required to operate MB1 as a separate 64-bit data bus and MB2 as a separate 64-bit data bus. Thus, for example, in FIG. 19-18, in a second configuration it may be required to operate MB1 and MB2 as a shared 128-bit data bus. Using the bus modes, bus mode configuration methods, and systems for stacked memory chip identification as described above in the context of FIG. 19-16, the buses may be configured (possibly dynamically, e.g., at run-time, etc.) to be either of the two configurations.

Of course, any number of buses may be merged and/or split in any fashion or combinations (e.g., two buses merged to one, one bus split to two, four buses merged to three, three buses split to nine, combinations of merge(s) and/or split(s), etc.). Of course, any number of memory chips may be coupled by any number of buses.

As an option, the memory bus merging system of FIG. 19-18 may be implemented in the context of the architecture and environment of the previous Figures and/or any subsequent Figure(s). Of course, however, the memory bus merging system of FIG. 19-18 may be implemented in the context of any desired environment.

As one example, one or more aspects of the various embodiments of the present invention may be included in an article of manufacture (e.g., one or more computer program products) having, for instance, computer usable media. The media has embodied therein, for instance, computer readable program code for providing and facilitating the capabilities of the various embodiments of the present invention. The article of manufacture can be included as a part of a computer system or sold separately.

Additionally, one or more aspects of the various embodiments of the present invention may be designed using computer readable program code for providing and/or facilitating the capabilities of the various embodiments or configurations of embodiments of the present invention.

Additionally, one or more aspects of the various embodiments of the present invention may use computer readable program code for providing and facilitating the capabilities of the various embodiments or configurations of embodiments of the present invention and that may be included as a part of a computer system and/or memory system and/or sold separately.

Additionally, at least one program storage device readable by a machine, tangibly embodying at least one program of instructions executable by the machine to perform the capabilities of the various embodiments of the present invention can be provided.

The diagrams depicted herein are examples. There may be many variations to these diagrams or the steps (or operations) described therein without departing from the spirit of the various embodiments of the invention. For instance, the steps may be performed in a differing order, or steps may be added, deleted or modified. All of these variations are considered a part of the claimed invention.

In various optional embodiments, the features, capabilities, techniques, and/or technology, etc. of the memory and/or storage devices, networks, mobile devices, peripherals, hardware, and/or software, etc. disclosed in the following applications may or may not be incorporated into any of the embodiments disclosed herein: U.S. Provisional Application No. 61/472,558, filed Apr. 6, 2011, titled “Multiple class memory systems”; U.S. Provisional Application No. 61/502,100, filed Jun. 28, 2011, titled “SYSTEM, METHOD, AND COMPUTER PROGRAM PRODUCT FOR IMPROVING MEMORY SYSTEMS”; U.S. Provisional Application No. 61/515,835, filed Aug. 5, 2011, titled “STORAGE SYSTEMS”; U.S. Provisional Application No. 61/566,577, filed Dec. 2, 2011, titled “IMPROVED MOBILE DEVICES”; U.S. Provisional Application No. 61/470,336, filed Mar. 31, 2011, titled “SYSTEM, METHOD, AND COMPUTER PROGRAM PRODUCT FOR UTILIZING IMAGE RECOGNITION TO PERFORM AN ACTION”; U.S. Provisional Application No. 61/470,391, filed Mar. 31, 2011, titled “SYSTEM, METHOD, AND COMPUTER PROGRAM PRODUCT FOR ENABLING A PERIPHERAL DEVICE TO UTILIZE FUNCTIONALITY ASSOCIATED WITH A MOBILE DEVICE”; U.S. Provisional Application No. 61/569,213, filed Dec. 9, 2011, titled “SYSTEM, METHOD, AND COMPUTER PROGRAM PRODUCT FOR MODIFYING CONTENT”; U.S. Provisional Application No. 61/569,107, filed Dec. 9, 2011, titled “SYSTEM, METHOD, AND COMPUTER PROGRAM PRODUCT FOR IMPROVING MEMORY SYSTEMS”; U.S. Provisional Application No. 61/580,300, filed Dec. 26, 2011, titled “SYSTEM, METHOD, AND COMPUTER PROGRAM PRODUCT FOR IMPROVING MEMORY SYSTEMS”; U.S. Provisional Application No. 61/585,640, filed Jan. 31, 2012, titled “SYSTEM, METHOD, AND COMPUTER PROGRAM PRODUCT FOR IMPROVING MEMORY SYSTEMS”; U.S. Provisional Application No. 61/581,918, filed Jan. 13, 2012, titled “USER INTERFACE SYSTEM, METHOD, AND COMPUTER PROGRAM PRODUCT”; U.S. Provisional Application No. 61/602,034, filed Feb. 22, 2012, titled “SYSTEM, METHOD, AND COMPUTER PROGRAM PRODUCT FOR IMPROVING MEMORY SYSTEMS”; U.S. Provisional Application No. 61/608,085, filed Mar. 7, 2012, titled “SYSTEM, METHOD, AND COMPUTER PROGRAM PRODUCT FOR IMPROVING MEMORY SYSTEMS”; U.S. Provisional Application No. 61/635,834, filed Apr. 19, 2012, titled “SYSTEM, METHOD, AND COMPUTER PROGRAM PRODUCT FOR IMPROVING MEMORY SYSTEMS”; U.S. application Ser. No. 13/441,132, filed Apr. 6, 2012, titled “MULTIPLE CLASS MEMORY SYSTEMS”; U.S. application Ser. No. 13/433,283, filed Mar. 28, 2012, titled “SYSTEM, METHOD, AND COMPUTER PROGRAM PRODUCT FOR ENABLING A PERIPHERAL DEVICE TO UTILIZE FUNCTIONALITY ASSOCIATED WITH A MOBILE DEVICE”; and U.S. application Ser. No. 13/433,279, filed Mar. 28, 2012, titled “SYSTEM, METHOD, AND COMPUTER PROGRAM PRODUCT FOR UTILIZING IMAGE RECOGNITION TO PERFORM AN ACTION”; and U.S. Provisional Application No. 61/647,492, filed May 15, 2012, titled “SYSTEM, METHOD, AND COMPUTER PROGRAM PRODUCT FOR CONFIGURING A SYSTEM ASSOCIATED WITH MEMORY.” Each of the foregoing applications are hereby incorporated by reference in their entirety for all purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. An apparatus, comprising:
a first semiconductor platform including a first memory; and
a second semiconductor platform stacked with the first semiconductor platform, the second semiconductor platform including a second memory;
circuitry in communication with the first semiconductor platform and the second semiconductor platform, the circuitry:
identifying one or more faulty components of the apparatus, the identified one or more faulty components capable of including: a through-silicon via (TSV) between the first memory and the second memory, and a memory cell of at least one of the first memory or the second memory; and
adjusting at least one aspect of the apparatus to repair the identified one or more faulty components, in response to the identification of the one or more faulty components of the apparatus.

2. The apparatus of claim 1, wherein the apparatus is configured such that the circuitry includes a logic chip.

3. The apparatus of claim 1, wherein the apparatus is configured such that the circuitry is located on a same die as at least one of the first semiconductor platform or the second semiconductor platform.

4. The apparatus of claim 1, wherein the apparatus is configured such that the circuitry is located on a same die as a processor that is separate from the first semiconductor platform and the second semiconductor platform.

5. The apparatus of claim 1, wherein the apparatus is configured such that the circuitry includes a multiplexer in communication with an input/output pin.

6. The apparatus of claim 1, wherein the apparatus is configured such that the circuitry includes a multiplexer that is programmable at manufacture before run time, in response to the identification of the one or more faulty components of the apparatus.

7. The apparatus of claim 1, wherein the apparatus is configured such that the circuitry includes a multiplexer that is programmable at run time, in response to the identification of the one or more faulty components of the apparatus.

8. The apparatus of claim 1, wherein the apparatus is configured such that the adjusting results in the repair of the identified one or more faulty components of the apparatus, which includes at least a portion of a bank of the first memory that corresponds to a row address.

9. The apparatus of claim 1, wherein the apparatus is configured such that the adjusting results in a permanent repair of identified the one or more faulty components of the apparatus.

10. The apparatus of claim 1, wherein the apparatus is configured such that the adjusting results in a non-permanent repair, utilizing a look-up table, of the identified one or more faulty components of the apparatus that includes one or more memory locations, such that the look-up table is utilized to substitute the one or more memory locations with one or more other memory locations.

11. The apparatus of claim 1, wherein the apparatus is configured such that the identified one or more faulty components includes the TSV.

12. The apparatus of claim 1, wherein the apparatus is configured such that the identified one or more faulty components includes at least one lane.

13. The apparatus of claim 1, wherein the apparatus is configured such that the adjusting includes reallocating one or more wire connections.

14. The apparatus of claim 1, wherein the apparatus is configured such that the adjusting results in the repair of the identified one or more faulty components, utilizing one or more fuses.

15. The apparatus of claim 1, wherein the apparatus is configured such that the adjusting results in the repair of the identified one or more faulty components of the apparatus, utilizing one or more spare memory resources in a stacked memory package including the first semiconductor platform and the second semiconductor platform, where a number of the one or more spare memory resources is communicated via a control bus.

16. The apparatus of claim 1, wherein the apparatus is configured such that the adjusting results in the repair of the identified one or more faulty components of the apparatus, utilizing repair information on one or more repair actions that is communicated between a separate processor and the circuitry.

17. The apparatus of claim 1, wherein the apparatus is configured such that the circuitry performs a self-test utilizing one or more patterns applied to one or more portions of at least one of the first semiconductor platform or the second semiconductor platform.

18. The apparatus of claim 1, wherein the apparatus is configured such that the circuitry includes a built-in self-test (BIST) controlled utilizing signals that are independent of memory signals.

19. The apparatus of claim 1, wherein the apparatus is configured such that the adjusting is in connection with a write or read command, and the at least one aspect includes a configuration of a register that is adjusted in response to the write or read command.

20. The apparatus of claim 1, wherein the apparatus is configured such that the identifying is performed by the circuitry, utilizing a loopback function and a linear feedback shift register (LFSR).

21. The apparatus of claim 1, wherein the apparatus is configured such that temperature-based refresh timing-related information is encoded for being conveyed to control a refresh of the first memory that includes dynamic random access memory (DRAM).

22. The apparatus of claim 1, wherein the apparatus is configured such that temperature-based refresh timing-related information is encoded for being conveyed to control a refresh of the first memory that includes dynamic random access memory (DRAM), where the temperature-based refresh timing-related information is updated utilizing stored information, in response to a temperature change.

23. The apparatus of claim 1, wherein the apparatus is configured such that at least one of the first semiconductor platform or the second semiconductor platform, includes a plurality of TSV data buses that are divided into one or more groups each corresponding to at least a portion of a memory array of at least one of the first semiconductor platform or the second semiconductor platform.

24. The apparatus of claim 23, wherein the apparatus is configured such that the at least portion of a memory array includes a subarray of the memory array.

25. The apparatus of claim 24, wherein the apparatus is configured such that the subarray corresponds to a portion of the memory array corresponding to a row buffer.

26. The apparatus of claim 1, wherein the apparatus is configured such that access to the first memory is divided into one or more virtual channels addressed utilizing an address field.

27. The apparatus of claim 1, wherein the apparatus is configured such that the circuit periodically performs error detection and error scrubbing during runtime.

28. The apparatus of claim 1, wherein the apparatus is configured such that the circuitry includes a timing control circuit that, during an initialization of the apparatus, measures to determine one or more delay properties of one or more interconnect structures, for adjusting a signal timing to align with one or more strobes.

29. The apparatus of claim 27, wherein the apparatus is configured such that the one or more interconnect structures include the TSV.

30. An apparatus, comprising:
one or more processors;
one or more memories in communication with the one or more processors; and
one or more programs, wherein the one or more programs are stored in the one or more memories and configured to be executed by the one or more processors, the one or more programs including instructions for:
causing a signal to be sent to a memory subsystem including: a first semiconductor platform including a first memory, a second semiconductor platform including a second memory stacked with the first semiconductor platform, and circuitry in communication with the first semiconductor platform and the second semiconductor platform, the signal causing an adjustment of at least one aspect, for repairing one or more faulty components of the memory subsystem capable of including: a through-silicon via (TSV) between the first memory and the second memory, and a memory cell of at least one of the first memory or the second memory.
